(19) United States
(12) Patent Application Publication
(10) Pub. No.: US 2018/0178184 A1
(43) Pub. Date: Jun. 28, 2018

(54) METHOD AND APPARATUS FOR CONDITIONING FLUIDS

(71) Applicant: Wilsa Holdings, LLC, Houston, TX (US)

(72) Inventor: Herbert William Holland, Houston, TX (US)

(21) Appl. No.: 15/797,829

(22) Filed: Oct. 30, 2017

Related U.S. Application Data
(63) Continuation of application No. PCT/US2016/030192, filed on Apr. 29, 2016.
(60) Provisional application No. 62/154,974, filed on Apr. 30, 2015.

(51) Int. Cl. B01J 19/08; C02F 1/48; B01D 17/04; B01D 21/00; B01F 3/12

(52) U.S. Cl. CPC B01J 19/087; C02F 1/487; C02F 2103/10; B01D 21/0009; B01F 3/1235; B01D 17/04

(57) ABSTRACT

An apparatus, comprising a magnetically conductive conduit having a fluid entry port, a fluid impervious boundary wall and a fluid discharge port defining a fluid impervious flow path through the magnetically conductive conduit, at least one end of the conduit having a taper forming a planar surface extending from an outer to an inner surface; an electrical conductor comprising a length of an electrical conducting material having a first and second conductor lead, the electrical conductor coiled with at least one turn to form an uninterrupted coil of electrical conductor encircling a section of the outer surface of the magnetically conductive conduit; and an electrical power supply operably connected to at least one of the first and second conductor leads, wherein the at least one coiled electrical conductor is thereby energized to provide a magnetic field having lines of flux directed along a longitudinal axis of the magnetically conductive conduit.

### INCORPORATION BY REFERENCE

The present patent application claims priority to the PCT patent application no. PCT/US2016/030192, having an international filing date of Apr. 29, 2016, and which claims priority to a provisional patent application identified by U.S. Ser. No. 62/154,974, filed Apr. 30, 2015, titled “Method and Apparatus for Conditioning Fluids”, the entire contents of which are hereby incorporated herein by reference.

### BACKGROUND

There are many practical advantages to altering at least one physical property of fluids. Several applications include improved phase separation, blending of distinct phases into a homogenous mixture, increasing the flow rate of fluids subjected to a constant pressure, and/or reducing the pressure required to maintain one or more fluids at a constant flow rate.

A phase is defined as a region of material in a thermodynamic system that is physically distinct, chemically uniform, and typically mechanically separable. The three common states of matter are historically known as solid, liquid and gas; their distinction commonly based on qualitative differences in the bulk properties of the phase in which each exists. A solid phase maintains a fixed volume and shape. A liquid phase has a volume that varies only slightly but adapts to the shape of its container. A gas phase expands to occupy the volume and shape of its container.

Physical properties of a phase do not change the chemical nature of matter and are traditionally defined by classic mechanics that include, but are not limited to, area, capacitance, concentration, density, dielectric, distribution, efficacy, elasticity, electric charge, electrical conductivity, electrical impedance, electric field, electric potential, electromagnetic absorption, electromagnetic permittivity, emission, flexibility, flow rate, fluidity, frequency, hardness, inductance, intrinsic impedance, intensity, irradiation, magnetic field, magnetic flux, magnetic moment, mass, opacity, permeability, physical absorption, pressure, radiance, resistivity, reflectivity, solubility, specific heat, temperature, tension, thermal conductivity, velocity, viscosity, volume, and wave impedance. Phases may also be differentiated by solubility, the maximum amount of a solute that can dissolve in a solvent before the solute ceases to dissolve and remains in a separate phase. Water (a polar liquid) and oil (a non-polar liquid) can be separated into two phases because water has very low solubility in oil, and oil has a low solubility in water. The concept of phase separation also extends to the separation of solids from solids, solids from liquids, solids from vapors, liquids from vapors, and vapors from vapors.

Efficient mechanical separation and physical separation have a number of practical applications. In oilfield applications, for example, crude oil, natural gas (commonly referred to as “gas”), and other naturally occurring hydrocarbons, which also contain water, are typically found in porous rock formations. Hydrocarbons, water, and solid contaminants extracted from oil producing formations and flowing out of wellheads are directed through bulk recovery apparatus in order to recover marketable hydrocarbons. Crude oil, petroleum liquors, condensate, other liquid hydrocarbons and gas containing residual amounts of water and other contaminants are then transported to processing facilities while the water and solids flowing out of separators are processed for disposal. Some water extracted in the bulk recovery process may be injected into an oil producing formation in order to maintain the pressure in the oil producing formation while other water may be processed for reuse after removing trace amounts of crude oil, gas, solids, bacteria, or other contaminants that may be present.

As disclosed herein, a system and method has been developed whereby a fluid containing at least one polar substance can have one or more of its physical properties altered by subjecting the fluid to a sufficient amount of magnetic force. Such a magnetically conditioned fluid can have improved efficiencies for oil/water separation, water/solids separation, oil/water/solids separation and oil/water/solids/gas separation as well as an increased rate by which the fluid can separate into at least two distinct phases—depending on the composition of the fluid.

It has also been presently found that altering at least one physical property of a fluid containing at least one polar substance may alternatively be utilized to improve blending of two or more distinct phases into, for example but without limitation, a homogenous exploration and production fluid depending on the conditions of the system and method of subjecting the fluid to a magnetic force as described in detail herein.

As used herein, the term “fluid containing at least one polar substance” may encompass water, aqueous-based solutions, aqueous-based mixtures, aqueous solutions, exploration and production fluids, diesel compounds, and/or combinations thereof as well as any other fluids containing at least one polar substance as would be known to those of ordinary skill in the art.

Also as described herein, the fluid containing at least one polar substance may also be present in a mixture comprising the fluid containing at least one polar substance and at least one dissimilar material, wherein the “at least one dissimilar material” is defined herein to encompass hydrocarbon compounds, autotrophic organisms, biological contaminants, chemical compounds, solids, fats and/or combinations thereof. A mixture of a fluid containing at least one polar substance and at least one dissimilar material is also referred to herein simply as a “fluid mixture”.

Additionally, as used herein, a “conditioned fluid medium” is a fluid containing at least one polar substance and/or a fluid mixture (i.e., a mixture of a fluid containing at least one polar substance and at least one dissimilar material) that has been magnetically conditioned using the apparatus and method(s) described herein.

Hydrocarbon compounds may include, but are not limited to, crude oil, bitumen, shale oils, mineral oils, asphalt, lubricating oils, fuel oils, hydrocarbon fuels, natural gasses, other compounds whose molecules contain carbon, and/or equivalents.

Autotrophic organisms may include, but are not limited to, algaes, phototrophs, lithotrophs, chemotrophs, and other organisms that produce complex organic compounds from simple substances present in their immediate surroundings, and/or combinations and equivalents thereof.

Biological contaminants may include, but are not limited to, bacteria, such as Escherichia coli, Staphylococcus aureus, Streptococcus and Legionella bacteria; protozoa, such as cryptosporidium; parasites, such as Giardia lambia; sulfate-reducing bacteria in oilfield water; plants, viruses and bacteria in marine ballast water; mildew; viruses; pollen; other living organisms that can be hazardous to animal or human health and/or combinations and equivalents thereof.

Chemical compounds may include, but are not limited to, molecular compounds held together with covalent bonds, salts held together with ionic bonds, intermetallic compounds held together with metallic bonds, complexes held together with coordinated covalent bonds, other chemical substances consisting of two or more chemical elements that can be separated into simpler substances by chemical reactions, and/or combinations and equivalents thereof.

Solids may include, but are not limited to, metals, minerals, ceramics, polymers, organic solids, composite materials, natural organic materials having cellulose fibers imbedded in a matrix of lignin, biomaterials, other substances having structural rigidity and resistance to changes in shape or volume, and/or combinations and equivalents thereof.

Fats may include, but are not limited to, triglycerides, triesters of glycol, fatty acids, lipids, sebum, waste vegetable oils, animal fat, grease, other compounds that are generally soluble in organic solvents and generally insoluble in water, and/or combinations and equivalents thereof.

As used herein, the term “exploration and production fluid” may encompass water and at least one dissimilar material that can be propelled under pressure into a wellbore, hydrocarbon producing formation and/or reservoir and may refer to “drilling fluids”, “frac fluid”, “mud”, “drilling mud”, “completion fluid”, “acid”, “cement”, “injection well water”, “waterflood formation stimulant”, and combinations thereof or equivalent fluids utilized in oil and gas exploration and production known to those of ordinary skill in the art.

As also used herein, the term “aqueous-based mixture(s)” is used to refer to water-based streams that may, in one example but without limitation, be generated during oil and gas production and which comprise water (i.e., “a fluid containing at least one polar substance”) as well as at least one dissimilar material (as defined above). More particularly, the term “aqueous-based mixture” may encompass, for example but without limitation, (a) oilfield production fluid comprising water and at least one of crude oil, petroleum liquors, gas, solids and/or other materials extracted from hydrocarbon producing formations, (b) flowback water, (c) produced water, (d) brine, (e) formation water, (f) saltwater, (g) drilling fluids, (h) muds, (i) completion fluids, and combinations thereof as well as one or more equivalent water-based streams generated in oil and gas production as would be known to those of ordinary skill in the art.

Changing the physical properties of fluids containing at least one polar substance—including the above-defined “aqueous-based mixtures”—can be useful in separating marketable oil and other hydrocarbon products from water, reducing chemical usage when processing such mixtures, and eliminating emulsions at oil/water interfaces in oilfield separation vessels. For example, after the bulk separation of oil and/or gas from water, solids, and other materials extracted from hydrocarbon producing formations, aqueous-based mixtures may be managed in one of several ways, including for example but without limitation: (i) re-injection of the aqueous-based mixtures into disposal wells, (ii) using the aqueous-based mixtures for secondary oil recovery techniques like waterflooding, and/or (iii) using a filtered or “cleaned” version of the aqueous-based mixture for many purposes including injection into producing wells as, for example but without limitation, at least a portion of a hydraulic fracturing fluid.

Flowback water and produced water typically have high salinity along with high percentages of total suspended solids and total dissolved solids. Conventional management of these recovered fluids involves trucking aqueous-based mixtures to a wastewater disposal facility for injection into an underground formation void of viable oil and gas production. Flowback water and produced water received by disposal wells can contain 0.01%-5.0% free-floating and readily recoverable oil, depending on the efficiency of the initial separation apparatus used in the field to segregate marketable oil from produced water. The cost of managing aqueous-based mixtures is a significant factor in the profitability of oil and gas production, and operators are constantly searching for cost effective means of managing water for recycling, reuse, or release into the environment.

Some aqueous-based mixtures extracted in the bulk recovery process may be injected into an oil producing formation in a secondary oil recovery technique known as “waterflooding” that may be used when an oil producing reservoir's pressure has been depleted and marketable oil production falls off due to reduced operating pressure. Waterflooding a formation, by injecting produced water back into the reservoir where it originated, typically reestablishes sufficient pressure within a hydrocarbon producing formation to allow for the recovery of additional amounts of oil.

In many instances, it may be advantageous to alter at least one physical property of a fluid containing at least one polar substance to improve separation of, for example but without limitation, water from at least one solid material and/or hydrocarbon material in order to provide cleaner water for injection into producing formations. Further, altering at least one physical property of fluids containing at least one polar substance (like drilling fluids, muds, and completion fluids) may be utilized to improve the separation of drill cuttings, liquid phase materials, and solid phase materials from fluids. Additionally, the ability to alter at least one physical property of a fluid containing at least one polar substance to increase the flow rate of the fluid at a constant pressure after magnetic conditioning or reduce the pressure required to maintain a volume of the fluid at a constant flow rate after magnetic conditioning may have impacts in a variety of industries, including the oil and gas industry by increasing exploration and production productivity and/or reducing costs.

Additionally, as well-known in the art, frac fluid is a mixture of water, chemicals, and proppants (rigid particles of substantially uniform size used to hold fractures in a hydrocarbon producing reservoir open after a hydraulic fracturing treatment). In addition to naturally occurring sand grains, man-made or specially engineered proppants, such as resin-coated sand or high-strength ceramic materials, are carefully sorted for size and sphericity to provide efficient flow channels to allow fluids to flow from a reservoir to a wellbore. Flowback water (a portion of the water, chemicals and proppants in frac fluid plus water, solids phase materials, liquid phase hydrocarbons and gas phase hydrocarbons from the wellbore and producing formation) may be returned to the wellhead over a period of three to six weeks after fracturing a shale formation. At a certain point in the early life of a well, there is a transition from primarily recovering flowback water containing frac fluid to that of recovering produced water from the hydrocarbon producing formation.

Also as well-known in the art, produced water is an aqueous-based mixture trapped in underground formations brought to the surface along with oil and/or gas. Produced water can also be called “brine”, “saltwater”, or “formation water.” Because this water has resided within hydrocarbon bearing formations for centuries, it typically possesses some of the chemical characteristics of the formation and the hydrocarbons produced by a formation. Produced water may include water from a hydrocarbon producing reservoir, water injected into the formation, solids phase materials from the wellbore and producing formation, and any chemicals added during drilling, production, and/or treatment processes. The major constituents of interest in produced water are salt content, oil and grease, organic and inorganic chemicals and naturally occurring radioactive material (NORM).

Produced water is the largest waste stream generated in the oil and gas exploration and production process. Over the life of a hydrocarbon producing formation, it is estimated 7-10 times more produced water than hydrocarbons can flow out of a formation. Given the volume of water and magnitude of this waste stream, the handling and disposal of produced water is a key factor in exploration and production costs and one that must adequately protect the environment at the lowest cost to the operator.

The volume of produced water generated by oil and gas wells does not remain constant over time, and over the life of a conventional oil or gas well the water-to-oil/gas ratio increases. Water typically makes up a small percentage of produced fluids when a well initially comes on line, but over time the amount of water produced by a well tends to steadily increase and the amount of oil/gas that is recovered tends to decrease. As such, there is a need for a system capable of handling the water produced during exploration and production of natural resources and conditioning it such that the produced water can be used for additional purposes, as well as to extract any oil/gas therein so as to improve the efficiency of the extraction and production operation.

Additionally, in some circumstance it may be advantageous to alter the dispersive surface tension and/or the polar surface tension of a fluid in order to improve mechanical blending of two or more distinct phases into a homogenous mixture rather than separating the phases as previously discussed. For example, it is oftentimes desirable to blend food products into homogenous mixtures (e.g., milk, ketchup, etc.) that will not readily separate into distinct phases over time and/or during transport or storage.

A solid phase (e.g., bentonite) and a liquid phase (e.g., water) along with other additives may be blended to form drilling fluids used in oil and gas exploration and production. Such “drilling mud” provides hydrostatic pressure that prevents formation fluids from entering a wellbore, keeps drill bits cool during drilling while also extracting drill cuttings from the wellbore, and/or suspends drill cuttings whenever the drilling assembly is brought in and out of the hole. Homogenous mixtures of drilling mud improve the drilling process, as well as enhance the efficiency of pumps that circulate such fluids and also increase the efficiency of screens, shakers, and other apparatus downstream of the wellbore that extract drill cuttings (for example) and other contaminants from the drilling mud.

In light of the above, there is a need for both an apparatus and method capable of altering one or more physical properties of a fluid containing a polar substance and/or a mixture of the fluid containing a polar substance and at least one dissimilar material, by subjecting the fluid and/or mixture to a sufficient amount of magnetic force, whereby—depending on the conditions of the method and apparatus—the fluid and/or mixture can have improved separation properties or improved blending properties.

### SUMMARY

The presently claimed and/or disclosed inventive concept(s) for conditioning fluids includes the step of directing a fluid containing at least one polar substance through a magnetically energized conduit in order to provide a conditioned fluid medium (also referred to herein as simply a “conditioned fluid”). In some instances, the conditioned fluid medium may then be directed to pass through a separation apparatus. Such conditioned fluid mediums are found to have improved efficiency of oil/water separation, water/solids separation, and oil/water/solids separation as well as an increased rate by which a fluid mixture separates into at least two distinct phases—depending on the conditions of the apparatus and methods used to magnetically condition the fluid.

The presently claimed and/or disclosed inventive concepts may also be utilized to alter at least one of a dispersive surface tension, a polar surface tension, and viscosity of a fluid containing at least one polar substance or alter at least one physical property of a fluid containing at least one polar substance flowing under pressure.

The total surface tension of a fluid is the sum of the dispersive surface tension component and the polar surface tension component of that fluid. The utilization of magnetic conditioning according to the presently claimed and/or disclosed inventive concepts has been shown to alter a dispersive surface tension component and/or a polar surface tension component of a fluid containing at least one polar substance.

The presently claimed and/or disclosed inventive concept(s) for conditioning fluids containing at least one polar substance includes the step of directing a fluid containing at least one polar substance through a magnetically energized conduit in order to provide a conditioned fluid medium. The conditioned fluid medium may then be directed to pass through at least one separation apparatus. Conventional chemical treatment and separation methods may be utilized in phase separation, as well as non-conventional water treatment methods and combinations thereof or equivalent types of separation methods known to those of ordinary skill in the art. The presently claimed and/or disclosed inventive concepts for conditioning fluids containing at least one polar substance may also be utilized to improve the mechanical blending of two or more distinct phases into a homogenous mixture and/or increase the flow rate of a conditioned fluid medium propelled under a constant pressure through a conduit.

The presently claimed and/or disclosed inventive concepts also include a method of altering the physical properties of a fluid mixture at ambient temperature, including the step of passing the fluid mixture through a magnetically conductive conduit having magnetic energy directed along the longitudinal axis of the magnetically energized conduit and extending through at least a portion of the fluid thereby altering a dispersive surface tension and/or a polar surface tension of a conditioned fluid medium. For example, inducing a first magnetic polarity can reduce the viscosity of a conditioned fluid mixture and inducing a second magnetic polarity can increase the viscosity of a conditioned fluid mixture.

### BRIEF DESCRIPTION OF THE DRAWINGS

FIG. 1 is a schematic diagram of a magnetically conductive conduit and a separation apparatus.

FIG. 1A is a schematic diagram of a magnetically conductive conduit and a separation apparatus.

FIG. 1B schematically depicts a magnetically conductive conduit disposed within a separation apparatus.

FIG. 1C is a schematic diagram of a magnetically conductive conduit, a first separation apparatus, and a second separation apparatus.

FIG. 2 schematically depicts the flow of magnetic flux loops encircling a length of magnetically energized conduit.

FIG. 3 and FIG. 3A schematically depict magnetically conductive conduits and embodiments of non-magnetically conductive fluid flow conduits.

FIG. 4 and FIG. 4A schematically depict serial couplings of conduit segments and embodiments of non-magnetically conductive fluid flow conduits.

FIG. 5 schematically depicts a non-contiguous array of magnetically conductive conduits sleeving a non-magnetically conductive fluid flow conduit.

FIG. 6 schematically depicts an apparatus for altering physical properties of a fluid flowing under pressure as disclosed herein.

FIG. 6A schematically depicts an apparatus for altering physical properties of a fluid as disclosed herein.

FIG. 7 is a graph showing changes in ultrasound attenuation over time during dissolution of MPC80 in a first sample of water subjected to no magnetic conditioning, a second sample of water subjected to positive magnetic conditioning, and a third sample of water subjected to negative magnetic conditioning.

FIG. 8 is a graph illustrating surface tension data for pure water that has been conditioned with a pulsed magnetic field during turbulent flow as compared to untreated pure water.

FIG. 9 is a graph illustrating surface tension data for 8.51 lb. brine water that has been conditioned with a pulsed magnetic field during turbulent flow as compared to untreated 8.51 lb. brine.

FIG. 10 is a graph illustrating surface tension data for 8.90 lb. brine water that has been conditioned with a pulsed magnetic field during turbulent flow as compared to untreated 8.90 lb. brine.

FIG. 11 is a graph illustrating surface tension data for 10 lb. brine water that has been conditioned with a pulsed magnetic field during turbulent flow as compared to untreated 10 lb. brine.

FIG. 12 is a graph illustrating viscosity data for pure water that has been conditioned with a pulsed magnetic field during turbulent flow as compared to untreated pure water.

FIG. 13 is a graph illustrating viscosity data for 8.51 lb. brine water that has been conditioned with a pulsed magnetic field during turbulent flow as compared to untreated 8.51 lb. brine.

FIG. 14 is a graph illustrating viscosity data for 8.90 lb. brine water that has been conditioned with a pulsed magnetic field during turbulent flow as compared to untreated 8.90 lb. brine.

FIG. 15 is a graph illustrating viscosity data for 10 lb. brine water that has been conditioned with a pulsed magnetic field during turbulent flow as compared to untreated 10 lb. brine.

FIG. 16 is a graph illustrating the relationship between conditioning-based reductions in cohesion energy and viscosity for pure water and various concentrations of brine.

FIG. 17 is a graph illustrating synthetic sea water viscosity as a function of cohesion energy due to treatment with a pulsed magnetic field.

FIG. 18 is a graph illustrating the dissipation of the reduced surface tension effect of synthetic sea water conditioned with a pulsed magnetic field.

FIG. 19 is a graph illustrating the dissipation of the increased surface polarity effect of synthetic sea water conditioned with a pulsed magnetic field.

FIG. 20 is a graph illustrating the dissipation of the acid/base component skew effect of synthetic sea water conditioned with a pulsed magnetic field.

FIG. 21 is a graph illustrating the dissipation of the viscosity reduction effect of synthetic sea water conditioned with a pulsed magnetic field.

FIG. 22 is a graph comparing the dissipation of the reduced surface tension effect of synthetic sea water conditioned with a pulsed magnetic field for 5 passes and 100 passes.

FIG. 23 is a graph comparing the dissipation of the increased surface polarity effect of synthetic seawater conditioned with a pulsed magnetic field for 5 passes and 100 passes.

FIG. 24 is a graph comparing the dissipation of the acid/base component skew effect of synthetic sea water conditioned with a pulsed magnetic field for 5 passes and 100 passes.

FIG. 25 is a graph comparing the dissipation of the viscosity reduction effect of synthetic sea water conditioned with a pulsed magnetic field for 5 passes and 100 passes.

FIG. 26 is an exploded view of a first magnetically conductive conduit adapted to sleeve a second magnetically conductive conduit.

FIG. 26A is an exploded view of a first magnetically conductive conduit adapted to sleeve a non-contiguous array of magnetically conductive conduits.

FIG. 26B is an exploded view of a first magnetically conductive conduit adapted to sleeve a serial coupling of conduit segments.

FIG. 26C is an exploded view of a first serial coupling of conduit segments adapted to sleeve a second serial coupling of conduit segments.

FIG. 27 schematically depicts a nucleus disposed within a non-magnetically conductive conduit segment.

FIG. 28 schematically depicts a nucleus disposed within a non-magnetically conductive fluid flow conduit.

FIG. 29 schematically depicts a nucleus supported by a non-magnetically conductive material within a conduit segment to form a static mixing device within the fluid flow path extending through the conduit segment.

FIG. 30 schematically depicts an apparatus for conditioning fluids.

FIG. 31 is a graphic representation of the operation of an apparatus for conditioning fluids showing magnetic flux.

FIG. 32 is a graphic representation of the operation of an apparatus for conditioning fluids showing magnetic forces.

FIG. 33 is a graphic representation of the operation of another embodiment of the apparatus for conditioning fluids showing magnetic flux.

FIG. 34A-34C schematically depict possible shapes and/or profiles of conduit segments in an apparatus for conditioning fluids.

FIG. 35-35D schematically depict a nucleus or nuclei disposed within a fluid flow path of a fluid flow conduit.

FIG. 36A-36E schematically depict possible positions of nuclei disposed within a fluid flow path of a fluid flow conduit.

FIG. 37A-37H schematically depict possible shapes and/or profiles of a nucleus.

FIG. 38 is a top plan view of an apparatus for conditioning fluids having coils configured to produce a pure dipole field.

FIG. 39A is an exploded view of a pressure vessel adapted to enclose an apparatus for conditioning fluids.

FIG. 39B is an exploded view of a pressure vessel adapted to removably enclose an apparatus for conditioning fluids.

FIG. 39C is a perspective view of a pressure vessel enclosing an apparatus for conditioning fluids.

FIG. 40 is a cross-sectional diagram of a pressure vessel of a pressure containment system for encapsulating a fluid flow conduit in accordance with the presently disclosed inventive concepts.

FIG. 40A is a cross-sectional diagram of the pressure vessel of FIG. 40 encapsulating a fluid flow conduit, and being disposed within a coil core in accordance with the presently disclosed inventive concepts.

FIG. 41 is a perspective view of a pressure vessel enclosing a plurality of apparatus for conditioning fluids.

### DETAILED DESCRIPTION

Stokes's Law describes the physical relationship that governs the settling of solid particles in a liquid and similarly governs the rising of light liquid droplets within a different, heavier liquid; and relates to the terminal settling, or rising, velocity of a smooth, rigid sphere having a known diameter through a viscous liquid of known density and viscosity when subjected to a known force (gravity). Stokes's Law assumes all particles are spherical and the same size; and flow is laminar, both horizontally and vertically, and that droplets will rise as long as laminar flow conditions prevail. Variables include the viscosity of the continuous liquid, the size of the particles and the difference in specific gravity between the continuous liquid and the particle.

Specific gravity is the ratio of the density (mass of a unit volume) of a first substance to the density (mass of the same unit volume) of a reference substance, which is nearly always water for liquids or air for gases. Specific gravity is commonly used in industrial settings as a simple means of obtaining information regarding the concentration of solutions of various materials. Temperature and pressure must be specified for both the substance and the reference when quantifying the specific gravity of a substance with pressure typically being 1.0 atmosphere, and the specific gravity of water commonly set at 1.0. Substances with a specific gravity of 1.0 are neutrally buoyant in water, those with a specific gravity greater than 1.0 are more dense and typically sink in water, while those with a specific gravity of less than 1.0 are less dense and typically float on water. When the respective specific gravities of the liquids, particle size and the viscosity of the continuous phase (typically water) are known, Stokes's Law outcome for the rise of an oil droplet is equivalent to the outcome for the settling of solid particles, with a negative velocity referencing the rising velocity of a droplet.

A modified version of Stokes's Law that accounts for a constant flow of a fluid mixture through a separator is: V=(2gr²)(d1−d2)/9μ, where V=velocity of rise (cm/sec), g=acceleration of gravity (cm/sec²), r=“equivalent” radius of a particle (cm), d1=density of a particle (g/cm³), d2=density of the fluid medium (g/cm³), and μ=viscosity of the fluid medium (dyne/sec/cm²).

The utilization of magnetic conditioning according to the presently claimed and/or disclosed inventive concepts to alter the viscosity, a dispersive surface tension and/or a polar surface tension of fluid containing at least one polar substance (e.g., water) accelerates the rate by which oil and solids separate from water.

Although often associated with each other, surface tension and viscosity are not normally directly related. For example, when surface tensions of solutions are decreased chemically (as with surface active agents—e.g., surfactants), this has little effect on the viscosities of the solutions when applied at commonly low concentrations. Alternatively, a solution's viscosity is increased by adding larger molecules that entangle to thicken the solution. Viscosity is a property of a fluid arising from collisions between neighboring particles within a fluid moving at different velocities. It is a quantity expressing the magnitude of internal friction, as measured by the force per unit area resisting a flow in which parallel layers move relative to one another. Viscosity depends on intermolecular forces within the bulk of a liquid.

One benefit of lowering the viscosity of a solution is that it will reduce the amount of energy consumed in moving a through a particular filter medium. Changes in surface tension can also be significant if they translate into a measurable difference in the way water wets a solid and/or how they affect the interfacial tension between water and another fluid (like oil). If changes in surface tension significantly enhance wetting, thereby easing the suspension of a dispersed solid, then they can be useful. If changes in surface tension significantly diminish wetting, thereby causing the solid to precipitate from a suspension with greater ease, then they can also be useful. Similarly, raising the interfacial tension between the water and oil will enhance separation, and lowering the interfacial tension between the water and oil will improve the emulsification of oil by the water.

Surface tension focuses more on the surface, rather than the bulk, of the liquid. Surface tension is a quantitative thermodynamic measure of the “unhappiness” experienced by a molecule of a liquid that is forced to be at the surface of a bulk of that same liquid and giving up the interactions that it would rather have with neighboring liquid molecules in the bulk of the liquid, and getting nothing in return from the gas. Surface tension is an attribute of a liquid in contact with a gas; and liquid molecules in contact with any other phase experience a different balance of forces than the molecules within the bulk of the liquid. Thus, surface tension is a special example of interfacial tension; which is defined by the work associated with moving a molecule from within the bulk of a liquid to its interface with any other phase.

However, both viscosity and surface tension are related to cohesive forces between molecules for pure liquids. For example, in addition to having a surface tension 4 times lower than that of water, hexane also has a viscosity of 0.33 cp at 20° C., which is about 3 times lower than the viscosity of water at 20° C. (1.02 cp). This is despite the fact that hexane (C₆H₁₂) is a much larger molecule than water (H₂O). This is because of the stronger polar cohesive forces between water molecules versus hexane molecules that only support van der Waals type interactions between themselves. So while surface tension and viscosity are not directly relatable even for pure liquids, and potential molecular entanglements and therefore the size of pure liquid molecules influence viscosity, cohesive forces have a strong impact on viscosity as well as on surface tension. As will be discussed in more detail herein, it has surprisingly been found that the presently claimed method of conditioning fluids is capable of reducing the cohesion energy of water molecules as a result of magnetic conditioning.

Stokes's Law predicts how fast an oil droplet will rise through water based on the density and size of the oil droplet and the distance the oil must travel. The difference in the specific gravities of oil and water are significant elements in the gravity separation of oil/water mixtures. As oil droplets coalesce they do not form flocs, like solid particles, but form larger droplets. Interfacial tension works to keep the drop spherical since a sphere has the lowest surface to volume ratio of any shape, and interfacial tension is, by definition, the amount of work necessary to create a unit area of interface. As oil droplets coalesce into larger droplets, the buoyancy of the droplets increases as they rise toward the surface of the water.

Increased interfacial tension improves coalescing of oil droplets into larger drops and also causes the droplets to assume spherical shapes. While all the variables of Stokes's Law have a decided impact on separation, the greatest impact is found in the size of the particle since its relationship in the Stokes's Law equation is not one-to-one, but the square of the size. That is, as the droplet size doubles, its separation velocity increases by four times, as the droplet size triples, separation is nine times faster; and so forth. Similarly, coalescing of solids accelerates their fall.

Many gravity separation apparatus are designed using Stokes's Law to define the rising velocity of oil droplets based on their density and size and the difference in the specific gravities of oil and water, which is much smaller than the difference in the specific gravities of solids and water. Based on such design criterion, most suspended solids will settle to the bottom of phase separators as a sediment layer while oil will rise to top of phase separators and form a layer that can be extracted by skimming or other means. Water forms a middle layer between the oil and the solids. Solids falling to the bottom of a separator may be periodically removed for disposal. Heat, at least one chemical compound, or both may be introduced into the fluid mixture in order to increase its rate of phase separation.

The greater the difference in the density of an oil droplet and the density of a continuous water phase, the more rapid the gravity separation. The terminal velocity of a rising or falling particle is affected by anything that will alter the drag of the particle. Terminal velocity is most notably dependent upon the size, spherical shape and density of the particles, as well as to the viscosity and density of the fluid. When the particle (or droplet) size exceeds that which causes a rate of rising or falling greater than the velocity of laminar flow, flow around the particle becomes turbulent and it will not rise or fall as rapidly as calculated by Stokes's Law because of hydrodynamic drag. However, larger particles (or droplets) will fall or rise very quickly in relationship to smaller particles and can be removed by a properly designed separator.

Drag coefficients quantify the resistance of an object to movement in a fluid environment and are always associated with the surface area of a particle. A low drag coefficient indicates that an object has less hydrodynamic drag. Skin friction directly relates to the area of the surface of a body in contact with a fluid and indicates the manner in which a particle resists any change in motion caused by viscous drag in a boundary layer around the particle. Skin friction rises with the square of its velocity. As described herein, magnetic conditioning has been determined to alter the dispersive surface tension and/or the polar surface tension of a fluid containing at least on polar substance. Such magnetic conditioning influences the viscosity of the fluid as it affects intermolecular forces within the liquid.

For dilute suspensions, Stokes's Law predicts the settling or rising velocity of small spheres in a fluid (for example, oil in water) which is due in part to the strength of viscous forces at the surface of the particle. While such viscous forces provide the majority of the retarding force working against the inertial rise or fall of the small spheres in Stokes's Law, increased use of empirical solutions may be required to effectively calculate the drag forces on the settling or rising velocity of small spheres in dilute solutions.

While increasing particle size has the greatest impact with respect to the rate of separation calculated by Stokes's Law, altering the viscosity, the dispersive surface tension and/or the polar surface tension of the continuous phase (for example, by magnetically conditioning a fluid containing at least one polar substance that flows within a separator) and/or altering the electric charge on the surface of a particle dispersed in a fluid according to the presently claimed and/or disclosed inventive concepts has a significant impact on the rate of phase separation.

In many fluids, a double layer, or electrical double layer, may appear on the surface of a particle when it is dispersed in a fluid. As used herein, the term “particle” may encompass a solid particle, a gas bubble and/or a liquid droplet. Additionally, double layering may refer to two parallel layers of charge surrounding the particle. The first layer, having either a positive or negative surface charge, may comprise ions absorbed onto the surface of the particle and the second layer may comprise ions attracted to the surface charge via the Coulomb force therebetween, wherein the second layer acts to electrically screen the first layer. This second or “diffuse layer” may be loosely associated with a particle, and comprise free ions moving within a fluid under the influence of electric attraction and thermal motion, rather than being firmly attached to the particle.

Interfacial double layering is common in systems having a large surface area to volume ratio, such as a colloid, and double layering plays a fundamental role in many everyday substances. For example, milk exists only because fat droplets are covered with double layers that prevent their coagulation into butter. Double layers exist in practically all heterogeneous fluid-based systems, such as blood, paint, ink and ceramic and/or cement slurries.

The formation of a “relaxed” double layer is the non-electric affinity of charge-determining ions for a surface, which leads to the generation of an electric surface charge typically expressed in units of coulomb per square meter (C/m²). This surface charge creates an electrostatic field that then affects the ions in the bulk of a liquid. The electrostatic field, in combination with the thermal motion of the ions, creates a counter charge that screens the electric surface charge. The net electric charge in this screening diffuse layer has an equal magnitude to the net surface charge, but with an opposite polarity, so that the complete structure is electrically neutral.

The diffuse layer, or at least part of it, may move under the influence of tangential stress along a slipping plane that separates mobile fluid in the bulk of a liquid from the fluid that remains attached to the surface of a particle, thereby allowing the particle to remain suspended within the bulk of a fluid. Electric potential at this plane is called electrokinetic potential or zeta potential.

Zeta potential is caused by the net electrical charge contained within the region bounded by the slipping plane, and also depends on the location of that plane; and it is widely used for quantification of the magnitude of the charge surrounding a particle and a key indicator of the stability of colloidal dispersions with the magnitude of the zeta potential indicating the degree of electrostatic repulsion between adjacent, similarly charged particles in a dispersion. Thus, zeta potential is the potential difference between the dispersion medium and the stationary layer of a fluid attached to a dispersed particle.

For molecules and particles that are small enough, a high zeta potential will confer stability, i.e., the solution or dispersion will resist aggregation. When the zeta potential is small, attractive forces may exceed repulsive forces and the dispersion may break and flocculate. Therefore, colloids with high zeta potential (negative or positive) are electrically stabilized while colloids with low zeta potentials tend to coagulate or flocculate.

In one aspect, the presently claimed and/or disclosed inventive concept(s) is directed to an apparatus for separating at least one dissimilar material from a fluid containing at least one polar substance, wherein the apparatus comprises: (a) a magnetically conductive conduit having magnetic energy directed along the longitudinal axis of the magnetically energized conduit and extending through at least a portion of the magnetically conductive conduit; and, optionally, (b) a separation apparatus downstream of the magnetically conductive conduit, wherein the at least one dissimilar material and the fluid containing at least one polar substance are capable of flowing through the magnetically conductive conduit and into a separation device.

The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the outer surface of the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit. As used herein, the term “magnetically energized conduit” refers to the “magnetically conductive conduit” in an energized state. The lines of flux form loops and the resulting magnetic field is of a strength that allows the flux to extend along the longitudinal axis of the magnetically energized conduit and concentrate at distinct points beyond each end of the conduit such that the magnetic flux extends from a point where the lines of flux concentrate beyond one end of the magnetically energized conduit, around the periphery of the coiled electrical conductor along the longitudinal axis of the fluid impervious boundary wall, and to a point where the lines of flux concentrate beyond the other end of the magnetically energized conduit. The magnetically conductive boundary wall absorbs the magnetic field and the magnetic flux loops generated by the coiled electrical conductor at the points of flux concentration.

The polarity of the magnetic field at an end of the energized magnetically conductive conduit segment can be determined as having either a positive or negative polarity by utilizing a gaussmeter to measure the strength and polarity of the magnetic field, with a first polarity detected proximate the end of a first segment of magnetically conductive conduit and a second polarity detected at an opposing end of a second segment of magnetically conductive conduit.

Computer modeling of the presently claimed and/or disclosed inventive concepts has been utilized to illustrate the unidirectional flow of magnetic flux loops consolidated at a point beyond the port at the proximal end of a magnetically energized conduit, along the longitudinal axis of the conduit and around the periphery of at least one continuous coil encircling the conduit and reconsolidating at a point beyond the port at the distal end of the magnetically energized conduit. Such models also show lines of magnetic flux flowing along the inner surface and the outer surface of the fluid impervious boundary walls of non-contiguous, axially aligned magnetically energized conduit segments.

The presently claimed and/or disclosed inventive concept(s) also includes one or more embodiments having more than one length of magnetically conductive material forming the magnetically conductive conduit, each length of magnetically conductive material having a fluid entry port at the proximal end of the conduit, a fluid discharge port at the distal end of the conduit, and a fluid impervious boundary wall having an inner surface and an outer surface extending between the fluid entry port and the fluid discharge port. Magnetic flux may extend from a point where the lines of flux concentrate beyond one end of an embodiment of the magnetically energized conduit having more than one length of magnetically conductive material forming the magnetically conductive conduit, around the periphery of the coiled electrical conductor along the longitudinal axis of each magnetically conductive boundary wall and to a point where the lines of flux concentrate beyond the other end of the magnetically energized conduit. Each magnetically conductive boundary wall may absorb the magnetic field and the magnetic flux loops generated by the coiled electrical conductor at the points of flux concentration; and it can be appreciated that magnetic energy may be concentrated in a plurality of distinct areas along the longitudinal axis of embodiments of a magnetically energized conduit having more than one length of magnetically conductive material forming the magnetically conductive conduit.

The presently claimed and/or disclosed inventive concept(s) also provides at least one gradient of one or more magnetic fields established in substantial orthogonal alignment to the flow path extending through a flow path of the conduit. For magnetic forces to effectively be applied to diamagnetic particles directed to pass through a magnetically energized conduit, the particles must pass through one or more magnetic fields establishing at least one well-defined gradient along the flow path extending along the longitudinal axis of the conduit. Directing a polar fluid containing at least one polar substance to pass through one or more magnetic fields established in substantial orthogonal alignment to the flow path extending through the conduit alters at least one physical property of the polar fluid. Accelerating the change per unit distance of the magnitude of a magnetic field forming the gradient traversing the flow path through the conduit increases the changes of at least one physical property of a fluid containing at least one polar substance. Altering at least one physical property of the polar fluid may be enhanced by increasing the flow rate of the fluid through the one or more magnetic field having at least one well-defined gradient in substantial orthogonal alignment to the flow path through the conduit.

The computer models also show opposing force fields converging in the space between the non-contiguous magnetically conductive conduit segments, as will be discussed further herein. External radiation of such force fields, relative to the fluid flow path, is markedly limited to the region extending between the outer surfaces of the fluid impervious boundary walls of the opposing magnetically conductive conduit segments; with highly concentrated converging force fields directed into the fluid flow path of the magnetically conductive conduit as magnetic energy is concentrated beyond the ends of the non-contiguous, axially aligned magnetically conductive conduit segments.

The presently claimed and/or disclosed inventive concepts may also be directed to a method of using, for example but without limitation, the apparatus described above to alter the electrical double layer on the surface of a particle and/or a porous body dispersed in a fluid, and the resulting composition. Without being bound to a particular theory, it is predicted that such a method of altering the electrical double layer on the surface of a particle and/or porous body dispersed in a fluid as presently disclosed and/or claimed herein alters the zeta potential of the particle and/or porous body and may accelerate the separation of the particle and/or the porous body from the fluid and improve the efficiency of solid/liquid, liquid/liquid and/or gas/liquid phase separation apparatus.

Magnetically conductive coupling devices and/or segments of magnetically conductive conduit may be utilized to make fluid impervious connections with the inlet and outlet ports of the magnetically energized conduit to promote the flow of fluid through magnetic energy. Utilization of magnetically conductive couplings and conduits results in magnetic energy that would otherwise concentrate at each end of a magnetically energized conduit being absorbed by the contiguous array of magnetically conductive coupling devices and/or segments of magnetically conductive conduit. Magnetic fluid conditioning is then limited to only that region along the fluid flow path within the coiled electrical conductor that sleeves the outer surface of the magnetically conductive conduit and/or is concentrated in a space between two non-contiguous lengths of the magnetically energized conduit in an embodiment wherein the magnetically energized conduit has more than one length of magnetically conductive material forming the magnetically conductive conduit due to the magnetic flux loops at each end of the magnetically energized conduit being absorbed by the contiguous array of magnetically conductive conduit(s) which prevents the magnetic flux loops from concentrating at each end of the magnetically energized conduit.

Non-magnetically conductive coupling devices and/or segments of non-magnetically conductive conduit may also be utilized to make fluid impervious connections with the inlet and outlet ports of a magnetically energized conduit to promote the flow of fluid through the magnetically energized conduit. Utilization of non-magnetically conductive materials allows the lines of flux (flowing from one end of the magnetically energized conduit to the other end of the magnetically energized conduit) to pass through the fluid impervious boundary walls of the non-magnetically conductive coupling devices and/or conduits and concentrate within the inlet and outlet ports at each end of the magnetically energized conduit so that fluid flowing through the magnetically conductive conduit receives additional magnetic conditioning in these regions. Therefore, it can be appreciated that magnetic energy is concentrated in a plurality of distinct areas along the longitudinal axis of a magnetically energized conduit when utilizing non-magnetically conductive coupling devices and/or segments of non-magnetically conductive conduit to make fluid impervious connections with the inlet and outlet ports of the magnetically energized conduit.

The at least one separation apparatus, as generally described above, may have at least one inlet port, at least one outlet port and a fluid impervious boundary wall extending between the at least one inlet port and the at least one outlet port.

In one embodiment, the at least one separation apparatus may have a fluid impervious boundary wall having an inner surface, an inlet port for receiving (a) a mixture of a fluid containing at least one polar substance and at least one dissimilar material and/or (b) a mixture of a fluid containing at least one polar substance and at least one dissimilar material that has been magnetically conditioned by the apparatus described herein (i.e., “a magnetically conditioned fluid medium”), a first outlet port for discharging a first amount of the (a) fluid containing at least one polar substance and/or (b) the magnetically conditioned fluid medium each having a reduced volume of the at least one dissimilar material, and a second outlet port for discharging the at least one dissimilar material separated from the fluid containing at least one polar substance or the conditioned fluid medium discharged in the first outlet port.

As used herein, a separator having a capacity to separate at least one dissimilar material from a fluid mixture or a conditioned fluid medium by centrifugal force, mechanical screening, gravity separation and/or physical separation may be selected from a group consisting of, but not limited to, two-phase separation equipment, three-phase separation equipment, dewatering apparatus, dissolved air flotation apparatus, induced gas flotation apparatus, froth flotation systems, centrifuges, hydrocyclones, desanders, wash tanks, oil/water separators, knock-out units, clarifiers, petroleum production equipment, distillation systems, evaporation systems, aeration systems, desalination equipment, reverse osmosis systems and/or membrane separation apparatus utilizing semipermeable membrane materials, graphene, Perforene™, nanoscopic scale materials and other membrane materials, ultrafiltration apparatus, pulsed electromagnetic wave apparatus, ultrasonic systems, cavitation apparatus, electro-dialysis apparatus, fuel filters, lubricant filters, and combinations thereof or equivalent types of separation apparatus known to those of ordinary skill in the art. A magnetically conductive conduit may be disposed within the fluid impervious boundary wall of a separation apparatus.

The at least one separation apparatus may have a fluid impervious boundary wall having an inner surface, an inlet port for receiving a fluid mixture or a magnetically conditioned fluid medium, and at least one outlet port for discharging an amount of the fluid containing at least one polar substance or the conditioned fluid medium containing a reduced volume of the at least one dissimilar material. As used herein, a separator having a capacity to separate at least one dissimilar material from a fluid mixture or a conditioned fluid medium by mechanical screening, gravity separation and/or physical separation may be selected from a group consisting of, but not limited to, settling tanks, gravity separators, weir tanks, dissolved air flotation apparatus, clarifiers, evaporation systems, aeration systems, screening apparatus, cartridge filters, water filters, fuel filters, lubricant filters, reverse osmosis systems and/or membrane separation apparatus utilizing semipermeable membrane materials, graphene, Perforene™, nanoscopic scale materials and other membrane materials, ultrafiltration apparatus, electromagnetic wave apparatus, ultrasonic separation systems, cavitation inducing apparatus, and combinations thereof or equivalent separation apparatus known to those of ordinary skill in the art. As used herein, open top pits and settling ponds having a fluid impervious boundary wall to contain a conditioned fluid medium may be included as one exemplary, but non-limiting, embodiment of the presently claimed and/or disclosed separation apparatus. A volume of the at least one dissimilar material that may be retained within a fluid impervious boundary wall of such separation apparatus may periodically be removed to provide capacity for ongoing separation of the at least one dissimilar material from the conditioned fluid medium.

A mixture of a fluid containing at least one polar substance and at least one dissimilar material (i.e., a “fluid mixture” as used herein) may be directed to pass through at least one pair of electrodes energized with electrical energy. At least one pair of electrically charged electrodes may be disposed within an electrochemical fluid conditioning apparatus having a fluid impervious boundary wall having an inner surface, an inlet port for receiving a fluid mixture, and at least one outlet port for discharging an amount of the fluid mixture directed to pass through an electrolysis process. As used herein, an electrochemical fluid conditioning apparatus having at least one pair of electrically charged electrodes disposed within a fluid impervious boundary may be selected from a group consisting of, but not limited to, electrolysis, electrocoagulation, electrodialysis and/or equivalent electrochemical fluid conditioning apparatus known to those of ordinary skill in the art. A magnetically conductive conduit may be disposed within the fluid impervious boundary wall of an electrochemical fluid conditioning apparatus upstream and/or downstream of the electrodes. A magnetically conductive conduit may be disposed upstream and/or downstream of an electrochemical fluid conditioning apparatus.

Each electrode may include at least one plate made of an electrical conducting material and having at least one conductor lead, with at least one pair of electrodes configured as a substantially parallel array of spaced-apart plates interleaving to form at least one cavity between the facing surfaces of adjacent plates. Each electrode plate may be energized with a positive or negative electrical charge opposite from its adjacent plate so that an input of controlled electrical energy to a fluid mixture flowing between charged electrodes results in physical reactions that destabilize the fluid mixture, allowing the at least one dissimilar material to change form and/or accelerate its removal from the fluid. As the fluid mixture passes through charged electrodes, the at least one dissimilar material within the fluid mixture may experience neutralization of ionic and particulate charges as an electrode acting as a cathode generates hydrogen and thereby also reduces the valence state of some dissolved solids, causing those materials to become less soluble or achieve a neutral valence state; and an electrode acting as an anode generates oxygen and ozone that eliminates many contaminants.

Carbon steel, aluminum, titanium, noble metals, stainless steel, and other electrically conductive materials or composite materials may form the electrodes, with the composition of the fluid mixture and the desired quality of fluid conditioning typically determining the type of material used to make the electrode plates.

The conductivity of a fluid mixture is primarily dependent upon the composition and quantity of the at least one dissimilar material carried within the fluid mixture. Fluid mixtures having high percentages of suspended and dissolved materials are typically more electrically conductive, and therefore provide less resistance to the flow of electrical charges through the fluid than fluid mixtures relatively free of suspended or dissolved materials. Seawater, for example, is typically more conductive than fresh water due to its high levels of dissolved minerals. A constant flow of electrons between the electrodes is desired for effective electrolysis. In many instances, voltage supplied to the electrodes may be allowed to fluctuate with the conductivity of a fluid mixture to provide for a constant level of amperage supplied to the electrodes.

Electrodes made of non-sacrificial materials, such as stainless steel, titanium, noble metals, and/or electrically conductive materials (or composite materials) coated or plated with one or more noble metal materials, typically do not donate ions to a fluid mixture. A fluid mixture directed to pass through non-sacrificial electrodes may be exposed to oxygen, ozone, hydrogen, hydroxyl radicals, and/or hydrogen peroxide as a result of electrolysis of the fluid. In addition, electrolysis of the fluid mixture can eliminate many organisms and biological contaminants by altering the function of their cells. Further, electrodes made of copper and/or silver may donate ions to a fluid mixture, thereby providing residual sanitizing properties to the fluid mixture. In addition to the destruction of many pathogens, additional benefits of electrolysis include significant reductions in the odor and turbidity of an effluent, as well as lower levels of total suspended solids, total petroleum hydrocarbons, chemical oxygen demand, and/or biological oxygen demand.

An electrolysis process commonly known as electrocoagulation utilizes electrodes made of sacrificial materials that donate metal ions to a fluid mixture that tend to combine with the at least one dissimilar material to form a stable floc. For example, the fluid mixture may initially be exposed to sacrificial electrodes donating iron ions that may then combine with the at least one dissimilar material in the fluid mixture. Sacrificial aluminum electrodes may then distribute aluminum ions to coalesce with suspended contaminants (as well as iron ions already combined with suspended contaminants) to form a stable floc that can be separated from the fluid mixture. In other applications, ions of iron, aluminum, and other flocculating elements may be dispersed into a fluid mixture upstream, or downstream, of energized electrodes to initiate coalescing of the at least one dissimilar material. Chemical compounds containing contaminant coagulating elements may also be dispersed into a fluid mixture. Combining flocculants and/or coagulants with electrolysis may allow many contaminants to emerge as newly formed compound that facilitate the separation of at least one dissimilar material from the fluid mixture.

A fluid mixture exposed to electrolysis, electrocoagulation, electrodialysis or equivalent electrochemical fluid conditioning apparatus known to those of ordinary skill in the art may be directed to subsequent treatment phases, if necessary, to extract any remaining contaminants—that is, the at least one dissimilar materials contained within the fluid mixture. Contaminants may be removed by skimming, dissolved air and/or induced air flotation apparatus, reverse osmosis systems and/or membrane separation apparatus utilizing semipermeable membrane materials, graphene, Perforene™, nanoscopic scale materials and other membrane materials, ultrafiltration apparatus, electromagnetic wave apparatus, ultrasonic separation systems, cavitation inducing apparatus, or equivalent separation apparatus known to those of ordinary skill in the art; or readily settle as a floc in a settling tank, gravity separator, clarifier, filter, and/or other type of separation apparatus. Electrodes may be energized with electrical energy having an alternating current component or a direct current component. When energizing electrodes with direct current, the polarity of the charge applied to such electrodes may be periodically reversed in order to reduce the plating of the surfaces of the electrodes with contaminants and also allow relatively equally degradation of sacrificial electrodes. Magnetic conditioning may be utilized upstream of an electrolysis process is disclosed herein to retard plating of electrodes. A separation apparatus of the presently claimed and/or disclosed inventive concepts may have a capacity to separate at least one dissimilar material from the fluid mixture directed to pass through an electrolysis process.

Water recovered from an electrolysis, electrocoagulation, electrodialysis or equivalent electrochemical fluid conditioning apparatus may be directed to pass through subsequent processing method and/or apparatus to improve the quality of the fluid, including distillation systems, desalination equipment, reverse osmosis systems and/or membrane separation apparatus utilizing semipermeable membrane materials, graphene, Perforene™, nanoscopic scale materials and other membrane materials, ultrafiltration apparatus, pulsed electromagnetic wave apparatus, ultrasonic systems, cavitation apparatus and/or equivalent fluid processing method and/or apparatus known to those of ordinary skill in the art.

A fluid mixture may be directed to pass through a fluid treatment vessel providing pulsed fluid treatment, the fluid treatment vessel defining a fluid impervious boundary wall with an inner surface and having a fluid input port and a fluid output port, the inner surface of the fluid impervious boundary wall establishing a fluid treatment chamber.

At least one transducer may be deployed proximate the fluid treatment vessel, each at least one transducer having at least one conductor lead operably connected to at least one electrical energizing unit having a capacity to produce at least one distinct programmable output of electrical energy continuously switched on and off at a pulsed repetition rate to establish at least one pulsed electrical signal to energize the at least one transducer and thereby produce pulsed fluid treatment proximate at least one distinct region within the fluid treatment chamber.

Introducing a fluid mixture receptive to pulsed fluid treatment to the fluid inlet port of the fluid treatment vessel establishes a flow of the fluid to be treated through the fluid treatment chamber; wherein the fluid mixture is directed to pass through the at least one region of pulsed fluid treatment; and then discharged through the fluid outlet port of the fluid treatment vessel as a processed fluid mixture.

At least one length of electrical conducting material forming at least one antenna may be disposed within the fluid impervious boundary wall of the fluid treatment vessel to form the at least one transducer. When energized with at least one pulsed electrical signal, the at least one antenna may produce at least one pulsed electromagnetic wave directing pulsed fluid treatment to at least one distinct region within the fluid treatment chamber. The at least one antenna may be directional or omni-directional in function and enclosed within a housing to protect said antenna from corrosive fluid mixtures and debris in a feed stream that could affect the performance of the antenna or destroy the antenna.

The at least one transducer may comprise at least one magnetostrictive or at least one piezoelectric transducer. Mounting these types of transducers to a diaphragm, such as the fluid impervious boundary wall a fluid treatment vessel proximate the fluid treatment chamber, and applying at least one electrical signal to energize the transducer produces at least one pulsed electromagnetic field that causes the movement of the diaphragm, which in turn causes a pressure wave to be transmitted through fluid within the fluid treatment chamber. Similarly, a transducer enveloped by a material forming a diaphragm and deployed within a fluid treatment chamber may cause a pressure wave to be transmitted through fluid within the fluid treatment chamber.

The fluid treatment vessel may be included in a processing system upstream of the magnetically conductive conduit so that a fluid mixture may be directed to pass through at least one region of pulsed fluid treatment prior to passing through concentrated magnetic energy. The fluid treatment vessel may be include in a processing system downstream of the magnetically conductive conduit so that a fluid mixture may be directed to pass through concentrated magnetic energy prior to passing through at least one region of pulsed fluid treatment.

The repetition rate, wavelength, amplitude, duty cycle and direction of the at least one pulsed electrical signal may be adjusted to treat a variety of fluids to improve the efficiency of apparatus utilized in gas/liquid phase separation, solid/liquid phase separation or liquid/liquid separation, and controlling and eliminating many biological contaminants. The presently claimed and/or disclosed inventive concepts for conditioning fluids typically will not over treat or under treat a feedstock, requires little monitoring or adjustment for effective fluid conditioning and may be utilized in either single pass or and closed-loop fluid transmission systems.

A fluid mixture may be directed to make a single pass through the magnetically conductive conduit and a single pass through the at least one separation apparatus, or a conditioned fluid may be directed to make at least one additional pass through the magnetically conductive conduit, the at least one separation apparatus, and/or both. At least one separation apparatus may be utilized upstream of the magnetically conductive conduit to separate at least one dissimilar material from the fluid mixture. A fluid mixture may be directed to pass through a pretreatment process, such as electrolysis, electrocoagulation, electrodialysis or equivalent electrochemical fluid conditioning apparatus and/or dispersing at least one chemical compound into the fluid, upstream of a separator to facilitate contaminant separation. A conditioned fluid medium may be directed to pass through subsequent fluid processing methods and apparatus to improve the quality of the fluid. Such methods and apparatus may include pulsed electromagnetic waves generated by at least one antenna and/or cavitation waves generated by at least one transducer to destroy contaminants remaining in the fluid and/or accelerate the extraction of any remaining solid materials. Other fluid processing methods may include filtration systems, distillation systems, desalination equipment, reverse osmosis systems, ultrafiltration, and combinations thereof or equivalent types of separation apparatus known to those of ordinary skill in the art.

A fluid mixture may be directed to a collection vessel and/or pretreatment apparatus to facilitate the separation of contaminants from the fluid. A first fluid mixture may then be directed to pass through at least one magnetically conductive conduit having magnetic energy directed along the longitudinal axis of the magnetically energized conduit and extending through at least a portion of the first fluid mixture thereby providing a conditioned fluid medium, then directed to pass through a first separation apparatus having a capacity to extract readily recoverable liquid phase contaminants from the conditioned fluid medium. The conditioned fluid medium may then be directed to pass through a second separation apparatus having a capacity to extract solid phase contaminants from the conditioned fluid medium; then discharged as a conditioned fluid medium having a reduced volume of liquid phase contaminants and solids phase contaminants within the first fluid mixture. In some instances, it may be desirable to direct the conditioned fluid medium to pass through a solids phase separation apparatus prior to directing the conditioned fluid medium to pass through a liquid phase separation apparatus. Gas phase contaminants may be extracted and/or collected from the conditioned fluid medium as it passes through the liquid phase separation apparatus, the solids phase separation apparatus and/or a separation apparatus dedicated to removing gas phase contaminants from the conditioned fluid medium. The conditioned fluid medium may be directed to subsequent processing apparatus to extract any remaining dissimilar materials and/or contaminants from the fluid. At least one magnetically conductive conduit may be deployed upstream of a collection vessel, pretreatment apparatus and/or separation apparatus.

As disclosed herein in a first example, a length of new ⅛″ plastic tubing was deployed through the fluid impervious wall of a magnetically conductive conduit comprising a serial coupling of conduit segments having a 1.315″ outside diameter boundary wall with the tubing extending through each end of the conduit to establish a fluid flow path; with the tubing being made of a material that, in and of itself, would not affect any physical properties of a fluid mixture sample—herein after referred to as the “1.315 inch outside diameter apparatus.”

The serial coupling of conduit segments had a length of approximately 22″ and comprised a non-magnetically conductive threaded coupling axially aligned between two magnetically conductive threaded conduit segments, each magnetically conductive conduit segment having a wall thickness of approximately 0.133″. The female NPT pipe threads on each end of the non-magnetically conductive coupling matched the male NPT pipe threads on the ends of the magnetically conductive segments that were threaded into the coupling so that distance from the distal end of the first threaded magnetically conductive conduit to the proximal end of the second threaded magnetically conductive conduit was approximately ¾″.

A coil encircling at least a section of the outer surface of the magnetically conductive threaded conduits and the non-magnetically conductive threaded coupling was formed by winding 242 turns of a length of 14 AWG copper wire to form a 16″ layer, and then adding seven more 16″ layers to form a continuous coil having a total of 1936 turns, wherein the length to diameter ratio of the coil was approximately 7:1.

A high throughput peristaltic pump (to prevent direct contact with the fluid samples) was used to propel the fluid samples through tubing (being made of a material that, in and of itself, would not affect any physical properties of a fluid mixture sample) sleeved by a non-energized magnetically conductive conduit and a magnetically energized conduit at a flow rate of 1150 ml/min; as disclosed herein, magnetic conditioning of a fluid containing at least one polar substance was determined to alter a dispersive surface tension and a polar surface tension of distilled water.

A first sample of untreated distilled water was collected in a certified clean container after being directed to make only one pass through the length of non-energized magnetically conductive conduit. The sample flowed uncollected for approximately 30 to 45 seconds to allow for the dismissal of any bubbles so that the untreated distilled water sample was collected during steady-state flow.

A second sample of the distilled water was collected in a certified clean container after energizing a coiled electrical conductor encircling the conduit with 12 VDC and approximately 5 amps of constant electrical energy to induce a negative polarity, then directing the distilled water to make only one pass through a magnetically energized conduit having an area of magnetic conditioning concentrated along a path extending through at least one turn of the electrical conductor encircling the outer surface of the magnetically conductive conduit generating a magnetic field strength of approximately 850 gauss (unit of magnetic field measurement), as well as a magnetic field strength of approximately 150 gauss concentrated at each end of the magnetically conductive conduit. The magnetically conditioned distilled water sample was similarly allowed to flow uncollected for approximately 30 to 45 seconds to allow for the dismissal of any bubbles so that the water sample was collected during steady-state flow.

The overall surface tensions of both untreated and magnetically conditioned distilled water samples were measured by the Wilhelmy plate method. Both samples were also tested for contact angle against a standard polytetrafluoroethylene (PTFE) hydrophobic surface in order to determine the fraction of the overall surface tension of each sample making up their non-polar surface tensions. Results are shown in Table 1.

TABLE 1
Distilled Water Conditioned with 850 Gauss
Component Surface Tension Information After Magnetic Conditioning
Distilled Water—(Flowing through Magnet)

| | Overall | Dispersive | Polar | |
|---|---|---|---|---|
| Time After | Surface | Surface | Surface | Surface |
| Conditioning | Tension | Tension | Tension | Polarity |
| (hours) | (mN/m) | (mN/m) | (mN/m) | (%) |
| 0 | 72.72 | 24.89 | 47.83 | 65.8 |
| 1 | 72.73 | 25.03 | 47.70 | 65.6 |
| 8 | 72.75 | 26.01 | 46.74 | 64.2 |
| 24 | 72.74 | 26.42 | 46.32 | 63.7 |
| 36 | 72.73 | 26.56 | 46.17 | 63.5 |
| 48 | 72.74 | 26.57 | 46.17 | 63.5 |

Untreated distilled water had an overall surface tension of 72.74 mN/M while magnetically conditioned distilled water had an overall surface tension of 72.72 mN/M, a value within a measurable margin of error indicating there was no change in the surface tension of the magnetically conditioned distilled water. However, untreated distilled water had a dispersive surface tension of 26.57 mN/M, a polar surface tension of 46.17 mN/M and a surface polarity of 63.5% while magnetically conditioned distilled water had a dispersive surface tension of 24.89 mN/M, a polar surface tension of 47.83 mN/M and a surface polarity of 65.8%, indicating significant changes in a dispersive surface tension and a polar surface tension of magnetically conditioned distilled water. Changes in the dispersive surface tension, polar surface tension and surface polarity of the distilled water sample directed to make one pass through the magnetically conductive conduit were greatest immediately after magnetic conditioning, with each property of the magnetically conditioned water sample returning to its untreated dispersive surface tension, polar surface tension and surface polarity value in less than 48 hours.

The presently claimed and/or disclosed inventive concepts also include a method of altering the physical properties of distilled water at ambient temperature, including the step of passing a first volume of distilled water through a magnetically conductive conduit having magnetic energy directed along the longitudinal axis of the magnetically energized conduit and extending through at least a portion of the distilled water thereby providing a conditioned distilled water medium, wherein a dispersive surface tension of the conditioned distilled water medium is lower than a dispersive surface tension of the first volume of distilled water and a polar surface tension of the conditioned distilled water medium is greater than a polar surface tension the first volume of distilled water.

The presently claimed and/or disclosed inventive concepts also include an apparatus for altering a dispersive surface tension and/or a polar surface tension of a fluid containing at least one polar substance at ambient temperature, including a magnetically conductive conduit having magnetic energy directed along the longitudinal axis of a magnetically energized conduit and extending through at least a portion of the magnetically conductive conduit. The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit. In each embodiment of the presently claimed and/or disclosed inventive concepts for altering a dispersive surface tension and/or a polar surface tension of a fluid, it can be appreciated that magnetic energy may be concentrated in a plurality of distinct areas along the longitudinal axis of the magnetically energized conduit.

Utilizing the previously disclosed method of generating untreated and magnetically conditioned fluid samples and the above-described “1.315 inch diameter apparatus”, a high throughput peristaltic pump (to prevent direct contact with the fluid samples) was used to propel fluid samples—in particular well water—through tubing (being made of a material that, in and of itself, would not affect any physical properties of a fluid mixture sample) sleeved by a non-energized magnetically conductive conduit and a magnetically energized conduit at a flow rate of 1150 ml/min. As disclosed herein, magnetic conditioning of a fluid containing at least one polar substance was determined to alter a dispersive surface tension and a polar surface tension of the fluid and influence its interaction with other substances.

A first sample of untreated well water having concentrations of >300 ppm of calcium, magnesium, gypsum and other minerals was collected in a certified clean container after being directed to make only one pass through the length of non-energized magnetically conductive conduit. The sample flowed uncollected for approximately 30 to 45 seconds to allow for the dismissal of any bubbles so that the untreated well water sample was collected during steady-state flow.

A second sample of the well water was collected in a certified clean container after energizing a coiled electrical conductor encircling the conduit with 12 VDC and approximately 5 amps of electrical energy and directing the well water to make only one pass through a magnetically energized conduit having an area of magnetic conditioning concentrated along a path extending through at least one turn of the electrical conductor encircling the outer surface of the magnetically conductive conduit generating a magnetic field strength of approximately 850 gauss (unit of magnetic field measurement), as well as a magnetic field strength of approximately 150 gauss concentrated at each end of the magnetically conductive conduit. The magnetically conditioned well water sample was similarly allowed to flow uncollected for approximately 30 to 45 seconds to allow for the dismissal of any bubbles so that the water sample was collected during steady-state flow.

Overall surface tensions of well water containing concentrations of >300 ppm of calcium, magnesium, gypsum and other minerals were measured on both untreated and magnetically conditioned water samples by the Wilhelmy plate method. Both samples were also tested for contact angle against a standard polytetrafluoroethylene (PTFE) hydrophobic surface to determine the fraction of the overall surface tension of each sample making up their non-polar surface tensions. Untreated well water had an overall surface tension of 71.12 mN/M, dispersive surface tension of 26.35 mN/M, polar surface tension of 44.77 mN/M and surface polarity of 62.9%. Magnetically conditioned well water had an overall surface tension of 61.36 mN/M, dispersive surface tension of 17.43 mN/M, polar surface tension of 43.93 mN/M and surface polarity of 71.6%. Periodic monitoring indicated the changes in overall surface tension, dispersive surface tension, polar surface tension and surface polarity of the magnetically conditioned well water were greatest immediately after magnetic conditioning. Each property of the magnetically conditioned well water gradually returned to its untreated value after conditioning, with the magnetically conditioned well water returning to its untreated surface tension and surface polarity values after 48 hours. Such results are shown in Table 2.

TABLE 2
Well Water Conditioned with 850 Gauss
Component Surface Tension Information After Magnetic Conditioning
Well Water—(Flowing through Magnet)

| | Overall | Dispersive | Polar | |
|---|---|---|---|---|
| Time After | Surface | Surface | Surface | Surface |
| Conditioning | Tension | Tension | Tension | Polarity |
| (hours) | (mN/m) | (mN/m) | (mN/m) | (%) |
| 0 | 61.36 | 17.43 | 43.93 | 71.6 |
| 1 | 63.52 | 18.89 | 44.63 | 70.3 |
| 8 | 66.23 | 21.21 | 45.02 | 68.0 |
| 24 | 69.08 | 24.09 | 44.99 | 65.1 |
| 36 | 70.51 | 25.63 | 44.88 | 63.6 |
| 48 | 71.12 | 26.35 | 44.77 | 62.9 |

Reducing the surface tension and/or lowering the viscosity of a fluid improves mechanical blending and allows at least one dissimilar material (such as a chemical compound) to be more readily dispersed and evenly distributed within a conditioned fluid medium (such as magnetically conditioned water). The presently claimed and/or disclosed inventive concepts include a method of fluid conditioning, including the steps of establishing a flow of a fluid containing at least one polar substance through a magnetically conductive conduit having magnetic energy directed along the longitudinal axis of the magnetically energized conduit and extending through at least a portion of the fluid mixture thereby altering a dispersive surface tension and/or a polar surface tension of the fluid containing the at least one polar substance, thereby producing a conditioned fluid medium; and dispersing an amount of at least one dissimilar material into the conditioned fluid medium to form a continuous mixture. At least one chemical compound may also be dispersed in the fluid containing at least one polar substance prior to magnetically conditioning of the fluid. At least one chemical compound may also be dispersed in the conditioned fluid medium.

At least one dissimilar material comprising a chemical compound may be selected from a group consisting of, but not limited to, algaecides, biocides, scale retardants, coagulants and flocculants, pesticides, fertilizers, surfactants, ambient air, oxygen, hydrogen, ozone and hydrogen peroxide. For example, reducing the surface tension and/or lowering the viscosity of water allows lower amounts of algaecides, biocides and scale retardants to be used in thermal exchange systems to control bacteria and reduce the formation of mineral scale and other deposits. Coagulants and flocculants more readily disperse and are evenly distributed within a conditioned fluid medium, improving the clarification of raw water. Reduced surface tension of irrigation water allows pesticides, fertilizers, and surfactants added to water to be more efficiently broadcast to crops. Reducing the surface tension and/or lowering the viscosity of water improves the mechanical blending of ambient air, oxygen, hydrogen, ozone and hydrogen peroxide in water so that they are more readily dispersed and evenly distributed within a conditioned water medium. For example, improved dispersion and even distribution of ambient air and/or oxygen injected into aqueous-based fluid mixtures results in smaller air and/or oxygen bubbles saturating water-based streams flowing into aeration basins, aerobic digesters, industrial processes and/or chemical reactions and provides greater concentrations of air and/or oxygen to be dispersed throughout the water column for improved fluid processing.

In another example, the above-described “1.315 inch outer diameter apparatus” was used in combination with a high throughput peristaltic (non-direct contact) pump used to propel samples of seawater through the magnetically conductive conduit at a flow rate of 1150 ml/min.

A first sample of untreated seawater was collected in a certified clean container after being directed to make only one pass through the length of non-energized magnetically conductive conduit. The sample flowed uncollected for approximately 30 to 45 seconds to allow for the dismissal of any bubbles so that the untreated seawater sample was collected during steady-state flow.

A second sample of seawater was collected in a certified clean container after energizing a coiled electrical conductor encircling the conduit with 12 VDC and approximately 5 amps of electrical energy and directing the seawater to make only one pass through a magnetically energized conduit having an area of magnetic conditioning concentrated along a path extending through at least one turn of the electrical conductor encircling the outer surface of the magnetically energized conduit generating a magnetic field strength of approximately 850 gauss (unit of magnetic field measurement), as well as a magnetic field strength of approximately 150 gauss concentrated at each end of the magnetically energized conduit. The magnetically conditioned seawater sample was similarly allowed to flow uncollected for approximately 30 to 45 seconds to allow for the dismissal of any bubbles so that the water sample was collected during steady-state flow. Overall surface tensions of untreated and magnetically conditioned seawater samples were measured by the Wilhelmy plate method, with both samples tested for contact angle against a standard polytetrafluoroethylene (PTFE) hydrophobic reference surface, in order to determine the fraction of the overall surface tension of each sample making up their non-polar surface tensions. Such results are shown in Table 3.

TABLE 3
Untreated Seawater vs. Seawater Conditioned with 850 Gauss
Surface Tensions and Contact Angles on PTFE
Untreated and Magnetically Conditioned Sea Water

| | Untreated | Conditioned | Untreated | Conditioned |
|---|---|---|---|---|
| | Seawater | Seawater | Seawater | Seawater |
| | Surface | Surface | Contact | Contact |
| | Tension | Tension | Angle | Angle |
| Test # | (mN/m) | (mN/m) | (degrees) | (degrees) |
| 1 | 64.95 | 62.12 | 114.1 | 117.8 |
| 2 | 64.95 | 62.13 | 113.6 | 117.3 |
| 3 | 64.96 | 62.17 | 114.5 | 117.3 |
| 4 | 64.98 | 62.12 | 114.2 | 117.3 |
| 5 | 64.98 | 62.12 | 113.5 | 117.8 |
| Average | 64.96 | 62.13 | 114.0 | 117.5 |
| Std. Dev. | 0.01 | 0.02 | 0.4 | 0.3 |

Reducing the overall surface tension of seawater and increasing its surface polarity makes seawater more hydrophilic. The overall surface tension of untreated seawater (64.96 milliNewtons per meter, or mN/M) is quite a bit lower than that of pure distilled water (72.5 mN/m), and its surface polarity (68.25%) is a bit higher than that of pure distilled water (63.4%). The raw seawater utilized in this example was collected approximately 100 miles offshore from the coast of Louisiana and contained no visible solid particulate matter; however, the seawater contained both surface active impurities in the form of proteins and other organics from sea life that lowered its overall surface tension, as well as polarity building impurities in the form of salts that increased the surface polarity of seawater.

Untreated seawater had an overall surface tension of 64.96 mN/M, dispersive surface tension of 20.62 mN/M, polar surface tension of 44.34 mN/M and surface polarity of 68.25%; magnetically conditioned seawater had an overall surface tension of 62.13 mN/M, dispersive surface tension of 15.53 mN/M, polar surface tension of 46.60 mN/M and surface polarity of 75.00%. Such results are shown in Table 4.

TABLE 4
Untreated Seawater vs. Seawater Conditioned at 850 Gauss
Untreated and Magnetically Conditioned Seawater
(Flowing through Magnet)

| | Overall | Dispersive | Polar | |
|---|---|---|---|---|
| | Surface | Surface | Surface | Surface |
| | Tension | Tension | Tension | Polarity |
| | (mN/m) | (mN/m) | (mN/m) | (%) |
| Untreated | 64.96 | 20.62 | 44.34 | 68.25 |
| Sea Water | | | | |
| Conditioned | 62.13 | 15.53 | 46.60 | 75.00 |
| Sea Water | | | | |

Interfacial tension is normally moderately high between oil and water, and the two liquids are immiscible because the hydrogen bonding structure of water discourages interaction with the oil. As disclosed herein, experimentation has shown that directing a fluid containing at least one polar substance, (e.g., seawater) and at least one dissimilar material (e.g., motor oil) through the magnetically conductive conduit as described above having magnetic energy directed along the longitudinal axis of the magnetically energized conduit and extending through at least a portion of the fluid mixture provides a conditioned fluid medium, wherein the at least one dissimilar material separates from the conditioned fluid medium at an increased rate as compared to a rate of separation of the at least one dissimilar material from the first fluid mixture.

The pendant drop method was utilized to analyze the interfacial tensions of seawater against motor oil. A drop of seawater having minerals and salts dissolved in the water to be studied for interfacial tension was formed to about 90% of its detachment volume on the end of a downward-pointing capillary tip, within a bulk phase of the motor oil. The drop was then digitally imaged using a high pixel camera, and analyzed to determine the drop's mean curvature at over 300 points along its surface.

The curvature of the drop that is pendant to the capillary tip, at any given point on its interface with the continuous phase, is dependent on two opposing factors, or forces. Interfacial tension works to keep the drop spherical while gravity works to make the drop elongated or “drip-like”; and the greater the difference in density between the drop of liquid and the continuous phase, the greater this force. Pendant drop evaluation involves observing the balance that exists between gravity and interfacial tension in the form of the drop's mean curvature at various points along its interface with the continuous phase. Lower interfacial tension liquids form a more “drip-like” shape while higher interfacial tension liquids form a more spherical drop shape. The actual mathematics of pendant drop analysis are based on the Laplace equation that says pressure differences exist across curved surfaces. The measurement of interfacial tension is actually made by determining the mean curvature of a drop at over 300 points, with the points then used in pairs in equations to solve for interfacial tension at least 150 times on any given drop; with those interfacial tension values then being averaged to give a single value for the overall interfacial tension of the drop.

This technique requires known values for the densities of all liquids involved in the studies at the conditions of interest, i.e. temperature. Such densities were determined prior to each set of pendant drop experiments by weighing precise volumes of each liquid phase having an identical temperature. The density of seawater was determined to be 1.003 g/cm³ and the density of motor oil was determined to be 0.8423 g/cm³. Using those densities, and as shown in Table 5, the following interfacial tensions were determined for the conditioned and untreated samples.

TABLE 5
Untreated Seawater and Motor Oil vs.
Seawater Conditioned at 850 Gauss and Motor Oil
Interfacial Tensions between Motor Oil and Sea Water

| | Untreated Motor Oil/ | Conditioned Motor |
|---|---|---|
| | Seawater Interfacial | Oil/Sea Water Interfacial |
| Test # | Tension (mN/m) | Tension (mN/m) |
| 1 | 28.36 | 33.14 |
| 2 | 28.33 | 33.05 |
| 3 | 28.39 | 33.10 |
| 4 | 28.42 | 33.14 |
| 5 | 28.42 | 33.08 |
| Average | 28.38 | 33.10 |
| Std. Dev. | 0.03 | 0.04 |

The interfacial tension of untreated seawater and motor oil was determined to be 28.38 mN/M. The interfacial tension of the magnetically conditioned seawater and motor oil was determined to be 33.10 mN/M. The higher interfacial tension of the conditioned motor oil/seawater indicates magnetic conditioning has an emulsion-breaking effect thereby improving oil/water separation.

In another aspect of the presently disclosed and/or claimed inventive concept, the above described methods may further include a step of recovering the fluid containing at least one polar substance from the conditioned fluid medium, wherein the removed fluid containing at least one polar substance has a reduced volume of the at least one dissimilar material therewith, and a step of recovering the at least one dissimilar material from the conditioned fluid medium. The viscosity of the conditioned fluid medium may be lower than the viscosity of the first fluid mixture. A particle size of the at least one dissimilar material in the conditioned fluid medium may be larger than a particle size of the at least one dissimilar material in the first fluid mixture. The fluid mixture may be heated upstream of the magnetically conductive conduit. The conditioned fluid medium may be heated upstream of the separation apparatus and/or within the separation apparatus. At least one chemical compound may be dispersed in the first fluid mixture. At least one chemical compound may be dispersed in the conditioned fluid medium.

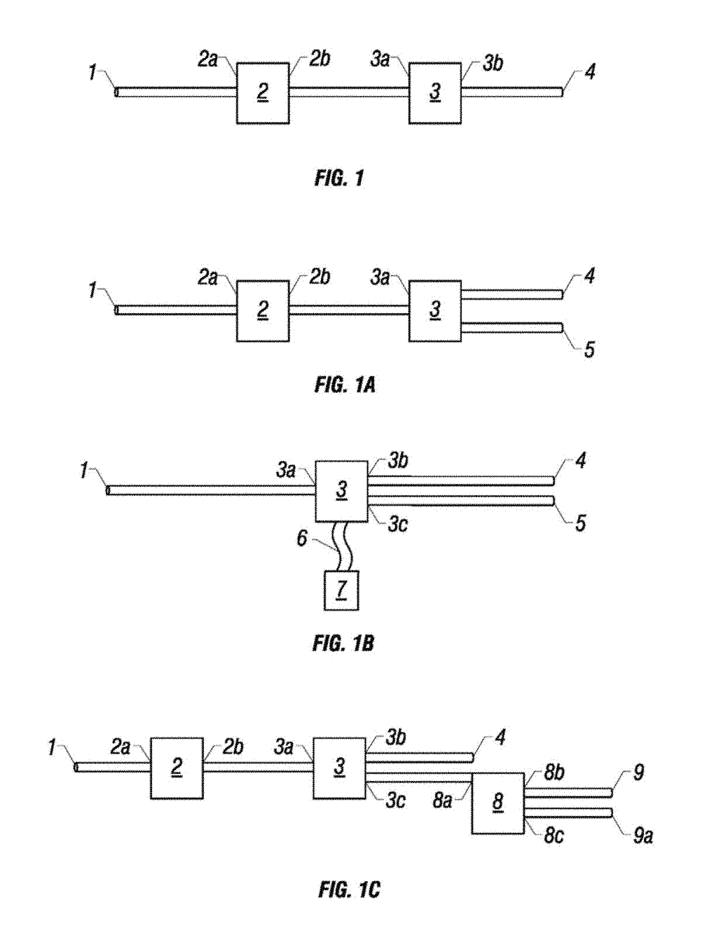

FIG. 1 is a schematic diagram of an embodiment of the presently claimed and/or disclosed inventive concepts for phase separation wherein a magnetically conductive conduit 2 is shown coupled to a separation apparatus 3 for fluid flow there between. A fluid mixture containing at least one polar substance and at least one dissimilar material introduced to port 1 may be directed to pass through fluid entry port 2a at the proximal end of the magnetically conductive conduit before passing through magnetically conductive conduit 2 having magnetic energy directed along the longitudinal axis of a magnetically energized conduit. The fluid mixture may then be discharged from fluid discharge port 2b at the distal end of the magnetically conductive conduit as a conditioned fluid medium. The conditioned fluid medium may then be directed through inlet port 3a of separation apparatus 3 having a capacity to separate the at least one dissimilar material from the conditioned fluid medium and retaining a volume of the at least one dissimilar material within the fluid impervious boundary wall of the separation apparatus 3, then directed to pass through outlet port 3b of the separation apparatus before being discharged as an amount of the conditioned fluid medium containing a reduced volume of the at least one dissimilar material through port 4.

Sediment, dirt, oil, and water that accumulate at the bottom of oilfield collection vessels and storage tanks in refineries reduce the storage capacity of such vessels and tanks. Oily sludge forms a mixture periodically cleaned from such vessels and processed to recover distinct hydrocarbon, solids and water phases.

Oil sands are a type of unconventional petroleum deposit having naturally occurring mixtures of sand saturated with a form of petroleum, technically referred to as “bitumen”, which flows very slowly. Oil sands may be extracted for processing by strip mining, or the oil may be made to flow into wells by in-situ techniques such as cyclic steam stimulation, steam assisted gravity drainage, solvent extraction, vapor extraction or toe to heel processes which reduce oil viscosity by injecting steam, solvents and/or hot air into the sands. These processes can use large quantities of water that are typically blended with the hydrocarbons and solids of the oil sands to form a mixture. Significant amounts of energy are then required to extract hydrocarbons from the mixture and process the water and solids for disposal and/or reuse.

The presently claimed and/or disclosed inventive concepts include a method for performing phase separation, including the steps of passing an amount of a fluid mixture through a magnetically conductive conduit having magnetic energy directed along the longitudinal axis of the magnetically energized conduit and extending through at least a portion of the first fluid mixture thereby providing a conditioned fluid medium; blending at least one solid material and at least one hydrocarbon material with an amount of the conditioned fluid medium to form a mixture; and separating a hydrocarbon phase, a solid phase, and a conditioned fluid medium phase from said mixture, wherein at least one of the solid material phase and the hydrocarbon material phase separates from the conditioned fluid medium at an increased rate as compared to a rate of separation of at least one of the solid material phase and the hydrocarbon material phase from the first fluid mixture.

The presently claimed and/or disclosed inventive concepts may further include the step of recovering the hydrocarbon phase, wherein the hydrocarbon phase has a reduced volume of the solid phase and the conditioned fluid medium phase; the step of recovering the solid phase, wherein the solid phase has a reduced volume of the hydrocarbon phase and the conditioned fluid medium phase and the step of recovering the conditioned fluid medium phase, wherein the conditioned fluid medium phase has a reduced volume of the solid phase and the hydrocarbon phase.

The fluid mixture may be heated upstream of a magnetically conductive conduit. The fluid mixture may be heated upstream of a separation apparatus and/or within a separation apparatus. At least one chemical compound may be dispersed in the fluid mixture. At least one chemical compound may be dispersed in the conditioned fluid medium. At least one chemical compound may be dispersed in the fluid mixture. The viscosity of the conditioned fluid medium may be lower than the viscosity of the fluid mixture. A particle size of at least one material of the conditioned fluid medium may be larger than a particle size of at least one of the solid material and the hydrocarbon material.

The presently claimed and/or disclosed inventive concepts include a method for performing phase separation, including the steps of blending an amount of a fluid containing at least one polar substance with at least one solid material and at least one hydrocarbon material to form a mixture; passing an amount of the mixture through a magnetically conductive conduit having magnetic energy directed along the longitudinal axis of the magnetically energized conduit and extending through at least a portion of the mixture thereby providing a conditioned medium; and separating a hydrocarbon phase, a solid phase, and a conditioned fluid medium phase from the conditioned medium, wherein at least one phase separates from the conditioned medium at an increased rate as compared to a rate of separation of the at least one phase from the mixture. The presently claimed and/or disclosed inventive concepts may further include the step of recovering the hydrocarbon phase, wherein the hydrocarbon phase has a reduced volume of the solid phase and the conditioned fluid medium phase; the step of recovering the solid phase, wherein the solid phase has a reduced volume of the hydrocarbon phase and the conditioned fluid medium phase; and the step of recovering the conditioned fluid medium phase, wherein the conditioned fluid medium phase has a reduced volume of the solid phase and the hydrocarbon phase.

The mixture may be heated upstream of a magnetically conductive conduit. The conditioned medium may be heated upstream of a separation apparatus and/or within a separation apparatus. At least one chemical compound may be dispersed in the fluid mixture. At least one chemical compound may be dispersed in the mixture. At least one chemical compound may be dispersed in the medium. The viscosity of the conditioned fluid medium phase may be lower than the viscosity of the fluid mixture. A particle size of at least one material of the conditioned medium may be larger than a particle size of at least one of the solid material and the hydrocarbon material.

FIG. 1A is a schematic diagram of an embodiment of the presently claimed and/or disclosed inventive concepts for phase separation wherein magnetically conductive conduit 2 is shown coupled to separation apparatus 3 for fluid flow there between. A fluid mixture introduced to port 1 may be directed to pass through fluid entry port 2a at the proximal end of the magnetically conductive conduit before passing through magnetically conductive conduit 2 having magnetic energy directed along the longitudinal axis of the magnetically energized conduit. The fluid mixture may then be discharged from fluid discharge port 2b at the distal end of the magnetically conductive conduit as a conditioned fluid medium. The conditioned fluid medium may then be directed through inlet port 3a of separation apparatus 3 having a capacity to separate the at least one dissimilar material from the conditioned fluid medium. A first amount of the conditioned fluid medium having a reduced volume of the at least one dissimilar material may be discharged through outlet port 4 and the separated at least one dissimilar material may be discharged through outlet port 5.

The presently claimed and/or disclosed inventive concepts include a method of separating at least one dissimilar material from a fluid mixture, including the steps of establishing a flow of a fluid mixture through the magnetically conductive conduit having magnetic energy directed along the longitudinal axis of the magnetically energized conduit and extending through at least a portion of the first fluid mixture thereby providing a conditioned fluid medium; and directing a flow of at least a portion of the conditioned fluid medium through the separation apparatus. The fluid mixture may be heated upstream of the magnetically conductive conduit. The conditioned fluid medium may be heated upstream of the separation apparatus and/or within the separation apparatus. At least one chemical compound may be dispersed in the fluid mixture. At least one chemical compound may be dispersed in the conditioned fluid medium.

In another example, a closed loop system having a five gallon collection vessel, a 12 VDC diaphragm pump energized with a variable power supply, a flow meter, and a magnetically conductive conduit comprising a serial coupling of conduit segments having a 1.050″ outside diameter boundary wall and a length of approximately 22″ and connected with ½″ plastic tubing (with the tubing being made of a material that, in and of itself, would not affect any physical properties of a fluid mixture sample) were utilized to generate untreated and magnetically conditioned fluid samples, with the variable power supply providing an adjustable amount of electrical energy to energize the DC pump and control the fluid flow rate. The closed loop system allowed fluid to be pulled from collection vessel by the pump and propelled through the flow meter and magnetically conductive conduit before being returned to the collection vessel.

The serial coupling of conduit segments comprised a non-magnetically conductive threaded coupling axially aligned between two magnetically conductive threaded conduit segments, each conduit segment having a wall thickness of approximately 0.113″. Female NPT pipe threads on each end of the non-magnetically conductive coupling matched the male NPT pipe threads on the ends of the magnetically conductive segments that were threaded into the coupling so that distance from the distal end of the first threaded magnetically conductive conduit to the proximal end of the second threaded magnetically conductive conduit was approximately ¾″.

A coil encircling at least a section of the outer surface of the magnetically conductive threaded conduits and the non-magnetically conductive threaded coupling was formed by winding 242 turns of a length of 14 AWG copper wire to form a 16″ layer, and then adding seven more layers to form a continuous coil having a total of 1936 turns encircling the serial coupling of conduit segments, wherein the length to diameter ratio of the coil was approximately 8:1.

Three gallons of homogenized whole milk were decanted into the collection vessel. The pump was energized and power supply adjusted to circulate the milk through the system at a rate of 2.0 gallons per minute (gpm). After circulating the milk for 5 minutes to allow for the dismissal of any bubbles so that the milk was circulating at a steady-state flow, a first sample of untreated milk was collected in a first 2 liter graduated container. The output of electrical energy supplied to the DC pump was then adjusted to maintain a flow rate of 2.0 gpm through the closed loop system.

A coiled electrical conductor encircling the magnetically conductive conduit was then energized with 12 VDC and approximately 5 amps of electrical energy. A second sample of milk, directed to make only one pass through an area of magnetic conditioning concentrated along a path extending through the electrical conductor encircling the outer surface of the magnetically energized conduit generating a magnetic field strength of approximately 1000 gauss (unit of magnetic field measurement) and a magnetic field strength of approximately 150 gauss concentrated at each end of the magnetically energized conduit, was collected in a second 2 liter graduated container. The output of electrical energy supplied to the DC pump was again adjusted to maintain a flow rate of 2.0 gpm through the closed loop system.

After circulating the milk through the magnetically energized conduit for 4 additional minutes, a third milk sample directed to make approximately six passes through the concentrated magnetic energy was collected in a third 2 liter graduated container. The output of electrical energy supplying the DC pump was again adjusted to maintain a flow rate of 2.0 gpm through the system. After circulating the milk for an additional 26 minutes through magnetically energized conduit, a fourth milk sample directed to make approximately 30 passes through the concentrated magnetic energy was collected in a fourth 2 liter graduated container.

The collected samples were allowed to rest at room temperature for 24 hours to observe any gravity separation of phases of the homogenized whole milk. After 24 hours, the first (untreated) sample showed no signs of separation and appeared to remain in a homogenized state. Approximately 75 ml of an aqueous material was observed floating at the top of the second milk sample. Approximately 225 ml of an aqueous material was observed floating at the top of the third milk sample. Approximately 400 ml of an aqueous material was observed resting beneath the fourth milk sample. As disclosed herein, magnetic conditioning of homogenized whole milk and gravity separation at ambient temperature resulted in an aqueous material separating from each sample of magnetically conditioned milk at an increased rate as compared to a rate of separation of an aqueous material from untreated milk. Such results are shown in Table 6.

TABLE 6
Untreated Milk vs. Milk Conditioned at 1000 Gauss
Untreated and Magnetically Conditioned
Whole Milk (Flowing through Magnet)

| | | Magnetically | Magnetically | Magnetically |
|---|---|---|---|---|
| | | Conditioned | Conditioned | Conditioned |
| | Untreated | Milk—1 | Milk—6 | Milk—30 |
| | Milk | Pass | Passes | Passes |
| % Separation | 0.00% | 3.75% | 11.25% | 20.00% |

Altering a dispersive surface tension and/or a polar surface tension of a fluid improves the mechanical blending of two or more distinct phases into homogenous mixtures that will not readily separate into distinct phases over time. A fundamental understanding of the properties of drilling fluids (i.e., “mud”, “drilling mud”, or “drilling fluid”) is essential for safe and efficient oil and gas exploration and production activities.

Mud density is used to provide hydrostatic pressure to control a well during drilling operations and is normally reported in pounds per gallon. The viscosity of a drilling fluid is defined as its internal resistance of fluid flow. Yield point (YP) of a drilling fluid is the resistance to initial flow, or the stress required to initiate fluid movement. Yield point is used to evaluate the ability of mud to lift cuttings. A higher yield point implies that a drilling fluid has the ability to carry cuttings better than a fluid of similar density but lower yield point.

Plastic viscosity (PV) of a drilling fluid is the slope of the shear stress-shear rate plot above the yield point of the fluid. A low plastic viscosity indicates mud may be utilized for rapid drilling due to its low viscosity as it exits a bit. A high plastic viscosity is created as excess colloidal solids are entrained in a viscous base fluid.

As described in more detail below, the above-described apparatus corresponding to the data illustrated in Table 6 was also used to treat a water based drilling fluid—the properties of which are illustrated below in Table 7. In particular, along with the previously disclosed method of generating untreated and magnetically conditioned fluid samples, a closed loop system having a five gallon collection vessel, a 12 VDC diaphragm pump energized with a variable power supply, a flow meter, and a magnetically conductive conduit comprising a serial coupling of conduit segments having a 1.050″ outside diameter boundary wall and a length of approximately 22″ and connected with ½″ plastic tubing (that would not affect physical properties of a fluid sample) were utilized to generate untreated and magnetically conditioned fluid samples. As disclosed herein, magnetic conditioning of a fluid containing at least one polar substance was determined to alter a dispersive surface tension and/or a polar surface tension of a conditioned fluid medium and affect the viscosity of the conditioned fluid medium.

Three gallons of a water-based drilling fluid (also known as “drilling mud” or “mud”) containing bentonite, salts, polymers, scale inhibitors, and other additives were decanted into the collection vessel. The pump was energized and power supply adjusted to circulate the drilling fluid through the system at a rate of 2.0 gpm. After circulating the drilling fluid for 5 minutes to achieve a steady-state flow, a first sample of untreated drilling fluid was collected and the plastic viscosity and yield point of the untreated drilling fluid were measured by utilizing a viscometer rotating at 300 rpm and 600 rpm to determine the viscosity of the fluid. Untreated drilling fluid had a plastic viscosity of 27 and a yield point of 24 dynes/cm².

A coiled electrical conductor encircling the magnetically conductive conduit was then energized with 12 VDC and approximately 5 amps of electrical energy. A second sample of drilling fluid, directed to make only one pass through an area of magnetic conditioning having a first polarity concentrated along a path extending through the electrical conductor encircling the outer surface of the magnetically energized conduit generating a magnetic field strength of approximately 1000 gauss (unit of magnetic field measurement), as well as a magnetic field strength of approximately 150 gauss concentrated at each end of the magnetically energized conduit, was collected to determine the viscosity of the fluid. Utilizing the same viscometer rotating at 300 rpm and 600 rpm, no significant change in the viscosity of the fluid was measured after only one pass through the magnetically energized conduit.

However, after circulating the drilling fluid through the magnetically energized conduit so that it made approximately 5 passes through magnetic energy inducing the first polarity, the viscosity of the drilling fluid was reduced as indicated by a drop in the plastic viscosity from 27 cP to 24 cP and a drop in the yield point from 24 dynes/cm² to 18 dynes/cm². After circulating the drilling fluid through the magnetically energized conduit for approximately 10 additional passes through the first polarity, the viscosity of the drilling fluid was further reduced as indicated by a drop in the plastic viscosity from 24 cP to 20 cP and the yield point increased from 18 dynes/cm² to 21 dynes/cm² for a net drop in yield point of 12.5%.

The magnetically conditioned drilling fluid having the reduced plastic viscosity and yield point as a result of making 15 passes through the magnetically energized conduit was then circulated through the closed loop system so that the drilling fluid made approximately 17 passes through the magnetically energized conduit inducing magnetic energy having a second polarity, the plastic viscosity of the drilling fluid increased from 20 cP to 22 cP and its yield point increased from 20 dynes/cm² to 24 dynes/cm². These results are shown in Table 7.

TABLE 7
Untreated Drilling Fluid vs. Drilling Fluid Conditioned at 1000 Gauss
Water-based Drilling Fluid Viscosity
Untreated and Magnetic Conditioning (Flowing through Magnet)

| Untreated | Conditioning | % | Conditioning | |
|---|---|---|---|---|
| Drilling | w/ 1st | Change | w/ 2nd | % Change |
| Fluid | Polarity | From | Polarity | From |
| PV/YP | PV/YP | Untreated | PV/YP | 1st Polarity |
| 27 cP/ | 20 cP/ | −25.9%/ | 22 cP/ | +10.0%/ |
| 24 dyn/cm² | 21 dyn/cm² | −12.5% | 24 dyn/cm² | +14.3% |

As disclosed herein, experimentation has shown magnetic conditioning as described in the presently claimed and/or disclosed inventive concepts alters at least one physical property of a fluid flowing under pressure. The presently claimed and/or disclosed inventive concepts also include a method of reducing a pressure to propel a fluid containing at least one polar substance, including the steps of establishing a flow of a fluid containing at least one polar substance through a magnetically conductive conduit having magnetic energy directed along the longitudinal axis of the magnetically energized conduit and extending through at least a portion of the fluid containing at least one polar substance thereby providing a conditioned fluid medium; and directing a volume of the conditioned fluid medium to flow through a constricted region, wherein the pressure required to propel a volume of the conditioned fluid medium through the constricted region is reduced as compared to the pressure required to propel a substantially identical volume of the first fluid mixture through the constricted region.

The presently claimed and/or disclosed inventive concepts also include a method of reducing a pressure to pass a fluid containing at least one polar substance through a conduit at ambient temperature, including the steps of establishing a flow of the fluid containing at least one polar substance through a magnetically conductive conduit having magnetic energy directed along the longitudinal axis of the magnetically energized conduit and extending through at least a portion of the fluid containing at least one polar substance thereby providing a conditioned fluid medium; and passing the conditioned fluid medium at a constant flow rate through a conduit downstream of the magnetically conductive conduit, wherein the pressure required to pass a volume of the conditioned fluid medium at a constant flow rate through the conduit at ambient temperature is reduced as compared to the pressure required to pass a substantially identical volume of the fluid containing at least one polar substance that has not been magnetically conditioned at a substantially identical constant flow rate through the conduit at ambient temperature.

In another example, as presented below, the same apparatus associated with the data illustrated in both Tables 6 and 8 was again used to treat tap water—the results of which are presented in Table 8. In particular, along with the previously disclosed method of generating untreated and magnetically conditioned fluid samples, a closed loop system having a five gallon collection vessel, a 12 VDC diaphragm pump energized with a variable power supply, a flow meter, and a magnetically conductive conduit comprising a serial coupling of conduit segments having a 1.050″ outside diameter boundary wall and a length of approximately 22″ and connected with new ½″ plastic tubing (that would not affect physical properties of a fluid sample) were utilized to generate untreated and magnetically conditioned fluid samples. As disclosed herein, magnetic conditioning of a fluid containing at least one polar substance was determined to increase the flow rate of the fluid propelled through a conduit under pressure at ambient temperature.

Four gallons of tap water were decanted into the collection vessel, the pump was energized and power supply adjusted to circulate the water through the system at a rate of 4.0 gpm. After circulating the water for 5 minutes to achieve a steady-state flow, a first sample of untreated tap water was collected in a collapsible plastic bladder. The water sample was then placed in a pneumatically driven flow evaluation system, wherein air pressure compressed the collapsible plastic bladder to propel the water sample through an adjustable solenoid valve and a 30″ length of 3/16″ stainless steel tubing before being decanted into a sample collection flask.

The solenoid valve, having a capacity to regulate fluid flow through an adjustable orifice at a predetermined pressure, was connected to an electric timer utilized to regulate the length of time the valve was open to allow for pneumatically driven fluid flow. Flow rates through the system were then determined by dividing the volume of water collected in the sample flask by the amount of time the solenoid valve was open to allow fluid to flow through the valve. The average flow rate of untreated water propelled at 20 psi through the system was determined to be 17.2 milliliters per second, or 0.0273 gpm and the average flow rate of untreated water propelled at 40 psi was determined to be 21.6 milliliters per second, or 0.0342 gpm.

A coiled electrical conductor encircling the magnetically conductive conduit was then energized with 12 VDC and approximately 5 amps of electrical energy to generate a magnetic field strength of approximately 1000 gauss near the center of the magnetically energized conduit, as well as a magnetic field strength of approximately 150 gauss concentrated at each end of the magnetically energized conduit. A second 4 gallon sample of tap water was circulated through the magnetically energized closed loop conditioning system at a rate of 4.0 gpm for approximately 10 minutes before a collecting a sample of conditioned tap water after it made approximately 10 passes through a magnetically energized conduit.

The magnetically conditioned water sample was then placed in the pneumatically driven flow evaluation system and samples were generated with water propelled through the solenoid valve at 20 psi and 40 psi. The average flow rate of magnetic conditioned water propelled at 20 psi through the flow evaluation system was determined to be 18.4 milliliters per second, or 0.0292 gpm; a 7.0% increase in flow rate as a result of magnetic conditioning and the average flow rate of magnetic conditioned water propelled at 40 psi through the flow evaluation system was determined to be 26.2 milliliters per second, or 0.0415 gpm, an increased flow rate of 21.3% as a result of magnetic conditioning. These results are shown in Table 8.

TABLE 8
Untreated Tap Water vs. Tap Water Conditioned at 1000 Gauss
Tap Water Propelled Through a Conduit at Pressure
Untreated and Magnetic Conditioning (Flowing through Magnet)

| Untreated | Magnetic | % | Untreated | Magnetic | % |
|---|---|---|---|---|---|
| Tap Water | Conditioning | Change | Tap Water | Conditioning | Change |
| 20 psi | 20 psi | @ 20 psi | 40 psi | 40 psi | @ 40 psi |
| .0273 gpm | .0292 gpm | 7.0% | .0342 gpm | .0415 gpm | 21.3% |

The presently claimed and/or disclosed inventive concepts also include a method of increasing the flow rate of a fluid containing at least one polar substance propelled through a conduit under pressure at ambient temperature, including the steps of establishing a flow of the fluid containing at least one polar substance through a magnetically conductive conduit having magnetic energy directed along the longitudinal axis of the magnetically energized conduit and extending through at least a portion of the fluid containing at least one polar substance, thereby providing a conditioned fluid medium; and propelling the conditioned fluid medium under pressure through a conduit downstream of the magnetically conductive conduit, wherein the flow rate of a volume of the conditioned fluid medium propelled at a constant pressure through the conduit at ambient temperature is increased as compared to the flow rate of a substantially identical volume of the fluid containing at least one polar substance prior to magnetic conditioning that is propelled at a substantially identical constant pressure through the conduit at ambient temperature.

The presently claimed and/or disclosed inventive concepts also include a method of increasing the flow rate of a fluid containing at least one polar substance, including the steps of establishing a flow of the fluid containing at least one polar substance through a magnetically conductive conduit having magnetic energy directed along the longitudinal axis of the magnetically energized conduit and extending through at least a portion of the fluid containing at least one polar substance thereby providing a conditioned fluid medium; and directing a volume of the conditioned fluid medium to flow through a constricted region, wherein the flow rate of a volume of the conditioned fluid medium propelled through the constricted region is increased as compared to the flow rate of a substantially identical volume of the fluid containing at least one polar substance without magnetic conditioning that is also propelled through the constricted region.

The presently claimed and/or disclosed inventive concepts of increasing the efficiency of phase separation of a dissimilar material from a fluid mixture were quantified in yet another example. A length of new ½″ ID plastic tubing was deployed through the fluid impervious wall of an embodiment of the presently claimed and/or disclosed magnetically conductive conduit having a 0.900″ inner diameter with the tubing extending through each end of the conduit to establish a fluid flow path; with the tubing being made of a material that, in and of itself, would not affect any physical properties of a fluid mixture sample.

A closed loop system having a 2 gallon collection vessel, a peristaltic (non-direct contact) pump to propel samples through the plastic tubing extending through the magnetically conductive conduit at flow rates of 43.6 ml/second, and an embodiment of the presently claimed and/or disclosed magnetically conductive conduit sleeving the ½″ plastic tubing was utilized to generate untreated and magnetically conditioned fluid samples. The closed loop system allowed fluid to be pulled from the collection vessel by the pump and propelled through the magnetically conductive conduit before being returned to the collection vessel.

A length of magnetically conductive conduit having an outside diameter of approximately 2.375″ and a length of approximately 36″ and a wall thickness of approximately 0.218″ formed a 2″ magnetically conductive coil core. A coil encircling at least a section of the outer surface of the 2″ coil core was formed by winding 272 turns of a length of 14 AWG copper wire to form a 18″ layer, and then adding seven more layers to form a continuous coil having a total of 2176 turns encircling the coil core, wherein the length to diameter ratio of the coil was approximately 5:1. The continuous coil was enclosed within a protective housing having a 12″ diameter, said housing comprising a length of 12″ non-magnetically conductive conduit having an inner surface and an outer surface and a proximal end and a distal end, the housing further comprising non-magnetically conductive end plates on each end of the housing with the outer edge of each end plate disposed in fluid communication with an end of the 12″ conduit and the inner edge the end plate in fluid communication with the outer surface of the 2″ coil core.

A serial coupling of conduit segments having an outside diameter of approximately 1.900″ and a length of approximately 34″ was formed with three non-magnetically conductive conduit segments interleaved between four magnetically conductive conduit segments, each conduit segment having a wall thickness of approximately 0.500″. The non-magnetically conductive segments were bored out with a 45° chamfer on each end to match the ends of the magnetically conductive segments that were turned down with 45° chamfers prior to coupling the segments to form the serial coupling of conduit segments. The serial coupling of conduit segments was sleeved within the coil core.

A first sample was generated by decanting 500 ml of high mineral containing whey, such as Greek yogurt whey containing suspended solids such as lactose, calcium, magnesium, lactates and other minerals, into a collection vessel of a closed-loop system. The pump was energized and adjusted to circulate the whey through the system at a rate of 1.0 gallon per minute (gpm). After circulating the untreated whey containing minerals for 2 minutes to allow for the dismissal of any bubbles so that it was circulating at a steady-state flow, a first sample of untreated whey was collected in a first 1 liter separatory funnel. The coiled electrical conductor encircling the magnetically conductive conduit was not energized during the generation of the first whey sample.

A second sample was generated by decanting 500 ml of untreated whey containing minerals into the collection vessel, circulating the untreated whey for 2 minutes to achieve steady-state flow and then energizing the coiled electrical conductor encircling the magnetically conductive conduit with approximately 32 VDC and 10 amps of electrical energy, with the energized conduit configured to induce a negative polarity to fluid flowing through the conduit. The whey was then directed to make 10 passes through areas of magnetic conditioning concentrated along a path extending through the magnetically energized conduit. A magnetic field strength of approximately 3,300 gauss was concentrated within the intermediate non-magnetically conductive conduit segment of the magnetically energized conduit and a magnetic field strength of approximately 1,000 gauss was concentrated within the outboard non-magnetically conductive conduit segments of the magnetically energized conduit. The second sample of negatively conditioned whey containing minerals was collected in a second 1 liter separatory funnel. Approximately 30 minutes elapsed between the generation of the first sample and the second sample.

After purging any negatively conditioned whey from the closed-loop and rinsing the system, a third sample was generated by decanting 500 ml of untreated whey containing minerals into the collection vessel and circulating the untreated whey for 2 minutes to achieve steady-state flow. Prior to energizing the magnetically energized conduit, the polarity induced by the magnetically energized conduit was reversed. The whey was then directing to make 10 passes through the magnetically energized conduit inducing a positive polarity. The third sample of positively conditioned whey containing minerals was collected in a third 1 liter Separatory funnel. Approximately 30 minutes elapsed between the generation of the second sample and the third sample.

The pH of each sample was adjusted to ˜7.2 using sodium hydroxide and then the samples were heated to ˜80 degrees C. Gravity separation of minerals from the untreated whey (control) and magnetically conditioned samples was observed for 1 hour. Approximately 200 ml of minerals settled to the bottom of the separatory funnel containing the first (untreated) sample, approximately 180 ml of minerals settled to the bottom of the separatory funnel containing the second (negatively conditioned) sample, and approximately 180 ml of minerals settled to the bottom of the separatory funnel containing the third (positively conditioned) sample. The samples were then directed through a filtration apparatus.

Using the equation Yield(%)=([(% suspended solids)sub Bottom×([weight)] sub Bottom)/([(% suspended solids)sub feed×([weight)] sub feed)×100, the negatively conditioned sample and the positively conditioned sample were found to each contain approximately 50% more minerals content than the untreated (control) sample as each sample flowed through the filtration apparatus. Such results are shown in Table 9.

TABLE 9
Untreated Greek Whey vs. Greek Whey Conditioned at 3,300 Gauss
Untreated and Magnetically Greek Whey (Flowing through Magnet)

| | Untreated | Negatively | Positively |
|---|---|---|---|
| | Whey Circulated | Conditioned Whey | Conditioned Whey |
| | to Steady-State | 10 Passes | 10 Passes |
| % Separation of | 40% | 59% | 58% |
| Minerals | | | |

Field Test at Gauss Levels of about 2400

As disclosed herein, field testing has shown that directing a mixture comprising a fluid containing at least one polar substance and at least one dissimilar material (e.g., produced water and crude oil from a hydrocarbon producing formation) through a magnetically conductive conduit having magnetic energy directed along the longitudinal axis of the magnetically energized conduit and extending through at least a portion of the mixture provides a conditioned fluid medium, wherein the at least one dissimilar material separates from the fluid containing at least one polar substance at an increased rate as compared to the rate of separation of the at least one dissimilar material from the fluid containing at least one polar substance when the mixture has not been magnetically conditioned.

In one first field test example, an oilfield operator was processing a production fluid mixture having 99.6% water and 0.04% crude oil through an oil/water separator at a flow rate of approximately 8,700 barrels of fluid per 24-hour day. Oil discharged from the separator was collected in oil storage tanks for sale as a commodity and water discharged from the separator was directed to a battery of water collection tanks that accumulated the water prior it to being injected back into the producing formation as part of a waterflood operation. The separation apparatus had been originally designed to effectively segregate oil and water at a flow rate of 4,000 barrels per day; but as the oil lease matured, production fluid from additional wells was directed to this central processing facility. The increase in flow rate through the separator resulted in less retention time to allow for effective oil/water separation so that an average of 500 ppm of oil was then typically resident in water discharged from a separator processing fluid at a flow rate more than twice its designed capacity. A portion of the oil in the water directed to the water tank battery typically floated to the surface of the collection tanks and was skimmed off for sale, resulting in an average of 300 ppm of oil remaining in the water injected back into the waterflood formation.

An embodiment of the presently claimed and/or disclosed magnetically conductive conduit described herein having an inside diameter of approximately 4″ was used for the field tests. The field trial apparatus utilized to generate the magnetically conditioned samples of the “field test example at about 2400 gauss” comprised a serial coupling of conduit segments having an outside diameter of approximately 4.500″ and a length of approximately 72″, the serial coupling of conduit segments further comprising three non-magnetically conductive conduit segments axially aligned between four magnetically conductive conduit segments, each conduit segment having a wall thickness of approximately 0.337″. The non-magnetically conductive segments were bored out with a 45° chamfer on each end to match the ends of the magnetically conductive segments that were turned down with 45° chamfers prior to coupling the segments to form a 4″ serial coupling of a first magnetically conductive conduit segment, a first non-magnetically conductive conduit segment, a second magnetically conductive conduit segment, a second non-magnetically conductive conduit segment, a third magnetically conductive conduit segment, a third non-magnetically conductive conduit segment and a fourth magnetically conductive conduit segment.

A coil encircling at least a section of the outer surface of the second 4″ magnetically conductive conduits segment, the second 4″ non-magnetically conductive conduit segment and the third 4″ magnetically conductive conduits segment was formed by winding 164 turns of a length of copper wire measuring 0.125″×0.250″ to form a 41″ layer, and then adding seven more layers to form a continuous coil having a total of 1312 turns encircling the magnetically conductive conduit, wherein the length to diameter ratio of the coil was approximately 6:1. The continuous coil was enclosed within a protective housing having a 12″ diameter, said housing comprising a length of 12″ conduit comprising a magnetically conductive material and having an inner surface and an outer surface and a proximal end and a distal end, the housing further comprising end plates on each end of the housing comprising a magnetically conductive material having the outer edge of each end plate disposed in fluid communication with an end of the 12″ conduit and the inner edge the end plate in fluid communication with the outer surface of the 4″ magnetically conductive conduit.

The magnetically conductive conduit was installed in the production flow line immediately upstream of the inlet of the separator and a coiled electrical conductor encircling the magnetically conductive conduit was then energized with 24 VDC and approximately 32 amps of electrical energy. The oilfield production fluid mixture was directed to make a single pass through areas of magnetic conditioning concentrated along a path extending through the electrical conductor encircling the outer surface of the magnetically energized conduit wherein a magnetic field strength of approximately 2400 gauss was concentrated within the intermediate non-magnetically conductive conduit segment of the magnetically energized conduit and a magnetic field strength of approximately 840 gauss was concentrated within the outboard non-magnetically conductive conduit segments of the magnetically energized conduit.

After installing an embodiment of the presently claimed and/or disclosed magnetically conductive conduit immediately upstream of the undersized separator, an average of 114 ppm of oil was found in water discharged from the separator (a 77.2% reduction of oil in water) and an average of 49 ppm of oil was found in the water injected back into the waterflood formation (a 83.6% reduction of oil in water). Such results are shown in Table 10.

TABLE 10
Mixtures of Untreated Fluids vs.
Mixtures of Fluids Conditioned at 2400 Gauss
Oil Recovery from Oilfield Production Fluid Comprising 99.6% Water and 0.4% Oil
Untreated and Magnetic Conditioning (Flowing through Magnet)

| Oil in | Oil in | | | | |
|---|---|---|---|---|---|
| Untreated | Magnetically | Reduction of | Oil in | Oil in | |
| Production | Conditioned | Oil | Untreated | Magnetically | Reduction of |
| Fluid | Production | in Water | Produced | Conditioned | Oil |
| Discharged | Fluid | Discharged | Water Injected | Produced | in Water |
| from | Discharged | from an | Into | Water Injected | Injected Into |
| Oil/Water | from Oil/Water | Oil/Water | Waterflood | Into Waterflood | Waterflood |
| Separator | Separator | Separator | Formation | Formation | Formation |
| 500 pm | 114 ppm | 77.20% | 300 ppm | 49 ppm | 83.6% |

The presently claimed and/or disclosed inventive concepts include a method of increasing the efficiency of phase separation of a dissimilar material from a fluid mixture at ambient temperature, including the step of installing a magnetically conductive conduit having magnetic energy directed along the longitudinal axis of the magnetically energized conduit upstream of an inlet of a separation apparatus thereby providing a conditioned fluid medium entering the inlet of the separation apparatus, wherein the at least one dissimilar material separates from the conditioned fluid medium at an increased rate as compared to a rate of separation of the at least one dissimilar material from the fluid mixture.

FIG. 1B schematically depicts an embodiment of the presently claimed and/or disclosed inventive concepts for increasing the efficiency of phase separation of a dissimilar material from a first fluid mixture wherein a magnetically conductive conduit is disposed within separation apparatus 3 and includes the steps of establishing a flow of the first fluid mixture through port 1 to direct the fluid mixture to pass through an inlet port of a separation apparatus having a capacity to separate the at least one dissimilar material from a conditioned fluid medium, the separation apparatus having a fluid impervious boundary wall having an inner surface, inlet port 3a for receiving a fluid mixture, a first outlet port 3b for discharging a first amount of the conditioned fluid medium having a reduced volume of the at least one dissimilar material and a second outlet port 3c for discharging the separated at least one dissimilar material; directing the first fluid mixture to pass through a magnetically conductive conduit disposed downstream of the inlet port and within the inner surface of the fluid impervious wall of the separation apparatus, the magnetically conductive conduit having magnetic energy directed along the longitudinal axis of the magnetically energized conduit and extending through at least a portion of the first fluid mixture thereby providing a conditioned fluid medium; and directing a flow of at least a portion of the conditioned fluid medium through the separation apparatus, wherein the at least one dissimilar material separates from the conditioned fluid medium at an increased rate as compared to a rate of separation of the at least one dissimilar material from the first fluid mixture.

At least one electrical power supply 7 is shown operably connected to at least one of the first and second conductor leads 6 of the magnetically conductive conduit disposed within the separation apparatus 3. Heat produced by the magnetically energized conduit may radiate into the conditioned fluid medium to increase the rate of phase separation. An amount of the conditioned fluid medium having a reduced volume of the at least one dissimilar material may then be discharged from first outlet port 4 and at least one dissimilar material containing a reduced volume of the conditioned fluid medium may then be discharged from second outlet port 5. At least one chemical compound may be dispersed in the fluid mixture. At least one chemical compound may be dispersed in the conditioned fluid medium.

FIG. 1C is a schematic diagram of an embodiment of the presently claimed and/or disclosed inventive concepts for phase separation of a first dissimilar material and a second dissimilar material from a fluid mixture wherein magnetically conductive conduit 2 is shown coupled to first separation apparatus 3 for fluid flow there between. The fluid mixture containing the first and the second dissimilar material introduced to port 1 may be directed to pass through fluid entry port 2a at the proximal end of the magnetically conductive conduit before passing through magnetic energy directed along the longitudinal axis of magnetically energized conduit 2. The fluid mixture may then be discharged from fluid discharge port 2b at the distal end of the magnetically conductive conduit as a conditioned fluid medium. The conditioned fluid medium may then be directed through inlet port 3a of first separation apparatus 3 having a capacity to separate a first dissimilar material from the conditioned fluid medium. An amount of the first dissimilar material may be discharged through outlet port 3b before being directed through outlet port 4 as a first dissimilar material containing a reduced volume of the conditioned fluid medium. The conditioned fluid medium having a reduced volume of the first dissimilar material may then be discharged through outlet port 3c of first separation apparatus 3 before being directed through inlet port 8a of second separation apparatus 8 having a capacity to separate a second dissimilar material from the conditioned fluid medium. An amount of the second dissimilar material may be discharged through outlet port 8b before being directed through outlet port 9 as a second dissimilar material containing a reduced volume of a fluid mixture containing at least one polar substance; and a fluid mixture containing at least one polar substance may be discharged through outlet port 8c before being directed through outlet port 9a as a fluid mixture containing at least one polar substance having a reduced volume of the first dissimilar material and the second dissimilar material.

In each embodiment of the presently claimed and/or disclosed inventive concepts for separating at least one dissimilar material from a fluid mixture containing at least one polar substance and performing phase separation, it can be appreciated that magnetic energy may be concentrated in a plurality of distinct areas along the longitudinal axis of the magnetically energized conduit.

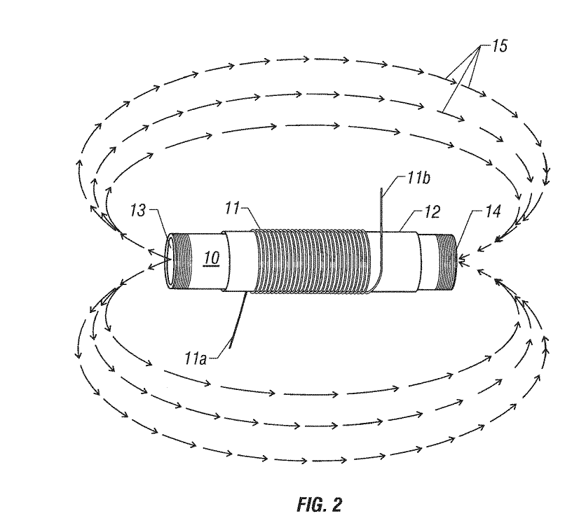

FIG. 2 shows a flow of magnetic flux loops 15 generated by energized coil 11. Coil core 12 is shown sleeving a section of magnetically conductive conduit 10 wherein the coiled electrical conductor 11 encircling the coil core 12 sleeves at least a section of an outer surface of the magnetically conductive conduit with at least one turn of the electrical conductor oriented substantially orthogonal to the longitudinal axis of the conduit. A single length of electrical conducting material is shown forming coil 11.

Operably connecting first conductor lead 11a and second conductor lead 11b to at least one supply of electrical power energizes the coiled electrical conductor and produce an electromagnetic field absorbed by magnetically conductive conduit 10 and concentrated within the inner surface of the fluid impervious boundary wall of the conduit. Magnetic flux loops 15 are shown consolidated at a point beyond port 13 at the proximal end of magnetically energized conduit 10, flowing around the periphery of continuous coil 11 along the longitudinal axis of the conduit and reconsolidating at a point beyond port 14 at the distal end of the magnetically energized conduit. Fluid directed to pass through the magnetically energized conduit may receive magnetic conditioning in at least one region along the fluid flow path extending through magnetically energized conduit 10. Magnetically conductive coupling devices and/or conduits and non-magnetically conductive coupling devices and/or conduits may be utilized to make fluid impervious connections with inlet port 13 and outlet port 14 of magnetically energized conduit 10 to promote the flow of fluid through at least one concentrated magnetic field.

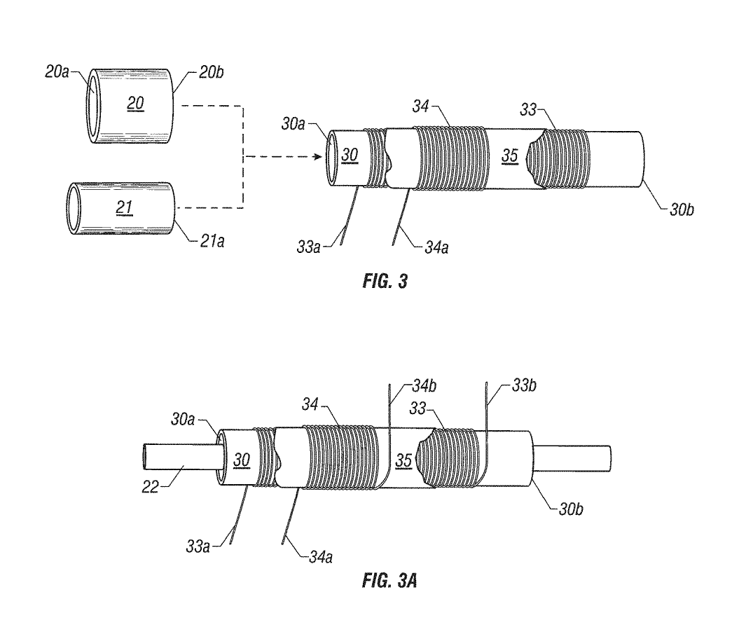

FIG. 3 schematically depicts an embodiment of the magnetically conductive conduit having a length of magnetically conductive material 30 defining a fluid impervious boundary wall with an inner surface and an outer surface and having port 30a at the proximal end of the conduit and port 30b at the distal end of the conduit. The inner surface of the boundary wall of magnetically conductive conduit 30 establishes a fluid flow path extending along the longitudinal axis of the conduit. A single length of electrical conducting material is shown forming first coil layer 33 and second layer 34 encircling the outer surface of magnetically conductive conduit 30 wherein the coiled electrical conductor sleeves at least a section of an outer surface of the magnetically conductive conduit with at least one turn of the electrical conductor oriented substantially orthogonal to the fluid flow path extending through the conduit.

Non-magnetically conductive stabilizer 35 is shown disposed between the coil layers. Conductor leads 33a and 34a may be operably connected to at least one electrical power supply to energize the coiled electrical conductor and establish a magnetic field having lines of flux directed along the flow path of the fluid. Introducing a fluid containing at least one polar substance to port 30a may direct the fluid to pass through at least one area of magnetic energy concentrated along a path extending through at least one turn of electrical conducting material encircling the outer surface of magnetically conductive conduit 30.

Coupling segment 20 is an embodiment of a non-magnetically conductive fluid flow conduit utilized to promote a flow of fluid through magnetically conductive conduit 30, said coupling segment having a non-magnetically conductive material defining a fluid impervious boundary wall with an inner surface and an outer surface and having inlet port 20a and outlet port 20b. Outlet port 20b may be adapted to provide for the fluid impervious connection with port 30a of magnetically conductive conduit 30, and inlet port 20a may be adapted to provide for the fluid impervious, non-contiguous connection of magnetically conductive conduit 30 with an additional segment of conduit, said non-contiguous connection establishing a non-magnetically conductive region providing for a concentration of magnetic energy at port 30a of conduit 30.

The non-contiguous connection between the magnetically conductive conduit 30 and an additional segment of magnetically conductive conduit establishes a non-magnetically conductive region within the coupler 20 providing for an increased concentration of magnetic energy in the space between the magnetically conductive conduits. An additional non-magnetically conductive coupling segment may similarly provide for the connection of port 30b of magnetically conductive conduit 30 with an additional segment of conduit to establish a non-magnetically conductive region providing for a concentration of magnetic energy at port 30b of magnetically conductive conduit 30.

Non-magnetically conductive conduit 21 is an embodiment of a non-magnetically conductive fluid flow conduit utilized to promote a flow of fluid through magnetically conductive conduit 30, said fluid flow conduit having a non-magnetically conductive material defining a fluid impervious boundary wall with an inner surface and an outer surface and having port 21a adapted to provide for the fluid impervious connection of fluid flow conduit 21 with port 30a of magnetically energized conduit 30, whereby said connection establishes a non-magnetically conductive region providing for a concentration of magnetic energy at port 30a of magnetically conductive conduit 30. An additional segment of non-magnetically conductive fluid flow conduit may similarly be adapted to provide a fluid impervious connection with port 30b of magnetically conductive conduit 30 to establish a non-magnetically conductive region providing for a concentration of magnetic energy at port 30b of magnetically conductive conduit 30.

FIG. 3A schematically depicts a first length of electrical conducting material forming coil layer 33 and a second length of electrical conducting material forming coil layer 34 encircling magnetically conductive conduit 30, wherein the coiled electrical conductor sleeves at least a section of an outer surface of magnetically conductive conduit 30 with at least one turn of the electrical conductor oriented substantially orthogonal to the fluid flow path extending through the conduit. Non-magnetically conductive stabilizer 35 is shown disposed between the layers of electrical conducting material to maintain the alignment of the coaxially disposed coil layers.

First conductor lead 33a and second conductor lead 33b of the first coil layer and first conductor lead 34a and second conductor lead 34b of the second coil layer may be operably connected separately and/or in combination to at least one supply of electrical power, to energize the coils. The first and second conductor leads of the first length of electrical conducting material may be connected to a first at least one supply of electrical power and first and second conductor leads of the second length of electrical conducting material may be connected to a second at least one supply of electrical power to energize the coils.

Fluid flow conduit 22 is an embodiment of a non-magnetically conductive fluid flow conduit utilized to promote a flow of fluid through magnetically conductive conduit 30, said fluid flow conduit defining a section of conduit within a piping system having a non-magnetically conductive material sleeved within magnetically conductive conduit 30, the fluid flow conduit being made with a length of non-magnetically conductive material defining a fluid impervious boundary wall with an inner surface and an outer surface and having inlet and outlet ports. Introducing a fluid containing at least one polar substance to the inlet of conduit 22 may direct fluid to pass through a first area of magnetic conditioning concentrated at port 30a at the proximal end of magnetically energized conduit 30, a second area of magnetic conditioning concentrated along a path extending through at least one turn of electrical conducting material encircling the outer surface of magnetically conductive conduit 30 and a third area of magnetic conditioning concentrated at port 30b at the distal end of magnetically energized conduit 30.

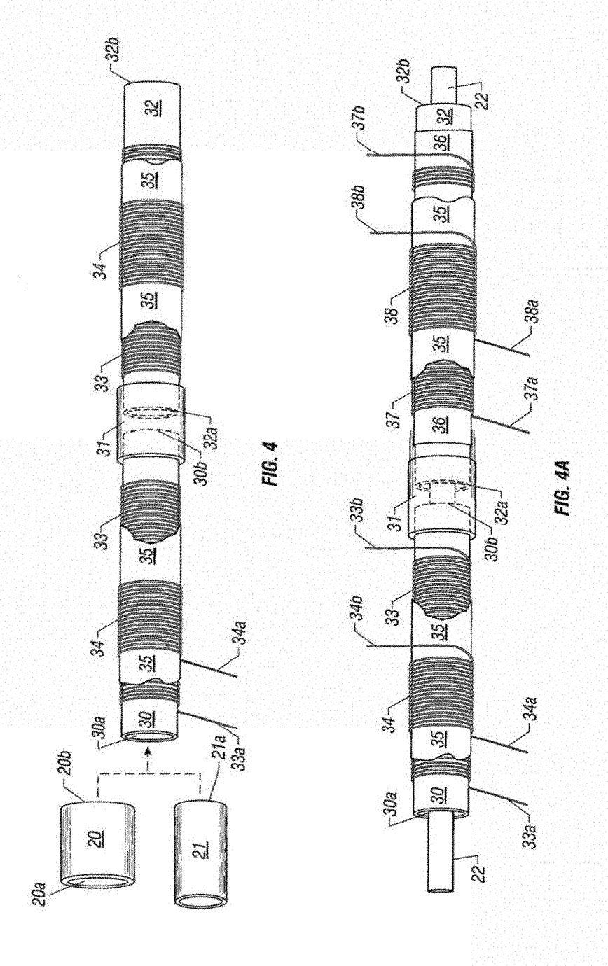

FIG. 4 schematically depicts an alternate embodiment of the magnetically conductive conduit having more than one length of magnetically conductive material forming the magnetically conductive conduit. A serial coupling of a magnetically conductive inlet conduit segment, a non-magnetically conductive intermediate conduit segment and a magnetically conductive outlet conduit segment may form the magnetically conductive conduit, each conduit segment having a length of material defining a fluid impervious boundary wall with an inner surface and an outer surface and having a port at the proximal end of the conduit segment and a port at the distal end of the conduit segment.

The serial coupling of magnetically conductive inlet conduit segment 30, non-magnetically conductive intermediate conduit segment 31 and magnetically conductive outlet conduit segment 32 establishes a non-magnetically conductive region between the magnetically conductive conduit segments that provides for a concentration of magnetic energy in the area between distal port 30b of magnetically conductive inlet conduit segment 30 and proximal port 32a of magnetically conductive outlet conduit segment 32. A single length of electrical conducting material is shown forming first coil layer 33 and second coil layer 34 encircling magnetically conductive inlet conduit segment 30, non-magnetically conductive intermediate conduit segment 31 and magnetically conductive outlet conduit segment 32, wherein the coiled electrical conductor sleeves at least a section of an outer surface of a magnetically conductive conduit segment with at least one turn of the electrical conductor oriented substantially orthogonal to the fluid flow path extending through the magnetically conductive conduit. Non-magnetically conductive stabilizer 35 is shown disposed between the coil layers to maintain the alignment of the coaxially disposed coil layers. First conductor lead 33a and second conductor lead 34a may be operably connected to at least one supply of electrical power to energize the coiled electrical conductor and establish a magnetic field having lines of flux directed along the flow path of the fluid. Introducing a fluid containing at least one polar substance to port 30a may direct a flow of the fluid to pass through a first area of magnetic conditioning concentrated at port 30a at the proximal end of the magnetically energized conduit. The flow may then pass through a second area of magnetic conditioning concentrated along a path extending through at least one turn of the coiled electrical conductor encircling the outer surface of magnetically energized inlet conduit segment 30 and a third area of magnetic conditioning concentrated in the space between port 30b at the distal end of magnetically energized inlet conduit segment 30 and port 32a at the proximal end of magnetically energized outlet conduit segment 32. The fluid may then pass through a fourth area of magnetic conditioning concentrated along a path extending through at least one turn of the coiled electrical conductor encircling the outer surface of magnetically energized outlet conduit segment 32 and a fifth area of magnetic conditioning concentrated at port 32b at the distal end of the magnetically energized conduit.

Coupling segment 20 is an embodiment of a non-magnetically conductive fluid flow conduit utilized to promote a flow of fluid through the magnetically conductive conduit, said coupling segment including a non-magnetically conductive material defining a fluid impervious boundary wall with an inner surface and an outer surface and having inlet port 20a and outlet port 20b. Outlet port 20b may be adapted to provide for the fluid impervious connection with port 30a of magnetically energized inlet conduit segment 30 and inlet port 20a may be adapted to provide for the fluid impervious, non-contiguous connection of the magnetically energized conduit with an additional segment of conduit, said non-contiguous connection establishing a non-magnetically conductive region providing for a concentration of magnetic energy at port 30a of the magnetically energized conduit.

The non-contiguous connection between magnetically energized inlet conduit segment 30 and an additional segment of magnetically conductive conduit establishes a non-magnetically conductive region providing for an increased concentration of magnetic energy in the space between the magnetically conductive conduits. An additional non-magnetically conductive coupling segment may similarly provide for the connection of port 32b of magnetically conductive outlet conduit segment 32 with an additional segment of conduit to establish a non-magnetically conductive region providing for a concentration of magnetic energy at port 32b of the magnetically energized conduit.

Non-magnetically conductive conduit 21 is an embodiment of a non-magnetically conductive fluid flow conduit utilized to promote a flow of fluid through the magnetically conductive conduit, said fluid flow conduit including a non-magnetically conductive material defining a fluid impervious boundary wall with an inner surface and an outer surface and having port 21a adapted to provide for the fluid impervious connection of said fluid flow conduit with port 30a of magnetically energized inlet conduit segment 30, whereby said connection establishes a non-magnetically conductive region providing for a concentration of magnetic energy at port 30a of the magnetically energized conduit. An additional segment of non-magnetically conductive fluid flow conduit may similarly be adapted to provide a fluid impervious connection with port 32b of the magnetically energized outlet conduit segment to establish a non-magnetically conductive region providing for a concentration of magnetic energy at port 32b of the magnetically energized conduit.

FIG. 4A schematically depicts an alternate embodiment of the magnetically conductive conduit having more than one length of magnetically conductive material forming the magnetically conductive conduit wherein the inner surfaces of the boundary walls of the serial coupling of conduit segments establish a flow path extending along the longitudinal axis of the magnetically conductive conduit.

A first length of electrical conducting material forming the first coil layer 33 having conductor leads 33a and 33b is shown encircling magnetically conductive inlet conduit segment 30, a second length of electrical conducting material forming second coil layer 34 having conductor leads 34a and 34b is shown encircling the first coil layer 33, a third length of electrical conducting material forming a first coil layer 37 having conductor leads 37a and 37b is shown encircling a coil core 36 and a fourth length of electrical conducting material forming a second coil layer 38 having conductor leads 38a and 38b is shown encircling the first coil layer 37, wherein the coiled electrical conductors 33 and 34 sleeve at least a section of the outer surface of the magnetically conductive conduit segment 30 and coiled electrical conductors 37 and 38 sleeve at least a section of the outer surface of the magnetically conductive conduit segment 32 with at least one turn of the electrical conductor oriented substantially orthogonal to the fluid flow path extending through the magnetically conductive conduit. Non-magnetically conductive stabilizer 35 is shown disposed between the layers of coiled electrical conductors 33 and 34 and between coiled electrical conductors 37 and 38 to maintain the alignment of the layers.

The coil core 36 is shown sleeving the magnetically conductive outlet conduit segment 32, said coil core 36 comprising a tubular conduit defining a boundary wall with an inner surface and an outer surface and having a port at the proximal end of the tube and a port at the distal end of the tube, the outer surface of said boundary wall adapted to receive the coiled electrical conductors 37 and 38 and the ports at each end of the tube and the inner surface of said boundary wall adapted to sleeve at least a section of the magnetically conductive conduit, whereby at least a section of the inner surface of the boundary wall of said coil core 36 is coaxially disposed in substantially concentric surrounding relation to at least a section of the outer surface of the boundary wall of magnetically conductive conduit 32. In one embodiment, the coil core 36 may be made with an embodiment of the magnetically conductive conduit. In another embodiment, the coil core 36 may be made with a non-magnetically conductive material, such as a film of non-magnetic stabilizing material or a non-magnetically conductive tube.

As used herein, encircling the magnetically conductive conduit within at least one coiled electrical conductor, wherein at least one coiled electrical conductor sleeves at least a section of an outer surface of the magnetically conductive conduit with at least one turn of the electrical conductor oriented substantially orthogonal to the fluid flow path extending through the conduit may include coiling at least one electrical conductor around at least a section of the outer surface of the fluid impervious boundary wall of the magnetically conductive conduit or coiling at least one electrical conductor around at least a section of the outer surface of the boundary wall of a coil core and sleeving at least a section of the magnetically conductive conduit within the coil core.

Conductor leads 33a and 33b, 34a and 34b, 37a and 37b and 38a and 38b may be operably connected separately and/or in combination to at least one electrical power supply. Energizing the coiled electrical conductor with the at least one electrical power supply provides a magnetic field having lines of flux directed along the longitudinal axis of the magnetically energized conduit. As used herein, the term magnetically energized conduit refers to the magnetically conductive conduit in an energized state. The at least one electrical power supply may energize the coiled electrical conductors 33, 34, 37 and 38 with a constant output of electrical energy having a direct current component, an output of electrical energy having an alternating current component, a pulsed output of electrical energy having a direct current component, and/or a pulsed output of electrical energy having an alternating current component. The lines of flux form loops and the resulting magnetic field is of a strength that allows the flux to extend along the longitudinal axis of the magnetically energized conduit and concentrate at distinct points beyond each end of the magnetically conductive conduit segments 30 and 32 such that the magnetic flux extends from a point where the lines of flux concentrate beyond port 30a of magnetically conductive conduit segment 30, around the periphery of the coiled electrical conductors 33, 34, 37 and 38 along the longitudinal axis of the fluid impervious boundary wall of the magnetically energized conduit, and to a point where the lines of flux concentrate beyond port 32b of magnetically conductive conduit segment 32. The boundary wall of each of the magnetically conductive conduit segments 30 and 32 absorbs the magnetic field and the magnetic flux loops generated by the coiled electrical conductors 33, 34, 37 and 38 at points of flux concentration.

Fluid flow conduit 22 is an embodiment of a non-magnetically conductive fluid flow conduit utilized to establish a fluid flow path extending along the longitudinal axis of the magnetically conductive conduit, said fluid flow conduit 22 defining a section of conduit within a piping system. As shown in FIG. 4A, the fluid flow conduit 22 may be sleeved by the magnetically conductive inlet conduit segment 30, non-magnetically conductive intermediate conduit segment 31 and magnetically conductive outlet conduit segment 32, said fluid flow conduit 22 being constructed of a length of non-magnetically conductive material defining a fluid impervious boundary wall with an inner surface and an outer surface and having an inlet and an outlet port.

Introducing a fluid to the inlet port of the fluid flow conduit 22 may direct a fluid to pass through a first area of magnetic flux concentration at port 30a at the proximal end of the magnetically energized conduit 30, a second area of magnetic flux concentration along a path extending through and, in one embodiment, substantially orthogonal to each turn of the electrical conductors forming the first and second coil layers 33 and 34 encircling magnetically conductive conduit segment 30, a third area of magnetic flux concentration may be within non-magnetically conductive conduit segment 31 in the space between port 30b at the distal end of the magnetically energized conduit segment 30 and port 32a at the proximal end of the magnetically energized conduit segment 32, a fourth area of magnetic flux concentration along a path extending through and, in one embodiment, substantially orthogonal to each turn of the electrical conductors forming the first and second coil layers 37 and 38 encircling magnetically conductive conduit segment 32 and a fifth area of magnetic flux concentration may be at port 32b at the distal end of the magnetically energized conduit segment 32.

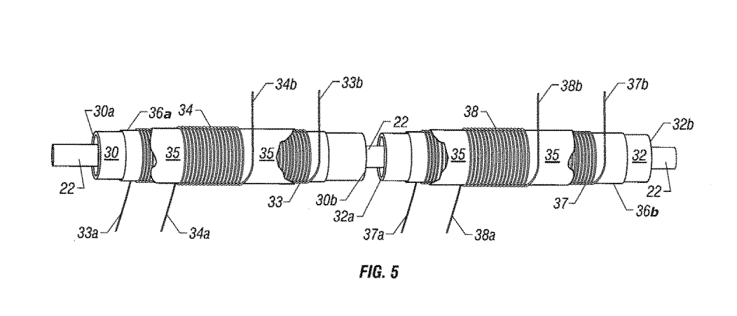

FIG. 5 schematically depicts another embodiment of the magnetically conductive conduit having a non-contiguous array of magnetically conductive conduit segments comprising a first magnetically conductive conduit segment 30 and a second magnetically conductive conduit segment 32. Fluid flow conduit 22, defining a fluid impervious boundary wall having an inner surface and an outer surface and further having a fluid entry port at one end of the fluid flow conduit 22 and a fluid discharge port at the other end of the fluid flow conduit 22 is shown extending through the fluid entry port 30a at the proximal end of the magnetically conductive conduit segment 30, port 30b at a distal end of the magnetically conductive conduit segment 30, port 32a at the proximal end of the magnetically conductive conduit segment 32 and the fluid discharge port 32b at the distal end of the magnetically conductive conduit segment 32 to define a fluid flow path extending along the longitudinal axis of the magnetically conductive conduit.

A first length of an electrical conducting material having first conductor lead 33a and second conductor lead 33b forms first coil layer 33 encircling a first coil core 36a, a second length of an electrical conducting material having first conductor lead 34a and second conductor lead 34b forms a second coil layer 34 encircling the first coil layer 33, a third length of an electrical conducting material having first conductor lead 37a and second conductor lead 37b forms first coil layer 37 encircling a second coil core 36b and a fourth length of an electrical conducting material having first conductor lead 38a and second conductor lead 38b forms a second coil layer 38 encircling the first coil layer 37, wherein each coiled electrical conductor 33, 34, 37 and 38 sleeves at least a section of an outer surface of a length of magnetically conductive material forming the magnetically conductive conduit with at least one turn of the electrical conductor oriented substantially orthogonal to the fluid flow path extending through the conduit.

The first coil core 36a is shown sleeving a section of the outer surface of magnetically conductive conduit segment 30 and the second coil core 36b is shown sleeving a section of the outer surface of magnetically conductive conduit segment 32. A non-magnetically conductive stabilizer 35 is shown disposed between the first and second layers of electrical conductors to maintain the alignment of the coil layers 34, 35, 37 and 38. At least one electrical power supply may be operably connected to at least one conductor lead to energize the coiled electrical conductors to produce a magnetic field having lines of flux directed along the fluid flow path. Fluid flowing through the non-magnetically conductive fluid flow conduit 22 may be directed to pass through a first area of magnetic flux concentration at port 30a, a second area of magnetic flux concentration along a path extending through and, in one embodiment, substantially orthogonal to each turn of the electrical conductors forming the first and second coil layers 33 and 34 encircling magnetically conductive conduit segment 30, a third area of magnetic flux concentration in the space between port 30b and port 32a, a fourth area of magnetic flux concentration may extend along a path through and substantially orthogonal to each turn of the electrical conductors forming coil layers 37 and 38 encircling the outer surface of magnetically conductive conduit segment 32 and a fifth area of magnetic flux concentration may be provided at port 32b.

Embodiments of the magnetically conductive conduit having a non-contiguous array of magnetically conductive conduit segments may be energized with at least one coil sleeving at least a section of a first magnetically conductive conduit segment, a non-magnetically conductive region established between the magnetically conductive conduit segments and at least a section of a second magnetically conductive conduit segment.

The magnetically conductive conduit segments may be made of a sheet of magnetically conductive material rolled into at least one layer to form a tube defining a boundary wall with an inner surface and an outer surface and having a port at the proximal end of the tube and a port at the distal end of the tube. The inner and outer surfaces of the fluid impervious boundary wall of a magnetically conductive conduit segments may be covered with a protective coating to prevent corrosion and extend the functional life of the conduit. At least one end of a fluid impervious boundary wall of the magnetically conductive conduit segments may be tapered.

A non-magnetically conductive stabilizing material, such as a protective film and/or a layer of paint, varnish, insulating material, epoxy or other non-magnetically conductive material, may be disposed between the outer surface of a magnetically conductive conduit segment and the coiled electrical conductor, between layers of the coiled electrical conductor, between the outer surface of a magnetically conductive conduit segment and the inner surface of a coil core, and/or between the outer surface of a coil core and the coiled electrical conductor. A non-magnetically conductive stabilizing material may envelope the outer layer of a coiled electrical conductor to maintain the alignment of the coil and protect the electrical conducting material from cuts and abrasions.

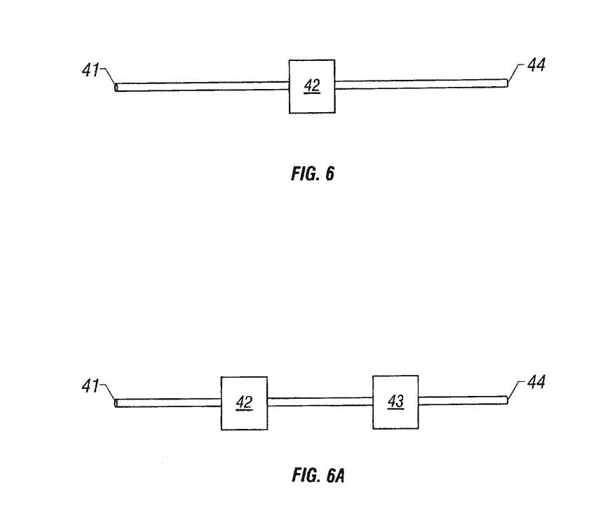

FIG. 6 schematically depicts one embodiment of the presently claimed and/or disclosed inventive concepts for increasing the flow rate of a fluid containing at least one polar substance and/or a fluid mixture propelled through a conduit under pressure at ambient temperature. The fluid containing at least one polar substance and/or fluid mixture may be introduced to port 41 may be directed to pass through magnetically conductive conduit 42 having magnetic energy directed along the longitudinal axis of the magnetically energized conduit and extending through at least a portion of the fluid containing at least one polar substance and/or fluid mixture, thereby altering the viscosity, the cohesion energy, a dispersive surface tension and/or a polar surface tension of a conditioned fluid medium discharged from port 44.

FIG. 6A schematically depicts another embodiment of the presently claimed and/or disclosed inventive concepts for altering a dispersive surface tension, a polar surface tension, the viscosity and/or the cohesion energy of a fluid containing at least one polar substance to improve the mechanical blending of two or more distinct phases into a homogenous mixture, which is similar to the embodiment depicted in FIG. 6 but with an additional blending apparatus 43. More particularly, a fluid containing at least one polar substance introduced to port 41 may be directed to pass through magnetically conductive conduit 42 having magnetic flux directed along the longitudinal axis of the magnetically energized conduit and extending through at least a portion of the fluid, thereby altering the cohesion energy, viscosity, a dispersive surface tension and/or a polar surface tension of a conditioned fluid medium. The conditioned fluid medium may then be directed through at least one blending apparatus 43 where an amount of at least one dissimilar material may be dispersed into the conditioned fluid medium and blended into a homogenous fluid mixture before being discharged from port 44 as a continuous mixture.

The at least one blending apparatus may have a capacity to disperse an amount of at least one dissimilar material into a magnetically conditioned aqueous medium to form a continuous mixture. The at least one blending unit may have a fluid impervious boundary wall having an inner surface, a first inlet port for receiving a magnetically conditioned aqueous medium, a second inlet port for receiving an amount of at least one dissimilar material, and an outlet port for discharging a continuous mixture.

As used herein, blending apparatus having a capacity to disperse an amount of at least one dissimilar material into a magnetically conditioned aqueous medium to form a continuous mixture by mechanical blending, centrifugal mixing, in-line static mixing, and/or power jet blending may be selected from a group consisting of, but not limited to, drilling fluid mixers, mud agitators, mud tank mixers, high torque mixers having large pitch impellors, venturi blenders, radial mixers, mixing eductors, jet nozzles, apparatus having vortices converging in a mixing chamber, and combinations thereof or equivalent blending apparatus known to those of ordinary skill in the art.

In each embodiment of the presently claimed and/or disclosed inventive concepts for increasing the efficiency of blending at least one dissimilar material with a fluid containing at least one polar substance (e.g., an aqueous solution), it can be appreciated that magnetic energy may be concentrated in a plurality of distinct areas along the longitudinal axis of the magnetically energized conduit.

In one embodiment, as disclosed herein, magnetic conditioning of a fluid containing at least one polar substance was determined to alter a dispersive surface tension and/or a polar surface tension of a conditioned fluid containing at least one polar substance medium and improve the mechanical blending of two or more distinct phases into a homogenous mixture. For example, the dissolution behavior of high protein milk powder (MPC80) in water was studied.

For this purpose, ten percent milk protein solutions were prepared using untreated tap water (control), tap water directed to make approximately 5 passes through a magnetic field inducing a positive polarity, tap water directed to make approximately 5 passes through a magnetic field inducing a negative polarity. Ten grams of MPC80 powder were mixed with 90 g of untreated tap water, ten grams of MPC80 powder were mixed with 90 g of water directed to make multiple passes through a magnetic field inducing a positive polarity, and ten grams of MPC80 powder were mixed with 90 g of water directed to make multiple passes through a magnetic field inducing a negative polarity. The dissolution behavior of each milk protein solution was observed using an ultrasound spectrometer.

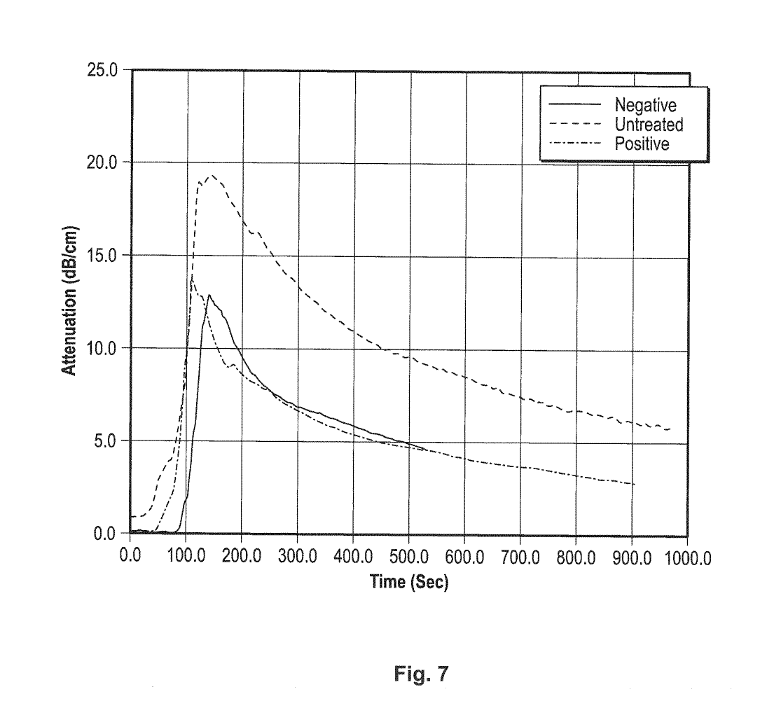

FIG. 7 is a graph showing the changes in the ultrasound attenuation over time during the dissolution of the MPC80 in each sample. As shown in FIG. 7, the attenuation began to increase in all the samples when the powder was added to the water. However, the samples generated with the magnetically conditioned water each displayed a significantly lower initial attenuation than with the sample generated with untreated tap water.

Lower initial attenuation indicates the MPC80 was more readily dispersed and evenly distributed within each conditioned fluid medium solution. In other words, the MPC80 was less likely to form large aggregates in the water and the powder was mixing more efficiently due to improved wetting of the particles by a conditioned fluid medium.

Method and Apparatus for Altering Physical Properties of Fluids Containing at least One Polar Substance at Gauss Levels Greater than 4500

In one embodiment, the method and apparatus disclosed herein are capable of altering the physical properties of fluids containing at least one polar substance as a result of the ability to generate (and subject the fluid containing at least one polar substance) to constant or pulsed levels of magnetic field strength greater than 4500 gauss, or greater than 4750 gauss, or greater than 7500 gauss. In some instances, embodiments of the magnetically conductive conduit, coiled electrical conductor, and supply of electrical energy, as disclosed herein, may be utilized to generate levels of magnetic energy in excess of I Tesla, or 2 Tesla, or 3 Tesla. The methods and apparatus disclosed herein are capable of providing sustained magnetic energy that can be maintained at substantially constant levels discussed above for periods of time including hours, days, weeks, months, years, or longer.

Without being bound to a particular theory, it is thought that increasing the thickness and density of the magnetically conductive conduit allows greater concentrations of flux density within the conduit. This is possible through the use of thicker-walled magnetically conductive materials and/or sleeving a first magnetically conductive conduit within a second magnetically conductive conduit. Even greater amounts of magnetic energy may be concentrated within embodiments of the magnetically conductive conduit having a first serial coupling of conduit segments sleeved within a second serial coupling of conduit segments with at least one non-magnetically conductive segment of the first serial coupling of conduit segments being aligned with at least one non-magnetically conductive segment of the second serial coupling of conduit segments in one or more planes substantially orthogonal to the longitudinal axis of the serial couplings of conduit segments.

Again, without being bound to a particular theory, it is thought that improved length to diameter ratios of the coiled electrical conductor may also be utilized to attain increased concentrations of flux density within the magnetically conductive conduit—as discussed further herein. While the coiled electrical conductors of prior art apparatus typically utilize length to diameter ratios of approximately 4:1 to 8:1 in an effort to dissipate heat generated by an electrically energized coil, coils having length to diameter ratios of approximately 1:1 to 1:6 have been discovered to create shorter lines of flux along the length of magnetically conductive conduit, with these concentrated lines of flux conducive to focusing magnetic energy proximate the energized coil and concentrating magnetic energy in a smaller surface area of the magnetically energized conduit. The length to diameter ratio of the at least one coiled electrical conductor encircling the magnetically conductive conduit and/or the number of layers of coiled electrical conductor forming a coil may be adapted for specific applications.

The coiled electrical conductor may be operably connected with at least one supply of electrical power pulsed with a repetition rate as low as 1 Hz to as high as 3 MHz, and may have a duty cycle from as low as 5% to as high as 95%, to establish a magnetic field having lines of flux directed along the flow path of the fluid.

As suggested above, the presently claimed and/or disclosed inventive concepts of generating levels of magnetic field strength greater than 4500 gauss have been shown to provide significant changes in the cohesion energy, dispersive surface tensions, viscosities, contact angles and the acidic and basic components of the polar surface tensions of fluids containing at least one polar substance. As illustrated in the following examples, this has even been demonstrated with pure water; and the effects have been shown to increase as the salinity of a fluid (e.g., water) increases and/or the conductivity of a fluid containing at least one polar substance increases.

For example, one embodiment of the apparatus and method capable of generating constant or pulsed levels of magnetic field strength greater than 4500 gauss, as disclosed herein, has been shown to reduce the surface tensions of pure distilled water from 72.80 mN/m to 67.10 mN/m (7.8% reduction), 8.51 lb. brine from 74.16 mN/m to 61.82 mN/m (16.6% reduction), 8.90 lb. brine from 75.18 mN/m to 61.75 mN/m (17.9% reduction) and 10.0 lb. brine from 78.09 mN/m to 62.28 mN/m (20.2% reduction). Subjecting fluids containing at least one polar substance to constant or pulsed levels of magnetic field strength greater than 4500 gauss has also been shown to reduce the viscosity of the fluids. For example but without limitation, the viscosities for the following fluids containing at least one polar substance were all reduced by at least 3.7%: pure distilled water from 1.025 cP to 0.987 cP (3.7% reduction), 8.51 lb. brine from 1.173 cP to 1.053 cP (10.2% reduction), 8.90 lb. brine from 1.284 cP to 1.145 cP (10.8% reduction) and 10.0 lb. brine from 1.600 cP to 1.397 cP (12.7% reduction). The effects also follow distinct trends, and similar reductions in surface tension, viscosity, contact angles and the acidic and basic polarities of surface tension may be anticipated with other fluids containing at least one polar substance.

As further illustrated in the following examples, inducing a positive (+) polarity and/or inducing a negative (−) polarity in a fluid containing at least one polar substance using a constant or pulsed magnetic field greater than 4500 gauss has also been discovered to heavily skew the split in the acidic and basic components of the polar surface tension of the fluid. For example, directing a fluid through the apparatus as presently disclosed and/or claimed while inducing a positive polarity causes an increase in the Lewis acidic component of the fluid and a decrease in the Lewis basic component of the fluid—even as the overall dispersive component of the surface tension of the fluid decreases.

Thus, conditioned water may react differently when, and if, surfactants are added to it. Water having increased surface polarity components may be predicted to drive surfactants to its surface more strongly and effectively, and also reduce the critical micelle concentrations of surfactants in general. Negatively conditioned water having a higher basic component may well be predicted to solvate anionic surfactants more completely. Similarly, positively conditioned water having a higher acidic component may be predicted to cationic surfactants more completely.

In addition to knowing the manner in which conditioning water with the presently disclosed and/or claimed inventive concepts provides a predictable effect on solid wetting, it is important to understand such conditioning does not simply change the surface tension of a fluid similar to the addition of an additive or surfactant. Without being bound to a particular theory, it is also predicted that magnetic conditioning as described and/or claimed herein also affects the bulk properties of fluids containing at least one polar substance subjected to a constant or pulsed magnetic field greater than 4500 gauss. Differences in interfacial tension are typically more exponential than linear in terms of effect on emulsification/separation, and increases in interfacial tension (for increased separation rates/efficiency) and decreases in interfacial tension (for easier emulsification) as a result of the magnetic conditioning as described and/or claimed herein are significant.

As such, the presently disclosed and/or claimed inventive concept(s) are directed to a system and method whereby a fluid containing at least one polar substance can have one or more of its physical properties altered by subjecting the fluid to a sufficient amount of magnetic force.

In one aspect, the presently disclosed and/or claimed inventive concept(s) is directed to a method of altering the physical properties of a fluid containing at least one polar substance comprising the step of subjecting a fluid containing at least one polar substance to a magnetic field of at least 4500 gauss, or at least 4750 gauss, or at least 7500 gauss. In one embodiment, the magnetic field is from about 4500 gauss to 3 Tesla, or 4750 gauss to 3 Tesla, or 4750 gauss to 2.5 Tesla, or 4750 gauss to 1 Tesla, or 7500 gauss to 3 Tesla, or 7500 gauss to 2.5 Tesla, or 7500 gauss to 1 Tesla.

In one embodiment, the temperature of the fluid containing at least one polar substance increases less than 5° F., or less than 4° F., or less than 3° F., or less than 2° F., or less than 1° F. The magnetic field is continuous or pulsed. In one embodiment, the magnetic field is pulsed with a repetition rate in a range of from about 1 Hz to about 3 MHz. The magnetically energized conduit can induce a magnetic field having either a positive or a negative polarity.

In one embodiment, the fluid containing at least one polar substance is subjected to the magnetic field by passing the fluid containing at least one polar substance through a magnetically conductive conduit at least once, or at least 3 times, or at least 5 times, or at least 10 times, or at least 20 times, or at least 50 times, or at least 100 times. The fluid containing at least one polar substance may be passed through the magnetically conductive conduit under laminar flow or turbulent flow.

In one embodiment, the fluid containing at least one polar substance is passed through the magnetically conductive conduit under laminar flow at a flow rate in a range of from about 10 to 75 mL/s, or from about 15 to about 65 mL/s, or from about 25 to about 55 mL/s, or from about 35 to about 50 mL/s, or from about 40 to about 45 mL/s, or at about 43.6 mL/s. In one embodiment, the fluid containing at least one polar substance is passed through the magnetically conductive conduit under laminar flow having a Reynolds number of from about 1000 to about 2500, or from about 1250 to about 2250, or from about 1500 to about 1750, or from about 1800 to about 1900, or about 1830.

In one embodiment, the fluid containing at least one polar substance is passed through the magnetically conductive conduit under turbulent flow at a flow rate in a range of from about 100 to 500 mL/s, or from about 105 to about 400 mL/s, or from about 110 to about 300 mL/s, or from about 115 to about 200 mL/s, or from about 120 to about 150 mL/s, or from about 125 to about 130 mL/s, or at about 129.5 mL/s. In one embodiment, the fluid containing at least one polar substance is passed through the magnetically conductive conduit under turbulent flow having a Reynolds number of from about 4000 to about 10000, or from about 4250 to about 7500, or from about 4500 to about 6500, or from about 5000 to about 5500, or about 5430.

In one aspect of the presently disclosed and/or claimed inventive concept(s), the method as described any one of the methods described above regarding subjecting a fluid containing at least one polar substance to a magnetic field of at least 4500 gauss, or at least 4750 gauss, or at least 7500 gauss, wherein at least one of the positive polarity and the negative polarity of the magnetic field results in a in viscosity of the fluid containing at least one polar substance that has been subjected to the magnetic field as compared to a fluid containing at least one polar substance that has not been subjected to the magnetic field—wherein the fluid containing at least one polar substance has a plus or minus temperature change of less than 5° F., or less than 4° F., or less than 3° F., or less than 2° F., or less than 1° F.

In one aspect of the presently disclosed and/or claimed inventive concept(s), the method as described any one of the methods described above regarding subjecting a fluid mixture to a magnetic field of at least 4500 gauss, or at least 4750 gauss, or at least 7500 gauss, wherein at least one of the positive polarity and the negative polarity of the magnetic field results in an at least one of (a) an increase in viscosity of the fluid mixture that has been subjected to the magnetic field, or (b) a decrease in viscosity of the fluid mixture that has been subjected to the magnetic field as compared to a fluid mixture that has not been subjected to the magnetic field—wherein the fluid containing at least one polar substance has a plus or minus temperature change of less than 5° F., or less than 4° F., or less than 3° F., or less than 2° F., or less than 1° F. Without intending to be bound to a particular theory, it has been found that magnetically conditioning a fluid mixture, as described herein, can result in an increase in viscosity (or decrease) depending on both the dissimilar material that is in the fluid mixture and the polarity induced by the magnetic conditioning.

Depending on the composition of one or more fluids containing at least one polar substance and, optionally, one or more dissimilar materials in the one or more fluids, at least one of the embodiments described above can be used to, for example but without limitation, (i) increase the rate by which a dissimilar material separates from a fluid containing at least one polar substance, (ii) encourage phase separation of at least two separate phases (e.g., one or more fluids containing at least one polar substance, a solid material phase, and/or a hydrocarbon phase), (iii) encourage the formation of a stable or semi-stable mixture or emulsion comprising at least one dissimilar material and/or one or more fluids containing at least one polar substance, (iv) reduce the pressure to pass a fluid containing at least one polar substance through a conduit at a constant temperature (e.g., ambient temperature) or with a change in temperature of less than 5° F., or less than 4° F., or less than 3° F., or less than 2° F., or less than 1° F., (v) increase the flow rate of a fluid containing at least one polar substance through a conduit under constant temperature and at a constant temperature (e.g., ambient temperature) or with a change in temperature of less than 5° F., or less than 4° F., or less than 3° F., or less than 2° F., or less than 1° F., and/or (vi) separate at least one biological contaminant from one or more fluids containing at least one polar substance.

The following examples illustrate via experimental analysis the extent that certain physical properties like the cohesion energy, surface tension, viscosity, wetting capability, and oil/water interfacial tension can be altered for a fluid containing at least one polar substance (as defined herein) when subjected to, for example, a magnetic field of approximately 4,750 to 5,000 gauss.

In a first example, a length of new 0.92 cm ID plastic tubing was deployed through the fluid entry port, the fluid discharge port and the fluid impervious boundary wall extending between the fluid entry port and the fluid discharge port of an embodiment of the presently claimed and/or disclosed magnetically conductive conduit having a ½″ inner diameter and extending through each end of the conduit to establish a fluid flow path; with the tubing being made of a material that, in and of itself, would not affect any physical properties of a fluid mixture sample. A high throughput peristaltic (non-direct contact) pump was then used to propel samples of distilled water, tap water (having approximately 400 ppm total dissolved solids), 8.5 lb. brine (having approximately 30,000 ppm total dissolved solids), 8.91 lb. brine (having approximately 100,000 ppm total dissolved solids) and 10.0 lb. brine (having approximately 300,000 ppm total dissolved solids), through the plastic tubing extending through the magnetically conductive conduit at flow rates of 43.6 ml/second (Reynolds Number of 1830) and 129.5 ml/second (Reynolds Number of 5430). All samples were circulated through a Fischer water bath measured and collected at a constant temperature of 20° C.

Prior to conditioning the samples with the energized magnetically conductive conduit at approximately 4750 gauss, standards were obtained for untreated samples of the distilled water, tap water, synthetic seawater, and each weight of brine by collecting such untreated samples in certified clean containers after being directed to make only one pass through the length of non-energized magnetically conductive conduit. The samples flowed uncollected for approximately 30 to 45 seconds to allow for the dismissal of any bubbles so that the untreated water samples were collected during steady-state flow. Second untreated samples of the distilled water, tap water, synthetic seawater, and each weight of brine were collected in certified clean containers after each sample had been directed to make approximately 3500 passes through the length of non-energized magnetically conductive conduit (circulated at approximately 129.5 ml/second for two hours so that the untreated water samples were collected during steady-state flow), noting that “non-energized” means that an intentional electrically generated magnetic field was not used to treat the samples at this point, much less a magnetic field greater than 4,500 gauss. Once the system was calibrated and standards were obtained, the samples were conditioned by exposing them to a magnetic field of around 4,500 using the apparatus and methods that follow:

The Experimental Apparatus utilized to generate the magnetically conditioned samples (hereinafter referred to as simply the “Experimental Apparatus”) comprised a first serial coupling of conduit segments having an outside diameter of approximately 1.315″ and a length of approximately 22″, the first serial coupling of conduit segments further comprising three non-magnetically conductive conduit segments axially aligned between four magnetically conductive conduit segments, each conduit segment having a wall thickness of approximately 0.179″. The non-magnetically conductive segments were bored out with a 45° chamfer on each end to match the ends of the magnetically conductive segments that were turned down with 45° chamfers prior to coupling the segments to form a 1″ magnetically conductive coil core comprising a serial coupling of a first magnetically conductive coil core section, a first non-magnetically conductive coil core section, a second magnetically conductive coil core section, a second non-magnetically conductive coil core section, a third magnetically conductive coil core section, a third non-magnetically conductive coil core section and a fourth magnetically conductive coil core section.

A coil encircling at least a section of the outer surface of the second and third 1″ magnetically conductive coil core sections and the second 1″ non-magnetically conductive conduit coil core section was formed by winding 242 turns of a length of 14 AWG copper wire to form a 16″ layer, and then adding seven more layers to form a continuous coil having a total of 1936 turns encircling the coil core, wherein the length to diameter ratio of the coil was approximately 7:1. The continuous coil was enclosed within a protective housing having a 3″ diameter, said housing comprising a length of 3″ magnetically conductive conduit having an inner surface and an outer surface and a proximal end and a distal end, the housing further comprising magnetically conductive end plates on each end of the housing with the outer edge of each end plate disposed in fluid communication with an end of the 3″ conduit and the inner edge the end plate in fluid communication with the outer surface of the 1″ coil core.

A second serial coupling of conduit segments having an outside diameter of approximately 0.840″ and a length of approximately 28″ was formed with three non-magnetically conductive conduit segments interleaved between four magnetically conductive conduit segments, each conduit segment having a wall thickness of approximately 0.147″. The non-magnetically conductive segments were bored out with a 45° chamfer on each end to match the ends of the magnetically conductive segments that were turned down with 45° chamfers prior to coupling the segments to form the ½″ magnetically conductive conduit. To increase the thickness and density of the magnetically conductive conduit, the second serial coupling of conduit segments was sleeved within the coil core and disposed with all non-magnetically conductive segments of the ½″ conduit being sleeved with the non-magnetically conductive segments of the 1″ coil core.

The coiled electrical conductor encircling the coil core had the capacity to be energized with either constant 24 VDC and approximately 10 amps of electrical energy having a positive (+) charge, constant 24 VDC and approximately 10 amps of electrical energy having a negative (−) charge, 24 VDC pulsed at 120 Hz and approximately 10 amps of electrical energy having a positive (+) charge and 24 VDC pulsed at 120 Hz and approximately 10 amps of electrical energy having a negative (−) charge. In each instance, areas of magnetic conditioning were concentrated along a path extending through at least one turn of the electrical conductor encircling the outer surface of the magnetically energized conduit generating approximately 4800 gauss (unit of magnetic field measurement) of magnetic energy concentrated within the intermediate non-magnetically conductive conduit segment of the magnetically energized conduit, as well as approximately 1150 gauss of magnetic energy concentrated within the outboard non-magnetically conductive conduit segments of the magnetically energized conduit.

Additional samples of the distilled water, tap water, and each weight of brine were collected in certified clean containers after energizing a coiled electrical conductor encircling the conduit with constant 24 VDC of electrical energy having a positive (+) charge, constant 24 VDC of electrical energy having a negative (−) charge, pulsed 24 VDC of electrical energy having a positive (+) charge and pulsed 24 VDC of electrical energy having a negative (−) charge and directing each sample to flow at a low Reynolds Number and a high Reynolds Number with either one pass, three passes or five passes through a magnetically energized conduit. The magnetically conditioned samples of the distilled water, tap water synthetic seawater, and each weight of brine were similarly allowed to flow uncollected for approximately 30 to 45 seconds to allow for the dismissal of any bubbles so that the water samples were collected in certified clean containers during steady-state flow.

It should be noted that the water, synthetic seawater and brine water samples were not substantially heated during the process and were maintained at approximately 20° C. when entering, exiting, and while passing through the “Experimental Apparatus”. As such, it was concluded that the reduction in viscosities and surface tensions as illustrated in the tables below are a result of altering the physical properties of the experimental fluids containing at least one polar substance (i.e., water, synthetic seawater, and brine water at different concentrations of salt) rather than due to an increase in temperature.

All waters, synthetic seawater and brines (both conditioned and control) were tested for viscosity in a low shear falling ball viscometer (Gilmont-100) and for surface tension components by testing overall surface tension using a Kruss Wilhelmy Plate Tensiometer (K100) and testing each sample against standard PTFE and BN hydrophobic reference surfaces to determine the contact angle of each sample and the fraction of the overall polar surface tension of each sample making up their acidic and basic surface tensions by using the van Oss technique.

The van Oss technique relies on the van Oss equation, as follows:

σ_{L}(1+cos θ)=2[(σ_{S}^{D}σ_{L}^{D})^{1/2}+(σ_{S}⁺σ_{L}⁻)^{1/2}+(σ_{S}⁻σ_{L}⁺)^{1/2}]

wherein: σ_{L}=the overall surface tension of the liquid tested, σ_{L}^{D}=the dispersive component of the surface tension of the liquid, σ_{L}+=the acid component of the surface tension of the liquid, σ_{L}−=the base component of the surface tension of the liquid, σ_{S}^{D}=the dispersive component of the surface energy of the solid, σ_{S}+=the acid component of the surface energy of the solid, and σ_{S}−=the base component of the surface energy of the solid. The van Oss equation can be solved to determine the components of any liquid's surface tension if the overall surface tension of the liquid is known and the liquid's contact angle (θ) is measured against two reference surfaces for which the surface energy components (σ_{S}^{D}, σ_{S}⁻, and σ_{S}⁺) are known. The selected reference surfaces are shown in Table 11.

TABLE 11

| | Overall | | | |
|---|---|---|---|---|
| | Surface | Dispersive | Acidic | Basic |
| | Tension | Component | Component | Component |
| Surface | (mN/m) | (mN/m) | (mN/m) | (mN/m) |
| Polytetrafluoroethylene | 18.00 | 18.00 | 0.0 | 0.0 |
| Boron Nitride | 40.89 | 19.98 | 3.00 | 17.91 |

All samples were tested for contact angle against a standard polytetrafluoroethylene (PTFE) hydrophobic reference surface to determine the fraction of the overall surface tension of each sample making up its non-polar surface tensions. Because it has no acidic or basic components to its overall surface tension, only the contact angle of a liquid on PTFE is necessary to determine the polar and dispersive components comprising the overall surface tension of the liquid; with the polar component being the sum of the acidic and basic components in this methodology.

Further, all samples were tested for contact angle against a standard Boron Nitride (BN) hydrophobic reference surface. Boron Nitride has a highly basic surface that produces higher than otherwise expected contact angles with water having a basic surface, and lower than expected contact angles with water having an acidic surface.

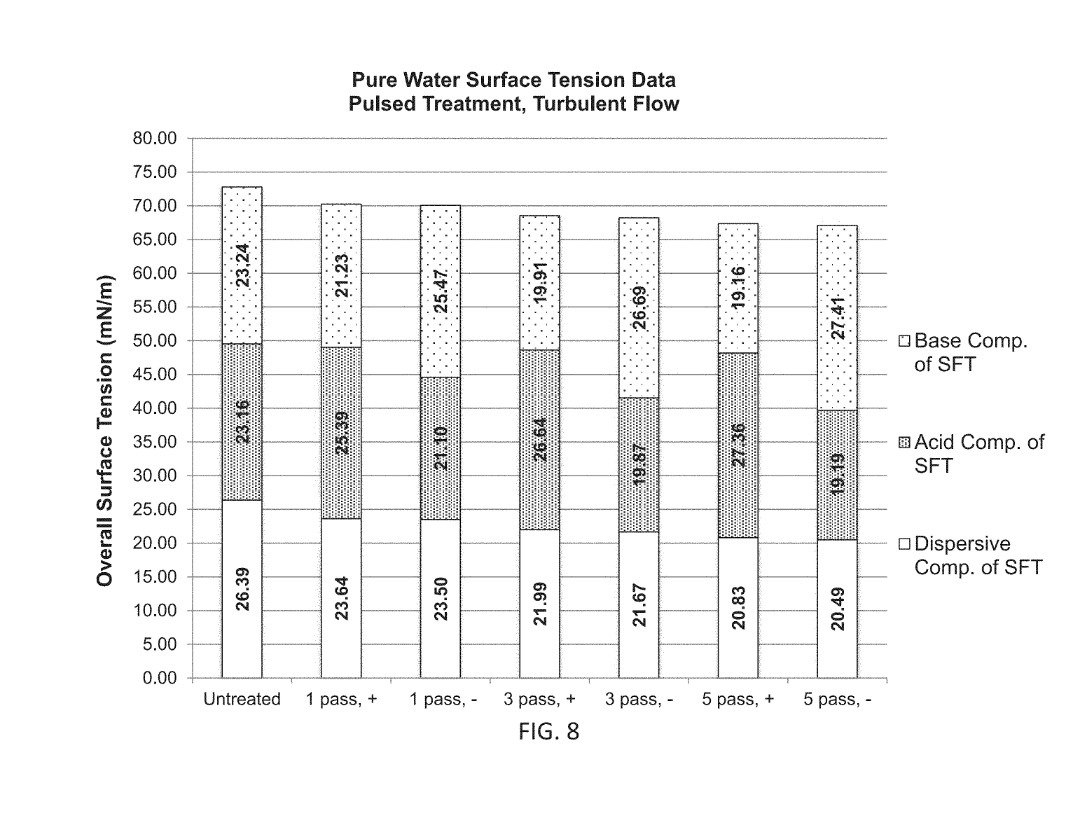

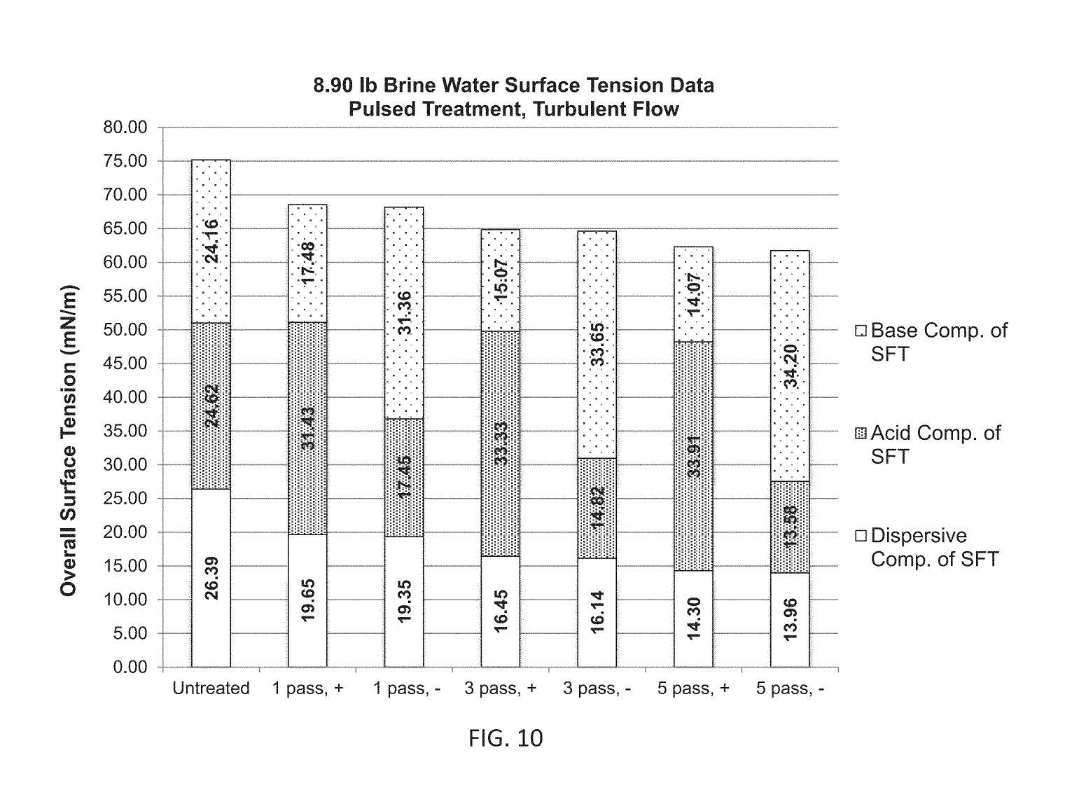

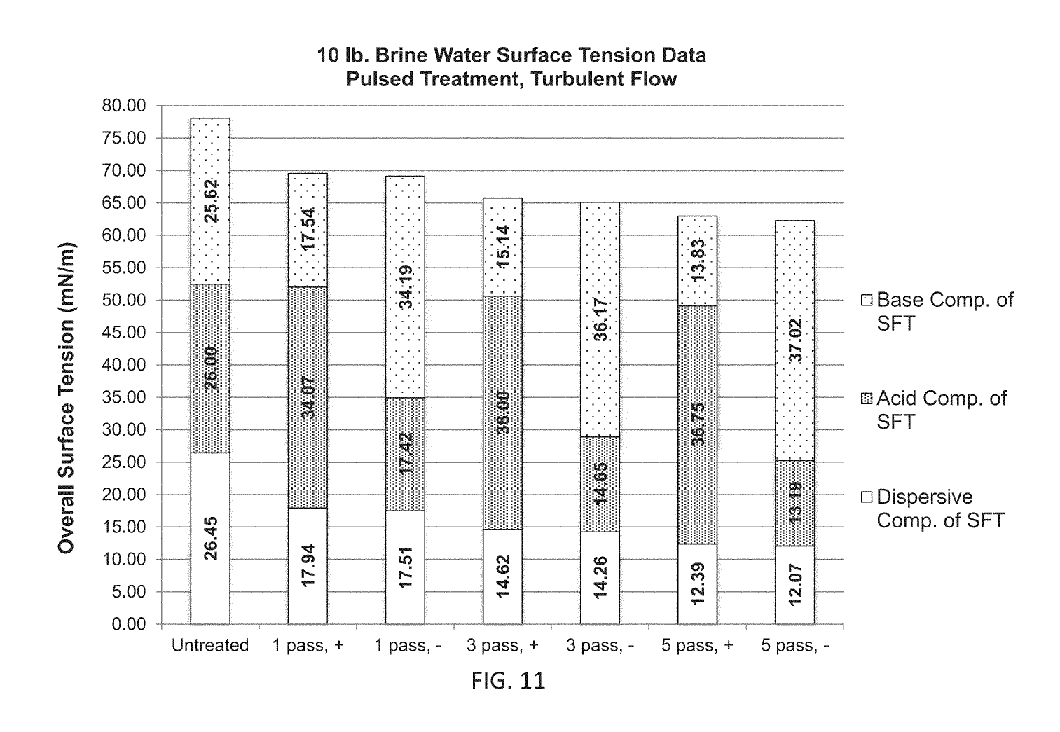

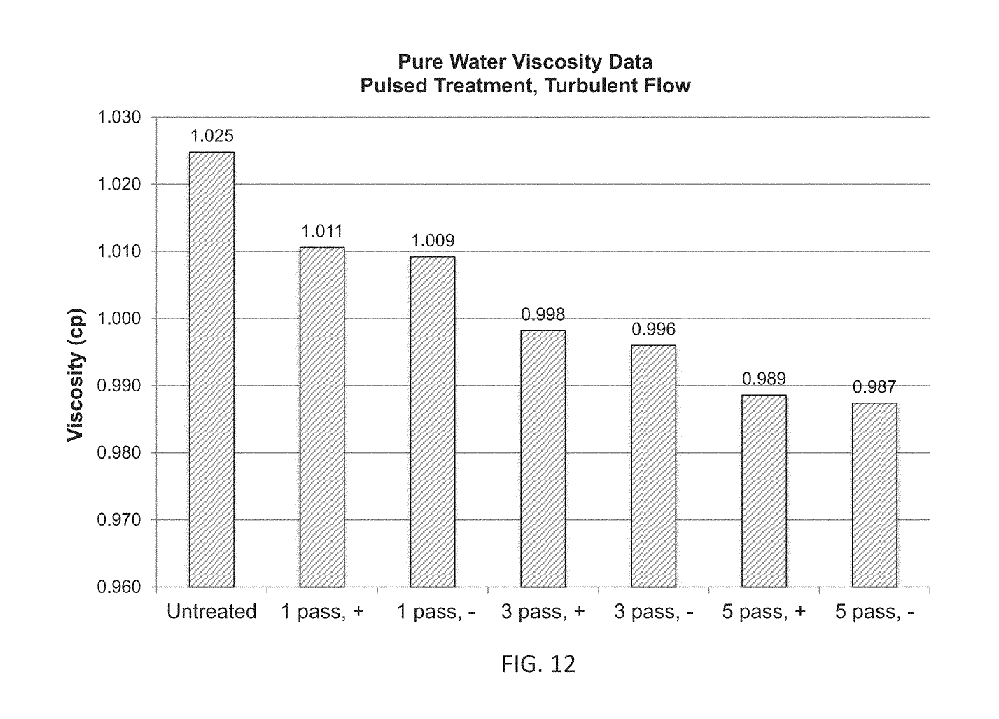

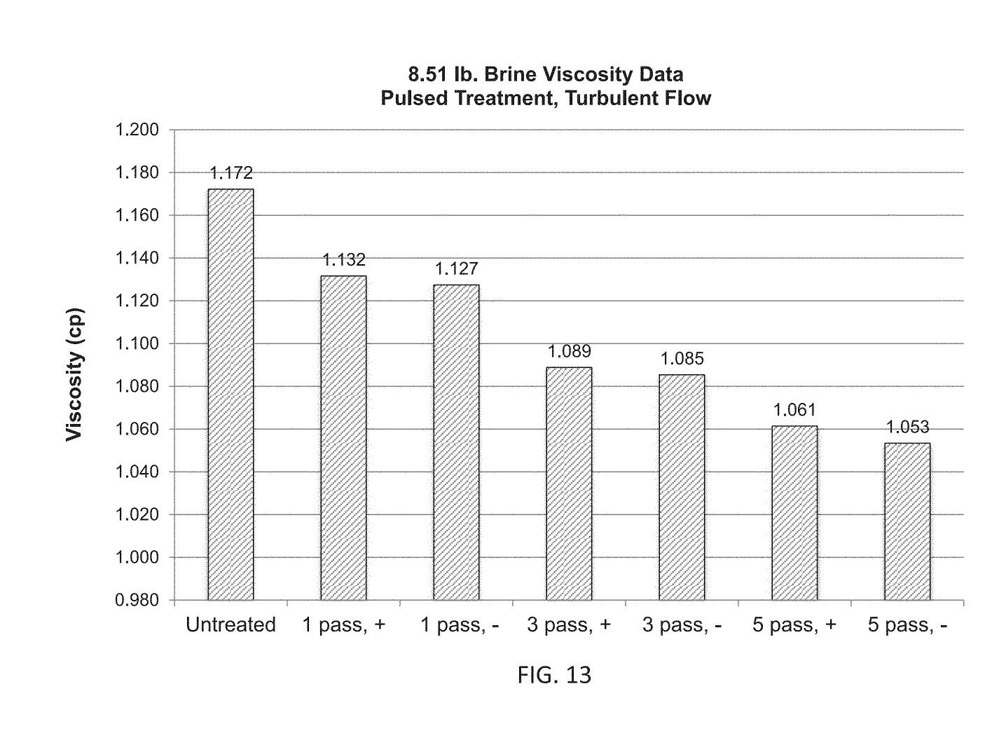

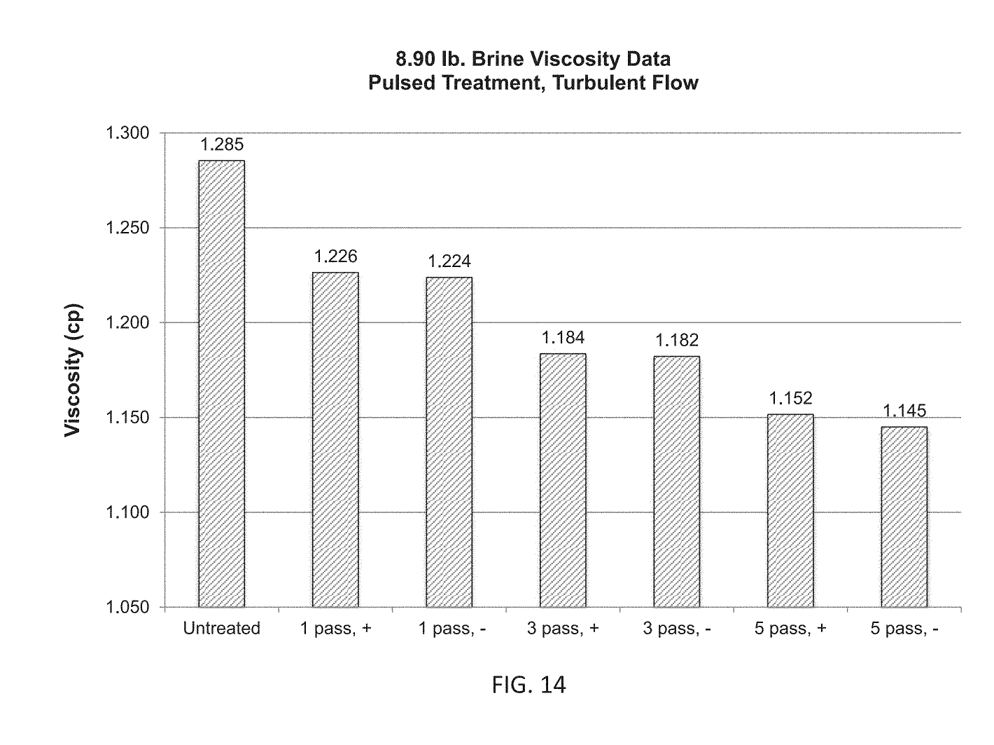

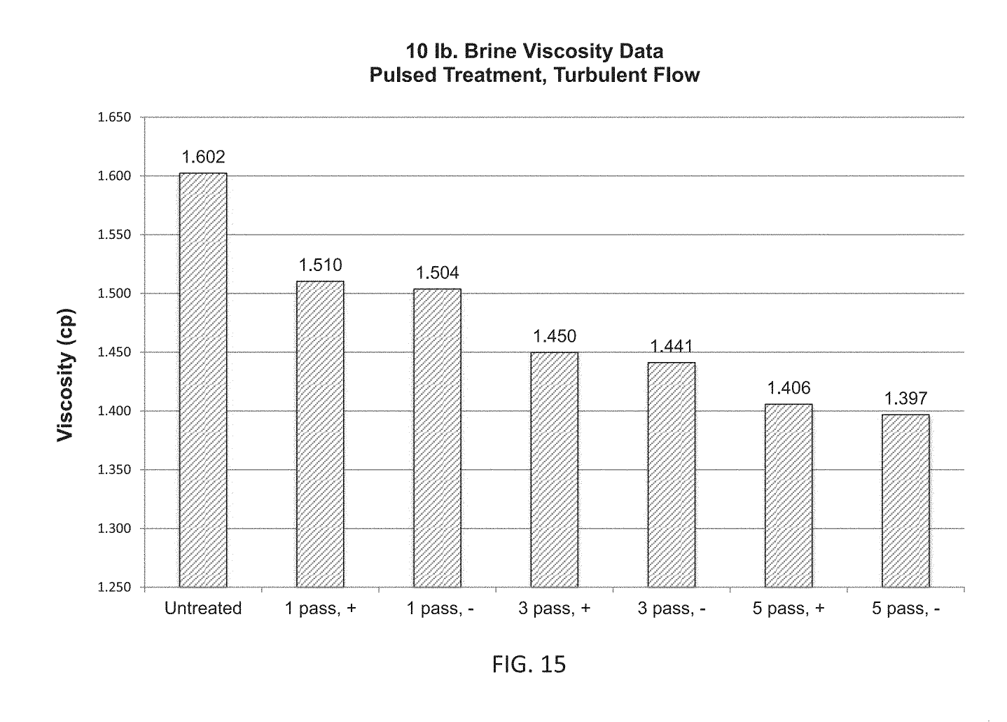

Comparison of the contact angles of each water sample against standard PTFE and BN hydrophobic reference surfaces were used to determine the fraction of the overall polar surface tension of each sample making up their acidic and basic surface tensions. Additionally, as previously disclosed, viscosity was measured for both the pure distilled water and the brines using a low shear falling ball viscometer (Gilmont-100). Such results are shown in Tables 12-15 as well as FIGS. 8-15.

For each sample in Tables 12-15, the Wilhelmy Plate values are an average of 5 measurements, the PTFE contact angle and BN contact values are an average of 10 measurements each, and the viscosity values are an average of 5 measurements for each sample.

TABLE 12
Pure Distilled Water Conditioned at about 4800 Gauss

| | | | | | PTFE | BN | | Overall | | | | |
|---|---|---|---|---|---|---|---|---|---|---|---|---|
| | | | | | Contact | Contact | | Surface | Dispersive | Acidic | Basic | Surface |
| Reynold's | | Gauss | | Wilhelmy | Angle | Angle | Viscosity | Tension | Component | Component | Component | Polarity |
| # | Passes | Field | Power | Plate Avg | Avg. | Avg. | Avg. | (mN/m) | (mN/m) | (mN/m) | (mN/m) | (%) |
| None | 0 | None | None | 72.80 | 113.6 | 65.2 | 1.025 | 72.80 | 26.51 | 22.90 | 23.39 | 63.59 |
| 5430 | Approx. | None | None | 72.79 | 113.7 | 65.2 | 1.025 | 72.79 | 26.39 | 23.16 | 23.24 | 63.74 |
| | 3500 | | | | | | | | | | | |
| 1830 | 1 | 4852 | Cont. | 71.28 | 114.1 | 63.9 | 1.018 | 71.28 | 24.65 | 24.64 | 22.00 | 65.42 |
| 1830 | 1 | −4839 | Cont. | 71.14 | 114.2 | 65.1 | 1.017 | 71.14 | 24.45 | 21.93 | 24.76 | 65.63 |
| 5430 | 1 | 4852 | Cont. | 71.01 | 114.2 | 63.6 | 1.016 | 71.01 | 24.42 | 24.93 | 21.66 | 65.60 |
| 5430 | 1 | −4839 | Cont. | 70.90 | 114.2 | 65.1 | 1.016 | 70.90 | 24.27 | 21.69 | 24.94 | 65.77 |
| 1830 | 1 | 4824 | Pulsed | 70.57 | 114.3 | 63.4 | 1.013 | 70.57 | 23.90 | 24.97 | 21.70 | 66.13 |
| 1830 | 1 | −4794 | Pulsed | 70.40 | 114.4 | 65.0 | 1.012 | 70.40 | 23.67 | 21.51 | 25.22 | 66.37 |
| 5430 | 1 | 4824 | Pulsed | 70.25 | 114.4 | 63.1 | 1.011 | 70.25 | 23.64 | 25.39 | 21.23 | 66.36 |
| 5430 | 1 | −4794 | Pulsed | 70.06 | 114.4 | 65.0 | 1.009 | 70.06 | 23.50 | 21.10 | 25.47 | 66.46 |
| 1830 | 3 | 4852 | Cont. | 70.06 | 114.5 | 63.0 | 1.009 | 70.06 | 23.40 | 25.44 | 21.21 | 66.59 |
| 1830 | 3 | −4839 | Cont. | 69.84 | 114.5 | 65.0 | 1.009 | 69.84 | 23.17 | 20.92 | 25.75 | 66.82 |
| 5430 | 3 | 4852 | Cont. | 69.67 | 114.6 | 62.6 | 1.007 | 69.67 | 22.96 | 25.96 | 20.75 | 67.05 |
| 5430 | 3 | −4839 | Cont. | 69.49 | 114.6 | 65.0 | 1.006 | 69.49 | 22.89 | 20.59 | 26.01 | 67.06 |
| 1830 | 5 | 4852 | Cont. | 69.17 | 114.7 | 62.2 | 1.003 | 69.17 | 22.56 | 26.27 | 20.34 | 67.39 |
| 1830 | 3 | 4824 | Pulsed | 69.01 | 114.7 | 62.1 | 1.002 | 69.01 | 22.41 | 26.19 | 20.42 | 67.54 |
| 1830 | 5 | −4839 | Cont. | 68.95 | 114.8 | 65.0 | 1.002 | 68.95 | 22.29 | 20.21 | 26.44 | 67.67 |
| 1830 | 3 | −4794 | Pulsed | 68.77 | 114.8 | 65.0 | 1.000 | 68.77 | 22.09 | 20.19 | 26.49 | 67.88 |
| 5430 | 5 | 4852 | Cont. | 68.68 | 114.8 | 61.8 | 1.000 | 68.68 | 22.14 | 26.44 | 20.10 | 67.76 |
| 5430 | 3 | 4824 | Pulsed | 68.54 | 114.8 | 61.7 | 0.998 | 68.54 | 21.99 | 26.64 | 19.91 | 67.92 |
| 5430 | 5 | −4839 | Cont. | 68.43 | 114.9 | 65.0 | 0.996 | 68.43 | 21.80 | 19.90 | 26.73 | 68.14 |
| 5430 | 3 | −4794 | Pulsed | 68.22 | 114.9 | 64.8 | 0.996 | 68.22 | 21.67 | 19.87 | 26.69 | 68.24 |
| 1830 | 5 | 4824 | Pulsed | 67.95 | 115.1 | 61.2 | 0.992 | 67.95 | 21.21 | 27.31 | 19.43 | 68.78 |
| 1830 | 5 | −4794 | Pulsed | 67.67 | 115.2 | 64.9 | 0.990 | 67.67 | 20.95 | 19.45 | 27.28 | 69.04 |
| 5430 | 5 | 4824 | Pulsed | 67.35 | 115.2 | 60.8 | 0.989 | 67.35 | 20.83 | 27.36 | 19.16 | 69.07 |
| 5430 | 5 | −4794 | Pulsed | 67.10 | 115.3 | 64.8 | 0.987 | 67.10 | 20.49 | 19.19 | 27.41 | 69.46 |

TABLE 13
8.51 lb. Brine Conditioned at about 4800 Gauss

| | | | | | PTFE | BN | | Overall | | | | |
|---|---|---|---|---|---|---|---|---|---|---|---|---|
| | | | | | Contact | Contact | | Surface | Dispersive | Acidic | Basic | Surface |
| Reynold's | | Gauss | | Wilhelmy | Angle | Angle | Viscosity | Tension | Component | Component | Component | Polarity |
| # | Passes | Field | Power | Plate Avg | Avg. | Avg. | Avg. | (mN/m) | (mN/m) | (mN/m) | (mN/m) | (%) |
| None | 0 | None | None | 74.16 | 114.4 | 66.1 | 1.173 | 74.16 | 26.35 | 23.87 | 23.94 | 64.46 |
| 5430 | Approx. | None | None | 74.14 | 114.4 | 66.0 | 1.172 | 74.14 | 26.34 | 24.21 | 23.59 | 64.47 |
| | 3500 | | | | | | | | | | | |
| 1830 | 1 | 4881 | Cont. | 70.53 | 115.4 | 62.8 | 1.147 | 70.53 | 22.56 | 28.07 | 19.90 | 68.02 |
| 1830 | 1 | −4845 | Cont. | 70.28 | 115.4 | 66.7 | 1.145 | 70.28 | 22.39 | 19.42 | 28.48 | 68.15 |
| 5430 | 1 | 4881 | Cont. | 70.09 | 115.5 | 62.4 | 1.143 | 70.09 | 22.15 | 28.60 | 19.34 | 68.39 |
| 5430 | 1 | −4845 | Cont. | 69.80 | 115.5 | 66.7 | 1.140 | 69.80 | 21.96 | 19.03 | 28.81 | 68.54 |
| 1830 | 1 | 4812 | Pulsed | 69.21 | 115.7 | 61.7 | 1.137 | 69.21 | 21.33 | 29.35 | 18.53 | 69.19 |
| 1830 | 1 | −4834 | Pulsed | 68.94 | 115.8 | 66.9 | 1.132 | 68.94 | 21.10 | 18.09 | 29.74 | 69.39 |
| 5430 | 1 | 4812 | Pulsed | 68.75 | 115.9 | 61.3 | 1.132 | 68.75 | 20.82 | 29.88 | 18.05 | 69.71 |
| 5430 | 1 | −4834 | Pulsed | 68.42 | 116.0 | 67.0 | 1.127 | 68.42 | 20.48 | 17.81 | 30.14 | 70.08 |
| 1830 | 3 | 4881 | Cont. | 67.34 | 116.3 | 60.3 | 1.117 | 67.34 | 19.59 | 30.63 | 17.12 | 70.91 |
| 1830 | 3 | −4845 | Cont. | 66.96 | 116.4 | 66.9 | 1.112 | 66.96 | 19.17 | 16.99 | 30.79 | 71.37 |
| 5430 | 3 | 4881 | Cont. | 66.66 | 116.6 | 59.7 | 1.110 | 66.66 | 18.85 | 31.44 | 16.37 | 71.72 |
| 5430 | 3 | −4845 | Cont. | 66.37 | 116.6 | 67.1 | 1.107 | 66.37 | 18.69 | 16.23 | 31.45 | 71.84 |
| 1830 | 3 | 4812 | Pulsed | 65.56 | 116.9 | 58.9 | 1.097 | 65.56 | 17.88 | 32.09 | 15.59 | 72.73 |
| 1830 | 5 | 4881 | Cont. | 65.28 | 116.9 | 58.7 | 1.096 | 65.28 | 17.75 | 31.92 | 15.62 | 72.81 |
| 1830 | 3 | −4834 | Pulsed | 65.20 | 117.1 | 67.4 | 1.095 | 65.20 | 17.53 | 15.30 | 32.37 | 73.11 |
| 1830 | 5 | −4845 | Cont. | 64.84 | 117.1 | 67.2 | 1.091 | 64.84 | 17.32 | 15.27 | 32.26 | 73.29 |
| 5430 | 3 | 4812 | Pulsed | 64.66 | 117.2 | 58.3 | 1.089 | 64.66 | 17.13 | 32.27 | 15.27 | 73.51 |
| 5430 | 5 | 4881 | Cont. | 64.46 | 117.2 | 58.1 | 1.084 | 64.46 | 17.02 | 32.54 | 14.90 | 73.60 |
| 5430 | 3 | −4834 | Pulsed | 64.40 | 117.4 | 67.4 | 1.085 | 64.40 | 16.75 | 15.00 | 32.65 | 74.00 |
| 5430 | 5 | −4845 | Cont. | 64.14 | 117.4 | 67.3 | 1.083 | 64.14 | 16.68 | 14.88 | 32.58 | 74.00 |
| 1830 | 5 | 4812 | Pulsed | 63.15 | 117.6 | 57.2 | 1.070 | 63.15 | 15.96 | 32.99 | 14.19 | 74.72 |
| 1830 | 5 | −4834 | Pulsed | 62.84 | 117.9 | 67.4 | 1.065 | 62.84 | 15.54 | 14.14 | 33.17 | 75.28 |
| 5430 | 5 | 4812 | Pulsed | 62.21 | 118.1 | 56.6 | 1.061 | 62.21 | 15.01 | 33.54 | 13.66 | 75.88 |
| 5430 | 5 | −4834 | Pulsed | 61.82 | 118.3 | 67.3 | 1.053 | 61.82 | 14.69 | 13.80 | 33.33 | 76.24 |

TABLE 14
8.90 lb. Brine Conditioned at about 4800 Gauss

| | | | | | PTFE | BN | | Overall | | | | |
|---|---|---|---|---|---|---|---|---|---|---|---|---|
| | | | | | Contact | Contact | | Surface | Dispersive | Acidic | Basic | Surface |
| Reynold's | | Gauss | | Wilhelmy | Angle | Angle | Viscosity | Tension | Component | Component | Component | Polarity |
| # | Passes | Field | Power | Plate Avg | Avg. | Avg. | Avg. | (mN/m) | (mN/m) | (mN/m) | (mN/m) | (%) |
| None | 0 | None | None | 75.18 | 114.9 | 66.7 | 1.284 | 75.18 | 26.35 | 24.48 | 24.34 | 64.94 |
| 5430 | Approx. | None | None | 75.17 | 114.8 | 66.7 | 1.285 | 75.17 | 26.39 | 24.62 | 24.16 | 64.89 |
| | 3500 | | | | | | | | | | | |
| 1830 | 1 | 4892 | Cont. | 70.62 | 116.2 | 62.7 | 1.250 | 70.62 | 21.65 | 29.90 | 19.06 | 69.34 |
| 1830 | 1 | −4875 | Cont. | 70.35 | 116.2 | 67.5 | 1.246 | 70.35 | 21.49 | 19.06 | 29.80 | 69.45 |
| 5430 | 1 | 4892 | Cont. | 70.04 | 116.3 | 62.3 | 1.243 | 70.04 | 21.11 | 30.39 | 18.54 | 69.86 |
| 5430 | 1 | −4875 | Cont. | 69.76 | 116.4 | 67.7 | 1.239 | 69.76 | 20.90 | 18.38 | 30.49 | 70.05 |
| 1830 | 1 | 4873 | Pulsed | 69.13 | 116.6 | 61.7 | 1.235 | 69.13 | 20.21 | 30.88 | 18.04 | 70.77 |
| 1830 | 1 | −4856 | Pulsed | 68.85 | 116.7 | 67.7 | 1.232 | 68.85 | 19.94 | 17.87 | 31.04 | 71.03 |
| 5430 | 1 | 4873 | Pulsed | 68.55 | 116.8 | 61.2 | 1.226 | 68.55 | 19.65 | 31.43 | 17.48 | 71.34 |
| 5430 | 1 | −4856 | Pulsed | 68.16 | 116.9 | 67.7 | 1.224 | 68.16 | 19.35 | 17.45 | 31.36 | 71.62 |
| 1830 | 3 | 4892 | Cont. | 67.69 | 117.0 | 60.7 | 1.217 | 67.69 | 18.93 | 31.54 | 17.22 | 72.04 |
| 1830 | 3 | −4875 | Cont. | 67.39 | 117.2 | 67.9 | 1.214 | 67.39 | 18.57 | 16.67 | 32.15 | 72.45 |
| 5430 | 3 | 4892 | Cont. | 67.03 | 117.3 | 60.1 | 1.211 | 67.03 | 18.32 | 32.46 | 16.25 | 72.67 |
| 5430 | 3 | −4875 | Cont. | 66.56 | 117.4 | 67.9 | 1.203 | 66.56 | 17.92 | 16.09 | 32.55 | 73.08 |
| 1830 | 3 | 4873 | Pulsed | 65.68 | 117.8 | 59.3 | 1.195 | 65.68 | 17.11 | 32.84 | 15.73 | 73.95 |
| 1830 | 5 | 4892 | Cont. | 65.44 | 117.8 | 59.0 | 1.192 | 65.44 | 16.93 | 33.27 | 15.23 | 74.12 |
| 1830 | 3 | −4856 | Pulsed | 65.36 | 117.8 | 68.0 | 1.190 | 65.36 | 16.88 | 15.37 | 33.10 | 74.17 |
| 1830 | 5 | −4875 | Cont. | 65.06 | 118.0 | 68.1 | 1.188 | 65.06 | 16.56 | 15.15 | 33.35 | 74.55 |
| 5430 | 3 | 4873 | Pulsed | 64.85 | 118.0 | 58.7 | 1.184 | 64.85 | 16.45 | 33.33 | 15.07 | 74.63 |
| 5430 | 3 | −4856 | Pulsed | 64.61 | 118.2 | 68.2 | 1.182 | 64.61 | 16.14 | 14.82 | 33.65 | 75.02 |
| 5430 | 5 | 4892 | Cont. | 64.58 | 118.1 | 58.5 | 1.179 | 64.58 | 16.26 | 33.46 | 14.86 | 74.83 |
| 5430 | 5 | −4875 | Cont. | 64.19 | 118.3 | 68.2 | 1.176 | 64.19 | 15.85 | 14.56 | 33.78 | 75.31 |
| 1830 | 5 | 4873 | Pulsed | 63.24 | 118.6 | 57.6 | 1.162 | 63.24 | 15.10 | 34.05 | 14.08 | 76.12 |
| 1830 | 5 | −4856 | Pulsed | 62.68 | 118.7 | 68.2 | 1.153 | 62.68 | 14.72 | 13.76 | 34.20 | 76.51 |
| 5430 | 5 | 4873 | Pulsed | 62.29 | 119.0 | 57.1 | 1.152 | 62.29 | 14.30 | 33.91 | 14.07 | 77.04 |
| 5430 | 5 | −4856 | Pulsed | 61.75 | 119.1 | 68.0 | 1.145 | 61.75 | 13.96 | 13.58 | 34.20 | 77.39 |

TABLE 15
10 lb. Brine Conditioned at about 4800 Gauss

| | | | | | PTFE | BN | | Overall | | | | |
|---|---|---|---|---|---|---|---|---|---|---|---|---|
| | | | | | Contact | Contact | | Surface | Dispersive | Acidic | Basic | Surface |
| Reynold's | | Gauss | | Wilhelmy | Angle | Angle | Viscosity | Tension | Component | Component | Component | Polarity |
| # | Passes | Field | Power | Plate Avg | Avg. | Avg. | Avg. | (mN/m) | (mN/m) | (mN/m) | (mN/m) | (%) |
| None | 0 | None | None | 78.09 | 116.2 | 68.5 | 1.600 | 78.09 | 26.36 | 26.30 | 25.43 | 66.25 |
| 5430 | Approx. | None | None | 78.07 | 116.2 | 68.5 | 1.602 | 78.07 | 26.45 | 26.00 | 25.62 | 66.12 |
| | 3500 | | | | | | | | | | | |
| 1830 | 1 | 4765 | Cont. | 72.05 | 118.0 | 64.0 | 1.542 | 72.05 | 20.35 | 32.24 | 19.46 | 71.75 |
| 1830 | 1 | −4780 | Cont. | 71.70 | 118.1 | 69.6 | 1.535 | 71.70 | 19.96 | 19.08 | 32.66 | 72.17 |
| 5430 | 1 | 4765 | Cont. | 71.37 | 118.2 | 63.5 | 1.532 | 71.37 | 19.73 | 32.86 | 18.78 | 72.36 |
| 5430 | 1 | −4780 | Cont. | 71.02 | 118.3 | 69.8 | 1.529 | 71.02 | 19.38 | 18.33 | 33.32 | 72.72 |
| 1830 | 1 | 4842 | Pulsed | 70.33 | 118.6 | 62.9 | 1.518 | 70.33 | 18.70 | 33.51 | 18.12 | 73.41 |
| 1830 | 1 | −4837 | Pulsed | 69.99 | 118.8 | 69.9 | 1.513 | 69.99 | 18.24 | 17.71 | 34.04 | 73.94 |
| 5430 | 1 | 4842 | Pulsed | 69.56 | 118.9 | 62.4 | 1.510 | 69.56 | 17.94 | 34.07 | 17.54 | 74.21 |
| 5430 | 1 | −4837 | Pulsed | 69.12 | 119.1 | 69.8 | 1.504 | 69.12 | 17.51 | 17.42 | 34.19 | 74.67 |
| 1830 | 3 | 4765 | Cont. | 68.78 | 119.2 | 61.8 | 1.496 | 68.78 | 17.20 | 35.24 | 16.34 | 74.99 |
| 1830 | 3 | −4780 | Cont. | 68.32 | 119.2 | 70.1 | 1.491 | 68.32 | 16.98 | 16.37 | 34.96 | 75.14 |
| 5430 | 3 | 4765 | Cont. | 67.87 | 119.4 | 61.4 | 1.486 | 67.87 | 16.63 | 34.48 | 16.76 | 75.50 |
| 5430 | 3 | −4780 | Cont. | 67.50 | 119.6 | 70.2 | 1.476 | 67.50 | 16.22 | 15.94 | 35.34 | 75.98 |
| 1830 | 3 | 4842 | Pulsed | 66.62 | 120.0 | 60.6 | 1.465 | 66.62 | 15.38 | 35.74 | 15.49 | 76.91 |
| 1830 | 5 | 4765 | Cont. | 66.30 | 120.1 | 60.5 | 1.459 | 66.30 | 15.14 | 35.69 | 15.48 | 77.17 |
| 1830 | 3 | −4837 | Pulsed | 66.14 | 120.2 | 70.3 | 1.461 | 66.14 | 15.04 | 15.17 | 35.94 | 77.27 |
| 1830 | 5 | −4780 | Cont. | 65.90 | 120.4 | 70.6 | 1.457 | 65.90 | 14.74 | 14.83 | 36.33 | 77.63 |
| 5430 | 3 | 4842 | Pulsed | 65.75 | 120.4 | 60.2 | 1.450 | 65.75 | 14.62 | 36.00 | 15.14 | 77.77 |
| 5430 | 5 | 4765 | Cont. | 65.47 | 120.5 | 60.0 | 1.446 | 65.47 | 14.45 | 36.06 | 14.96 | 77.93 |
| 5430 | 3 | −4837 | Pulsed | 65.08 | 120.5 | 70.3 | 1.441 | 65.08 | 14.26 | 14.65 | 36.17 | 78.09 |
| 5430 | 5 | −4780 | Cont. | 64.93 | 120.6 | 70.2 | 1.440 | 64.93 | 14.11 | 14.78 | 36.03 | 78.26 |
| 1830 | 5 | 4842 | Pulsed | 63.73 | 121.1 | 59.0 | 1.422 | 63.73 | 13.17 | 36.52 | 14.04 | 79.34 |
| 1830 | 5 | −4837 | Pulsed | 63.28 | 121.4 | 70.4 | 1.411 | 63.28 | 12.74 | 13.99 | 36.55 | 79.87 |
| 5430 | 5 | 4842 | Pulsed | 62.97 | 121.7 | 58.7 | 1.406 | 62.97 | 12.39 | 36.75 | 13.83 | 80.32 |
| 5430 | 5 | −4837 | Pulsed | 62.28 | 121.8 | 70.7 | 1.397 | 62.28 | 12.07 | 13.19 | 37.02 | 80.62 |

As illustrated by Table 12 and FIG. 8, reducing the overall surface tension of distilled water and increasing its surface polarity with the various combinations of flowing at either a low Reynolds Number (˜1830) or high Reynolds Number (˜5430), inducing a constant positive or negative polarity, inducing a pulsed positive or negative polarity and directing a sample to make either one, three or five passes through the magnetically energized conduit makes distilled water more hydrophilic. The overall surface tension of the best combination of variables to condition pure distilled water (67.10 milliNewtons per meter, or mN/M) is lower than that of untreated pure distilled water (72.8 mN/m), and its surface polarity (69.46%) is higher than that of untreated pure distilled water (63.59%).

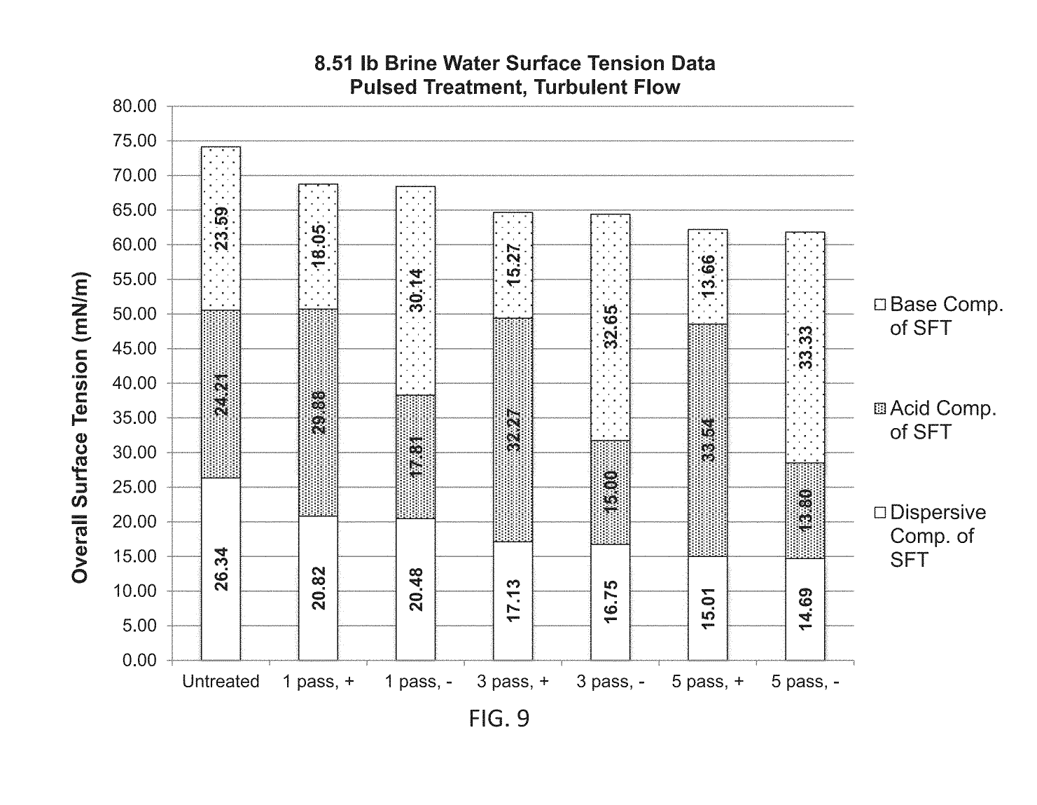

Additionally, as illustrated in Tables 13-15 and FIGS. 9-11, the overall surface tension of 8.51 lb. brine water, 8.90 lb. brine water, and 10 lb. brine water was reduced and the surface polarity increased for the samples subjected to the various combinations of flowing at either a low Reynolds Number (˜1830) or high Reynolds Number (˜5430), energizing the coiled electrical conductor with a constant positive or negative charge, energizing the coiled electrical conductor with a pulsed positive or negative charge and directing a sample to make either one, three or five passes through the magnetically energized conduit inducing approximately 4750 to 5000 Gauss. For each sample, the maximum surface tension reductions came from the conditions of: 5 passes with turbulent flow through the magnetically energized conduit with a pulsed magnetic field and inducing a negative polarity. The maximum viscosity change for each sample was also determined at the same settings. Therefore, whether the conditions comprise a single pass, multiple passes, energizing the coiled electrical conductor with a positive or negative charge, turbulent or laminar flow, and/or pulsed or continuous magnetic fields, subjecting a fluid containing at least one polar substance (e.g., water and/or brine) to a magnetic field of at least 4500 gauss (or more particularly, 4750 to 5000 gauss) results in reduced surface tension and viscosities for such a fluid.

Also illustrated in Tables 12-15 is the influence of the polarity of the magnetic field on the Lewis acid and Lewis base components of the surface tension of the fluids containing at least one polar substance. For example, when the fluid containing at least one polar substance was directed to pass through a magnetically energized conduit inducing a positive polarity (indicated by a lack of the negative symbol “−” for the Gauss field value), the measured fluid samples have an increased Lewis acid component versus a lower Lewis base component of their total polar surface tensions. In particular, after 5 turbulent passes of the pure distilled water in the positive direction at a pulsed Gauss level of 4824, the Lewis acid fraction of its polar surface tension component was measured at 27.36 mN/m and the Lewis base fraction was measured at 19.16 mN/m. When the direction in which the pure distilled water passed through the field was reversed (i.e., subjected to a Gauss level of −4837) while keeping the rest of the conditions the same, the Lewis acid fraction of its polar surface tension component decreased to 19.19 mN/m and the Lewis base fraction increased to 27.41 mN/m—completely opposite of the Lewis acid and Lewis base fractions when the pure distilled water is passed through the Gauss field inducing a positive polarity.

In other words, inducing a positive (+) polarity and/or inducing a negative (−) polarity in a fluid containing at least one polar substance heavily skew the split in the acidic and basic components of the polar surface tension of the fluid. As illustrated above, directing a fluid through the apparatus of the presently disclosed and/or claimed inventive concepts inducing a positive polarity causes an increase in the Lewis acid component of the fluid and a decrease in the Lewis base component of the fluid—even as the overall dispersive component of the surface tension of the fluid decreases. For example, the viscosity of the distilled water decreased from 1.025 cp to 0.989 cp after 5 passes through a magnetically conductive conduit inducing a positive polarity in the distilled water (a 3.5% reduction in viscosity) and similarly decreased from 1.025 cp to 0.987 cp after 5 passes through a magnetically conductive conduit inducing a negative polarity in the distilled water (a 3.7% reduction in viscosity).

As evidenced in Tables 12-15, the presently disclosed and/or claimed inventive concepts provide significant changes in the surface tensions and viscosities of these waters. This is true even on pure (i.e., distilled) water; and the effects increase as the salinity of the water increases. The effects also follow distinct trends.

Without being bound to a particular theory, it is predicted that the magnetic conditioning disclosed herein lowers the surface tension of water and lowers the dispersive (or non-polar) component of the surface tension, leaving the polar component skewed so that the water or brine water (i.e., fluid containing at least one polar substance) either favors or disfavors wetting a particular surface or dissimilar material—depending on the acidic or basic nature of the surface. As illustrated in Tables 13-15, the effects are greater for the brine water solutions, increasing with increased salt concentrations.

To better illustrate the reductions in surface tension and viscosity for the water samples (i.e., pure distilled water, 8.51 lb. brine water, 8.90 lb. brine water, and 10.0 lb. brine water), the untreated and conditioned (at a Reynolds number of 5430, pulsed magnetic field at about 4800 gauss, and 5 passes) values for each sample are presented as percentages in Tables 16-17.

TABLE 16
Surface Tension of Fluids Conditioned at about 4800 Gauss

| | | Water Sample | |
|---|---|---|---|
| | | Conditioned | |
| | | with | Reduction |
| | Untreated | Experimental | in Surface |
| Water Sample | Water Sample | Apparatus | Tension |
| Pure Distilled Water | 72.80 mN/m | 67.10 mN/m | 7.8% |
| 8.51 lb. Brine Water | 74.16 mN/m | 61.82 mN/m | 16.6% |
| 8.90 lb. Brine Water | 75.18 mN/m | 61.75 mN/m | 17.9% |
| 10.0 lb. Brine Water | 78.09 mN/m | 62.28 mN/m | 20.2% |

TABLE 17
Viscosity of Fluids Conditioned at about 4800 Gauss

| | | Water Sample | |
|---|---|---|---|
| | | Conditioned | |
| | | with | Reduction |
| | Untreated | Experimental | in |
| Water Sample | Water Sample | Apparatus | Viscosity |
| Pure Distilled Water | 1.025 cP | 0.987 cP | 3.7% |
| 8.51 lb. Brine Water | 1.173 cP | 1.053 cP | 10.2% |
| 8.90 lb. Brine Water | 1.284 cP | 1.145 cP | 10.8% |
| 10.0 lb. Brine Water | 1.600 cP | 1.397 cP | 12.7% |

As shown in Table 16 and 17, the apparatus and method as disclosed herein provide greater reductions in surface tension and viscosity for fluids containing at least one polar substance as the conductivity of such fluids increases. Similar reductions in surface tension and viscosity may be anticipated with other fluids containing at least one polar substance. Additionally, it can be seen when comparing Table 16 and Table 1, that conditioning pure distilled water at lower gauss levels (˜850 gauss) had no significant impact on the surface tension of water, however, at higher gauss levels of, for example, 4800 gauss the pure distilled water had a reduction in surface tension of almost 8%.

The apparatus and methods as presently claimed and/or disclosed herein of altering one or more physical properties of a fluid containing at least one polar substance can result in several unexpected properties when the fluid having at least one altered physical property is contacted with a dissimilar material (as defined above).

Additionally, as illustrated in the following examples, once the altered physical properties of the magnetically conditioned fluid containing at least one polar substance were obtained, a method was determined, as disclosed and/or claimed herein, for predicting how the conditioned fluid medium would interact with at least one dissimilar material and thereafter operating the apparatus to obtain specific physical properties of the fluid containing at least one polar substance such that one or more desired interactions may occur with a dissimilar material.

In one particular embodiment, it was determined that the method of magnetically conditioning the fluid containing at least one polar substance as disclosed and/or claimed herein can be controlled so as to intentionally alter one or more physical properties of the fluid containing at least one polar substance so as to either (a) cause a lower contact angle between the magnetically conditioned fluid containing at least one polar substance and the at least one dissimilar material (which may result in more stable emulsions), or (b) cause higher contact angle and a resulting increased interfacial tension between the magnetically conditioned fluid containing at least one polar substance and at least one dissimilar material when in combination (which may result in the at least one dissimilar material separating from the conditioned fluid medium at an increased rate as compared to the rate of separation of the at least one dissimilar material from the fluid containing at least one polar substance when not passed through the magnetically conductive conduit).

The following examples demonstrate such results wherein the fluid containing at least one polar substance is pure distilled water, 8.90 lb. brine water, synthetic seawater, and tap water, and the at least one dissimilar material is cement, bentonite, drilling mud, Similac® powder, guar gum, waste oil, West Texas Crude oil, and diesel fuel. As disclosed in detail in the tables below, each fluid containing at least one polar substance was subjected to magnetic conditioning using the “Experimental Apparatus” and methods described above in light of the conditions specified in the tables below.

Prior to predicting and thereafter experimentally confirming the contact angle of the magnetically conditioned fluids containing at least one polar substance, the dissimilar materials were characterized by determining their respective surface energies and surface tensions.

### Characterization of Dissimilar Materials

The surface energy properties of the solid materials, i.e., the cement, bentonite, drilling mud, and Similac® powder (available from Abbott Laboratories), were determined using the Washburn wicking method to measure the contact angles of packed cells of the various solids and using the van Oss equation—described above and as known to persons of ordinary skill in the art. The cement, bentonite, and drilling mud were in 2.0 gram packed cells and the guar gum and Similac® powder were in 1.5 gram packs. Additionally, hexane, water, diiodomethane, and formamide were used as the probe liquids for characterizing the solids. The properties of such probe liquids are presented in Table 18.

TABLE 18

| | Overall | Disper- | | | | |
|---|---|---|---|---|---|---|
| | Surface | sive | Acidic | Basic | | Viscos- |
| | Tension | Comp. | Comp. | Comp. | Density | ity |
| Probe Liquid | (mN/m) | (mN/m) | (mN/m) | (mN/m) | (g/cm³) | (cP) |
| Hexane | 18.40 | 18.40 | 0.00 | 0.00 | 0.661 | 0.33 |
| Water | 72.80 | 26.40 | 23.20 | 23.20 | 0.998 | 1.02 |
| Diiodomethane | 50.80 | 50.80 | 0.00 | 0.00 | 3.325 | 2.76 |
| Formamide | 57.00 | 22.40 | 10.10 | 24.50 | 1.113 | 3.81 |

Using the properties of the probe liquids as presented above, the resulting surface energies for the solid materials were determined and are presented in Table 19.

TABLE 19

| | Overall | Disper- | | | | |
|---|---|---|---|---|---|---|
| | Surface | sive | Acidic | Basic | Surface | Acid/ |
| | Energy | Comp. | Comp. | Comp. | Polarity | Base |
| Solid | (mJ/m²) | (mJ/m²) | (mJ/m²) | (mJ/m²) | (%) | Ratio |
| Cement | 62.42 | 36.34 | 6.42 | 19.66 | 41.78 | 0.33 |
| Bentonite | 56.04 | 37.86 | 2.67 | 15.51 | 32.44 | 0.17 |
| Drilling Mud | 54.87 | 37.73 | 2.21 | 14.94 | 31.25 | 0.15 |
| Similac ® | 48.91 | 37.44 | 5.16 | 6.32 | 23.46 | 0.82 |
| Powder | | | | | | |
| GuarGum | 44.30 | 35.57 | 4.69 | 4.04 | 19.70 | 1.16 |

As seen in Table 19, the surface energy and surface polarity is the highest for cement and lowest for guar gum. All of the solids except for guar gum appear to be more basic at their surfaces. Guar gum is the only solid that has an acidic surface. As discussed further herein, the basic or acidic surfaces is important in determining which magnetically conditioned fluid containing at least one polar substance should be used to encourage a stable emulsion or, alternatively, encourage separation of the fluid containing at least one polar substance and the solid. That is, a fluid containing at least one polar substance conditioned with a negative magnetic polarity will have a more basic component and thereby have better stabilization with, for example, guar gum which has a more acidic surface component and vice versa for a fluid containing at least one polar substance conditioned with a positive magnetic polarity.

Additionally, the properties of the waste oil, West Texas crude oil, and diesel fuel—specifically, overall surface tension components by testing overall surface tension using a Kruss Wilhelmy Plate Tensiometer (K100) and testing each sample against standard PTFE and BN hydrophobic reference surfaces to determine the contact angle of each sample and the fraction of the overall polar surface tension of each sample making up their acidic and basic surface tensions by using the van Oss technique.

The resulting surface tension and surface polarities of the waste oil, West Texas crude oil, and diesel fuel are presented in Table 20, wherein the surface tension is an average of 5 Wilhelmy plate measurements and the contact angles used to determine the surface polarities were based on 10 measurements each using the PTFE and BN reference surfaces.

TABLE 20

| | Overall | Disper- | | | | |
|---|---|---|---|---|---|---|
| | Surface | sive | Acidic | Basic | Surface | Acid/ |
| | Tension | Comp. | Comp. | Comp. | Polarity | Base |
| Oil | (mN/m) | (mN/m) | (mN/m) | (mN/m) | (%) | Ratio |
| Waste Oil | 25.81 | 23.90 | 1.28 | 0.63 | 7.38 | 2.04 |
| West Texas | 26.37 | 23.70 | 1.93 | 0.74 | 10.14 | 2.59 |
| Crude | | | | | | |
| Diesel Fuel | 28.08 | 23.50 | 2.92 | 1.67 | 16.32 | 1.75 |

As compared to the solids, the surface tensions and surface polarities of the waste oil, West Texas crude, and diesel fuel are much lower. Additionally, all three have an acidic surface component.

In order to test the solids and oils against magnetically conditioned fluids having at least one polar substance of different varieties, several samples of pure distilled water, 8.90 lb. brine water, synthetic sea water (available from RICCA Chemical, ASTM D1141), and tap water (having approximately 400 ppm total dissolved solids) (as described above) were conditioned using the “Experimental Apparatus” and method described above under turbulent flow (i.e., a Reynolds number of 5483) for 5 passes and a pulsed magnetic field of about 4842 inducing a positive polarity and about −4837 inducing a negative polarity. The overall surface tensions of each sample were measured by the Wilhelmy plate method and separating their overall surface tensions into polar and dispersive components, and then Lewis acid and Lewis base components using the van Oss technique, with all samples tested for contact angle against a standard polytetrafluoroethylene (PTFE) hydrophobic reference surface and a standard Boron Nitride (BN) hydrophobic reference surface. The results are presented in Table 21.

TABLE 21
Properties of Fluids Conditioned at about 4800 vs. Untreated Fluids

| | | Overall | | | | | |
|---|---|---|---|---|---|---|---|
| | Treatment | Surface | Dispersive | Acidic | Basic | Surface | |
| | (Gauss | Energy | Comp. | Comp. | Comp. | Polarity | Acid/Base |
| Water | Field) | (mJ/m²) | (mJ/m²) | (mJ/m²) | (mJ/m²) | (%) | Ratio |
| Pure Distilled | +4842 | 67.35 | 20.86 | 27.26 | 19.23 | 69.02 | 1.418 |
| Water | | | | | | | |
| Pure Distilled | −4837 | 67.10 | 20.47 | 19.16 | 27.47 | 69.49 | 0.697 |
| Water | | | | | | | |
| 8.90 lb. Brine | Untreated | 75.17 | 26.45 | 24.41 | 24.31 | 64.81 | 1.004 |
| Water | | | | | | | |
| 8.90 lb. Brine | +4842 | 62.29 | 14.32 | 33.95 | 14.03 | 77.01 | 2.420 |
| Water | | | | | | | |
| 8,90 lb. Brine | −4837 | 61.75 | 13.95 | 13.60 | 34.19 | 77.40 | 0.398 |
| Water | | | | | | | |
| Synthetic Sea | Untreated | 73.41 | 26.37 | 23.71 | 23.33 | 64.08 | 1.016 |
| Water | | | | | | | |
| Synthetic Sea | +4842 | 59.12 | 13.97 | 32.34 | 12.81 | 76.38 | 2.524 |
| Water | | | | | | | |
| Synthetic Sea | −4837 | 58.70 | 13.64 | 12.44 | 32.61 | 76.76 | 0.381 |
| Water | | | | | | | |
| Tap Water | Untreated | 71.26 | 27.09 | 21.98 | 22.19 | 61.99 | 0.991 |
| Tap Water | +4842 | 65.30 | 20.52 | 26.62 | 18.15 | 68..58 | 1.466 |
| Tap Water | −4837 | 65.02 | 20.26 | 17.64 | 27.12 | 68.84 | 0.650 |

As can be seen in Table 21, the overall surface tension for the pure distilled water and 8.90 lb. brine water showed similar decreases in overall surface energy and increases in surface polarity when conditioned at pulsed gauss levels of either +4842 or −4837 when passed through the Experimental Apparatus 5 times at turbulent flow rates. That is, the overall surface energy of distilled water decreased from a value of 72.79 mJ/m² when untreated to approximately 67 mJ/m² when conditioned at the above-referenced conditions and the overall surface energy of 8.90 lb. brine water decreased from 75.17 mJ/m² when untreated to about 61.75-62.29 mJ/m² when conditioned at the above-referenced conditions. Both the distilled water and the 8.90 lb. brine water had acidic surface components when conditioned with a positive polarity and basic surface components when conditioned with a negative polarity at the above-recited conditions.

Additionally, as can be seen in Table 21, the overall surface energy of synthetic seawater decreased from a value of 73.41 mJ/m² when untreated to approximately 59.12 to 58.70 mJ/m² when conditioned at the above-referenced conditions and the overall surface energy of the tap water decreased from 71.26 mJ/m² when untreated to about 65.30-65.02 mJ/m² when conditioned at the above-referenced conditions. Both the synthetic seawater and the tap water also had acidic surface components when conditioned with a positive polarity and basic surface components when conditioned with a negative polarity at the above-recited conditions.

Using the above information regarding the properties of the water samples as well as the surface properties of the dissimilar materials, predictions were made as to how the water and dissimilar materials would interact, which were then measured, as described below.

Predicted and Measured Contact Angles of Magnetically Conditioned Fluids Containing at least One Polar Substance in Contact with the Solids

Using the Van Oss theory, several predictions were made as to the contact angles between the pure distilled water, 8.90 lb. brine water, synthetic sea water, and tap water samples set out in Table 21 and the solids in Table 19. The predictions are presented in Table 22.

TABLE 22
Predicted Contact Angles of Fluids Conditioned at about 4500 Gauss vs. Untreated Fluids

| | | Contact | Contact | Contact | Contact | Contact |
|---|---|---|---|---|---|---|
| | Treatment | Angle on | Angle on | Angle on | Angle on | Angle on |
| | (Gauss | Cement | Bentonite | Drilling Mud | Similac ® Powder | Guar Gum |
| Water | Field) | (degrees) | (degrees) | (degrees) | (degrees) | (degrees) |
| Pure Distilled | +4842 | 33.4 | 48.8 | 51.3 | 59.0 | 66.3 |
| Water | | | | | | |
| Pure Distilled | −4837 | 38.1 | 53.2 | 55.6 | 59.5 | 66.1 |
| Water | | | | | | |
| 8.90 lb. Brine | Untreated | 42.3 | 55.0 | 57.1 | — | 68.6 |
| Water | | | | | | |
| 8.90 lb. Brine | +4842 | 29.9 | 47.1 | 49.6 | — | 68.8 |
| Water | | | | | | |
| 8.90 lb. Brine | −4837 | 42.4 | 58.4 | 60.9 | — | 68.2 |
| Water | | | | | | |
| Synthetic Sea | Untreated | 40.1 | 53.2 | 55.4 | — | 67.3 |
| Water | | | | | | |
| Synthetic Sea | +4842 | 22.8 | 42.8 | 45.6 | — | 66.2 |
| Water | | | | | | |
| Synthetic Sea | −4837 | 38.3 | 55.5 | 58.2 | — | 65.6 |
| Water | | | | | | |
| Tap Water | Untreated | 37.0 | 50.7 | 53.0 | 58.3 | 65.0 |
| Tap Water | +4842 | 29.8 | 46.4 | 48.9 | 57.1 | 64.7 |
| Tap Water | −4837 | 35.6 | 51.5 | 54.0 | 57.6 | 64.4 |

Using the Washburn method, the actual contact angles between the pure distilled water, 8.90 lb. brine water, synthetic sea water, and tap water samples set out in Table 21 and the solids in Table 19 were measured. The measured values are presented in Table 23.

TABLE 23
Measured Contact Angles of Fluids Conditioned at about 4500 Gauss vs. Untreated Fluids

| | | Contact | Contact | Contact | Contact | Contact |
|---|---|---|---|---|---|---|
| | Treatment | Angle on | Angle on | Angle on | Angle on | Angle on |
| | (Gauss | Cement | Bentonite | Drilling Mud | Similac ® Powder | Guar Gum |
| Water | Field) | (degrees) | (degrees) | (degrees) | (degrees) | (degrees) |
| Pure Distilled | +4842 | 33.9 | 48.9 | 51.5 | 59.4 | 66.9 |
| Water | | | | | | |
| Pure Distilled | −4837 | 38.4 | 53.5 | 56.0 | 59.3 | 66.5 |
| Water | | | | | | |
| 8.90 lb. Brine | Untreated | 42.8 | 55.1 | 56.6 | — | 68.6 |
| Water | | | | | | |
| 8.90 lb. Brine | +4842 | 29.8 | 47.1 | 50.0 | — | 68.4 |
| Water | | | | | | |
| 8.90 lb. Brine | −4837 | 42.8 | 58.5 | 61.4 | — | 68.5 |
| Water | | | | | | |
| Synthetic Sea | Untreated | 40.2 | 53.5 | 55.6 | — | 67.7 |
| Water | | | | | | |
| Synthetic Sea | +4842 | 22.8 | 42.8 | 45.7 | — | 65.9 |
| Water | | | | | | |
| Synthetic Sea | −4837 | 38.6 | 55.4 | 57.9 | — | 65.2 |
| Water | | | | | | |
| Tap Water | Untreated | 36.9 | 50.4 | 52.6 | 58.4 | 64.9 |
| Tap Water | +4842 | 29.9 | 46.7 | 48.8 | 56.8 | 64.9 |
| Tap Water | −4837 | 35.6 | 51.0 | 53.7 | 57.5 | 64.4 |

As can be seen when comparing the predicted contact angles and the measured contact angles, the predicted contact angles were very close to the actual measured contact angles. As previously noted, the fluids containing at least one polar substance that were subjected to a positive polarity generally show lower contact angles (i.e., better wetting) on the solids with basic surfaces (i.e., all but guar gum) and the fluids subjected to a negative polarity generally show lower contact angles on the guar gum, which has an acidic surface. The following table, Table 24, illustrates how close the predicted contact angles were to the measured contact angles suggesting the ability to predict the relationship between magnetically conditioned fluids containing at least one polar substance and characterize dissimilar materials as well as intentionally select specific conditions for magnetically conditioning fluids containing at least one polar substance such that they interact with dissimilar materials in a desired manner. In particular, Table 24 shows the differences between the predicted and measured contact values and plus or minuses relative to the predicted value.

TABLE 24
Differences

| | | Contact | Contact | Contact | Contact | Contact |
|---|---|---|---|---|---|---|
| | Treatment | Angle on | Angle on | Angle on | Angle on | Angle on |
| | (Gauss | Cement | Bentonite | Drilling Mud | Similac ® Powder | Guar Gum |
| Water | Field) | (degrees) | (degrees) | (degrees) | (degrees) | (degrees) |
| Pure Distilled | +4842 | 0.5 | 0.1 | 0.2 | 0.4 | 0.6 |
| Water | | | | | | |
| Pure Distilled | −4837 | 0.3 | 0.2 | 0.4 | −0.2 | 0.3 |
| Water | | | | | | |
| 8.90 lb. Brine | Untreated | 0.5 | 0.1 | −0.5 | — | 0.0 |
| Water | | | | | | |
| 8,90 lb. Brine | +4842 | −0.2 | 0.0 | 0.3 | — | 0.5 |
| Water | | | | | | |
| 8.90 lb. Brine | −4837 | 0.4 | 0.1 | 0.4 | — | 0.3 |
| Water | | | | | | |
| Synthetic Sea | Untreated | 0.0 | 0.3 | 0.2 | — | 0.4 |
| Water | | | | | | |
| Synthetic Sea | +4842 | 0.0 | 0.0 | 0.4 | — | 0.3 |
| Water | | | | | | |
| Synthetic Sea | −4837 | 0.3 | −0.1 | −0.4 | — | 0.4 |
| Water | | | | | | |
| Tap Water | Untreated | −0.1 | −0.4 | −0.4 | 0.1 | 0.2 |
| Tap Water | +4842 | 0.1 | 0.3 | −0.1 | −0.3 | 0.2 |
| Tap Water | −4837 | 0.0 | −0.5 | −0.4 | −0.1 | 0.0 |

The largest differences found between predicted and measured contact angle was 0.6 degrees on experiments that measurement-wise have a repeatability of about 0.2 degrees, indicating the theoretical and measured contact angles are close, even for different aqueous-based samples that have a 12-13 degree difference in contact angle on the same solid for conditioned water versus untreated water (or positively conditioned versus negatively conditioned). The positively conditioned waters show lower contact angles (better wetting) on the basic surfaces and the negatively conditioned waters show lower contact angles on the acidic guar gum surface. This is significant because even a few degrees of difference in contact angle on a scale that ranges from 0 degrees (perfect wetting) to 90 degrees (the top angle for the onset of immersional wetting of a solid) determines the ability of a solid to disperse in a liquid.

Without being bound to a particular theory, it is predicted that conditioning a fluid containing at least one polar substance by the presently disclosed and/or claimed inventive concepts provides changes throughout the bulk of the fluid, and is not simply a surface phenomenon similar to the use of a surfactant that can be added to water to achieve a certain set of surface tension, surface polarity, and/or acidic/basic component splits in the polar component of surface energy at its surface. Conditioning water with the presently disclosed and/or claimed inventive concepts provides measured contact angles that replicate predicted contact angles. This only occurs with a “pure” liquid for which exposure of any part of it (bulk or surface) is effectively the same to the solid.

In addition to knowing the manner in which conditioning water with the presently disclosed and/or claimed inventive concepts provides a predictable effect on solid wetting, it is important to understand such conditioning does not simply change the surface tension of a fluid similar to the addition of an additive or surfactant; but also effects the bulk properties if the conditioned fluid, in essence transforming it into a different pure solvent.

Predicted and Measured Contact Angles of Magnetically Conditioned Fluids containing at Least One Polar Substance in Contact with the Oils

Again using the Van Oss theory, several predictions were also made as to the contact angles between the unconditioned and conditioned pure distilled water, 8.90 lb. brine water, synthetic sea water, and tap water samples set out in Table 21 and the oils in Table 20. The predictions are presented in Table 25.

TABLE 25
Predicted Interfacial Tensions of Fluids Conditioned at about
4800 Gauss vs. Untreated Fluids

| | | | Interfacial | |
|---|---|---|---|---|
| | | Interfacial | Tension with | Interfacial |
| | | Tension with | West Texas | Tension with |
| | Treatment | Waste Oil | Crude | Diesel Fuel |
| Water | (Gauss Field) | (mN/m) | (mN/m) | (mN/m) |
| Pure Distilled | +4842 | 30.31 | 28.06 | 22.69 |
| Water | | | | |
| Pure Distilled | −4837 | 29.88 | 27.31 | 22.12 |
| Water | | | | |
| 8.90 lb. Brine | Untreated | 31.71 | 29.25 | 23.80 |
| Water | | | | |
| 8.90 lb. Brine | +4842 | 33.40 | 31.36 | 25.85 |
| Water | | | | |
| 8.90 lb. Brine | −4837 | 31.96 | 29.14 | 24.12 |
| Water | | | | |
| Synthetic Sea | Untreated | 30.37 | 27.97 | 22.64 |
| Water | | | | |
| Synthetic Sea | +4842 | 31.28 | 29.35 | 24.06 |
| Water | | | | |
| Synthetic Sea | −4837 | 29.89 | 27.16 | 22.36 |
| Water | | | | |
| Tap Water | Untreated | 28.10 | 25.78 | 20.69 |
| Tap Water | +4842 | 29.00 | 26.83 | 21.59 |
| Tap Water | −4837 | 28.39 | 25.86 | 20.84 |

Using the pendant drop method, the actual contact angles between the pure distilled water, 8.90 lb. brine water, synthetic sea water, and tap water samples set out in Table 21 and the oils in Table 20 were measured. The measured values are presented in Table 26.

TABLE 26
Measured Interfacial Tensions of Fluids Conditioned at about
4800 Gauss vs. Untreated Fluids

| | | | Interfacial | |
|---|---|---|---|---|
| | | Interfacial | Tension with | Interfacial |
| | Treatment | Tension with | West Texas | Tension with |
| | (Gauss | Waste Oil | Crude | Diesel Fuel |
| Water | Field) | (mN/m) | (mN/m) | (mN/m) |
| Pure Distilled | +4842 | 27.69 | 25.80 | 20.18 |
| Water | | | | |
| Pure Distilled | −4837 | 25.74 | 22.11 | 17.84 |
| Water | | | | |
| 8.90 lb. Brine | Untreated | 27.42 | 23.72 | 18.87 |
| Water | | | | |
| 8.90 lb. Brine | +4842 | 30.92 | 27.66 | 22.18 |
| Water | | | | |
| 8.90 lb. Brine | −4837 | 27.92 | 22.85 | 18.33 |
| Water | | | | |
| Synthetic Sea | Untreated | 26.43 | 22.74 | 16.96 |
| Water | | | | |
| Synthetic Sea | +4842 | 29.46 | 26.78 | 21.03 |
| Water | | | | |
| Synthetic Sea | −4837 | 26.52 | 22.13 | 16.75 |
| Water | | | | |
| Tap Water | Untreated | 23.06 | 21.43 | 15.78 |
| Tap Water | +4842 | 27.30 | 24.03 | 18.52 |
| Tap Water | −4837 | 24.25 | 20.88 | 16.21 |

As illustrated in Table 26, the measured interfacial tensions change significantly when the water samples were conditioned using the “Experimental Apparatus” and method described above under turbulent flow (i.e., a Reynolds number of 5483) for 5 passes and a pulsed magnetic field of about 4842 inducing a positive polarity and about −4837 inducing a negative polarity. For example, for 8.90 lb. brine water, the interfacial tension with West Texas Crude increased almost 4 mN/m, from 23.72 mN/m for untreated 8.90 lb. brine water to 27.66 mN/m when conditioned at the above-described conditions. Such a large increase in interfacial tension (i.e., ˜17%) would clearly result in an easier separation between the brine water and the West Texas Crude. In fact, a person of ordinary skill in the art would recognize that interfacial tension differences commonly have an effect that is more exponential than linear in terms of effect on emulsification/separation, thereby further demonstrating the significance of either the increases in interfacial tension (for increased separation rates/efficiency) and decreases in interfacial tension (for easier emulsification) as a result of the samples being passed through the apparatus five times inducing either a positive polarity of about 4842 or a negative polarity of about 4837 under turbulent flow.

A comparison of the predicted versus the measured values of the interfacial tensions of the water samples and the oil samples are presented below in Table 27.

TABLE 27

| | | Interfacial | Interfacial | Interfacial |
|---|---|---|---|---|
| | | Tension with | Tension with | Tension with |
| | Treatment | Waste Oil | West Texas | Diesel Fuel |
| | (Gauss | (% of | Crude | (% of |
| Water | Field) | predicted) | (% of predicted) | predicted) |
| Pure Distilled | +4842 | 91.4 | 92.0 | 88.9 |
| Water | | | | |
| Pure Distilled | −4837 | 86.1 | 81.0 | 80.7 |
| Water | | | | |
| 8.90 lb. Brine | Untreated | 86.5 | 81.1 | 79.3 |
| Water | | | | |
| 8.90 lb. Brine | +4842 | 92.6 | 88.2 | 85.8 |
| Water | | | | |
| 8.90 lb. Brine | −4837 | 87.4 | 78.4 | 76.0 |
| Water | | | | |
| Synthetic Sea | Untreated | 87.0 | 81.3 | 74.9 |
| Water | | | | |
| Synthetic Sea | +4842 | 94.2 | 91.3 | 87.4 |
| Water | | | | |
| Synthetic Sea | −4837 | 88.7 | 81.5 | 74.9 |
| Water | | | | |
| Tap Water | Untreated | 82.1 | 83.1 | 76.3 |
| Tap Water | +4842 | 94.1 | 89.6 | 85.8 |
| Tap Water | −4837 | 85.4 | 80.7 | 77.8 |

In viewing Table 27, as you progress across the table from Waste Oil to Diesel Fuel the measured surface tensions are lesser percentages of the predicted. This is due to the Diesel Fuel being more polar than the West Texas Crude, which is more polar than the Waste Oil. The more polar the oil, the more options it has to become compatible with water versus air. So the prediction of interfacial tension based on surface tension data is further off the more polar the oil becomes; however, the predictions are still within at least about 75% of the measured values.

Additionally, when viewing Table 27, the highest percentages in the table are for the 5 pass+water conditioning in every case. This is due to the interfacially active portions of the oil which might help it adapt toward interaction with water (making the actual interfacial tension lower than predicted) are going to be the polar parts of the oil. Those are predominately+(or acidic) in the case of these oils based on surface tension results. So less adaption in fact happens at the interface when the water is +conditioned. As a result the actual interfacial tension values are closer to the predicted values (i.e. higher percentages in the tables above) when the water is conditioned by inducing a +magnetic field.

Additionally, it was discovered that several of the magnetically conditioned samples, which were conditioned at the above-described conditions, retained at least 10% of their altered properties after 4 weeks of storage in glass bottles. Thereby suggesting that the altered physical properties are not short term, but are, in fact, present for significant durations of time.

In light of the above and the relative degree of accuracy between the predicted and measured, it is feasible to predict the resulting interfacial tension between a magnetically conditioned fluid containing at least one polar substance and a dissimilar material comprising an organic composition (e.g., oil, diesel, and/or oil production composition) as well as the magnetic conditions at which the fluid containing at least one polar substance must be processed at in the presently disclosed and/or claimed apparatus to alter the properties thereof to either have improved separation or improve emulsification.

Effect on the Cohesion Energy of Fluids Containing at least One Polar Substance at Gauss Levels Greater than 4500

As previously disclosed, changes in surface tension as a result of adding chemicals at low concentrations can either change a fluid's viscosity very little or potentially increase a fluid's viscosity. In many instances, adding chemicals to a fluid can also result in filters being clogged by the chemicals. In either case, adding surface active agents (e.g., surfactants) to a fluid reduces the surface tension of the fluid only at its surface.

Surfactants have molecular structures that have weaker bonding capabilities than water and are hydrophobic, so that when they are added to a volume of water they are promoted to its surface in disproportionate numbers and form a “boundary layer” on the surface of the water (which has lower surface tension than within the bulk of the water). In contrast, it is thought, without intending to be bound to a specific theory, that the effects of magnetic conditioning are actually a bulk treatment. That is, one non-limiting explanation is that magnetically conditioning does not simply change the surface tension of water on its surface, but actually affects the entire bulk of the fluid in terms of its surface tension and thereby the cohesiveness between its molecules, which is what reduces the viscosity in these situations.

As justification for this correlation, consider the standard definition of the cohesion energy of a fluid is twice its surface tension: Cohesion Energy=2σ, where σ=the overall surface tension of the liquid. When evaluating the surface energy of a fluid in three components that include its dispersive, acidic, and basic components when using the van Oss expression (as was previously demonstrated in accurately predicting contact angles and interfacial tensions between conditioned water samples against solids and oils) the expression expands to be:

Cohesion Energy=2(σ^{D} σ^{D})^{1/2}+2(σ⁺ σ⁻)^{1/2}+2(σ⁻ σ⁺)^{1/2}

where σ^{D}=the dispersive component of the surface tension of the liquid, σ⁺=the acid component of the surface tension of the liquid and σ=the base component of the surface tension of the liquid.

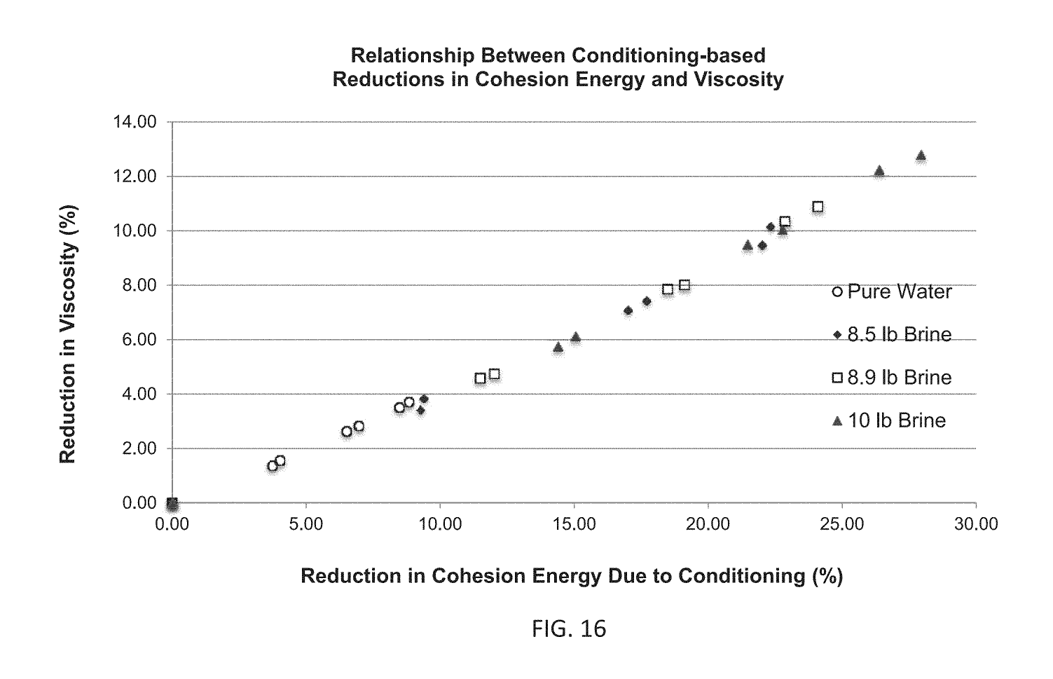

When pure water or a brine solution without chemical additives is magnetically conditioned, rather than chemically treated, nothing is added or removed from the conditioned fluid and it remains pure water or a mixture of water and salt; and the molecules and ions are of the same size. What does change, however, is the cohesion energy of the water since the dispersive, acidic, and basic components have been altered. The relationship between the percentage reduction in fluid cohesion energy and the percentage of reduction in viscosity is shown in FIG. 16. Additionally, Table 28 illustrates the changes in surface tension and viscosity of various water samples reported in FIG. 16, as well as their cohesion energy, with magnetic conditioning at turbulent flow, ˜4840 Gauss EWC energized with pulsed 24 VDC/10 A fluids at 20° C.

TABLE 28
Effect of conditioning on the cohesion energy and viscosity of water samples

| | | Surface | Surface | Surface | | | Reduction in | Reduction in |
|---|---|---|---|---|---|---|---|---|
| | | Tension | Tension | Tension | | | Cohesion | Viscosity |
| | | Dispersive | Acidic | Basic | Cohesion | | Energy due to | due to |
| | | Component | Component | Component | Energy | Viscosity | Conditioning | Conditioning |
| Solution | Conditioning | (Dyne/cm) | (Dyne/cm) | (Dyne/cm) | (Dyne/cm) | (cp) | (%) | (%) |
| Pure Water | Untreated | 26.39 | 23.16 | 23.24 | 145.6 | 1.025 | 0.00 | 0.00 |
| Pure Water | 1 pass+ | 23.64 | 25.39 | 21.23 | 140.1 | 1.011 | 3.73 | 1.37 |
| Pure Water | 1 pass− | 23.50 | 21.10 | 25.47 | 139.7 | 1.009 | 4.02 | 1.56 |
| Pure Water | 3 pass+ | 21.99 | 26.64 | 19.91 | 136.1 | 0.998 | 6.51 | 2.63 |
| Pure Water | 3 pass− | 21.67 | 19.87 | 26.69 | 135.5 | 0.996 | 6.95 | 2.83 |
| Pure Water | 5 pass+ | 20.83 | 27.36 | 19.16 | 133.2 | 0.989 | 8.47 | 3.51 |
| Pure Water | 5 pass− | 20.49 | 19.19 | 27.41 | 132.7 | 0.987 | 8.83 | 3.71 |
| 8.5 lb Brine | Untreated | 26.34 | 24.21 | 23.59 | 148.3 | 1.172 | 0.00 | 0.00 |
| 8.5 lb Brine | 1 pass+ | 20.82 | 29.88 | 18.05 | 134.5 | 1.132 | 9.27 | 3.41 |
| 8.5 lb Brine | 1 pass− | 20.84 | 17.81 | 30.14 | 134.4 | 1.127 | 9.39 | 3.84 |
| 8.5 lb Brine | 3 pass+ | 17.13 | 32.27 | 15.27 | 123.1 | 1.089 | 17.01 | 7.08 |
| 8.5 lb Brine | 3 pass− | 16.75 | 15.00 | 32.65 | 122.0 | 1.085 | 17.70 | 7.42 |
| 8.5 lb Brine | 5 pass+ | 15.01 | 33.54 | 13.66 | 115.6 | 1.061 | 22.01 | 9.47 |
| 8.5 lb Brine | 5 pass− | 14.69 | 13.80 | 33.33 | 115.2 | 1.053 | 22.33 | 10.15 |
| 8.9 lb Brine | Untreated | 26.39 | 24.62 | 24.16 | 150.3 | 1.285 | 0.00 | 0.00 |
| 8.9 lb Brine | 1 pass+ | 19.65 | 31.43 | 17.48 | 133.1 | 1.226 | 11.49 | 4.59 |
| 8.9 lb Brine | 1 pass− | 19.35 | 17.45 | 31.36 | 132.3 | 1.224 | 12.02 | 4.75 |
| 8.9 lb Brine | 3 pass+ | 16.45 | 33.33 | 15.07 | 122.5 | 1.184 | 18.48 | 7.86 |
| 8.9 lb Brine | 3 pass− | 16.14 | 14.82 | 33.65 | 121.6 | 1.182 | 19.11 | 8.02 |
| 8.9 lb Brine | 5 pass+ | 14.30 | 33.91 | 14.07 | 116.0 | 1.152 | 22.86 | 10.35 |
| 8.9 lb Brine | 5 pass− | 13.96 | 13.58 | 34.20 | 114.1 | 1.145 | 24.09 | 10.89 |
| 10 lb Brine | Untreated | 26.45 | 26.00 | 25.62 | 156.1 | 1.602 | 0.00 | 0.00 |
| 10 lb Brine | 1 pass+ | 17.94 | 34.07 | 17.54 | 133.7 | 1.510 | 14.39 | 5.74 |
| 10 lb Brine | 1 pass− | 17.51 | 17.42 | 34.19 | 132.6 | 1.504 | 15.05 | 6.12 |
| 10 lb Brine | 3 pass+ | 14.62 | 36.00 | 15.14 | 122.6 | 1.450 | 21.46 | 9.49 |
| 10 lb Brine | 3 pass− | 14.26 | 14.65 | 36.17 | 120.6 | 1.441 | 22.76 | 10.05 |
| 10 lb Brine | 5 pass+ | 12.39 | 36.75 | 13.83 | 115.0 | 1.406 | 26.37 | 12.23 |
| 10 lb Brine | 5 pass− | 12.07 | 13.19 | 37.02 | 112.5 | 1.397 | 27.93 | 12.80 |

Reductions in viscosity of up to 3.71%, reductions in surface tension of up to 7.83% and reductions in cohesion energy of up to 8.47% were achieved with pure water exposed to the highest conditioning parameters tested. Reductions in viscosity increased with the addition of salt to water and then exposing various brine solutions to the highest conditioning parameters tested, with a 12.80% reduction in viscosity, a 20.24% reduction in surface tension and reductions in cohesion energy of up to 27.93% recorded in 10.0 lb brine.

As shown In Table 28 and FIG. 16, the reductions in cohesion energy are linearly related to reductions in viscosity in all cases, with magnetic conditioning fundamentally changing cohesion energy between molecules, which affects both surface energy and viscosity. Reductions in cohesion energy of a fluid containing at least one polar substance may be anticipated to improve the emulsification of a dissimilar material with the conditioned fluid medium. A conditioned fluid medium having reduced cohesion energy may be anticipated to evaporate at an accelerated rate and/or reach its boiling point in a reduced period of time compared to an untreated fluid containing at least one polar substance.

Maximum Changes in Surface Tension, Viscosity and Cohesion Energy of Synthetic Seawater at Gauss Levels Greater than 4500 and Dissipation of Effects over Time

As suggested above in Tables 12-15, the presently claimed and/or disclosed inventive concepts of generating levels of magnetic field strength greater than 4500 gauss have been shown to provide significant changes in the cohesion energy, dispersive surface tensions, viscosities, contact angles and the acidic and basic components of the polar surface tensions of fluids containing at least one polar substance.

For example, one embodiment of the apparatus and method capable of generating pulsed levels of magnetic field strength greater than 4500 gauss, as disclosed herein, has been shown to reduce the surface tensions of pure distilled water from 72.80 mN/m to 67.10 mN/m (7.8% reduction), 8.51 lb. brine from 74.16 mN/m to 61.82 mN/m (16.6% reduction), 8.90 lb. brine from 75.18 mN/m to 61.75 mN/m (17.9% reduction) and 10.0 lb. brine from 78.09 mN/m to 62.28 mN/m (20.2% reduction). Subjecting fluids containing at least one polar substance to pulsed levels of magnetic field strength greater than 4500 gauss has also been shown to reduce the viscosities of the following fluids containing at least one polar substance by at least 3.7%: pure distilled water from 1.025 cP to 0.987 cP (3.7% reduction), 8.51 lb. brine from 1.173 cP to 1.053 cP (10.2% reduction), 8.90 lb. brine from 1.284 cP to 1.145 cP (10.8% reduction) and 10.0 lb. brine from 1.600 cP to 1.397 cP (12.7% reduction). These effects follow distinct trends, and similar reductions in surface tension, viscosity, contact angles and the acidic and basic polarities of surface tension may be anticipated with other fluids containing at least one polar substance.

Additionally, as illustrated in the following examples, this has even been demonstrated with synthetic sea water (available from RICCA Chemical, ASTM D1141—having concentrations of Sodium Chloride (NaCl), Magnesium Chloride Hexahydrate (MgCl2·6H2O), Sodium Sulfate Anhydrous (Na2SO4), Calcium Chloride Dihydrate (CaCl2·2H2O), Potassium Chloride (KCl), Sodium Bicarbonate (NaHCO3), Potassium Bromide (KBr), Strontium Chloride Hexahydrate (SrCl2·6H2O), Boric Acid (H3BO3), Sodium Fluoride (NaF) and Sodium Hydroxide (NaOH)); and the effects have been shown to increase as the enhanced complexity of this mixture containing triatomic salts (which dissolve to produce +2 ions like Mg⁺²) produced lower surface tensions in a conditioned fluid medium than the +1 ions found in 8.51, 8.9 and 10 lb. brines containing only Na+ and Cl− ions.

As further illustrated in the following examples, inducing a positive (+) polarity and/or inducing a negative (−) polarity in synthetic sea water using a pulsed magnetic field strength greater than 4500 gauss has also been discovered to heavily skew the split in the acidic and basic components of the polar surface tension of the fluid. For example, directing synthetic sea water through the apparatus as presently disclosed and/or claimed while inducing a positive polarity caused an increase in the Lewis acidic component of the fluid and a decrease in the Lewis basic component of the fluid—even as the overall dispersive component of the surface tension of the fluid decreased. Directing synthetic sea water through the apparatus as presently disclosed and/or claimed while inducing a negative polarity caused a reduction in the Lewis acidic component of the fluid and an increase in the Lewis basic component of the fluid

Depending on the composition of synthetic sea water and, optionally, one or more dissimilar materials in fluid, at least one of the embodiments described above can be used to, for example but without limitation, (i) increase the rate by which a dissimilar material separates from synthetic sea water, (ii) encourage phase separation of at least two separate phases (e.g., synthetic sea water, a solid material phase, and/or a hydrocarbon phase), (iii) encourage the formation of a stable or semi-stable mixture or emulsion comprising at least one dissimilar material and synthetic sea water, (iv) reduce the pressure to pass synthetic sea water through a conduit at a constant temperature (e.g., ambient temperature) or with a change in temperature of less than 5° F., or less than 4° F., or less than 3° F., or less than 2° F., or less than 1° F., (v) increase the flow rate of synthetic sea water through a conduit under constant temperature and at a constant temperature (e.g., ambient temperature) or with a change in temperature of less than 5° F., or less than 4° F., or less than 3° F., or less than 2° F., or less than 1° F., and/or (vi) separate at least one biological contaminant from synthetic sea water.

The following examples illustrate via experimental analysis the extent that certain physical properties like the surface tension, viscosity and cohesion energy can be altered for synthetic sea water (as defined herein) when subjected to, for example, a magnetic field of approximately 4,750 to 5,000 gauss.

Several samples of synthetic sea water available from RICCA Chemical, ASTM D1141 (as described above) were conditioned using the “Experimental Apparatus” and method described above; and conditioned with turbulent flow (i.e., a Reynolds number of 5430) for either one pass, three passes, five passes, ten passes, twenty passes, fifty passes or one hundred passes and a pulsed magnetic field of about 4772 gauss inducing a positive polarity and a pulsed magnetic field of about −4763 gauss inducing a negative polarity.

Prior to conditioning the samples with the energized magnetically conductive conduit at approximately 4750 gauss, standards were obtained for untreated samples of synthetic seawater by collecting an untreated sample in a certified clean container after being directed to make only one pass through the non-energized magnetically conductive conduit. The samples flowed uncollected for approximately 30 to 45 seconds to allow for the dismissal of any bubbles so that the untreated synthetic sea water sample was collected during steady-state flow. Second untreated sample of synthetic seawater was collected in a certified clean container the synthetic sea water had been directed to make approximately 3500 passes through the non-energized magnetically conductive conduit (circulated at approximately 129.5 ml/second for two hours so that the untreated synthetic sea water sample was collected during steady-state flow), noting that “non-energized” means that an intentional electrically generated magnetic field was not used to treat the samples at this point, much less a magnetic field greater than 4,500 gauss. Once the system was calibrated and standards were obtained, the samples were conditioned by exposing them to a magnetic field of around 4,500 using the apparatus and methods that follow:

Additional samples of synthetic sea water were collected in certified clean containers after energizing a coiled electrical conductor encircling the conduit with pulsed 24 VDC of electrical energy having a positive (+) charge and pulsed 24 VDC of electrical energy having a negative (−) charge and directing each sample to flow at a high Reynolds Number with either one pass, three passes, five passes, ten passes, twenty passes, fifty passes or one hundred passes through a magnetically energized conduit. The magnetically conditioned samples of synthetic sea water were similarly allowed to flow uncollected for approximately 30 to 45 seconds to allow for the dismissal of any bubbles so that the water samples were collected in certified clean containers during steady-state flow.

It should be noted that the synthetic sea water samples were not substantially heated during the process and were maintained at approximately 20° C. when entering, exiting, and while passing through the “Experimental Apparatus”. As such, it was concluded that the reduction in surface tension, viscosity and cohesion energy and as illustrated in the Table 29 below are a result of altering the physical properties of the experimental synthetic sea water rather than due to an increase in temperature.

TABLE 29
Magnetic Conditioning of Synthetic Sea Water

| Number of | Measure of | Average | | | | | | Reduced | | |
|---|---|---|---|---|---|---|---|---|---|---|
| Passes at | Magnetic | Surface | Dispersive | Acidic | Basic | Surface | Cohesion | Cohesion | Avg. | Reduced |
| Reynold's | Field | Tension | Component | Component | Component | Polarity | Energy | Energy | Viscosity | Viscosity |
| Number 5430 | (Gauss) | (mN/m) | (mN/m) | (mN/m) | (mN/m) | (%) | (mN/m) | (%) | (cP) | (%) |
| 0 | N/A | 73.41 | 26.34 | 23.74 | 23.33 | 64.11 | 146.8 | 0.0 | 1.224 | 0.0 |
| 0 | N/A | 73.41 | 26.34 | 23.74 | 23.33 | 64.11 | 146.8 | 0.0 | 1.222 | 0.0 |
| 1 | +4772 | 69.25 | 22.45 | 27.53 | 19.27 | 67.58 | 137.0 | 6.7 | 1.183 | 3.3 |
| 3 | +4772 | 63.16 | 17.09 | 31.09 | 14.98 | 71.94 | 120.5 | 17.9 | 1.107 | 9.6 |
| 5 | +4772 | 59.13 | 13.99 | 32.05 | 13.10 | 76.34 | 109.9 | 25.1 | 1.067 | 12.8 |
| 10 | +4772 | 54.06 | 10.39 | 32.90 | 10.77 | 80.77 | 96.1 | 34.6 | 1.012 | 17.3 |
| 20 | +4772 | 51.61 | 8.86 | 32.78 | 9.97 | 82.83 | 90.0 | 38.7 | 0.986 | 19.4 |
| 50 | +4772 | 51.27 | 8.64 | 32.61 | 10.02 | 83.15 | 89.6 | 39.0 | 0.977 | 20.2 |
| 100 | +4772 | 51.26 | 8.64 | 32.57 | 10.06 | 83.15 | 89.7 | 38.9 | 0.981 | 19.9 |
| 0 | N/A | 73.41 | 26.34 | 23.74 | 23.33 | 64.11 | 146.8 | 0.0 | 1.223 | 0.0 |
| 0 | N/A | 73.40 | 26.34 | 23.72 | 23.34 | 64.12 | 146.8 | 0.0 | 1.224 | 0.0 |
| 1 | −4763 | 69.13 | 22.25 | 19.01 | 27.87 | 67.82 | 136.6 | 7.0 | 1.178 | 3.8 |
| 3 | −4763 | 62.84 | 16.82 | 14.82 | 31.20 | 73.23 | 119.7 | 18.5 | 1.111 | 9.2 |
| 5 | −4763 | 58.71 | 13.63 | 12.69 | 32.39 | 76.78 | 108.4 | 26.2 | 1.058 | 13.6 |
| 10 | −4763 | 53.56 | 10.08 | 10.65 | 32.83 | 81.18 | 95.0 | 35.3 | 1.003 | 18.1 |
| 20 | −4763 | 51.17 | 8.61 | 9.80 | 32.76 | 83.18 | 88.9 | 39.4 | 0.973 | 20.5 |

All synthetic sea water samples were tested for viscosity in a low shear falling ball viscometer (Gilmont-100) and for surface tension components by testing overall surface tension using a Kruss Wilhelmy Plate Tensiometer (K100) and testing each sample against standard PTFE and BN hydrophobic reference surfaces to determine the contact angle of each sample and the fraction of the overall polar surface tension of each sample making up their acidic and basic surface tensions by using the van Oss technique. For each sample in Table 29, the Wilhelmy Plate values are an average of 5 measurements, the PTFE contact angle and BN contact values are an average of 10 measurements each, and the viscosity values are an average of 5 measurements for each sample.

As illustrated by Table 29, reducing the overall surface tension of synthetic sea water and increasing its surface polarity with the various combinations of flowing at a high Reynolds Number (˜5430), inducing a pulsed positive or negative polarity and directing a sample to make either one pass, three passes, five passes, ten passes, twenty passes, fifty passes or one hundred passes through the magnetically energized conduit inducing approximately 4750 to 5000 Gauss makes synthetic sea water more hydrophilic. The overall surface tension of the best combination of variables to condition synthetic sea water (50.84 milliNewtons per meter, or mN/M) is lower than that of untreated synthetic sea water (73.41 mN/m), and its surface polarity (83.60%) is higher than that of untreated synthetic sea water (64.11%).

Thus, conditioning synthetic sea water with a single pass or multiple passes at turbulent flow and energizing the coiled electrical conductor with a positive or negative pulsed charge to generate a magnetic field of at least 4500 gauss (or more particularly, 4750 to 5000 gauss) results in reduced surface tension, viscosity and the cohesion energy of the synthetic sea water. Maximum reductions in surface tension, viscosity and cohesion energy were achieved after 20 passes with turbulent flow through the magnetically energized conduit inducing a pulsed magnetic field approximately 4750 Gauss having a negative polarity; and samples directed to make 50 passes and 100 passes through the magnetically energized conduit provided no significant reductions in the physical properties of the conditioned synthetic sea water.

Also illustrated in Table 29 is the influence of the polarity of the magnetic field on the Lewis acid and Lewis base components of the surface tension of the synthetic sea water. For example, when synthetic sea water having a dispersive component of its surface tension measured at 26.34 mN/m, a Lewis acid fraction of its polar surface tension component measured at 23.74 mN/m and a Lewis base fraction was measured at 23.33 mN/m was directed to pass through a magnetically energized conduit inducing a positive polarity (indicated by a lack of the negative symbol “−” for the Gauss field value), the measured fluid samples have an increased Lewis acid component versus a lower Lewis base component of their total polar surface tensions. In particular, after 20 turbulent passes of the synthetic sea water through a pulsed magnetic field inducing a positive polarity at a Gauss level of 4772, the dispersive component of its surface tension was measured at 8.86 mN/m, the Lewis acid fraction of its polar surface tension component was measured at 32.78 mN/m and the Lewis base fraction was measured at 9.97 mN/m. When the direction in which the synthetic sea water passed through the field was reversed (i.e., subjected to a Gauss level of −4763) while keeping the rest of the conditions the same, after 20 turbulent passes of the synthetic sea water through a pulsed magnetic field inducing a negative polarity, the dispersive component of its surface tension was measured at 8.61 mN/m, the Lewis acid fraction of its polar surface tension component decreased to 9.76 mN/m and the Lewis base fraction increased to 32.74 mN/m—resulting in a completely reversal of the Lewis acid and Lewis base fractions after conditioning with 20 turbulent passes of the synthetic sea water through a pulsed magnetic field inducing a positive polarity.

Thus, inducing a positive (+) polarity and/or inducing a negative (−) polarity in synthetic sea water heavily skews the split in the acidic and basic components of the polar surface tension of the fluid. As illustrated above, directing synthetic sea water through the apparatus of the presently disclosed and/or claimed inventive concepts inducing a positive polarity causes an increase in the Lewis acid component of the fluid and a decrease in the Lewis base component of the fluid—even as the overall dispersive component of the surface tension of the synthetic sea water decreases. For example, the viscosity of the synthetic sea water decreased from 1.224 cp to 0.986 cp after 20 passes through a magnetically conductive conduit inducing a positive polarity in the synthetic sea water (a 19.5% reduction in viscosity) and similarly decreased from 1.223 cp to 0.973 cp after 20 passes through a magnetically conductive conduit inducing a negative polarity in the synthetic sea water (a 20.5% reduction in viscosity).

Without intending to be bound to a particular theory, it is predicted that the magnetic conditioning disclosed herein lowers the surface tension of synthetic sea water and lowers the dispersive (or non-polar) component of the surface tension, leaving the polar component skewed so that the synthetic sea water either favors or disfavors wetting a particular surface or dissimilar material—depending on the acidic or basic nature of the surface. As illustrated in Table 29, the effects of magnetic conditioning of synthetic sea water, with its increased complexity of the minerals and ionic compounds, are greater than the effects of magnetic conditioning of the previously studied pure distilled water and brine samples.

To better illustrate the reductions in surface tension, viscosity and cohesion energy for synthetic sea water samples conditioned with a different exposure (passes through the magnetically energized conduit), the untreated and conditioned (at a Reynolds number of 5430, pulsed magnetic field at about −4763 gauss, and 1, 3, 5, 10, 20, 50 and 100 passes) values for each sample are presented as percentages in Tables 30-32.

TABLE 30
Surface Tension of Synthetic Sea Water Conditioned at −4763 Gauss

| | Untreated | Water Sample | |
|---|---|---|---|
| Synthetic Sea | Surface | Conditioned with | Reduction in |
| Water | Tension | Experimental Apparatus | Surface |
| (Passes) | (mN/m) | (mN/m) | Tension |
| One Pass | 73.41 | 69.13 | 5.8% |
| Three Passes | 73.41 | 62.84 | 14.4% |
| Five Passes | 73.41 | 58.71 | 20.0% |
| Ten Passes | 73.41 | 53.56 | 27.0% |
| Twenty Passes | 73.41 | 51.17 | 30.3% |
| Fifty Passes | 73.41 | 50.85 | 30.7% |
| One Hundred | 73.41 | 50.84 | 30.7% |
| Passes | | | |

TABLE 31
Viscosity of Synthetic Sea Water Conditioned at −4763 Gauss

| | | Water Sample | |
|---|---|---|---|
| Synthetic Sea | Untreated | Conditioned with | Reduction |
| Water | Viscosity | Experimental Apparatus | in |
| (Passes) | (cP) | (cP) | Viscosity |
| One Pass | 1.224 | 1.178 | 3.8% |
| Three Passes | 1.224 | 1.111 | 9.2% |
| Five Passes | 1.224 | 1.058 | 13.6% |
| Ten Passes | 1.224 | 1.003 | 18.1% |
| Twenty Passes | 1.224 | 0.973 | 20.5% |
| Fifty Passes | 1.224 | 0.974 | 20.4% |
| One Hundred | 1.224 | 0.978 | 20.1% |
| Passes | | | |

TABLE 32
Cohesion Energy of Synthetic Sea Water Conditioned at −4763 Gauss

| | Untreated | Water Sample | |
|---|---|---|---|
| Synthetic Sea | Cohesion | Conditioned with | Reduction |
| Water | Energy | Experimental Apparatus | in Cohesion |
| (Passes) | (mN/m) | (mN/m) | Energy |
| One Pass | 146.8 | 136.6 | 7.0% |
| Three Passes | 146.8 | 119.7 | 18.5% |
| Five Passes | 146.8 | 108.4 | 26.2% |
| Ten Passes | 146.8 | 95.0 | 35.3% |
| Twenty Passes | 146.8 | 88.9 | 39.4% |
| Fifty Passes | 146.8 | 88.1 | 40.0% |
| One Hundred | 146.8 | 88.2 | 39.9% |
| Passes | | | |

As shown in Tables 30-32, the apparatus and method as disclosed herein provide greater reductions in surface tension, viscosity and cohesion energy for synthetic sea water with increased exposure (passes) to the magnetic field strength of −4763 Gauss; up to 20 passes through the magnetically energized conduit. Additional exposure to the magnetic field strength of −4763 Gauss of more than 20 passes resulted in minimal reduction in the physical properties of the conditioned seawater, and is some instances, a slight dissipation of the effects were recorded. In one particular embodiment, it was determined that controlling the exposure of synthetic sea water to a magnetic field greater than 4,500 gauss as disclosed and/or claimed herein can be utilized to manage the changes in one or more physical properties of the synthetic sea water.

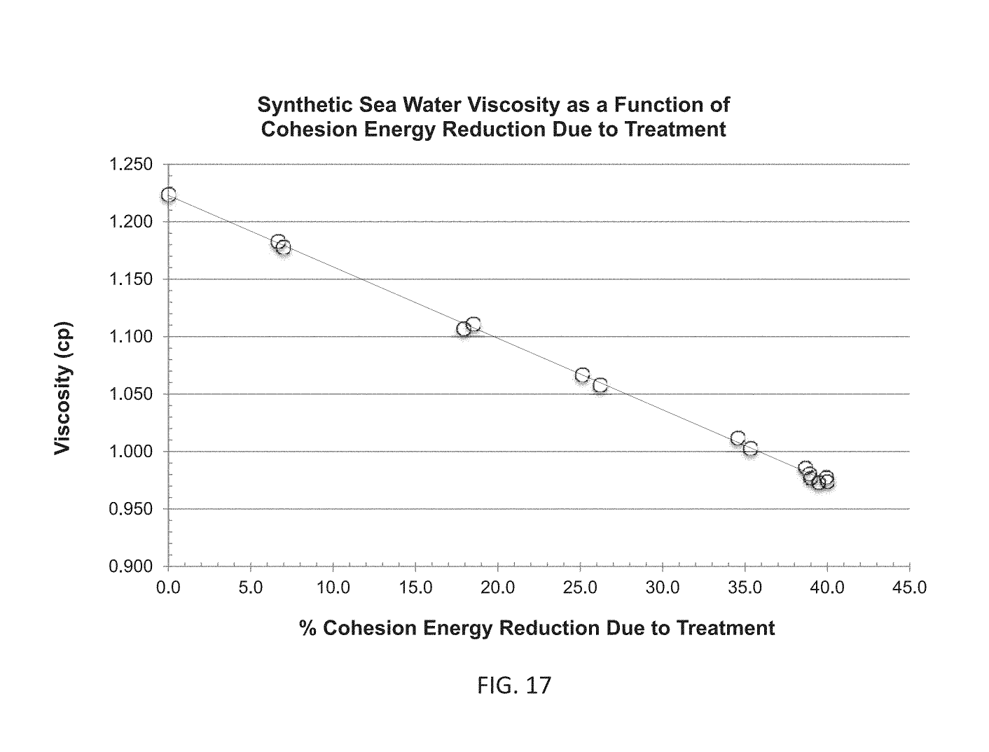

The relationship between the percentage reduction in fluid cohesion energy and the percentage of reduction in viscosity is shown in FIG. 17. Similar reductions in surface tension and viscosity may be anticipated with other fluids containing at least one polar substance.

The apparatus and methods as presently claimed and/or disclosed herein of altering one or more physical properties of synthetic sea water can result in several unexpected properties with regard to the dissipation of the altered physical properties of the synthetic sea water. As illustrated in the following examples, once the values of altered physical properties of the magnetically conditioned synthetic sea water were obtained, a method was determined, as disclosed and/or claimed herein, for measuring how the altered physical properties of the conditioned synthetic sea water would dissipate over time.

Prior to this experiment, little was known regarding the dissipation of the effects of magnetic conditioning. One observation of the dissipation of magnetic conditioning occurred during the initial testing of the synthetic sea water samples the found in Table 3 (above), where the changes in the surface tension and surface polarity of synthetic sea water were determined to have fully dissipated within 36 hours of conditioning of the synthetic sea water with a single pass at laminar flow through a constant magnetic field of about 850 gauss within a magnetically energized conduit inducing a positive polarity, as well as a magnetic field strength of approximately 150 gauss concentrated at each end of the magnetically energized conduit. In a separate observation, analysis of several water and brine samples found in Tables 12-15 (above) approximately 30 days after conditioning with magnetic field strength greater than 4500 gauss indicated approximately 10% of the total changes in surface tension and surface polarity were still evident in samples stored in certified clean glass containers.

As a result of these observations, a study of the dissipation effects of synthetic sea water conditioned by inducing a magnetic field greater than 4,500 gauss was conducted. Experimentation was conducted to determine if one or more altered physical property of the synthetic sea water immediately after conditioning with relative few passes through the magnetically energized conduit was substantially the same as the decayed effects of the altered physical property of the synthetic sea water conditioned with a substantially higher number of passes through the magnetically energized conduit at a given point in time, with analysis conducted to learn if there is hysteresis in the effects of magnetic conditioning of synthetic sea water.

As used herein, hysteresis is defined as a time-based dependence of the retardation of an altered physical property of synthetic sea water conditioned with a magnetic field greater than 4,500 gauss acting upon a polar fluid are changed (surface tension, viscosity and/or cohesion energy), wherein the reaction of the fluid to changes with conditioning by a magnetic field greater than 4,500 gauss is dependent upon its past reactions to change. That is, the lag in a variable physical property of a polar fluid with respect to the magnetic conditioning effect produces one or more changes in the physical properties of a polar fluid as the magnetic conditioning effect varies. In this respect, hysteresis of a polar fluid is analogous to the lagging in the values of resulting magnetization in a magnetic material (such as iron) due to a changing magnetizing force, in which the reaction of the magnetic material to changes is dependent upon its past reactions to change in the magnetizing force.

The “Experimental Apparatus” and method described above at a turbulent flow (i.e., a Reynolds number of 5430) through a pulsed magnetic field of about 4772 gauss inducing a positive polarity and a pulsed magnetic field of about −4763 gauss inducing a negative polarity. Again, the effects of inducing both a positive and a negative polarity provided substantially equal reductions in the dispersive component of the surface tension of the samples, but opposite with regard to the acid/base components of surface tension effect of first inducing a positive polarity and then inducing a negative polarity.

As previously disclosed, maximum reductions in surface tension, viscosity and cohesion energy were achieved after 20 passes with turbulent flow through the magnetically energized conduit inducing a pulsed magnetic field approximately 4750 Gauss having a negative polarity; and samples directed to make 50 passes and 100 passes through the magnetically energized conduit provided no significant reductions in the physical properties of the conditioned synthetic sea water.

To explore hysteresis, as previously described, it was determined the dissipation of one or more changes in the physical properties of synthetic sea water conditioned with less than maximum conditioning effects should be studies with the dissipation of one or more changes in the physical properties of synthetic sea water conditioned with more than maximum conditioning effects. The effects of magnetic conditioning of four samples of synthetic sea water with 5 passes through a pulsed magnetic field greater than 4,500 gauss having a negative polarity and a positive polarity were compared with of magnetic conditioning of synthetic sea water with 100 passes through a pulsed magnetic field greater than 4,500 gauss having a negative polarity and a positive polarity to learn if a value for an altered physical property of conditioned synthetic sea water was consistent with a substantially level of conditioning of that water at a given point in time. Conditioning parameters were chosen to follow samples exposed to more than maximum conditioning through a range of surface tensions and viscosities and learn if samples exposed to less than maximum conditioning experienced similar rates of dissipation in changes to one or more physical properties. The dissipation of the effects of reduced surface tension of synthetic sea water are shown in Table 33 below.

TABLE 33
Dissipation of Magnetic Conditioning
Effects of Synthetic Sea Water

| | | | Mea- | Test | |
|---|---|---|---|---|---|
| | | | sured | Time | Average |
| | Treatment | Effective | Gauss | Post- | Surface |
| | Reynold's | Treatment | Field | Treatment | Tension |
| Treatment | # | Passes | (Gauss) | (hours) | (mN/m) |
| Turbulent, | 5430 | 5 | +4772 | 1 | 59.18 |
| 5 pass, +, Pulsed | | | | | |
| Turbulent, | 5430 | 5 | +4772 | 3 | 59.27 |
| 5 pass, +, Pulsed | | | | | |
| Turbulent, | 5430 | 5 | +4772 | 6 | 59.40 |
| 5 pass, +, Pulsed | | | | | |
| Turbulent, | 5430 | 5 | +4772 | 12 | 59.67 |
| 5 pass, +, Pulsed | | | | | |
| Turbulent, | 5430 | 5 | +4772 | 24 | 60.19 |
| 5 pass, +, Pulsed | | | | | |
| Turbulent, | 5430 | 5 | +4772 | 48 | 61.16 |
| 5 pass, +, Pulsed | | | | | |
| Turbulent, | 5430 | 5 | +4772 | 96 | 62.91 |
| 5 pass, +, Pulsed | | | | | |
| Turbulent, | 5430 | 5 | +4772 | 168 | 65.07 |
| 5 pass, +, Pulsed | | | | | |
| Turbulent, | 5430 | 5 | +4772 | 336 | 68.53 |
| 5 pass, +, Pulsed | | | | | |
| Turbulent, | 5430 | 5 | +4772 | 720 | 71.98 |
| 5 pass, +, Pulsed | | | | | |
| Turbulent, | 5430 | 5 | −4763 | 1 | 58.76 |
| 5 pass, +, Pulsed | | | | | |
| Turbulent, | 5430 | 5 | −4763 | 3 | 58.85 |
| 5 pass, +, Pulsed | | | | | |
| Turbulent, | 5430 | 5 | −4763 | 6 | 58.99 |
| 5 pass, +, Pulsed | | | | | |
| Turbulent, | 5430 | 5 | −4763 | 12 | 59.26 |
| 5 pass, +, Pulsed | | | | | |
| Turbulent, | 5430 | 5 | −4763 | 24 | 59.80 |
| 5 pass, +, Pulsed | | | | | |
| Turbulent, | 5430 | 5 | −4763 | 48 | 60.80 |
| 5 pass, +, Pulsed | | | | | |
| Turbulent, | 5430 | 5 | −4763 | 96 | 62.59 |
| 5 pass, +, Pulsed | | | | | |
| Turbulent, | 5430 | 5 | −4763 | 168 | 64.82 |
| 5 pass, +, Pulsed | | | | | |
| Turbulent, | 5430 | 5 | −4763 | 336 | 68.38 |
| 5 pass, +, Pulsed | | | | | |
| Turbulent, | 5430 | 5 | −4763 | 720 | 71.93 |
| 5 pass, +, Pulsed | | | | | |
| Turbulent, 100 | 5430 | 100 | +4772 | 1 | 51.33 |
| pass, +, Pulsed | | | | | |
| Turbulent, 100 | 5430 | 100 | +4772 | 3 | 51.47 |
| pass, +, Pulsed | | | | | |
| Turbulent, 100 | 5430 | 100 | +4772 | 6 | 51.68 |
| pass, +, Pulsed | | | | | |
| Turbulent, 100 | 5430 | 100 | +4772 | 12 | 52.09 |
| pass, +, Pulsed | | | | | |
| Turbulent, 100 | 5430 | 100 | +4772 | 24 | 52.90 |
| pass, +, Pulsed | | | | | |
| Turbulent, 100 | 5430 | 100 | +4772 | 48 | 54.41 |
| pass, +, Pulsed | | | | | |
| Turbulent, 100 | 5430 | 100 | +4772 | 96 | 57.12 |
| pass, +, Pulsed | | | | | |
| Turbulent, 100 | 5430 | 100 | +4772 | 168 | 60.47 |
| pass, +, Pulsed | | | | | |
| Turbulent, 100 | 5430 | 100 | +4772 | 336 | 65.85 |
| pass, +, Pulsed | | | | | |
| Turbulent, 100 | 5430 | 100 | +4772 | 720 | 71.20 |
| pass, +, Pulsed | | | | | |
| Turbulent, 100 | 5430 | 100 | −4763 | 1 | 50.91 |
| pass, +, Pulsed | | | | | |
| Turbulent, 100 | 5430 | 100 | −4763 | 3 | 51.06 |
| pass, +, Pulsed | | | | | |
| Turbulent, 100 | 5430 | 100 | −4763 | 6 | 51.27 |
| pass, +, Pulsed | | | | | |
| Turbulent, 100 | 5430 | 100 | −4763 | 12 | 51.69 |
| pass, +, Pulsed | | | | | |
| Turbulent, 100 | 5430 | 100 | −4763 | 24 | 52.51 |
| pass, +, Pulsed | | | | | |
| Turbulent, 100 | 5430 | 100 | −4763 | 48 | 54.05 |
| pass, +, Pulsed | | | | | |
| Turbulent, 100 | 5430 | 100 | −4763 | 96 | 56.80 |
| pass, +, Pulsed | | | | | |
| Turbulent, 100 | 5430 | 100 | −4763 | 168 | 60.22 |
| pass, +, Pulsed | | | | | |
| Turbulent, 100 | 5430 | 100 | −4763 | 336 | 65.70 |
| pass, +, Pulsed | | | | | |
| Turbulent, 100 | 5430 | 100 | −4763 | 720 | 71.14 |
| pass, +, Pulsed | | | | | |

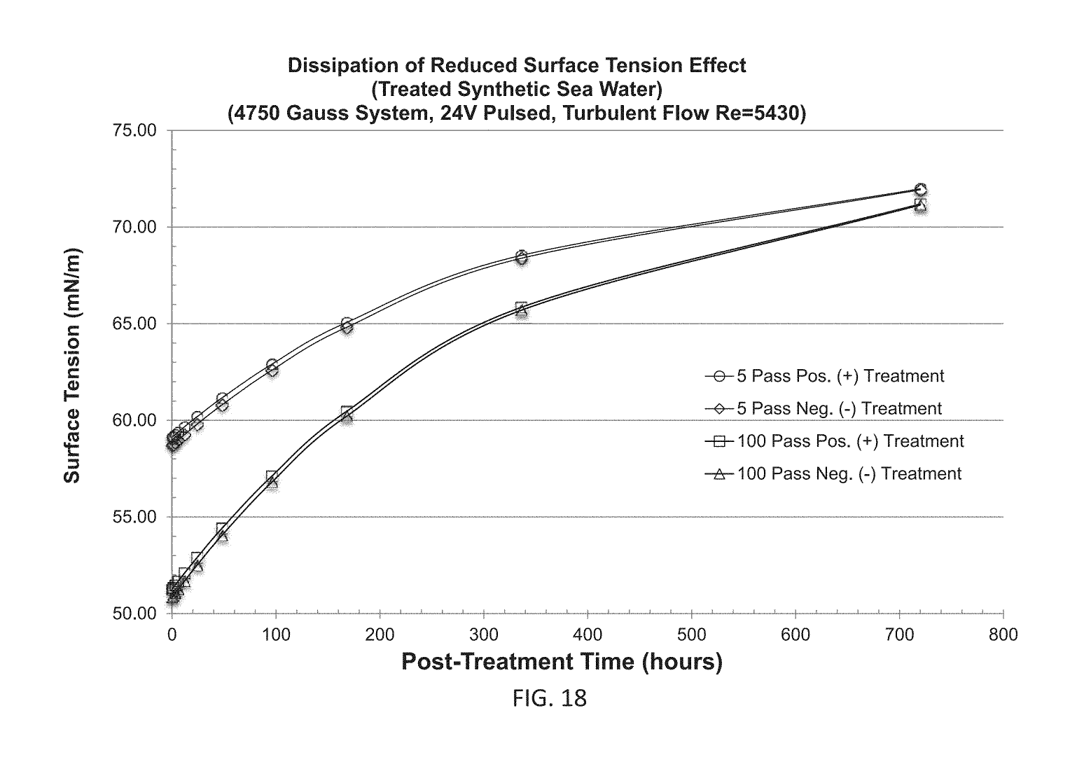

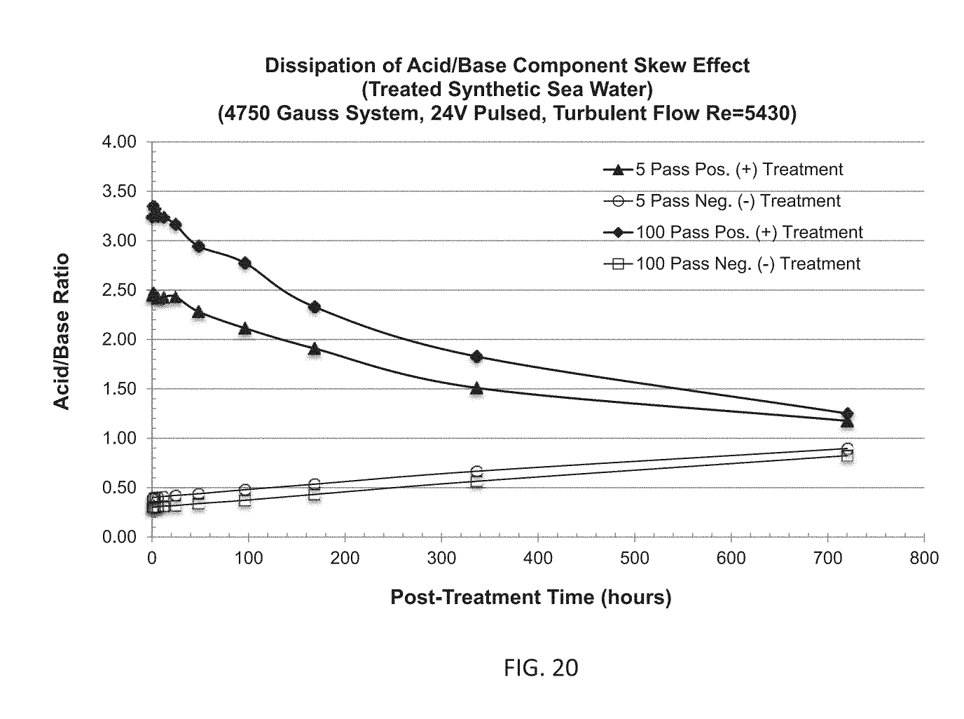

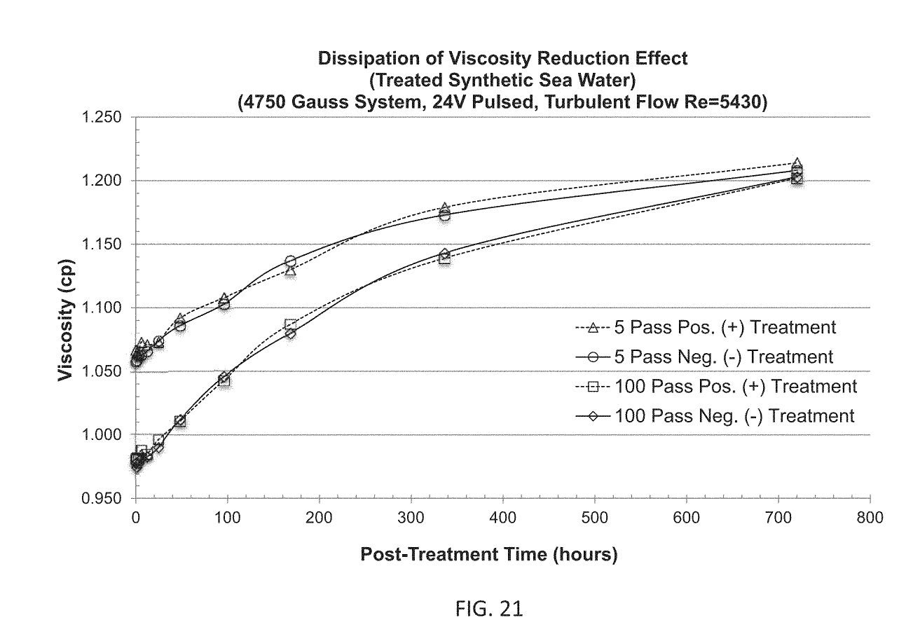

In one particular embodiment, it was determined that the method of magnetically conditioning synthetic sea water as disclosed and/or claimed herein can be manipulated to control the change in the altered one or more physical properties of the synthetic seawater before an altered physical property begins to dissipate and return to its untreated physical property value. FIGS. 18-21 show the dissipation of changes to one or more physical properties tests over 1 month, including the following test times after conditioning: 1 hour, 3 hours, 6 hours, 12 hours, 24 hours, 48 hours, 96 hours (4 days), 168 hours (1 week), and 336 hours (2 weeks), 720 hours (1 month).

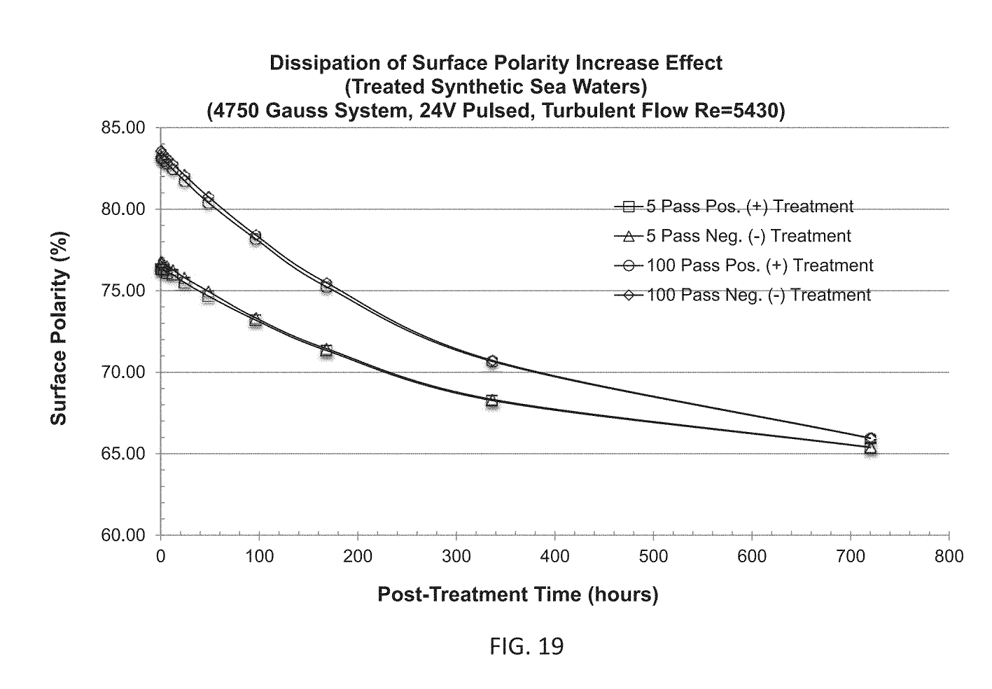

The overall surface tension values of the two samples conditioned with 100 passes increased from approximately 51 mN/m to approximately 71 mN/m in one month, and the overall surface tension of the two samples conditioned with 5 pass increased from approximately 59 mN/m to approximately 71.5 mN/m in the first month. Similar dissipation is shown in following FIGS. 19-21. For example, overall surface polarity values of the two samples conditioned with 100 passes decreased from approximately 83% to approximately 66% in one month, and the overall surface polarity values of the two samples conditioned with 5 pass decreased from approximately 76% to approximately 65% in the first month.

An important aspect of this study was to determine if hysteresis exists between different numbers of passes of synthetic sea water exposed to less than maximum conditioning parameters (in this instance, 5 passes) and more than maximum conditioning parameters (in this instance, 100 passes).

Superimposing of the 5 pass dissipation curves over the 100 pass dissipation curves indicated that at approximately 140 hours into the dissipation of the changes in the physical properties of synthetic sea water conditioned with 100 passes through a pulsed magnetic field greater than 4,500 gauss, the dissipation of the changes in the physical properties of synthetic sea water conditioned with 5 passes was substantially identical; indicating a lack of hysteresis.

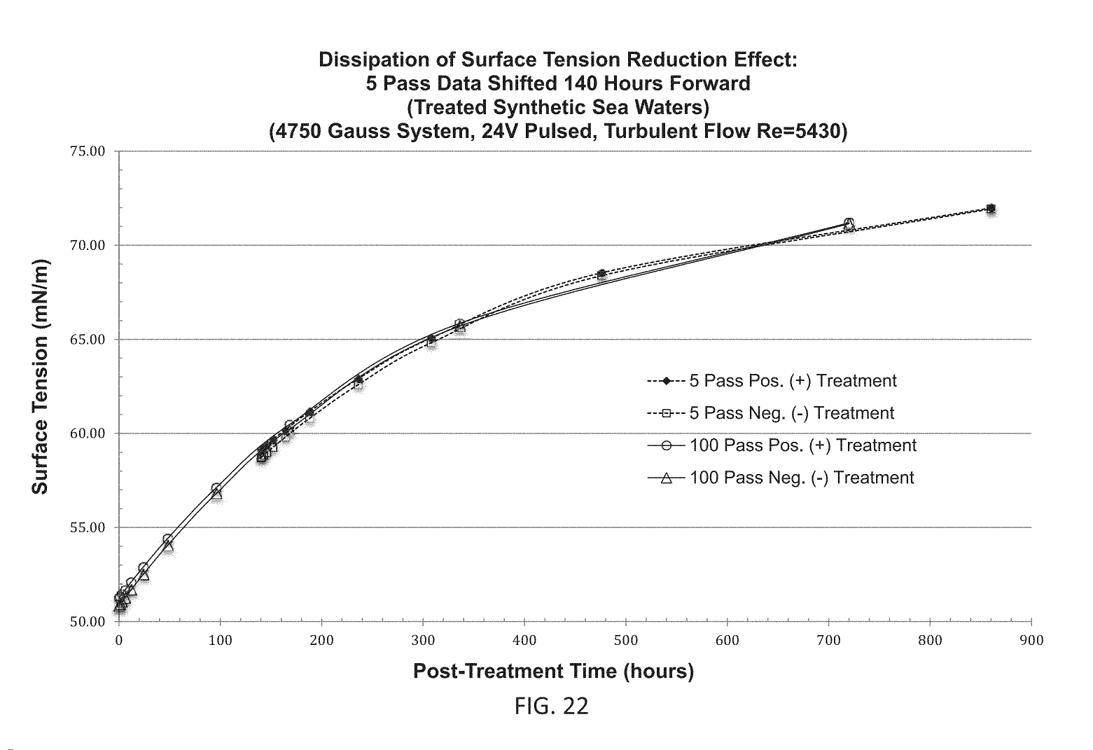

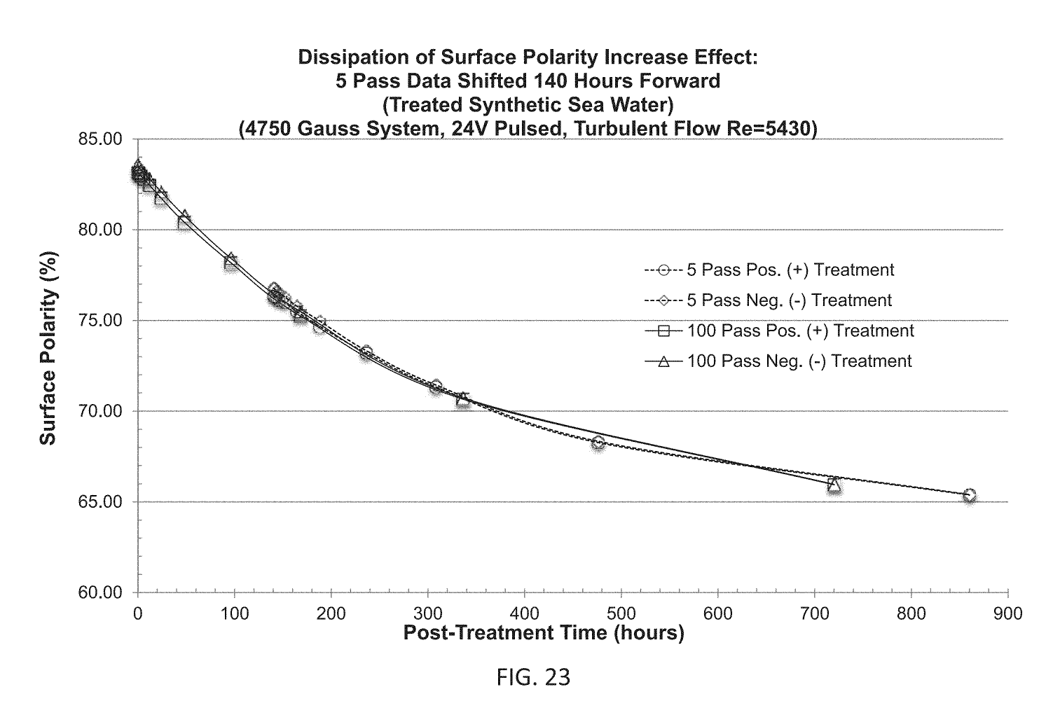

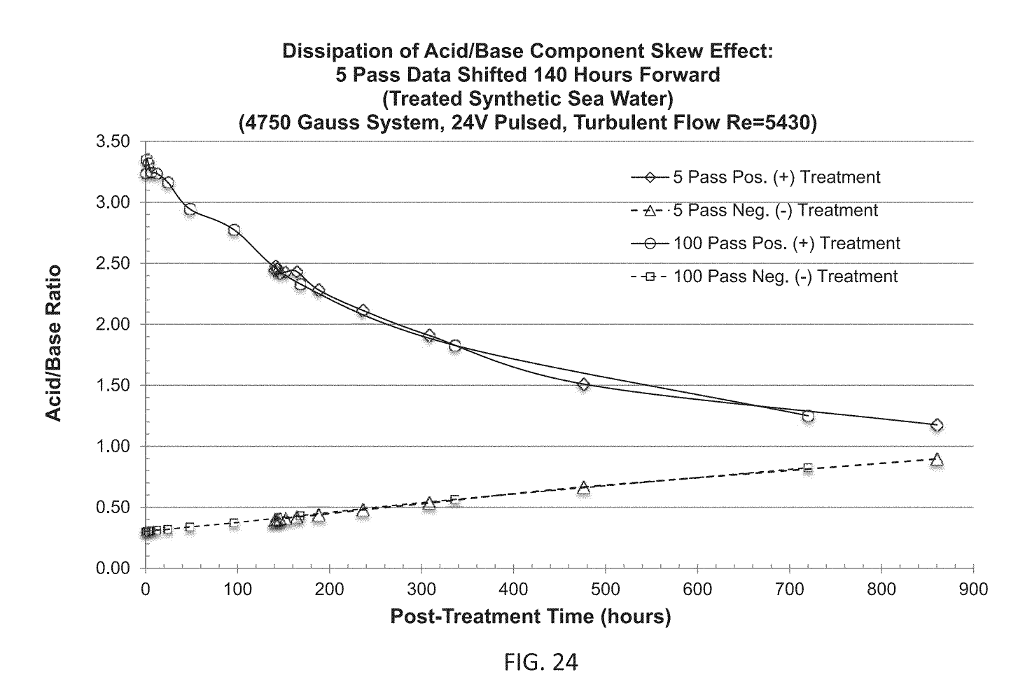

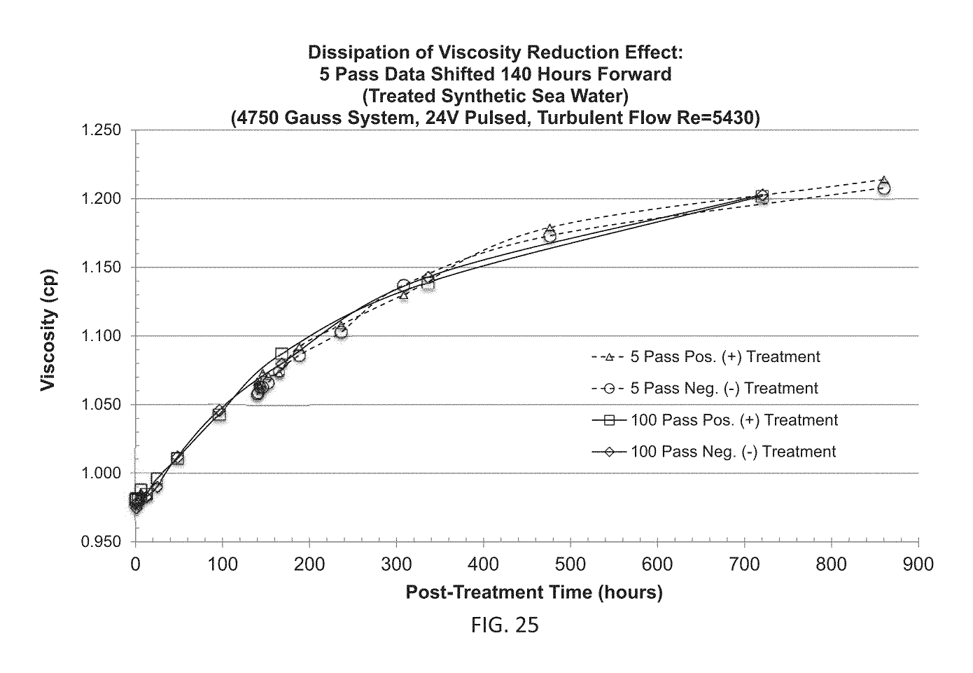

FIGS. 22-25 show the measured changes in the physical properties of synthetic sea water conditioned with 5 passes superimposed over the measured changes in the physical properties of synthetic sea water conditioned with 100 passes.

It has been discovered that after 140 hours, the values and dissipation rates of the altered physical properties of synthetic sea water conditioned with 100 passes through a pulsed magnetic field greater than 4,500 gauss was substantially identical to the values and dissipation rates of the altered physical properties of synthetic sea water conditioned with 5 passes through a pulsed magnetic field greater than 4,500 gauss; and that hysteresis does not exist between changes in the physical properties of synthetic sea water conditioned with 5 passes and 100 passes.

Field Tests Subjecting the Fluid containing at Least One Polar Substance to Higher Gauss Levels

The presently claimed and/or disclosed inventive concepts of increasing the efficiency of phase separation of a dissimilar material from a fluid mixture (e.g., water flowing back to the surface after being utilized in hydraulic fracturing of a formation as well as produced water and crude oil from a hydrocarbon producing formation) were quantified in a first field test example at gauss levels of about 7500, as follows:

An oilfield operator was processing flowback fluid from newly completed oil and natural gas producing wells immediately after the hydraulic fracturing of hydrocarbon producing formations. These flowback fluid mixtures typically comprised between 8.9% to 24.8% crude oil in the production fluids, with the remaining percentage of the flowback fluids comprising water and suspended solids flowing from the hydraulically fractured formations. Prior to being directed through a portable four-phase separator, the frac flowback fluid mixtures were directed to pass through a sand trap where the bulk of the proppants and other suspended solids in the production fluid were collected for disposal.

Downstream of the sand trap, the flowback fluids were each directed through the inlet port of small, portable four-phase separation apparatus designed to capture and separate marketable oil and natural gas from the water utilized in hydraulic fracturing of the formations. Water flowing back to the surface after being utilized in hydraulic fracturing of a formation, produced water from the formation and suspended solids, were simultaneously separated from the frac flowback fluid and collected for disposal while permanent oilfield production equipment was erected at each new production site. The frac flowback fluid mixtures flowed through the portable four-phase separators at approximately 20-30 barrels per hour. Oil discharged from the separators was collected in storage tanks, natural gas discharged from the separators was directed to pipelines for sale and suspended solids in the frac flowback fluid were collected within the base of the separators and periodically discharged and collected for disposal. Water discharged from the separators was directed to water collection tanks prior to being transported to off-site saltwater disposal wells, where the water was injected into non-producing formations. Approximately 1.5%-4.8% oil was typically found in the water discharged from the portable, undersized separators, allowing disposal well operators to recover and collect these trace amounts of oil from the water transported to the off-site disposal facilities prior to injecting the water into non-producing formations. The disposal well operators then marketed the oil they had collected from the water.

The field trial apparatus utilized to generate the magnetically conditioned samples of the “first field test example at about 7500 gauss” comprised a serial connection of an embodiment of the presently claimed and/or disclosed magnetically conductive conduit having inside diameters of approximately 2″ were installed in the fluid flow line downstream of the sand traps and immediately upstream of the inlets of the undersized four-phases separators. Each magnetically conductive conduit utilized to generate the magnetically conditioned samples comprised a first serial coupling of conduit segments having an outside diameter of approximately 6.635″ and a length of approximately 36″, the first serial coupling of conduit segments further comprising a non-magnetically conductive conduit segment axially aligned between two magnetically conductive conduit segments, each conduit segment having a wall thickness of approximately 0.432″. The non-magnetically conductive segment was bored out with a 45° chamfer on each end to match the ends of the magnetically conductive segments that were turned down with 45° chamfers prior to coupling the segments to form a 6″ magnetically conductive coil core.

Six coils encircled at least a section of the outer surface of the 6″ coil core, with each coil formed by winding 15 turns of a length of 0.114″×0.162″ electrical conductor to form a layer approximately 2.5″ in length, and then adding 19 more layers to form a continuous coil having a total of 300 turns, wherein the length to diameter ratio of the coil was approximately 1:5.

The coils were enclosed within a protective housing having an 18″ diameter, said housing comprising a length of 18″ conduit having an inner surface and an outer surface and a proximal end and a distal end, the housing further comprising end plates on each end of the housing with the outer edge of each end plate disposed in fluid communication with an end of the 18″ conduit and the inner edge the end plate in fluid communication with the outer surface of an outboard segment of 6″ coil core.

A second serial coupling of conduit segments having an outside diameter of approximately 2.875″ and a length of approximately 48″ was formed with three non-magnetically conductive conduit segments interleaved between four magnetically conductive conduit segments, each conduit segment having a wall thickness of approximately 0.276″. The non-magnetically conductive segments were bored out with a 45° chamfer on each end to match the ends of the magnetically conductive segments that were turned down with 45° chamfers prior to coupling the segments to form the 2.875″ magnetically conductive fluid flow conduit. To increase the thickness and density of the second serial coupling of conduit segments, the intermediate segments of magnetically conductive conduit of the fluid flow conduit were sleeved with third segments of magnetically conductive material having an outside diameter of approximately 5.700″ and an inside diameter of approximately 2.95″ and having a wall thickness of approximately 1.4″. The fluid flow conduit was sleeved within the coil core and disposed with the intermediate non-magnetically conductive segment of the 2.875″ magnetically conductive fluid flow conduit being aligned within the non-magnetically conductive segment of the 6″ coil core.

A serial connection of a first 2.875″ fluid flow conduit sleeved with a first 6″ coil core and a second 2.875″ fluid flow conduit sleeved with a second 6″ coil core was formed. The coiled electrical conductors encircling the coil cores were energized with 24 VDC of electrical energy pulsed at 120 Hz and drew approximately 17 amps of electrical energy. The frac flowback fluid mixtures directed to pass through a separator made only one pass through the magnetically energized conduit generating a magnetic field strength of approximately 7500 gauss concentrated within the intermediate non-magnetically conductive segment of each fluid flow conduit, as well as a magnetic field strength of approximately 2400 gauss concentrated within each outboard non-magnetically conductive segment of each magnetically energized fluid flow conduit.

Unlike the 1.5%-4.8% of oil in water previously discharged from the portable, undersized separators, 1.5 ppm-69.1 ppm of oil was found in water discharged from the separators (a 99.99% reduction of oil in water discharged from the separator). Such results are shown in Table 34.

TABLE 34
Fluids Conditioned at about 7500 Gauss
Oil Recovery from Oilfield Flowback Fluid
Untreated and Magnetically Conditioned (Flowing through Magnet)

| | | | Oil in Water | |
|---|---|---|---|---|
| | | Oil in Water | Discharged | |
| | | Discharged | from | |
| | | from | Oil/Water | |
| | Oil in Oilfield | Oil/Water | Separator | Improved |
| Test | Flowback | Separator | (Magnetically | Separation |
| Well # | Production Fluid | (Untreated) | Conditioned) | Efficiency |
| 1 | 23.5% | 1.7%-3.2% | 1.5 ppm | 99.99% |
| 2 | 8.9% | 1.5%-2.1% | 69.1 ppm | 99.99% |
| 3 | 12.8% | 1.8%-2.9% | 5.6 ppm | 99.99% |
| 4 | 20.1% | 2.3%-4.7% | 12.0 ppm | 99.99% |

The presently claimed and/or disclosed inventive concepts also include a method of increasing the rate by which a dissimilar material separates from a fluid mixture, including the steps of passing a fluid mixture (i.e., a mixture comprising a fluid containing at least one polar substance and at least one dissimilar material, as defined above) through a magnetically conductive conduit having magnetic energy directed along the longitudinal axis of the magnetically energized conduit and extending through at least a portion of the first fluid mixture thereby providing a conditioned fluid medium; and separating the conditioned fluid medium into at least two distinct phases in a separation apparatus downstream of the magnetically conductive conduit, wherein the at least one dissimilar material separates from the conditioned fluid medium at an increased rate as compared to a rate of separation of the at least one dissimilar material from the non-magnetically conditioned fluid mixture.

Second Experimental Field Test at about 7500 Gauss

In addition to the first experimental field trial identified above having gauss levels of about 7500, second field trial having gauss levels of about 7500 was undertaken to quantify the increase in the rate at which crude oil (i.e., a dissimilar material) separates from produced water (i.e., a fluid containing at least one polar substance) in a fluid mixture using the general methods and apparatus disclosed above. The results as well as the specifics of the method and apparatus are as follows:

An oilfield operator was processing a production fluid mixture having an average of 99.02% water and 0.08% crude oil through an oil/water separator at a flow rate of approximately 20,000 barrels of fluid per 24-hour day. The operator had experienced difficulty in achieving adequate oil/water separation for decades due to submersible pumps used to propel the production fluid to the surface creating heavy oil/water emulsions. In an effort to improve separation, a common demulsifying chemical was injected into the emulsified production fluid at the wellheads of each of the nine wells connected to a central processing facility. Absent chemical treatment, the facility's 3-phase separator lacked sufficient retention time to effectively separate the 26 API oil from the produced water, and even with the use of demulsifying chemicals, a consistent emulsion remained at the oil/water interface layer within the separator.

Oil discharged from the separator was collected in oil storage tanks for sale as a commodity and water discharged from the separator and retaining an average of 43 ppm oil was directed to a water collection tank that accumulated the water prior it to being injected back into a disposal well. A portion of the oil in the water directed to the water tank typically floated to the surface of the collection tanks and was skimmed off for sale, resulting in an average of an average of 19 ppm of oil remaining in the water injected into the disposal well.

In an effort to reduce the amount of costly demulsifying process chemicals, a serial connection of an embodiment of the presently claimed and/or disclosed magnetically conductive conduit having inside diameters of approximately 5″ was installed in the production flow line immediately upstream of the inlet of the separator. Each magnetically conductive conduit utilized to generate the magnetically conditioned samples comprised a first serial coupling of conduit segments having an outside diameter of approximately 6.635″ and a length of approximately 36″, the first serial coupling of conduit segments further comprising a non-magnetically conductive conduit segment axially aligned between two magnetically conductive conduit segments, each conduit segment having a wall thickness of approximately 0.432″. The non-magnetically conductive segment was bored out with a 45° chamfer on each end to match the ends of the magnetically conductive segments that were turned down with 45° chamfers prior to coupling the segments to form a 6″ magnetically conductive coil core.

Six coils encircled at least a section of the outer surface of the 6″ coil core, with each coil formed by winding 15 turns of a length of 0.114″×0.162″ electrical conductor to form a layer approximately 2.5″ in length, and then adding 19 more layers to form a continuous coil having a total of 300 turns, wherein the length to diameter ratio of the coil was approximately 1:5.

The coils were enclosed within a protective housing having an 18″ diameter, said housing comprising a length of 18″ conduit having an inner surface and an outer surface and a proximal end and a distal end, the housing further comprising end plates on each end of the housing with the outer edge of each end plate disposed in fluid communication with an end of the 18″ conduit and the inner edge the end plate in fluid communication with the outer surface of an outboard segment of 6″ coil core.

A second serial coupling of conduit segments having an outside diameter of approximately 5.563″ and a length of approximately 48″ was formed with three non-magnetically conductive conduit segments interleaved between four magnetically conductive conduit segments, each conduit segment having a wall thickness of approximately 0.750″. The non-magnetically conductive segments were bored out with a 45° chamfer on each end to match the ends of the magnetically conductive segments that were turned down with 45° chamfers prior to coupling the segments to form the 5.563″ magnetically conductive fluid flow conduit. The fluid flow conduit was sleeved within the coil core with the intermediate non-magnetically conductive segment of the 5.563″ fluid flow conduit being aligned within the non-magnetically conductive segment of the 6″ coil core.

A serial connection of a first 5.563″ magnetically conductive conduit. sleeved with a first 6″ coil core and a second 5.563″ magnetically conductive conduit sleeved with a second 6″ coil core was formed, wherein the coiled electrical conductors encircling the magnetically conductive conduits were then energized with 24 VDC of electrical energy pulsed at 120 Hz and approximately 18 amps of electrical energy. The emulsified oilfield production fluid mixture was directed to make a single pass through areas of magnetic conditioning concentrated along a path extending through the electrical conductor encircling the outer surface of the magnetically energized conduit and generating a magnetic field strength of approximately 7500 gauss concentrated within the intermediate non-magnetically conductive segment of the magnetically conductive conduit, as well as a magnetic field strength of approximately 2400 gauss concentrated within each outboard non-magnetically conductive segment of the magnetically energized conduit prior to passing through a separator.

After installing an embodiment of the presently claimed and/or disclosed magnetically conductive conduit immediately upstream of the separator, the rate of injecting the demulsifier into the production fluid was gradually reduced until it was completely removed from the production process.

In addition to eliminating demulsifying chemicals, directing the production fluid to make a single pass through a serial array of magnetically conductive conduits having magnetic energy directed along the longitudinal axis of the magnetically energized conduits and extending through at least a portion of the production fluid to provide a conditioned fluid medium allowed the crude oil to separate from the produced water in the conditioned fluid medium at an increased rate as compared to a rate of separation of the crude oil from produced water in the unconditioned production fluid so that an average of 22 ppm of oil was found in water discharged from the separator (a 48.8% reduction of oil in water) and an average of 6 ppm of oil was found in the water injected into the disposal well (a 68.4% reduction of oil in water). Such results are shown in Table 35.

TABLE 35
Fluids Conditioned at about 7500 Gauss
Oil Recovery from Oilfield Production Fluid Comprising 99.6%
Water and 0.4% Oil Untreated and Magnetic Conditioning
(Flow through Magnetically Energized Conduit)

| | | | Oil in | | |
|---|---|---|---|---|---|
| Oil in | Oil in | | Untreated | Oil in | |
| Untreated | Conditioned | | Produced | Conditioned | |
| Production | Production | Reduction | Water | Produced | |
| Fluid | Fluid | of Oil | Discharged | Water | Reduction |
| Discharged | Discharged | in Water | from Water | Discharged | of Oil |
| from Oil/Water | from Oil/Water | Discharged | Tank Using | from Water | in Water |
| Separator | Separator | from | Chemicals | Tank | Discharged |
| Using | Without | Oil/Water | Using | Without | from Water |
| Chemicals | Chemicals | Separator | Chemicals | Chemicals | Tank |
| 43 ppm | 22 ppm | 48.8% | 19 ppm | 6 ppm | 68.4% |

The presently claimed and/or disclosed inventive concepts further include an apparatus for altering at least one physical property of a fluid containing at least one polar substance flowing under pressure at ambient temperature, including a magnetically conductive conduit having magnetic energy directed along the longitudinal axis of a magnetically energized conduit and extending through at least a portion of the magnetically conductive conduit. The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit.

In each embodiment of the presently claimed and/or disclosed inventive concepts for altering at least one physical property of a fluid containing at least one polar substance flowing under pressure at ambient temperature, it can be appreciated that magnetic energy may be concentrated in a plurality of distinct areas along the longitudinal axis of the magnetically energized conduit.

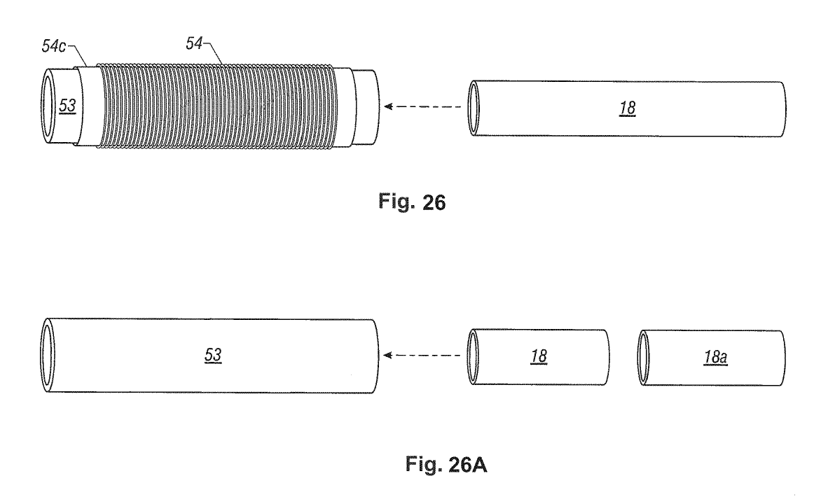

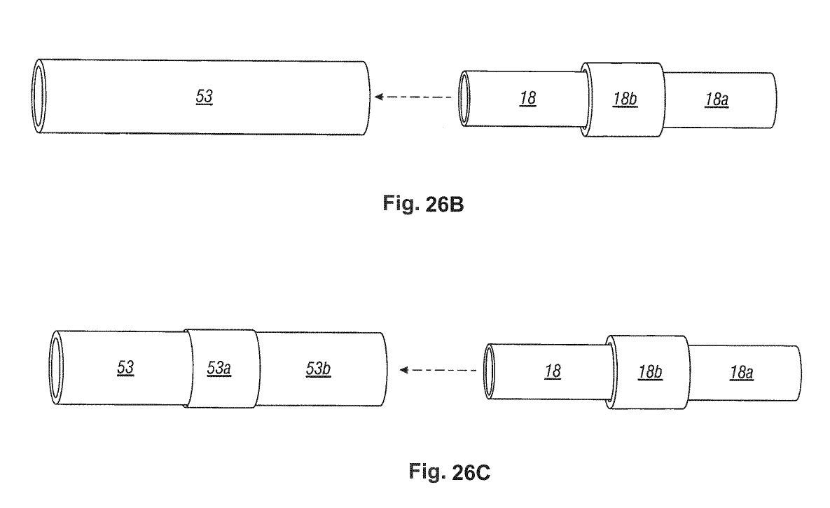

Increasing the density and thickness of the fluid impervious boundary wall of the magnetically conductive conduit typically results in greater concentrations of magnetic energy within each section of magnetically conductive conduit and non-magnetically conductive regions established between magnetically conductive conduits. Embodiment of the magnetically conductive conduit wherein at least one length of magnetically conductive material sleeves at least one additional length of magnetically conductive material may be utilized to increase the density and thickness of the fluid impervious boundary wall of the magnetically conductive conduit. FIG. 26 is an exploded view of one embodiment of the magnetically conductive conduit having more than one length of magnetically conductive material forming the magnetically conductive conduit comprising a first length of magnetically conductive conduit segment 53 adapted to sleeve second length of magnetically conductive conduit segment 18, whereby at least a section of the inner surface of the boundary wall of magnetically conductive conduit segment 53 may be coaxially disposed in substantially concentric surrounding relation to at least a section of the outer surface of the boundary wall of magnetically conductive conduit segment 18. The inner surface of the boundary wall of conduit segment 18 establishes a fluid flow path extending along the longitudinal axis of the magnetically conductive conduit. Coiled electrical conductor 54 is shown encircling coil core 54c.

Coil core 54c is shown sleeving a section of conduit segment 53 so that at least one turn of the coiled electrical conductor encircles at least a section of the outer surface of magnetically conductive conduit segment 53. As magnetically conductive conduit segment 53 sleeves magnetically conductive conduit segment 18, at least one turn of the coiled electrical conductor may encircle at least a section of each length of magnetically conductive material with at least one turn of the electrical conductor oriented substantially orthogonal to the fluid flow path extending through the magnetically conductive conduit.

In some embodiments, the coil core 54c may comprise a serial coupling (not shown) of a first magnetically conductive coil core section, a non-magnetically conductive intermediate coil core section and a second magnetically conductive coil core section, each coil core section having a length of material defining a fluid impervious boundary wall with an inner surface and an outer surface and having a port at the proximal end of the coil core section and a port at the distal end of the coil core section. The at least one coiled electrical conductor 54 may encircle at least a section of the outer surface of at least one section of the serial coupling of coil core sections with at least one turn of the electrical conductor 54 oriented substantially orthogonal to the longitudinal axis of the serial coupling of coil core sections.

FIG. 26A is an exploded view of one embodiment of the magnetically conductive conduit having more than one length of magnetically conductive material forming the magnetically conductive conduit with magnetically conductive conduit segment 53 adapted to sleeve the non-contiguous array of magnetically conductive conduit segment 18 and magnetically conductive conduit segment 18a, whereby at least a section of the inner surface of the boundary wall of magnetically conductive conduit segment 53 may be coaxially disposed in substantially concentric surrounding relation to at least a section of the outer surface of the boundary wall of magnetically conductive conduit segment 18, a non-magnetically conductive region between the distal end of magnetically conductive conduit segment 18 and the proximal end of magnetically conductive conduit segment 18a, and at least a section of the outer surface of the boundary wall of magnetically conductive conduit segment 18a.

A spacer (not shown) made of a non-magnetically conductive material may be utilized to maintain the non-magnetically conductive region between the distal end of magnetically conductive conduit segment 18 and the proximal end of magnetically conductive conduit segment 18a. The inner surfaces of the boundary walls of magnetically conductive conduit segment 18 and magnetically conductive conduit segment 18a establish a flow path extending along the longitudinal axis of the magnetically conductive conduit. As magnetically conductive conduit segment 53 sleeves the non-contiguous array of magnetically conductive conduit segment 18 and magnetically conductive conduit segment 18a, at least one turn of at least one coiled electrical conductor encircling at least a section of the outer surface of magnetically conductive conduit segment 53 may encircle at least a section of each length of magnetically conductive material with at least one turn of the electrical conductor oriented substantially orthogonal to the fluid flow path extending through the magnetically conductive conduit.

FIG. 26B schematically depicts an alternate embodiment of the magnetically conductive conduit having more than one length of magnetically conductive material forming the magnetically conductive conduit with magnetically conductive conduit segment 53 adapted to sleeve a serial coupling of magnetically conductive conduit segment 18, non-magnetically conductive conduit segment 18b and magnetically conductive conduit segment 18a. The inner surfaces of the boundary walls of magnetically conductive conduit segment 18, non-magnetically conductive conduit segment 18b and magnetically conductive conduit segment 18a establish a fluid flow path extending along the longitudinal axis of the magnetically conductive conduit. As magnetically conductive conduit segment 53 sleeves the serial coupling of magnetically conductive conduit segment 18, non-magnetically conductive conduit segment 18b and magnetically conductive conduit segment 18a, at least one turn of at least one coiled electrical conductor encircling at least a section of the outer surface of magnetically conductive conduit segment 53 may encircle at least a section of each length of magnetically conductive material with at least one turn of the electrical conductor oriented substantially orthogonal to the fluid flow path extending through the magnetically conductive conduit. In an alternate embodiment of the magnetically conductive conduit having more than one length of magnetically conductive material forming the magnetically conductive conduit, a first segment of magnetically conductive material may be adapted to sleeve at least a section of the outer surface of magnetically conductive conduit segment 18 and a second segment of magnetically conductive material may be adapted to sleeve at least a section of the outer surface of magnetically conductive conduit segment 18a.

FIG. 26C schematically depicts an alternate embodiment of the magnetically conductive conduit having more than one length of magnetically conductive material forming the magnetically conductive conduit with an exploded view of first serial coupling of magnetically conductive conduit segment 53, non-magnetically conductive conduit segment 53a and magnetically conductive conduit segment 53b adapted to sleeve second serial coupling of magnetically conductive conduit segment 18, non-magnetically conductive conduit segment 18b and magnetically conductive conduit segment 18a. The inner surfaces of the boundary walls of magnetically conductive conduit segment 18, non-magnetically conductive conduit segment 18b and magnetically conductive conduit segment 18a establish a fluid flow path extending along the longitudinal axis of the magnetically conductive conduit. As magnetically conductive conduit segment 53, non-magnetically conductive conduit segment 53a and magnetically conductive conduit segment 53b sleeve magnetically conductive conduit segment 18, non-magnetically conductive conduit segment 18b and magnetically conductive conduit segment 18a, at least one turn of at least one coiled electrical conductor may encircle at least a section of a length of magnetically conductive material with at least one turn of the electrical conductor oriented substantially orthogonal to the fluid flow path extending through the magnetically conductive conduit.

In embodiments of the presently claimed and/or disclosed inventive concepts having at least one first length of magnetically conductive conduit adapted to sleeved at least one second length of magnetically conductive conduit, at least one second magnetically conductive conduit may be removably deployed within at least one first magnetically conductive conduit.

Magnetically conductive contaminants, such as metal shavings and/or other forms of ferrous metal debris, may be introduced into a fluid column during a number of production procedures, such as milling operations and/or perforating wellbore casing and production tubing. If not removed from a fluid, such impurities and aggregates of metal debris may be circulated and reintroduced downhole where they accumulate in higher concentrations and collect in the cavities of recirculating pumps. Metal contaminants can cut pump liners and pistons, which impedes the flow of fluids. Frequently replacement of circulating pump parts is necessary, resulting in downtime and high maintenance costs.

The presently claimed and/or disclosed inventive concepts have been demonstrated to simply and effectively collect magnetically conductive impurities and metal contaminants from fluids, including non-polar liquids such as cutting oils and other liquid hydrocarbons utilized as cooling and lubrication agents in metal cutting and shaping processes. Magnetically conductive debris suspended within a fluid flowing through a magnetically energized conduit may adhere to the inner surface of the boundary wall of a magnetically energized conduit and/or the outer surface of a nucleus 39, effectively collecting such contaminants and removing them from fluid discharged from the magnetically energized conduit. Switching an output of electrical energy to an “off” state to interrupt the energizing of the at least one coiled electrical conductor may allow the magnetically conductive debris to be dislodged from the inner surface of the boundary wall of a magnetically conductive conduit and/or the nucleus 39 by the flow of fluid through the magnetically conductive conduit. A flow of fluid containing the collected contaminants may then be directed to a filter, collection vessel and/or other separation apparatus known to those of ordinary skill in the art, downstream of the magnetically conductive conduit to capture the debris and remove it from the fluid.

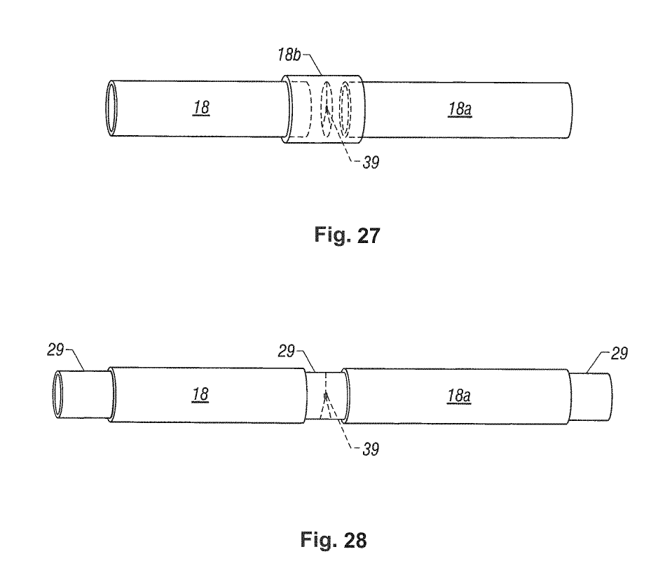

Referring now to FIG. 27, schematically depicted is one embodiment of the magnetically conductive conduit having a nucleus 39 deployed within the aperture of the magnetically conductive conduit, with nucleus 39 having at least an outer surface with a proximal end and a distal end. As shown in FIG. 27, nucleus 39 may be deployed within non-magnetically conductive conduit segment 18b by utilizing a non-magnetically conductive material to make at least one mechanical connection extending between the inner surface of the boundary wall of conduit segment 18b and the outer surface of the nucleus 39. The inner surface of the boundary walls of magnetically conductive conduit segment 18 and magnetically conductive conduit segment 18a are shown in coaxial alignment to the outer surface of the nucleus 39. At least one coiled electrical conductor may encircle at least a section of each segment of magnetically conductive material forming the length of magnetically conductive conduit with at least one turn of the electrical conductor oriented substantially orthogonal to the fluid flow path extending through the magnetically conductive conduit. Fluid flowing through a serial coupling of magnetically conductive conduit segment 18, non-magnetically conductive conduit segment 18b and magnetically conductive conduit segment 18a may be exposed to higher concentrations of magnetic energy between the inner surface of the boundary wall of conduit segment 18b and the outer surface of the nucleus 39.

In one embodiment, the nucleus 39 may be formed of a permanent magnet. In another embodiment, the nucleus 39 may be formed of an electromagnet. In another embodiment, the nucleus 39 may be formed of a magnetically conductive material. In still another embodiment, the nucleus 39 may be formed of a non-magnetically conductive material.

Deploying at least one nucleus 39 formed of at least one of a permanent magnet, an electromagnet, and/or a magnetically conductive material within the non-magnetically conductive region between segments of a magnetically energized conduit has been determined to provide for an enhanced magnetic state of nucleus 39 and provide an increased concentration of magnetic energy within the fluid flow path as nucleus 39 is concentrically attracted by the magnetically energized conduit segments.

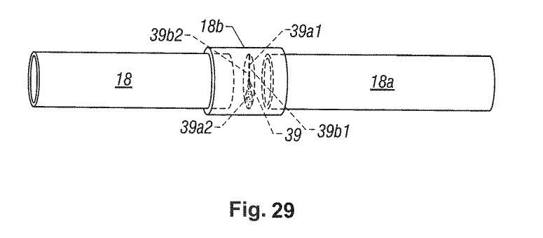

The structural elements of FIG. 29 are substantially identical to that shown in FIG. 27, therefore, in the interest of brevity, common features of the magnetically conductive conduit and the nucleus 39 will be labeled in FIG. 29. FIG. 29 schematically depicts one embodiment of the magnetically conductive conduit having the nucleus 39 deployed within non-magnetically conductive conduit segment 18b by utilizing one or more pieces of non-magnetically conductive material 39a to make at least one mechanical connection extending between the inner surface of the boundary wall of conduit segment 18b and the outer surface of the nucleus 39. As shown in FIG. 29, the non-magnetically conductive material 39a making a mechanical connection between the inner surface of the boundary wall of conduit segment 18b and the outer surface of the nucleus 39 may have two components 39a1 and 39a2 which define two openings 39b1 and 39b2 to permit passage of fluid past the nucleus 39 to form a static mixing device within the fluid flow path extending through the conduit segment 18b. As shown in FIG. 29, the non-magnetically conductive material 39a2 may form a restriction within the conduit segment 18b by encompassing from about 30 degrees to about 180 degrees of cross-sectional area of the conduit segment 18b. The size of the openings 39b1 and 39b2 can collectively vary from about 330 degrees to about 180 degrees of the cross-sectional area of the conduit segment 18b. For example, the openings 39b1 and 39b2 depicted in FIG. 19 collectively encompass approximately 240 degrees of the cross-sectional area of the conduit segment 18b. The inner surface of the boundary walls of the magnetically conductive conduit segment 18 and magnetically conductive conduit segment 18a are shown in coaxial alignment to the outer surface of the nucleus 39.

FIG. 28 schematically depicts an alternate embodiment of the magnetically conductive conduit having more than one length of magnetically conductive material forming the magnetically conductive conduit with a non-contiguous array of first length of magnetically conductive conduit segment 18 and second length of magnetically conductive conduit segment 18a forming the magnetically conductive conduit. A spacer made of a non-magnetically conductive material may be utilized to maintain the non-magnetically conductive region between the distal end of conduit segment 18 and the proximal end of conduit segment 18a. The inner surface of the boundary wall of magnetically conductive conduit segment 18 and the inner surface of the boundary wall of magnetically conductive conduit segment 18a define a flow path extending along the longitudinal axis of the magnetically conductive conduit. Fluid flow conduit 29, made with a length of non-magnetically conductive material defining a fluid impervious boundary wall with an inner surface and an outer surface and having a fluid entry port at one end of the conduit and a fluid discharge port at the other end of the conduit, is shown extending through magnetically conductive conduit segment 18 and magnetically conductive conduit segment 18a to establish a fluid flow path through the magnetically conductive conduit. The nucleus 39 may be made of a magnetically conductive material and has an outer surface and is shown deployed within the aperture of non-magnetically conductive fluid flow conduit 29. The inner surface of the boundary walls of magnetically conductive conduit segment 18 and magnetically conductive conduit segment 18a are shown in coaxial alignment to the outer surface of the nucleus 39. The nucleus 39 may be deployed within non-magnetically conductive fluid flow conduit 29 by utilizing a magnetically conductive material and/or a non-magnetically conductive material to make at least one mechanical connection extending between the inner surface of the boundary wall of non-magnetically conductive fluid flow conduit 29 and the outer surface of the nucleus 39. At least one coiled electrical conductor may encircle at least a section of each length of magnetically conductive conduit with at least one turn of the electrical conductor oriented substantially orthogonal to the fluid flow path extending through the magnetically conductive conduit. Fluid flowing along a path extending through non-magnetically conductive conduit 29 sleeved by magnetically energized conduit segment 18 and magnetically energized conduit segment 18a may be exposed to high concentrations of magnetic energy as it flows between the inner surface of the boundary wall of fluid flow conduit 29 and the outer surface of the nucleus 39.

Disposing at least one nucleus 39 formed of a permanent magnet, an electromagnet, and/or a magnetically conductive material within a magnetically energized conduit has been determined to provide for an enhanced magnetic state of the nucleus 39, allowing fluid flowing proximate the nucleus 39 to be exposed to increased concentrations of magnetic energy. It may be appreciated that at least one tortuous fluid flow path may be established when deploying various embodiments of at least one nucleus 39 within a magnetically conductive conduit of the presently claimed and/or disclosed inventive concepts.

In one embodiment, the nucleus 39 may comprise an axially aligned array of nucleus segments having at least one nucleus segment formed of a length of magnetically conductive material having an outer surface with a proximal end and a distal end (hereinafter the magnetically conductive nucleus segment) in fluid communication with at least one nucleus segment formed of a length of non-magnetically conductive material having an outer surface with a proximal end and a distal end (hereinafter the non-magnetically conductive nucleus segment). In one such embodiment of the nucleus 39, the serial coupling of axially aligned nucleus segments may have a first magnetically conductive nucleus segment, a non-magnetically conductive intermediate nucleus segment and a second magnetically conductive nucleus segment. In another embodiment of the nucleus 39, the serial coupling of axially aligned nucleus segments may have a first non-magnetically conductive nucleus segment, a magnetically conductive intermediate nucleus segment and a second non-magnetically conductive nucleus segment. Although the serial coupling of axially aligned nucleus segments of the nucleus 39 has been described having certain embodiments, a person of skill in the art will recognize that the nucleus 39 may comprise other serial couplings having at least one magnetically conductive nucleus segment and at least one non-magnetically conductive nucleus segment.

In an axially aligned array of nucleus segments and/or a serial coupling of axially aligned nucleus segments, at least one non-magnetically conductive nucleus segment may be shaped to make at least one mechanical connection extending between the inner surface of the boundary wall of a magnetically energized conduit segment and/or the inner surface of the boundary wall of a length of non-magnetically conductive fluid flow conduit sleeved by a magnetically energized conduit.

In some instances, small magnetically conductive contaminants less than 10 microns in size, may be collected from a fluid passing through an alternate embodiment of a the nucleus 39 disposed within a magnetically conductive conduit, wherein the nucleus 39 formed of a screen of magnetically conductive wire mesh may be deployed within the magnetically conductive conduit and oriented substantially orthogonal to the fluid flow path extending through the magnetically conductive conduit. The wire mesh screen may comprise at least one length of magnetically conductive material forming a single strand of wire and/or at least a first strand of wire and second strand of wire, each strand of wire having an outer surface, with the at least first and second strands of wire configured to form a grid.

The presently claimed and/or disclosed inventive concepts have been demonstrated to simply and effectively collect magnetically conductive impurities and metal contaminants from fluids, including non-polar liquids such as cutting oils and other liquid hydrocarbons utilized as cooling and lubrication agents in metal cutting and shaping processes. The nucleus 39 formed of the magnetically energized wire mesh may provide an increase in magnetically energized surface area across the cross section of the fluid flow path so that magnetically conductive debris may adhere to the magnetically energized wire mesh of the nucleus 39, effectively collecting such contaminants from fluid flowing through the magnetically energized conduit. Contaminants may then be collected for disposal by switching the output of electrical energy to an “off” state to interrupt the energizing of the at least one coiled electrical conductor and allow magnetically conductive debris to be dislodged from the magnetically conductive wire mesh of the nucleus 39 by the flow of fluid. Such contaminants may then collected and removed from the fluid downstream of the magnetically conductive conduit by at least one filter, collection vessel, electrochemical fluid conditioning device and/or other separation apparatus known to those of ordinary skill in the art.

The nucleus 39 formed of the magnetically conductive wire mesh may be deployed within the non-magnetically conductive conduit segment of a serial coupling of conduit segments by making at least one mechanical connection extending between the inner surface of the boundary wall of the non-magnetically conductive conduit segment and at least one peripheral surface of the nucleus 39. The nucleus 39 formed of the magnetically conductive wire mesh screen may be deployed within the non-magnetically conductive fluid flow conduit by making at least one mechanical connection extending between the inner surface of the boundary wall of the non-magnetically conductive fluid flow conduit and at least one peripheral surface of the nucleus 39.

A first non-magnetically conductive fluid flow conduit and a second non-magnetically conductive fluid flow conduit may be sleeved within the boundary wall of a magnetically energized conduit. A first fluid may be directed to pass through the first non-magnetically conductive fluid flow conduit and a second fluid may be directed to pass through the second non-magnetically conductive fluid flow conduit and exposed to at least one area of concentrated magnetic energy.

As used herein, the term “electrical power supply” may refer to common sources of alternating current electrical energy, direct current electrical energy, and alternate sources of electrical energy such as electrical energy generated by photovoltaic cells and/or other sources of solar power generation, the conversion of wind energy into electrical energy via wind turbines and/or other means of generating wind-driven electrical energy, the hydroelectric generation of electrical energy via the force of a fluid flowing through a conduit to propel a turbine and spin an electrical generator to generate electrical energy, and/or other sources of electrical energy known to those of ordinary skill in the art. The at least one electrical power supply may energize the coiled electrical conductor with a constant output of electrical energy having a direct current component, an output of electrical energy having an alternating current component, a pulsed output of electrical energy having a direct current component, and/or a pulsed output of electrical energy having an alternating current component.

The at least one electrical power supply may establish an output of electrical energy having an alternating current component to energize at least one coiled electrical conductor through a switching sequence including initially energizing said at least one coiled electrical conductor during a first time interval with electrical energy flowing between the first conductor lead to the second conductor lead in a first direction, switching the direction of the flow of electrical energy and energizing said at least one coiled electrical conductor during a second time interval with electrical energy flowing between the first conductor lead to the second conductor lead in a second direction and causing the switching sequence to repeat at a repetition rate.

The at least one electrical power supply may establish a pulsed output of electrical energy having a direct current component through a switching sequence including initially switching an output of electrical energy to an “on” state during a first time interval to energize at least one coiled electrical conductor with electrical energy flowing from the first conductor lead to the second conductor lead, switching said first output of electrical energy to an “off” state to interrupt the energizing of said at least one coiled electrical conductor, switching an output of electrical energy to the “on” state during a second time interval to energize said at least one coiled electrical conductor with electrical energy flowing from the first conductor lead to the second conductor lead, switching said second output of electrical energy to the “off” state to interrupt the energizing of said at least one coiled electrical conductor and causing the switching sequence to repeat at a repetition rate. The first and second time intervals and the repetition rate may be substantially constant or one or more of the first and second time intervals and the repetition rate may be variable.

The at least one electrical power supply may establish a pulsed output of electrical energy having an alternating current component through a switching sequence including initially switching an output of electrical energy to an “on” state during a first time interval to energize at least one coiled electrical conductor with electrical energy flowing between the first conductor lead to the second conductor lead in a first direction, switching said first output of electrical energy to an “off” state to interrupt the energizing of said at least one coiled electrical conductor, reversing the direction of the flow of electrical energy, switching an output of electrical energy to the “on” state during a second time interval to energize said at least one coiled electrical conductor with electrical energy flowing between the first conductor lead to the second conductor lead in a second direction, switching said second output of electrical energy to the “off” state to interrupt the energizing of said at least one coiled electrical conductor and causing the switching sequence to repeat at a repetition rate. The first and second time intervals and the repetition rate may be substantially constant or one or more of the first and second time intervals and the repetition rate may be variable.

A duty cycle is the percentage of one time interval in which an output of electrical energy is active, with a time interval being the length of time it takes for an output of electrical energy to complete an on-and-off cycle. A duty cycle may be expressed in a formula as D=T/P×100%, wherein D is the duty cycle, T is the time the output of electrical energy is switched to an “on” state during a time interval and P is the total time interval of the output of electrical energy. For example, a 75% duty cycle would require an output of electrical energy to be switched to an “on” state for 75% during a time interval and switched to an “off” state for 25% during that same time interval. A pulsed output of electrical energy may be constant; or pulsed outputs of electrical energy may sweep a range of repetition rates. For example, an output of electrical energy may be pulsed with a repetition rate as low as 1 Hz to as high as 3 MHz, and may have a duty cycle from as low as 5% to as high as 95%. An at least one electrical power supply may establish pulsed outputs of electrical energy sweeping a range of repetition rates, with the repetition rates and/or duty cycles for a specific range of pulsed outputs of electrical energy being established according to the composition of a fluid to be conditioned.

One or more of the voltage and current of the output of electrical energy may be substantially constant or one or more of the voltage and current of the output of electrical energy may be variable. One or more of the time intervals, repetition rate, duty cycle, or direction of a pulsed output of electrical energy may be established according to one or more of the material making up the coiled electrical conductor, resistance or impedance of the coiled electrical conductor and/or the configuration of the at least one coiled electrical conductor. The at least one power supply may provide a plurality of programmable outputs of electrical energy, each output of electrical energy establishing a distinct output of electrical energy wherein a first output of electrical energy energizes a first coiled electrical conductor and a second output of electrical energy energizes a second coiled electrical conductor. A first supply of electrical power and a second supply of electrical power may be connected in series or parallel to energize at least one coiled electrical conductor.

A first flow of electrical energy having a first set of electrical characteristics may be utilized to provide conditioning for a first fluid containing at least one polar substance and a second flow of electrical energy having a second set of electrical characteristics may be used to provide conditioning for a second fluid containing at least one polar substance. One or more of the time intervals, repetition rate, duty cycle, voltage, current, or direction of a pulsed output of electrical energy may be programmable to provide effective fluid conditioning as the characteristics and substances comprising a fluid mixture change. The size, shape and dimensions of the electrical conducting material, the length to diameter ratio of the at least one coiled electrical conductor encircling the magnetically conductive conduit and/or the number of layers of coiled electrical conductor forming a coil may be adapted for specific applications.

Max Karl Planck's black-body radiation studies had a significant role in starting the quantum physics revolution. These investigations made an important connection between the effects of ordered work energy at the macrostate (bulk) level and the effects of ordered and resonant electromagnetic work energy at the microstate (molecular) level, and formalized the concept of “resonant Hertzian waves” (resonant electromagnetic energy) as a form of non-thermal energy available for work on a molecular basis. Planck's Resonance Hypothesis provides a mechanistic explanation for many experimental observations in optical, photonic, and electromagnetic technologies that cannot be explained by existing quantum or thermodynamic theories where resonant energy is free to be converted into work and the application of resonant energies produce effects not typically seen under purely thermodynamic conditions.

The effects of resonant energies in Planck's Resonance Hypothesis extend far beyond the fields of photochemistry and photobiology. His resonance concept has been confirmed in a wide variety of systems and phases—solid, liquid, gas, plasma, biologic, organic, inorganic, electrical, magnetic, chemical, materials, and crystalline—and these effects span the entire electromagnetic spectrum. Results range from accelerated growth of plants and animals, to enhanced chemical catalysis, increased crystal nucleation, virtual thermal effects and resonant phase changes.

In Planck's Resonance Hypothesis, “resonant Hertzian waves” induce Helmholtz's “sympathetic resonance” in a system and the energy may be free to be converted into work so that large and powerful oscillations may result. Because pulsed magnetic energy may be completely free to be converted into work, the resulting resonant energy may be completely converted into work. Experimental measurement of the work energy and/or its effects can provide the value of the resonance factor.

As shown in Table 36, when water was conditioned with pulsed magnetic oscillations, its capacity to dissolve more solute was greater than water that had been kept under purely thermal/entropic conditions; despite the fact that the water in both the resonant system and the thermal system had identical temperatures, volumes, pressures, solutes and dissolution times.

TABLE 36

| | Resonant System | Thermal System |
|---|---|---|
| Weight of Dissolved | 26.0 | 23.8 |
| NaCl (g/100 ml) | | |
| Moles Dissolved NaCl | 4.65 | 4.25 |
| Heat of solution (kJ) | 17.5 | 16.0 |
| as 3.76 kJ/mol for the solute | | |
| NaCl in liquid water | | |

The resonant system possessed 1.09 times more energy to dissolve the NaCI than the thermal system as pulsed magnetic energy was converted into work for dissolution. Further, more solute was dissolved in the resonant system despite the temperature, volume, pressure and dissolution time being identical in both systems. The water conditioned with pulsed magnetic energy reacted as though it was at 46° C. (while at only 21° C.), with the Helmholtz energy provided by the “virtual” or apparent thermal effect from pulsed magnetic oscillations replicating an increase in temperature of 25° C. Without the Helmholtz energy provided by conditioning with “pulsed magnetic oscillations, the water would have been required to be heated to 46° C. to dissolve the same amount of solute.

Other variables may include the size, shape and material comprising the conduit and coupling segments; and the size, shape and composition of materials comprising an enclosure to protect at least the coiled electrical conductor. At least one magnetically conductive material or at least one non-magnetically conductive material may be utilized to maintain the spacing between a non-contiguous array of coils. At least one non-magnetically conductive material may be utilized to maintain the spacing between the outer layer of a coiled electrical conducting material and the inner surface of a protective coil enclosure. A plurality of magnetically conductive conduits may be utilized in an in-line and/or manifold configuration having multiple magnetically conductive conduits in parallel to achieve desired flow rates and/or levels of fluid conditioning.

Energizing the coiled electrical conductor with at least one pulsed output of electrical energy provides a variety of fluid conditioning benefits. In a first example, switching the output of electrical energy to an “off” state to interrupt the energizing of the at least one coiled electrical conductor may allow magnetically conductive debris that may adhere to the inner surface of the boundary wall of a magnetically energized conduit to be dislodged and removed by a flow of fluid passing through the non-energized magnetically conductive conduit.

In a second example, energizing the at least one coiled electrical conductor with pulsed outputs of electrical energy having rapid repetition rates may generate alternating positive and negative pressure waves in some fluids that tend to tear a fluid apart and create vacuum cavities that form micron-size bubbles. Such bubbles may continue to grow under the influence of the alternating positive and negative pressure waves until they reach a resonant size where they then collapse, or implode, under a force known as cavitation. Imploding bubbles form jets of plasma having extremely high temperatures that travel at high rates of speed for relatively short distances. Energy released from a single cavitation bubble is extremely small, but the cavitation of millions of bubbles every second has a cumulative effect throughout a fluid as the pressure, temperature and velocity of the jets of plasma destroy many contaminants in the fluid. In certain applications, diffused ambient air or other forms of small bubbles may be introduced immediately upstream of a magnetically energized conduit to assist in initiating the cavitation process. Electrolysis of water and other aqueous-based fluid mixtures may be utilized to generate small bubbles upstream of a magnetically conductive conduit energized with pulsed outputs of electrical energy.

As disclosed herein, the presently claimed and/or disclosed inventive concepts include a method of separating at least one biological contaminant from a mixture comprising a fluid containing at least one polar substance and at least one biological contaminant, having the step of establishing a flow of mixture through a magnetically conductive conduit having magnetic energy directed along the longitudinal axis of the magnetically energized conduit and extending through at least a portion of the mixture thereby providing a conditioned fluid medium; wherein the flow of at least a portion of the conditioned fluid medium through distinct areas of concentrated fluid conditioning energy destroys the membrane of the at least one biological contaminant and the conditioned fluid medium has a reduced volume of the at least one biological contaminant.

A variety of processes and methods have been devised in an effort to control and/or eliminate biological contaminants, such as unwanted bacteria and other forms of undesirable microorganisms, found in fluids containing at least one polar substance. For example, traditional thermal treatments, such as pasteurization, are commonly used in the food industry to ensure food safety and meet extended shelf-life goals. However, thermal treatments are known to cause unwanted changes in the nutritional, organoleptic and functional properties of many food products. Consequently, the food industry is constantly looking for alternative non-thermal processing technologies to deal with food quality and safety issues while protecting the sensory attributes of the products involved. Other modern methods of food preservation include exposing such products to various types of radiation, such as ultraviolet light. While many of these methods of controlling unwanted microorganisms in food products have proven to be quite desirable, they can substantially alter the nature of the food so that the quality and taste of the processed foods are less desirable. Microwave cooking subjects food to a magnetic field; however, as mentioned above, the induced thermal effect kills microorganisms while substantially altering the character of the food.

Other alternative processing technologies such as chemical additives, high intensity ultrasound processing, high hydrostatic pressure processing, pulsed electric fields processing, and ozone processing are some of the most common fluid processing technologies in food industry to control pathogenic and spoilage bacteria in foods. Although “non-thermal” is a term associated with some of these technologies, most cause a rise in the temperature of aqueous-based fluids and the reduction in microbial population is often a synergistic effect associated with temperature elevation. Moreover, some of these technologies can accelerate enzymatic or non-enzymatic reactions in foods that can affect the sensory properties of foods. For example, exposure of milk to UV light can trigger oxidative changes that are responsible for subsequent development of oxidized flavor. Conventional ozone generators (either corona discharge or UV lamps) typically do not scale down and are impractical for low flow rate water treatment regimens (i.e., for treating 500 L/hr. or less). The food industry is actively looking for a suitable non-thermal technology than can be used to achieve a 5-log reduction of pathogenic and spoilage bacteria without causing a detrimental effect to nutritional, sensory quality and/or other characteristics of foods.

Limited studies have been carried out on the application of the use of oscillating magnetic fields in conditioning fluids where reductions in the number of microorganisms in fluids containing at least one polar substance can be achieved by exposing the fluids to high intensity magnetic fields for a very short time without a significant increase in temperature.

In U.S. Pat. No. 1,863,222, Hoermann et al. described a method of exposing food and other products with high frequency oscillations by placing them in the conductive pathway of a high frequency electrical circuit. In U.S. Pat. No. 3,876,373, Glyptis described a method and apparatus for sterilizing matter by inhibiting the reproduction of organisms by the use of a plasma discharge or by electromagnetic excitation to destroy or disrupt the functioning of the DNA molecule of the organisms.

Magnetic fields have been used previously in conjunction with certain food processing steps. For example, in U.S. Pat. No. 4,042,325, Tensmeyer described a method of killing microorganisms inside a container by directing an electromagnetic field into the container, inducing a plasma by focusing a single-pulsed, high-power laser beam into the electromagnetic field and exposing the inside of the container to the plasma for about 1.0 millisecond to about 1.0 second by sustaining the plasma with the electromagnetic field.

In U.S. Pat. No. 4,524,079, Hofmann described a method and apparatus utilizing moderate frequency, high intensity magnetic fields as a non-thermal process to inactivate some selected microorganisms within a generally non-electrically conductive environment. Destruction of microorganisms within food (disposed in a container having relatively high electrical resistivity and subjected to an oscillating magnetic field) was accomplished within very short time periods during which no significant rise in temperature was observed in the food. The food was sterilized without any detectable change in its character, without a plasma being produced and without the addition of chemicals.

According to Hofmann, exposing various food products to a high intensity, moderate frequency oscillating magnetic field for very short time periods makes his method of controlling such biological contaminants effective as microorganisms were either destroyed or reproductively inactivated. He found that during the batch treatment of orange juice, milk and yogurt, the short period of time these food products were subjected to an oscillating magnetic field resulted in minimal heating of the food and except for destruction of the microorganisms, the food was substantially unaltered. He described a single pulse of the magnetic field as generally having the capacity to decrease the microorganism population by at least about two orders of magnitude, and subjecting the material to additional pulses more closely approached substantially complete sterility, yet the taste of the food was unaltered.

However, Hofmann merely placed food products packaged in non-conductive containers in a high intensity magnet to kill bacteria and sterilized only the food products within the containers. While this non-thermal method of controlling microorganisms in liquid food proved to be highly effective, the operational challenges associated with the batch treatment of individually packaged food products can be remedied by the bulk conditioning of food materials flowing through a processing system.

Most biological contaminants regulate their water intake through osmosis via the electrical charge of fats and proteins in their surface membranes. Directing biological contaminants to pass through concentrated magnetic energy may overwhelm the electrical fields and charges in the surface membranes of these microorganisms and drive them to an imbalanced state, weakening their cell walls and destroying the membranes. Unlike chemical treatment and other means of controlling many biological contaminants, such organisms may not develop immunity to the presently claimed and/or disclosed inventive concepts of fluid conditioning.

In addition to the food industry, other industries are also looking for ways to control and/or eliminate unwanted bacteria and undesirable microorganisms in fluids containing at least one polar substance. Ballast water brought onboard an empty ocean going vessel to stabilize the ship at its port of departure typically contains a variety of non-native biological materials, including plants, viruses and bacteria that can cause extensive ecological and economic damage to aquatic ecosystems when untreated prior to its discharge at a destination port. In the oilfield, water that is injected into a formation is typically treated to prevent the reservoir from being flooded with water containing sulfate-reducing bacteria that can result in the in-situ development of H2S concentrations during the waterflood. Once sulfate-reducing bacteria have been introduced into a reservoir, they are essentially impossible to kill; however, and result in lower quality hydrocarbons being produced by the formation as well as posing a number of health and environmental dangers for operators.

Biological contaminants in oilfield production fluids and/or injection water can be classified by their effect. Sulfate-reducing bacteria (SRB), heterotrophic nitrate-reducing bacteria (hNRB), sulfide-oxidizing bacteria (NR-SOB), yeast and molds, protozoa, Sulfurospirillum spp., Thauera spp., Desulfovibrio sp. strain Lac3, Lac6, and/or Lac15, and/or combinations and equivalents thereof can be encountered in nearly any body of water in and around an oilfield. Bacteria may be found in solution (planktonic), as dispersed colonies or immobile deposits (sessile bacteria), and rely on a variety of nitrogen, phosphorus, and carbon compounds (such as organic acids) to sustain growth. Concentrations of nitrogen and phosphorus usually found in exploration and production water are usually sufficient to sustain bacterial growth. The injection of organic nitrogen and phosphorus containing chemicals in fluid injected into hydrocarbon producing formations can increase the proliferation of microorganisms detrimental to exploration and production activities.

The presently claimed and/or disclosed inventive concepts for conditioning fluids provide non-contact conditioning that can be delivered to a fluid flowing through a conduit in any process, without any need for engineering modifications. In addition, this method of conditioning fluids may have no moving parts and may be scalable to configure to a broad range of flow rates. Further, heat generation that has been a major limitation in providing conditioning for flowing fluids is virtually eliminated.

Fluid mixtures containing at least one biological contaminant may be directed through the magnetically energized conduit without the addition of chemical additives, and the process may be utilized to destroy the membranes of biological contaminants flowing through the magnetically energized conduit. Typically, a fluid may be conditioned at ambient temperature, but conditioning may also occur at a wide range of temperatures.

The intensity of the pulsed magnetic energy that is used may be as low as 0.25 Tesla and may exceed 3.0 Tesla, and preferably the intensity of the magnetic field is between 0.75 and 1.0 Tesla. The actual intensity of the magnetic field used depends on the properties of the fluid being conditioned, including the resistivity of the material and its thickness, with higher intensities typically utilized for materials of lower resistivities and greater viscosity. No direct relationship has currently been derived relating magnetic energy intensity to various types of materials. Sufficient destruction of microorganisms may be effected by adjusting parameters, such as exposure time, which is a function of the flow rate through the distinct regions of concentrated fluid conditioning energy, as well as the repetition rate and uniformity of the pulsed outputs of magnetic energy.

The magnetic field may be pulsed with a repetition rate as low as 1 Hz to as high as 3 MHz, and may have a duty cycle from as low as 5% to as high as 95%. Total exposure time of fluid mixtures to the magnetic energy is minimal, ranging from about 1 second up to about 10 seconds. With reference to the above-described process, exposure time can be considered the number of pulses multiplied by the duration of each pulse as the liquid flows through each region of concentrated energy. A single pulse generally decreases the population of a microorganism by about two orders of magnitude; however, additional pulses may be used to affect a greater degree of conditioning, and, typically, fluids are subjected to between about 100 pulses and about 1,000 pulses.

Regardless of the intensity of the magnetic energy and the number of pulses, a fluid will not be significantly heated, and will normally be subjected to at least 100 pulses. Desirably, the fluid mixture will not be heated more than 1 degree C. by the magnetic conditioning procedure.

As disclosed herein, the presently claimed and/or disclosed inventive concepts include a method of reducing the concentration of at least one biological contaminant from a volume of a fluid mixture, having the step of establishing a flow of a volume of the fluid mixture through a magnetically conductive conduit having magnetic energy directed along the longitudinal axis of the magnetically energized conduit and extending through at least a portion of the fluid mixture, thereby providing a conditioned fluid medium; wherein the flow of at least a portion of the conditioned fluid medium through distinct areas of concentrated fluid conditioning energy destroys the membrane of the at least one biological contaminant in the fluid mixture the and the conditioned fluid medium has a reduced concentration of at least one biological contaminant as compared to the fluid mixture prior to the magnetic conditioning. Magnetic energy may be generated with a constant output of electrical energy having a direct current component, an output of electrical energy having an alternating current component, a pulsed output of electrical energy having a direct current component, and/or a pulsed output of electrical energy having an alternating current component. One or more of the voltage, current, time intervals, repetition rate, duty cycle, or direction of a pulsed output of electrical energy may be established according to one or more of the classification and/or concentration of at least one biological contaminant in a volume of a fluid mixture and/or the classification and/or volume of the fluid mixture.

In many instances, directing a fluid mixture to pass through magnetic energy may neutralize the electrical charges of at least one dissimilar material in the fluid, rendering the dissimilar material non-adhesive and enhancing the clarification of the fluid. Water utilized as a heat transfer medium in thermal exchange systems, utilizing equipment such as boilers, steam generators, evaporators, condensers, cooling towers, heat exchangers and/or equivalent apparatus known to those of ordinary skill in the art to transfer heat between one or more fluids, may be directed through concentrated magnetic energy to retard the formation of scale and other heat insulating deposits in such thermal exchange systems. Neutralizing the charges of suspended solids adhering to small oil droplets that tend to keep the oil suspended in water may disrupt the stability of some emulsions. Increasing the interfacial tension between water and oil allows small oil droplets to coalesce into larger droplets, float out of the water and be removed by separation apparatus. Charged electrodes may also be used in concert with magnetic fluid conditioning to break many bonds that tend to create emulsions. Similarly, water may be removed from hydrocarbon fluids.

Directing a fluid mixture to pass through the presently claimed and/or disclosed inventive concepts may cause at least one dissimilar material in the fluid mixture to be repelled from the fluid containing at least one polar substance and facilitate its removal from the fluid, and thereby reduce the amount of flocculants and/or coagulants required for adequate dewatering processes so that drier solids and clearer filtrate may be discharged from dewatering equipment.

At least one chemical dispersing apparatus having a capacity to distribute a supply of at least one chemical compound and/or at least one fluid conditioning chemical into a fluid containing at least one polar substance directed to pass through magnetic energy may be utilized to disperse a supply of at least one chemical into a fluid mixture upstream of the magnetically conductive conduit, downstream of the magnetically conductive conduit, upstream of the separation apparatus, and/or downstream of the separation apparatus.

Fluid conditioning chemicals may be selected from a group consisting of, but not limited to, algaecides, biocides, scale retardants, coagulants and flocculants, pesticides, fertilizers, surfactants, petroleum production fluid additives, fuel additives, lubricant additives, ambient air, oxygen, hydrogen, ozone and hydrogen peroxide. As used herein, charged electrodes generating oxygen and hydrogen bubbles and hydroxyl radicals in the electrolysis of aqueous-based fluid mixtures may be included as a chemical dispersing apparatus.

Algaecides may include, but are not limited to, copper sulfate, cupric sulfate, chelated copper, quaternary ammonia compounds and equivalents. Biocides, may include, but are not limited to, chlorine, hypochlorite solutions, sodium dichloro-s-triazinetrione, trichloro-s-triazinetrione, hypochlorous acid, halogenated hydantoin compounds and equivalents. Scale retardants may include, but are not limited to, ion-exchanger resins, analcime, chabazite, clintptilolite, heulandite, natrolite, phillipsite, stilbite and equivalents. Coagulants and flocculants may include, but are not limited to, multivalent cations such as aluminum, iron, calcium or magnesium, long-chain polymer flocculants such as modified polyacrylamides, and equivalents. Pesticides may include, but are not limited to, organochlorides, such as dichlorodiphenylethanes and cyclodiene compounds, organophosphates, carabamates, such as thiocarbamate and dithiocarbamates, pheoxy and benzoic acid herbicides, triazines, ureas, chloroacetanilides, glyphosate and equivalents. Fertilizers may include, but are not limited to, nitrogen fertilizers, such as anhydrous ammonium nitrate and urea, potash, and equivalents. Surfactants such as detergents, wetting agents, emulsifiers, foaming agents and dispersants may include, but are not limited to, ammonium lauryl sulfate, sulfate, sodium lauryl ether sulfate, sodium myreth sulfate, dioctyl sodium sulfosuccinate, perfluorooctanesulfonate, perfluorobutanesulfonate, linear alkylbenzene sulfonates, perfluorononanoate, octenidine dihydrochloride, perfluorononanoate, alkyltrimethylammonium salts, cocamidopropyl hydroxysultaine, cocamidopropyl betaine, polyoxyethylene glycol, alkyl ethers, octaethylene glycol monododecyl ether, pentaethylene glycol monododecyl ether, polyoxypropylene glycol alkyl ethers, polyoxyethylene glycol octylphenol ethers, polyoxyethylene glycol alkylphenol ethers, dodecyldimethylamine oxide, polyethylene glycol and equivalents.

In some instances, chemical pretreatment may hamper the efficiency of separation apparatus, such as screening apparatus, hydrocyclones, desanders and desilters that tend to blind off with chemically treated fluid mixtures. Improved removal of at least one dissimilar material from a fluid may be achieved by directing a fluid mixture containing at least one polar substance free of coagulants or flocculants to pass through the magnetically conductive conduit upstream of such separation apparatus to enhance the separation of at least one dissimilar material from the fluid mixture.

As shown in FIG. 29, one embodiment of the fluid conditioning apparatus having a capacity to alter the flow of a fluid directed to pass through magnetic energy may be utilized to alter the flow of a fluid containing at least one polar substance upstream of the magnetically conductive conduit, downstream of the magnetically conductive conduit, upstream of the separation apparatus, and/or downstream of the separation apparatus. Fluid conditioning apparatus may be selected from a group consisting of, but not limited to, pumps, blowers, vortex inducing equipment, static mixing devices and dynamic mixing apparatus to create turbulence in a flow of a fluid or laminar flow conditioners to remove turbulence from a flow of a fluid. Further, the static mixing devices can be positioned in a sequence in which the static mixing devices have different configurations. For example, a first static mixing device in the sequence may have a first configuration, a second static mixing device in the sequence may have a second configuration, and a third static mixing device in the sequence may have a third configuration that is different from the first and second configurations. Also, the fluid conditioning apparatus, such as the static mixing devices, may be supported by the nucleus 39, described above.

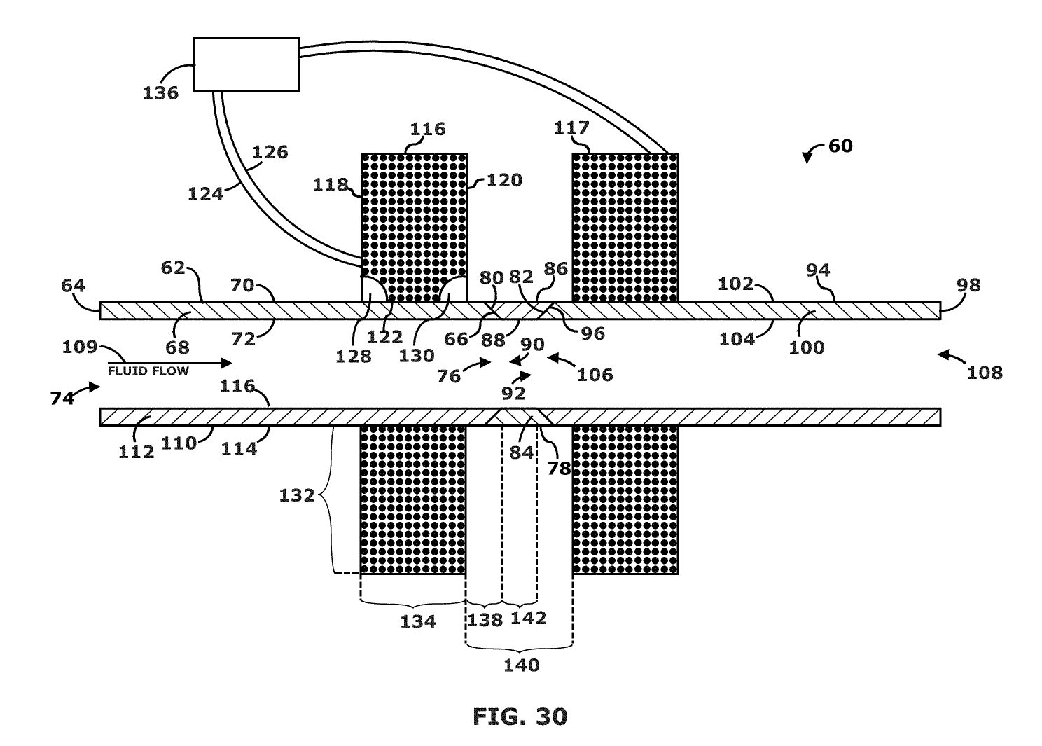

Referring now to FIG. 30, a cross-section of an apparatus 60 for conditioning fluids is schematically shown comprising a serial coupling of axially aligned conduit segments having a first magnetically conductive conduit segment 62, a non-magnetically conductive conduit segment 78, and a second magnetically conductive conduit segment 94 in fluid communication with each other forming a fluid flow conduit 110. The first magnetically conductive conduit segment 62 may be at least partially encircled by a first coiled electrical conductor 116 and the second magnetically conductive conduit segment 94 may be at least partially encircled by a second coiled electrical conductor 117. The first magnetically conductive conduit segment 62, the non-magnetically conductive conduit segment 78, and the second magnetically conductive conduit segment 94 each have a fluid intake port 74, 90 and 106 at a proximal end 64, 80 and 96, a fluid discharge port 76, 92 and 108 at a distal end 66, 82 and 98, and a fluid impervious boundary wall 68, 84 and 100 having an inner surface 72, 88 and 104 and an outer surface 70, 86 and 102 extending between the fluid intake port 74, 90 and 106 and the fluid discharge port 76, 92 and 108, the inner surface 72, 88 and 104 of the boundary wall 68, 84 and 100 of the conduit segments 62, 78 and 94 defining a fluid flow path 109 of the fluid flow conduit 110.

By way of example, the first and second magnetically conductive conduit segments 62 and 94 may be constructed of carbon steel. The distal end 66 of the first magnetically conductive conduit segment 62 may have a taper forming a planar surface extending from the inner surface 72 to the outer surface 70 at an angle having an absolute value within a range from about 30° to about 75°, and in one embodiment, at a substantially 45° angle. The proximal end 96 of the second magnetically conductive conduit segment 94 may have a taper forming a planar surface extending from the inner surface 104 to the outer surface 102 at an angle having an absolute value within a range from about 30° to about 75°, and in one embodiment, at a substantially 45° angle. The non-magnetically conductive conduit segment 78 may be constructed of stainless steel. The proximal end 80 of the non-magnetically conductive conduit segment 78 may have a taper forming a planar surface extending from the outer surface 86 to the inner surface 88 at an angle having an absolute value within a range from about 30° to about 75°, and in one embodiment, at a substantially 45° angle and the distal end 82 may have a taper forming a planar surface extending from the outer surface 86 to the inner surface 88 at an angle having an absolute value within a range from about 30° to about 75°, and in one embodiment, at a substantially 45° angle. The first magnetically conductive conduit segment 62, the non-magnetically conductive conduit segment 78, and the second magnetically conductive conduit segment 94 may be mechanically connected at the boundary wall 68, 84 and 100, for instance, by welding the segments together to form the fluid flow conduit 110 having a fluid impervious boundary wall 112 with an inner surface 116 and an outer surface 114 extending from the fluid intake port 74 of the first magnetically conductive conduit segment 62 to the fluid discharge port 108 of the second magnetically conductive conduit segment 94. The fluid flow conduit 110 may have the first coiled electrical conductor 116 encircling at least a portion of the first magnetically conductive conduit segment 62 and the second coiled electrical conductor 117 encircling at least a portion of the second magnetically conductive conduit segment 94.

The first coiled electrical conductor 116 and the second coiled electrical conductor 117 may be substantially identical in construction and function. Therefore, in the interest of brevity, only the first coiled electrical conductor 116 will be described hereinafter. The first coiled electrical conductor 116 has a proximal end 118, a distal end 120, and at least one electrical conductor 122. The at least one electrical conductor 122 has a first conductor lead 124, and a second conductor lead 126. The at least one electrical conductor 122 is coiled with at least one turn to form at least one uninterrupted coil of the at least one electrical conductor 122, each coil forming at least one layer of the first coiled electrical conductor 116. The first coiled electrical conductor 116 may further have a first base angle 128, a second base angle 130, a height measurement 132, and a length measurement 134. The first coiled electrical conductor 116 may be constructed having the at least one electrical conductor 122 being formed with a plurality of layers having a substantially uniform number of turns of the at least one electrical conductor 122 in each layer so that the first base angle 128 of the first coiled electrical conductor 116 forms a substantially 90° angle relative to the boundary wall 112 of the fluid flow conduit 110 and the second base angle 130 of the first coiled electrical conductor 116 also forms a substantially 90° angle relative to the boundary wall 112 of the first fluid flow conduit 110.

The length of the first coiled electrical conductor 116 may be measured along the longitudinal axis of the fluid flow conduit 110 and represented by a length measurement 134. The length measurement 134 of the first coiled electrical conductor 116 may range from 0.5 inches to 48 inches.

The height of the first coiled electrical conductor 116 is measured on a plane substantially orthogonal to the boundary wall 112 of the fluid flow conduit 110 and represented by a height measurement 132. The height measurement 132 may be greater than the length measurement 134. In some embodiments, the length measurement 134 and the height measurement 132 form a ratio between 1:1 to 1:6. In some embodiments, the length measurement 134 and the height measurement 132 form a ratio between 3:8 to 3:4 and in at least one embodiment, the length measurement 134 and the height measurement 132 may form a ratio of 1:2 (in other words, the height measurement 132 is twice as large as the length measurement 134).

The apparatus 60 may also be provided with an electrical power supply 136. As used herein, the term “electrical power supply” may refer to common sources of alternating current electrical energy, direct current electrical energy, alternate sources of electrical energy such as electrical energy generated by photovoltaic cells and/or other sources of solar power generation, the conversion of wind energy into electrical energy via wind turbines and/or other means of generating wind-driven electrical energy, the hydroelectric generation of electrical energy via the force of a fluid flowing through a conduit to propel a turbine and spin an electrical generator to generate electrical energy, and/or other sources of electrical energy known to those of ordinary skill in the art. The electrical power supply 136 may be operably connected to the first coiled electrical conductor 116 and the second coiled electrical conductor 117 so as to supply electrical current to the first and second coiled electrical conductors 116 and 117 thereby energizing the first and second coiled electrical conductors 116 and 117 to provide a magnetic field having lines of flux directed along a longitudinal axis of the fluid flow conduit 110. As used herein, the term magnetically energized fluid flow conduit 110 refers to the fluid flow conduit 110 in an energized state. The electrical power supply 136 may energize the first and second coiled electrical conductor 116 and 117 with a constant output of electrical energy having a direct current component, an output of electrical energy having an alternating current component, a pulsed output of electrical energy having a direct current component, and/or a pulsed output of electrical energy having an alternating current component. The lines of flux form loops and the resulting magnetic field is of a strength that allows the flux to extend along the longitudinal axis of the fluid flow conduit 110 and concentrate at distinct points beyond each end 64, 66, 96 and 98 of the first and second magnetically conductive conduit segments 62 and 94 such that the magnetic flux extends from a point where the lines of flux concentrate beyond one end of magnetically conductive conduit segment 62, around the periphery of the first and second coiled electrical conductors 116 and 117 along the longitudinal axis of the fluid impervious boundary wall of flow conduit 110, and to a point where the lines of flux concentrate beyond the other end of magnetically energized conduit segment 94. The boundary wall 68 and 100 of each of the magnetically conductive conduit segments 62 and 94 absorbs the magnetic field and the magnetic flux loops generated by the first and second coiled electrical conductors 116 and 117 at the points of flux concentration.

As shown in FIG. 30, the first coiled electrical conductor 116 and the second coiled electrical conductor 117 may be spaced apart at a distance (referred to hereinafter as a coil location measurement 138) away from the non-magnetically conductive conduit segment 78. For example, with respect to the first coiled electrical conductor 116, the coil location measurement 138 extends along the longitudinal axis of the boundary wall 112 of the fluid flow conduit 110 starting at the distal end 66 of the first magnetically conductive conduit segment 62 and extending to the distal end 120 of the first coiled electrical conductor 116. The coil location measurement 138 may have a range from the distal end 120 of the first coiled electrical conductor to the distal end 66 of the first magnetically conductive conduit segment 62, of 0.00 inches, to 14 inches.

The second coiled electrical conductor 117 may be spaced a distance (referred to hereinafter as a coil separation measurement 140) from the first coiled electrical conductor 116. The coil separation measurement 140 between the first coiled electrical conductor 116 and the second coiled electrical conductor 117 may be measured along the longitudinal axis at the outer surface 114 of the fluid flow conduit 110 and may be from 0.25 inches to 14 inches.

The second magnetically conductive conduit segment 94 may be spaced a distance (referred to hereinafter as a magnetically conductive conduit segment separation measurement 142) from the first magnetically conductive conduit segment 62. The magnetically conductive conduit segment separation measurement 142 may be measured along the longitudinal axis at the inner surface 116 of the fluid flow conduit 110 extending from the distal end 66 of the first magnetically conductive conduit segment 62 to the proximal end 96 of the second magnetically conductive conduit segment 94 and may be from 0.125 inches to 3.5 inches. The magnetically conductive conduit segment separation measurement 142 may be varied based on, for instance, the length, diameter, thickness of the boundary wall 68 and 100 and/or the material comprising the magnetically conductive conduit segments 62 and 94.

A person of skill in the art will recognize that although the apparatus 60 for conditioning fluids is shown having two magnetically conductive conduit segments 62 and 94 separated by one non-magnetically conductive conduit segment 78, the apparatus 60 may be provided with more magnetically conductive conduit segments (e.g., 3, 4, 5, 6, 7, etc.), and more non-magnetically conductive conduit segments with one non-magnetically conductive conduit segment positioned between each pair of magnetically conductive conduit segments. In addition, a person of skill in the art will recognize that although two coiled electrical conductors 116 and 117 are shown adjacent to the magnetically conductive conduit segments 62 and 94, the apparatus 60 may be provided with more coiled electrical conductors positioned adjacent to and on either end of other magnetically conductive conduit segments.

In another embodiment of the apparatus 60 for conditioning fluids, the first coiled electrical conductor 116 may be provided wherein the at least one electrical conductor 122 may be formed having fewer turns of the at least one electrical conductor 122 in each layer, with each layer having a common centerline substantially orthogonal to the boundary wall 112 of the fluid flow conduit 110, the first coiled electrical conductor 116 having the profile of a triangle. In one such embodiment, for instance, the first base angle 128 may form an absolute angle of substantially 45° relative to the outer surface 114 and the second base angle 130 may form an absolute angle of substantially 45° relative to the outer surface 114, or, in other words, the first coiled electrical conductor 116 may form substantially opposing isosceles triangles.

In still another embodiment of the apparatus 60 for conditioning fluids, the first coiled electrical conductor 116 may be provided having at least one coil of the at least one electrical conductor 122 formed with additional turns of the at least one electrical conductor 122 in each layer, with each layer having a common centerline substantially orthogonal to the boundary wall 112 of the fluid flow conduit 110, to provide the first coiled electrical conductor 116 having the profile of an hourglass or a hyperboloid cross section. In one such embodiment, for instance, the first base angle 214 may form an absolute angle of substantially 45° and the second base angle 216 may form an absolute angle of substantially 45° relative to the outer surface 114 of the fluid flow conduit 110 diverging from the outer surface 114.

In one embodiment, the apparatus 60 may further be provided with a helical structure having substantially the same cross-sectional radius of curvature as the internal surface 116 of the boundary wall of the fluid flow conduit 110. The helical structure may have a channel for passage of fluid. In one embodiment, the channel may have a circular cross-sectional shape. However, the channel can have other cross-sectional shapes. The height and pitch ratio of the helical structure may be varied to produce the desired turbulent flow of the fluid.

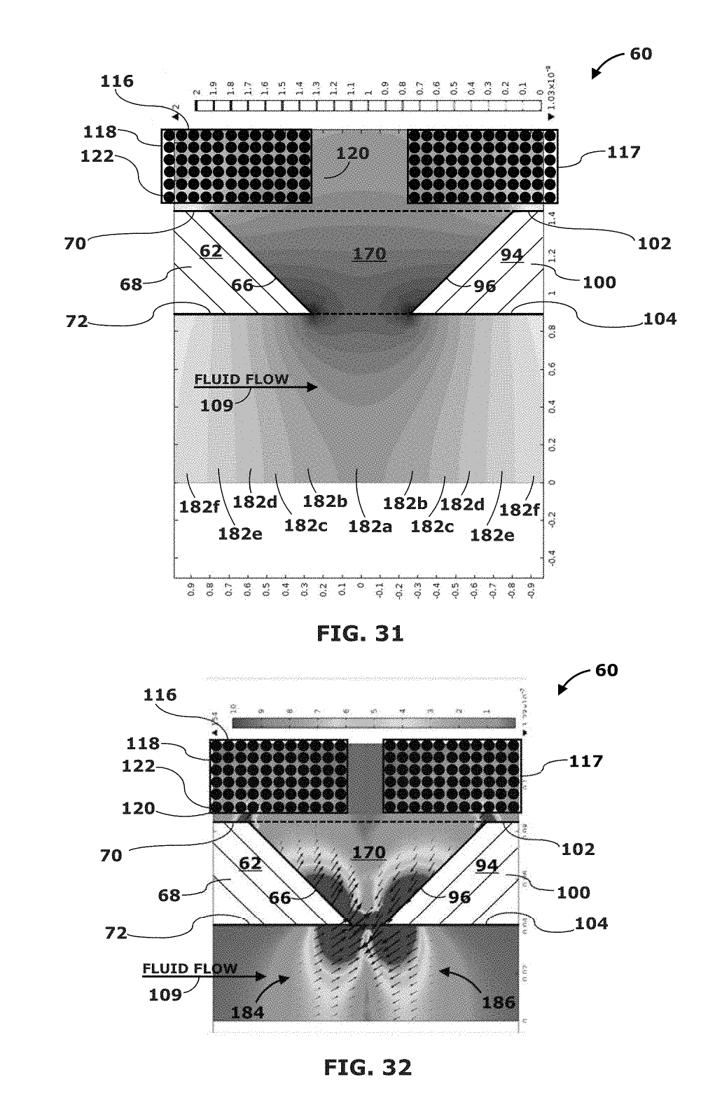

As shown in FIGS. 31-33, computer modeling of the apparatus 60 for conditioning fluids has been performed using COMSOL Multiphysics® software. The structural elements of FIG. 31-32 are substantially the same as that shown in FIG. 30, with the exception that the computer modeled apparatus 60 has a space between the distal end 66 of the upper section of the boundary wall of first magnetically conductive conduit segment 62 and the proximal end 96 of the upper section of the boundary wall of second magnetically conductive conduit segment 94 defining a non-magnetically conductive region 170 (hereinafter the non-magnetically conductive region 170). Therefore, in the interest of brevity, common features of the apparatus 60 will be labeled in FIGS. 31 and 32. The non-magnetically conductive region 170 was modeled as air, and is believed to be analogous to properties of the non-magnetically conductive conduit segment 78.

Graphic representation of the magnetically conductive conduit segments 62 and 94 which have been energized by the first and second coiled electrical conductors 116 and 117 can be seen in FIG. 31. As shown in FIG. 31, the magnetic flux generated by the first and second coiled electrical conductors 116 and 117 is concentrated in the non-magnetically conductive region 170 and also extends into the fluid flow path 109 of the fluid flow conduit 110. This is shown in FIG. 31 as a magnetic energy intensity region 182a, 182b, 182c, 182d, 182e, and 182f that are representative of the different magnetic energy intensities induced into the non-magnetically conductive region 170 and the fluid flow path 109 of the fluid flow conduit 110. The magnetic energy intensity regions 182a, 182b, 182c, 182d, 182e, and 182f are shown with darker shades representing areas having a higher intensity of magnetic energy, and areas shown with lighter shades represent areas with a lower intensity of magnetic energy. As can be seen in FIG. 31, the apparatus 60 for conditioning fluids may subject a volume of fluid flowing along the fluid flow path 109 to different levels of the magnetic energy, with the magnetic energy being most intense near the inner surfaces 72 and 104 and consolidated at the distal end 66 of the first magnetically conductive conduit segment 62 and the proximal end 96 of the second magnetically conductive conduit segment 94.

Referring now to FIG. 32, shown is a graphic representation of a first magnetic force region 184 and second magnetic force region 186 converging between first magnetically conductive conduit segment 62 and second magnetically conductive conduit segment 94. As can be seen from FIG. 32, the first and second magnetic force field regions 184 and 186 extend in substantially opposite directions, converging in the non-magnetically conductive region 170 representing the non-magnetically conductive conduit segment 78 and extending into the fluid flow path 109 of the fluid flow conduit 110. Magnetic force per volume (force density) is proportional to the strength of the magnetic field and the gradient (or rate of change) in the magnetic field. It is believed that magnetic force region 184 induces a first polarity to fluid particles and then magnetic force region 186 induces a second polarity to the fluid particles, thereby creating and applying a “jigging” effect to the volume of fluid which assists and/or results in the various effects referred to herein.

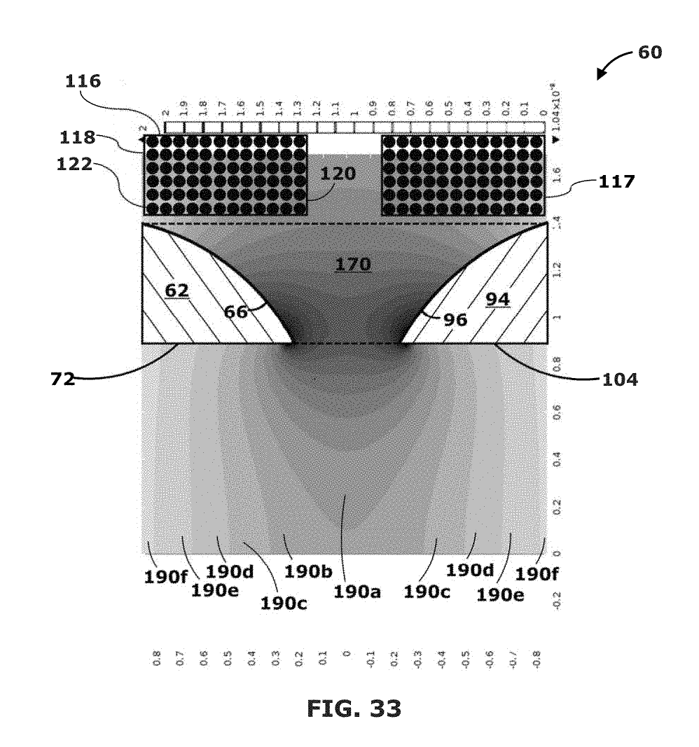

Shown in FIG. 33 is a second model, which is identical to the first model with the exception that the distal end 66 of the first magnetically conductive conduit segment 62 is arcuate, rather than planar, and the proximal end 96 of the second magnetically conductive conduit segment 94 is arcuate, rather than planar.

FIG. 33 graphically represents magnetic field strength created by energizing first and second magnetically conductive conduit segments 62 and 94. In FIG. 33, the magnetic field is shown as magnetic energy intensity bands 190a, 190b, 190c, 190d, 190e, and 190f representative of the different magnetic energy intensity. Magnetic energy intensity bands 1910a, 190b, 190c, 190d, 190e, and 190f having higher intensity magnetic energy are shown with darker shades, and magnetic energy intensity bands 190a, 190b, 190c, 190d, 190e and 190f having lower intensity are shown with lighter shades. As can be seen in FIG. 33, the second model shows that when first and second magnetically conductive conduit segments 62 and 94 are magnetically energized, magnetic energy is concentrated in the non-magnetically conductive region 170 representing the non-magnetically conductive conduit segment 78 and also extends into the fluid flow path 109 of the fluid flow conduit 110. Comparison of FIG. 30 and FIG. 32 shows it is apparent that by changing the shape of the distal end 66 of the first magnetically conductive conduit segment 62, and the proximal end 96 of the second magnetically conductive conduit segment 94, the apparatus 60 for conditioning fluids may be tuned to aim and apply the magnetic energy within the fluid flow path 109 as desired for a given application, for instance, by changing the shape and/or angle of the distal end 66 and the proximal end 96 to apply the magnetic energy into a particular region of the fluid flow path 109. It is also contemplated that the fluid flow conduit 110 may have a first combination of the first magnetically conductive conduit segment 62, the non-magnetically conductive conduit segment 78, and the second magnetically conductive conduit segment 94 having a first configuration of the proximal end 96 and the distal end 66 to provide magnetic energy concentrated in a first region of the fluid flow path 109, and a second combination of the first magnetically conductive conduit segment 62, the non-magnetically conductive conduit segment 78, and the second magnetically conductive conduit segment 94 having a second configuration of the proximal end 96 and the distal end 66 to provide magnetic energy concentrated in a second region of the fluid flow path 109 that is different from the first configuration.

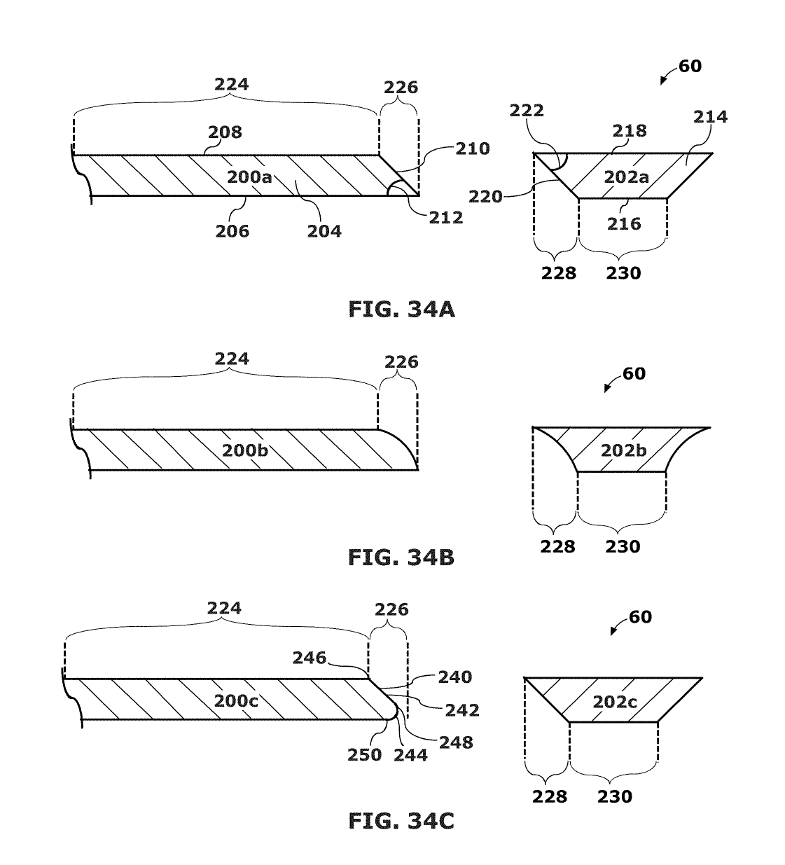

FIG. 34A-34C are schematic representations of possible shapes and/or profiles of the distal end 66 and the proximal end 96 of the magnetically conductive conduit segments 62 and 94 and the proximal end 80 and the distal end 82 of the non-magnetically conductive conduit segment 78 shown in FIG. 30. For purposes of clarity, the examples set forth in FIGS. 34A-34C will be provided with different reference numerals directed to the specific examples. It should also be noted that the shapes, geometries, profiles and connections illustrated and described are for descriptive purposes and are not meant to limit the apparatus 60 for conditioning fluids to the described embodiments. It should also be noted that FIG. 34A-34C depict only one pairing of a magnetically conductive conduit segment 200a, 200b, and 200c and a non-magnetically conductive conduit segment 202a, 202b and 202c, however, a person having skill in the art will recognize that the connections and/or shapes described are representative of the connections and/or shapes that may be utilized at any paring between the magnetically conductive conduit segments 200a, 200b, and 200c and a non-magnetically conductive conduit segment 202a, 202b and 202c.

FIG. 34A shows the magnetically conductive conduit segment 200a and the non-magnetically conductive conduit segment 202a. The magnetically conductive conduit segment 200a and the non-magnetically conductive conduit segment 202a each has a tapered end 210 and 220 and a fluid impervious boundary wall 204 and 214. The fluid impervious boundary walls 204 and 214 have an inner surface 206 and 216 and an outer surface 208 and 218. The magnetically conductive conduit segment 200a may further have a body section 224, a magnetic energy aiming section 226, and a magnetic energy aiming section angle 212. The non-magnetically conductive conduit segment 202a may further have a magnetic energy aiming section connection 228, a body section 230, and a magnetic energy aiming section angle 222.

By way of example, the body section 224 of the magnetically conductive conduit segment 200a may have a uniform thickness extending between the inner surface 206 the outer surface 208. For instance, a 6″ ANSI schedule 80 carbon steel pipe may be used for the magnetically conductive conduit segment 200a. According to the ASTM International Book of Standards A53 (ASTM A53), Standard Specification for Pipe, Steel, Black and Hot-Dipped, Zinc-Coated, Welded and Seamless, a 6″ schedule 80 pipe has an outside diameter (outer surface 208) of 6.625 inches and an inside diameter (inner surface 206) of 5.761 inches, meaning the boundary wall 204 in the body section 224 would be a substantially consistent thickness of 0.432 inches across the body section 224.

Similarly, by way of example, the conduit body section 230 of the non-magnetically conductive conduit segment 202a may have a uniform thickness extending between the inner surface 216 and the outer surface 218. For instance, when a 6″ ANSI schedule 80 carbon steel pipe is used for the magnetically conductive conduit segment 200a, a 6″ ANSI schedule 80S stainless steel pipe may be used for the non-magnetically conductive conduit segment 202a. According to the ASTM A53, a 6″ schedule 80S pipe has a wall thickness of 0.432 inches, or, in other words, the boundary wall 214 of the non-magnetically conductive conduit segment 202a in the conduit body section 230 would be a substantially consistent thickness of 0.432 inches.

Referring now to FIG. 34A in particular, the tapered end 210 in the magnetic energy aiming section 226 of the magnetically conductive conduit segment 200a may form a planar surface extending between the inner surface 206 and the outer surface 208 of the boundary wall 204 of the magnetically conductive conduit segment 200a. The magnetic energy aiming section angle 212 defines the angle of the planar surface of the magnetic energy aiming section 226 and may be between an absolute value of 15° and 75° at one end and between an absolute value of 15° and 75° at the opposite end.

The tapered end 220 in the magnetic energy aiming section 228 of the non-magnetically conductive conduit segment 202a forms a planar surface extending between the outer surface 218 and the inner surface 216 of the boundary wall 214. The magnetic energy aiming section angle 222 defines the angle of the planar surface of the magnetic energy aiming section 228 and may be between an absolute value of 15° and 75° at one end and an absolute value of between 15° and 75° at the opposite end.

Referring now to FIG. 34B another embodiment is shown and described using similar terminology and reference numerals and with the differences between the embodiment of FIG. 34A explained. The tapered end 210 in the magnetic energy aiming section 226 of the magnetically conductive conduit segment 200b may form an arcuate surface extending from the inner surface 206 to the outer surface 208 of the boundary wall 204, rather than the planar surface describe above. As shown in FIG. 34B, the arcuate surface of the magnetic energy aiming section 226 may form a convex shape. The tapered end 220 in the magnetic energy aiming section 228 of the non-magnetically conductive conduit segment 202b may form an arcuate surface extending from the outer surface 218 to the inner surface 216 of the boundary wall 214. As shown in FIG. 34B, the arcuate surface of the tapered end 220 in the magnetic energy aiming section 228 may form a concave shape.

As will be recognized by a person having skill in the art, the tapered ends 210 and 220 of the magnetic energy aiming sections 226 and 228 may be formed to substantially mirror one another facilitating a mechanical interface between the magnetically conductive conduit segment 200a, 200b and 200c and the non-magnetically conductive conduit segment 202a, 202b and 202c. However, in some embodiments, the tapered ends 210 and 220 of the magnetic energy aiming sections 226 and 228 may not mirror one another across the entire tapered end 210 and 220. In other words, the tapered end 210 of the magnetic energy aiming section 226 of the magnetically conductive conduit segment 200a, 200b and 200c may only partially interface with the tapered end 220 of the magnetic energy aiming section 228 of the non-magnetically conductive conduit segment 202a, 202b and 202c. FIG. 34C is a schematic representation of a cross section of one such connection. The magnetic energy aiming section 226 of the magnetically conductive conduit segment 200c forms a segmented surface 240 having a first surface 242 and a second surface 244 the first surface 242 being planar and the second surface 244 forming an arcuate shape. The first surface 242 forms a planar surface extending from a first point 246 to a second point 248. The second surface 244 extends from the second point 248 to a third point 250 of the inner surface of the boundary wall 206 and defining an arcuate shape.

The tapered end 220 in the magnetic energy aiming section 228 of the non-magnetically conductive conduit segment 202c forms a planar surface extending from the outer surface 218 to the inner surface 216. The planar surface of the tapered end 220 may be constructed to substantially mirror the angle of the first surface 242 of the segmented surface 240. For instance, by way of example, the first surface 242 of the tapered end 210 forms a planar surface extending from the first point 246 to the second point 248 along an angle having an absolute value of substantially 45° and the planar surface of the tapered end 220 forms a planar surface extending from the outer surface 218 to the inner surface 216 along an angle having an absolute value of substantially 45° When the magnetically conductive conduit segment 200c and the non-magnetically conductive conduit segment 202c are coupled in axial alignment, the first surface 242 of the tapered end 210 will matingly interface with the planar surface of the tapered end 220. However, the second surface 244 of the segmented surface 240 of the tapered end 210 may not matingly interface with the planar surface of the tapered end 220 as the second surface 244 curves in an arcuate shape from the second point 248 to the third point 250 defining a space between the second surface 244 of the segmented surface 240 of the tapered end 210 and the planar surface of the tapered end 220. As will be recognized by a person having skill in the art, the outer surface of the boundary wall of magnetically conductive conduit segment 200c and/or non-magnetically conductive conduit segment 202c may be formed as a chamfer or an arcuate shape similar to the space between second surface 244 of tapered end 210 and the planar surface of the tapered end 220 to facilitate the mechanical connection of magnetically conductive conduit segment 200c and non-magnetically conductive conduit segment 202c.

Although the first surface 242 of the tapered end 210 is shown forming a planar surface extending from the first point 246 to the second point 248 along an angle having an absolute value of substantially 45° and the planar surface of the tapered end 220 is shown forming a planar surface extending from the outer surface 218 to the inner surface 216 along an angle having an absolute value of substantially 45° it should be noted that in some embodiments the first surface 242 may form an angle having an absolute value between 15° and 75° and the planar surface of tapered end 220 may form an angle having an absolute value between 15° and 75°.

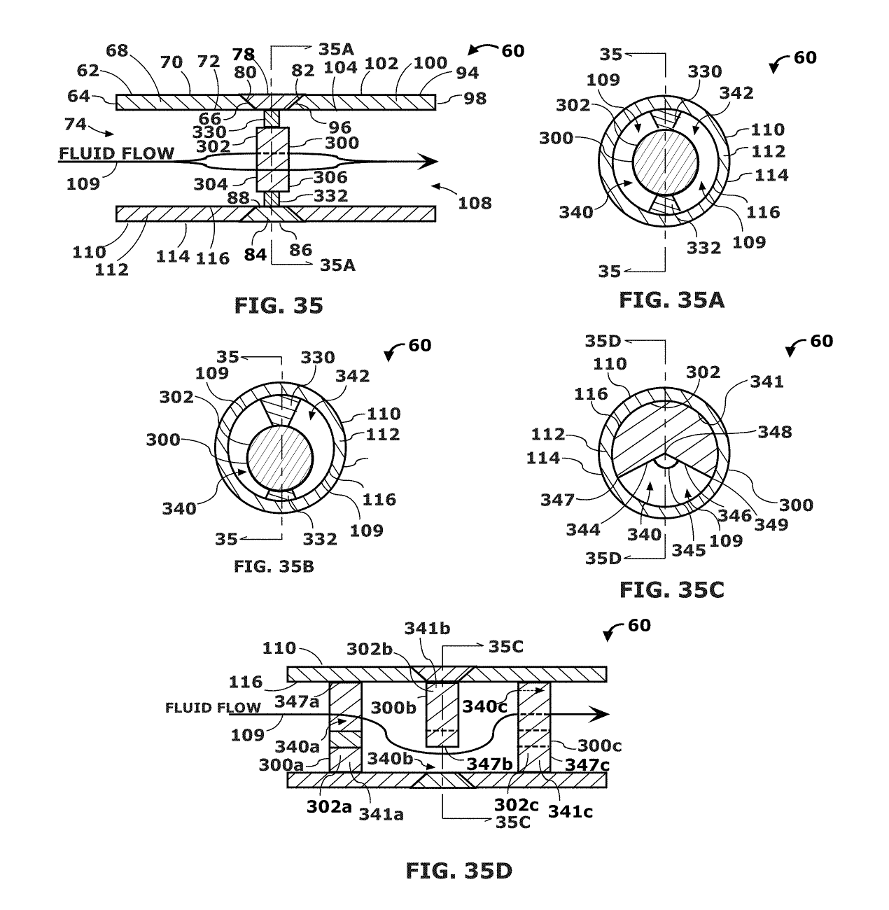

The structural elements of FIGS. 35, 35A, 35B, 35C and 35D are substantially the same as that shown in FIG. 30, therefore, in the interest of brevity, common features of the apparatus 60 will be labeled in FIGS. 35, 35A, 35B, 35C and 35D. Referring now to FIG. 35, the apparatus 60 for conditioning fluids may further be provided with at least one nucleus 300 positioned within the fluid flow path 109 of the fluid flow conduit 110. The nucleus 300 may have an outer surface 302, a first end 304, and a second end 306. The nucleus 300 may be deployed within the fluid flow path 109 of the fluid flow conduit 110 utilizing at least one mechanical connector 330 and 332 extending between the inner surface 116 of the fluid flow conduit 110 and the outer surface 302 of the nucleus 300. As depicted in FIG. 35, the nucleus 300 may be connected between the inner surface 116 of the fluid flow conduit 110 and the outer surface 302 of the nucleus 300 by a first mechanical connector 330 and a second mechanical connector 332. In some embodiments, the magnetically conductive nucleus 300 may be formed with a permanent magnet. Although components 330 and 332 are shown oriented substantially orthogonal to the fluid flow path extending through the conduit, it should be understood that components 330 and 332 may be deployed in oblique, tangential and/or other orientations with the flow path extending through the conduit to form a static mixing device within the fluid flow path 109.

Referring now to FIG. 35A, a cross-section of the apparatus 60 for conditioning fluids is shown. As depicted in FIG. 35A, the nucleus 300 may be disposed within the fluid flow path 109 of the fluid flow conduit 110 in coaxial alignment with the inner surface 116. The first mechanical connector 330 and the second mechanical connector 332 define a first fluid opening 340 and a second fluid opening 342 to permit passage of a fluid past the nucleus 300 within the fluid flow path 109. The first and second mechanical connectors 330 and 332 may form a restriction within the fluid flow conduit 110 which may encompass from 30° to 180° of the cross-sectional area of the fluid flow conduit 110. The size of the first fluid opening 340 and the second fluid opening 342 can collectively vary from 330° to 180° of the cross-sectional area of the fluid flow conduit 110. For instance, as depicted in FIG. 35A, the first fluid opening 340 and the second fluid opening 342 collectively encompass approximately 240° of the cross-sectional area of the fluid flow conduit 110.

FIG. 35B schematically depicts another embodiment of the apparatus 60 for conditioning fluids 60 which is constructed in a similar manner as the apparatus 60 depicted in FIG. 35A, with the exception that the outer surface 302 of the nucleus 300 is in an eccentric relation to the inner surface 116 of the fluid flow conduit 110.

Referring now to FIG. 35C, in another embodiment of the apparatus 60 for conditioning fluids, the nucleus 300 may be provided having a first, second, and third surface 343, 344 and 346 of the outer surface 302, a surface angle 345, a first surface point 347, a central point 348, and a second surface point 349. The first surface 343 of the outer surface 302 may define an arcuate shape extending from the first surface point 347 to the second surface point 349. The second surface 344 of the outer surface 302 may be a planar surface extending from the first surface point 347 to the central point 348. The third surface 346 may be a planar surface extending from the central point 348 to the second surface point 349. The surface angle 345 defines an angle between the planar surface of the second surface 344 and the planar surface of the third surface 346 with the central point 348 being the intersecting point and may be an absolute angle between 75° and 180°. The space between the second and third surface 344 and 346 of the surface 302 of the nucleus 300 defines the fluid opening 340 and allows passage of the fluid past the nucleus 300 in the fluid flow path 109.

The nucleus 300 may be disposed within the fluid flow path 109 in coaxial alignment between the first surface 341 of the outer surface 302 and the inner surface 116 of the fluid flow conduit 110. As shown in FIG. 35C, the first surface 341 of the outer surface 302 of the nucleus 300 may be in fluid communication with the inner surface 116 of the fluid flow conduit 110 forming a connection between the nucleus 300 and the fluid flow conduit 110.

FIG. 35D schematically depicts another embodiment of the apparatus 60 for conditioning fluids having a non-contiguous array of coaxially aligned nuclei comprising a first, second and third nuclei 300a, 300b and 300c disposed within the fluid flow path 109 of the fluid flow conduit 110. The first, second and third nuclei 300a, 300b and 300c may be constructed substantially identical to the nucleus 300 described in FIG. 35C, therefore, in the interest of brevity, the common elements will not be described again with the exception that the letters a, b and c will be added to the numbers to differentiate the elements of the first, second and third nuclei 300a, 300b and 300c respectively for clarity. The first, second and third nuclei 300a, 300b and 300c may be constructed wherein the surface angles 345a, 345b and 345c are absolute angles of substantially 120° with the space between the second surface 344a, 344b and 344c and the third surface 346a, 346b, and 346c of the surface 302a, 302b and 302c forming the fluid opening 340a, 340b and 340c. The first, second and third nuclei 300a, 300b and 300c may be deployed within the fluid flow path 109 with the fluid openings 340a, 340b and 340c being offset by 120°. For instance, as shown in FIG. 35D, the first surface point 347a of the first nucleus 300a may be positioned at a substantially 0° angle, the first surface point 347b of the second nucleus 300b may be positioned at a substantially 120° angle, and the first surface point 347c of the third nucleus 300c may be positioned at a substantially 240° angle relative to the fluid flow conduit 110. The offset deployment of the nuclei 300a, 300b and 300c in the fluid flow path 109 may direct the fluid to flow in a substantially helical pattern providing a mixing effect.

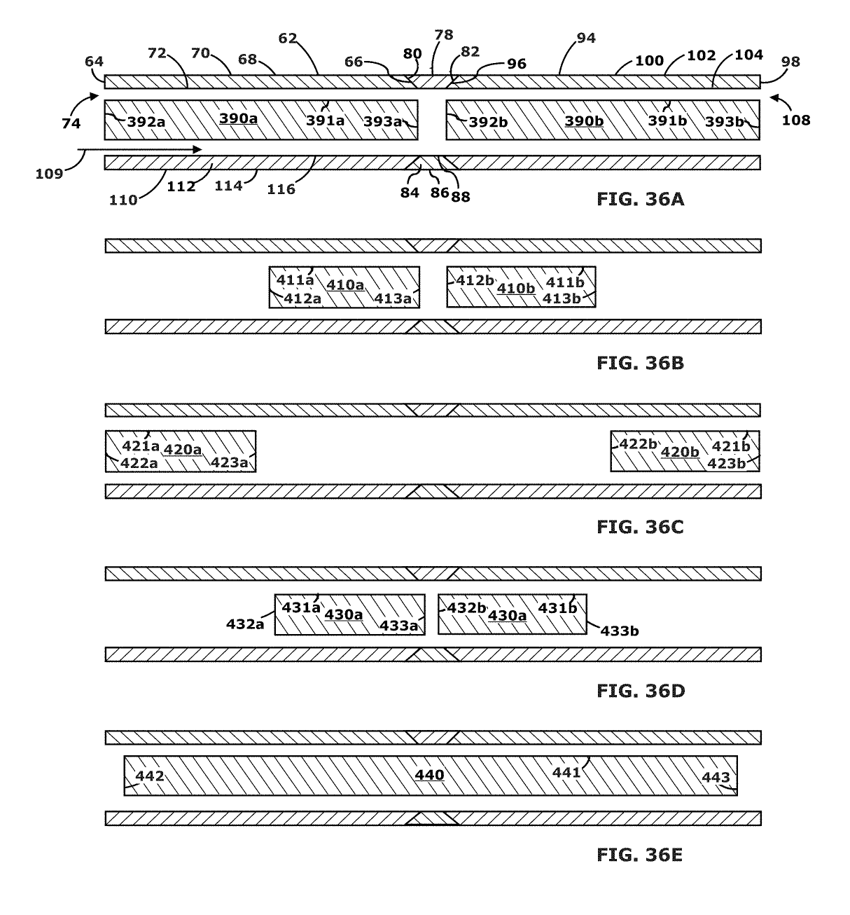

FIG. 36A-36E are schematic representations of possible placement locations of the nucleus 300 within the fluid flow path 109 of the fluid flow conduit 110. For the purposes of clarity, the examples of the nucleus 300 set forth in FIG. 36A-36E will be provided with different reference numerals directed to the specific examples.

Referring now to FIG. 36A, a first nucleus 390a may be deployed within the fluid flow path 109 within the boundary wall of the first magnetically conductive conduit segment 62 and a second nucleus 390a may deployed within the fluid flow path and within the boundary wall of the second magnetically conductive conduit segment 94. A first end 392a of the first nucleus 390a may be substantially aligned with the proximal end 64 of the first magnetically conductive conduit segment 62 and a second end 393a of the first nucleus 390a may be substantially aligned with the distal end 66 of the first magnetically conductive conduit segment 62. The first end 392b of the second nucleus 390b may be substantially aligned with the proximal end 96 of the second magnetically conductive conduit segment 94 and the second end 393b of the second nucleus 390b may be substantially aligned with the distal end 98 of the second magnetically conductive conduit segment 94.

Referring now to FIG. 36B, a first nucleus 410a may be deployed within the boundary wall of first magnetically conductive conduit segment 62 and a second nucleus 410b may be deployed within the boundary wall of second magnetically conductive conduit segment 94. The length of the first nucleus 410a and the second nucleus 410b extending from a first end 412a and 412b to a second end 413a and 413b may be less that the length of the first magnetically conductive conduit segment 62 and the second magnetically conductive conduit segment 94 respectively. The second end 413a of the first nucleus 410a may be substantially aligned with the distal end 66 of the first magnetically conductive conduit segment 62. The first end 412b of the second nucleus 410b may be substantially aligned with the proximal end 96 of the second magnetically conductive conduit segment 94.

Referring now to FIG. 36C, a first nucleus 420a may be deployed within the boundary wall of the first magnetically conductive conduit segment 62 and a second nucleus 420b may be deployed within the boundary wall of the second magnetically conductive conduit segment 94. The length of the first nucleus 420a and the second nucleus 420b from a first end 422a and 422b to a second end 423a and 423b may be less that the length of the first magnetically conductive conduit segment 62 and the second magnetically conductive conduit segment 94 respectively. The first end 422a of the first nucleus 420a may be substantially aligned with the proximal end 64 of the first magnetically conductive conduit segment 62. The second end 423b of the second nucleus 420b may be substantially aligned with the distal end 98 of the second magnetically conductive conduit segment 94.

Referring now to FIG. 36D, a first nucleus 430a may be deployed within the boundary wall 68 of the first magnetically conductive conduit segment 62 and a second nucleus 430b may be deployed within the boundary wall 100 of the second magnetically conductive conduit segment 94. The length of the first nucleus 430a and the second nucleus 430b from a first end 432a and 432b to a second end 433a and 433b may be less that the length of the first magnetically conductive conduit segment 62 and the second magnetically conductive conduit segment 94 respectively. The second end 433a of the first nucleus 430a may be disposed within the boundary wall 84 of the non-magnetically conductive conduit segment 78. The first nucleus 430a may be disposed within the boundary walls 68 and 86 of the first magnetically conductive conduit segment 62 and the non-magnetically conductive conduit segment 78. The first end 432b of the second nucleus 430b may be disposed within the boundary wall 84 of non-magnetically conductive conduit segment 78. The second nucleus 430b may be disposed within the boundary walls 86 and 100 of the non-magnetically conductive conduit segment 78 and the second magnetically conductive conduit segment 94.

Referring now to FIG. 36E, a nucleus 440 may be deployed within the boundary wall 112 of fluid flow conduit 110 with a first end 442 disposed within the boundary wall 68 of first magnetically conductive conduit segment 62 and a second end 443 disposed within the boundary wall 100 of second magnetically conductive conduit segment 94.

The location of the nuclei 300, 300a, 300b, 300c, 390a, 390b, 410a, 410b, 420a, 420b, 430a, 430b and 440 within the fluid flow path 109 may be selected, for instance, to optimize the exposure of the fluid flowing through the fluid flow path 109 to magnetic energy. As discussed herein, the fluid flow conduit 110, when energized by the first and second coiled electrical conductors 116 and 117, concentrates magnetic energy in distinct areas and at distinct points including, but not limited to, the inner surface 116 of the fluid flow conduit 110 and the ends 64, 66, 96 and 98 of the magnetically conductive conduit segments 62 and 94. As a result, deploying the nuclei 300, 300a, 300b, 300c, 390a, 390b, 410a, 410b, 420a, 420b, 430a, 430b and 440 within the fluid flow path 109 in positions designed to direct the flow of the volume of fluid in the fluid flow path 109 may result in more of the fluid volume being exposed to stronger magnetic energy. For instance, in one embodiment shown in FIG. 36A, the nuclei 390a and 390b may be disposed in coaxial alignment with the inner surface 116 of the fluid flow conduit 110 thereby directing the fluid to flow between the inner surface 116 of the fluid flow conduit 110 and the outer surfaces 391a and 391b, or, in other words, the fluid is directed away from the central portion of the fluid flow conduit 110 and out toward the inner surface 116 where the magnetic energy may be stronger. In addition, deploying the first and second nuclei 390a and 390b in non-contiguous coaxial alignment with one another within the fluid flow path 109 may result in a static mixing device extending between the distal end 393a of the first nucleus 390a and the proximal end 392b of the second nucleus 390b.

In operation of one such embodiment, as fluid enters the proximal port 74 of the first magnetically conductive conduit segment 62 of the fluid flow conduit 110 it may be directed toward the inner surface 116 of the boundary wall 112 by the proximal end 392a of the first nucleus 390a. The fluid may then be directed to flow between the inner surface 116 of the boundary wall 112 and the outer surface 391a along the length of the first nucleus 390a. Upon reaching the distal end 393a of the first nucleus 390a, the fluid enters the static mixing device creating a turbulent fluid flow which mixes the fluid. The mixed fluid may then be directed toward the inner surface 116 of the boundary wall 112 of the fluid flow conduit 110 at the proximal port 92 of the second magnetically conductive conduit segment 94 by the proximal end 392b of the second nucleus 390b. The fluid may then be directed to flow along the inner surface 116 of the boundary wall 112 between the inner surface 116 and the outer surface 391b along the length of the second nucleus 390b. As discussed herein, magnetic energy is highest at the inner surface 116 of the fluid flow conduit 110 and the ends 64, 66, 96 and 98 of the magnetically conductive conduit segments 62 and 94. As a result, this embodiment may cause more of the fluid volume passing through the fluid flow path 109 to be exposed to higher levels of magnetic energy as the fluid is directed to flow near the inner surface 116 of the boundary wall 112 and the ends 64, 66, 96 and 98 of the magnetically conductive conduit segments 62 and 94. In addition, the mixing of the fluid volume caused by the static mixer may further ensure that more of the fluid volume is exposed to higher levels of magnetic energy.

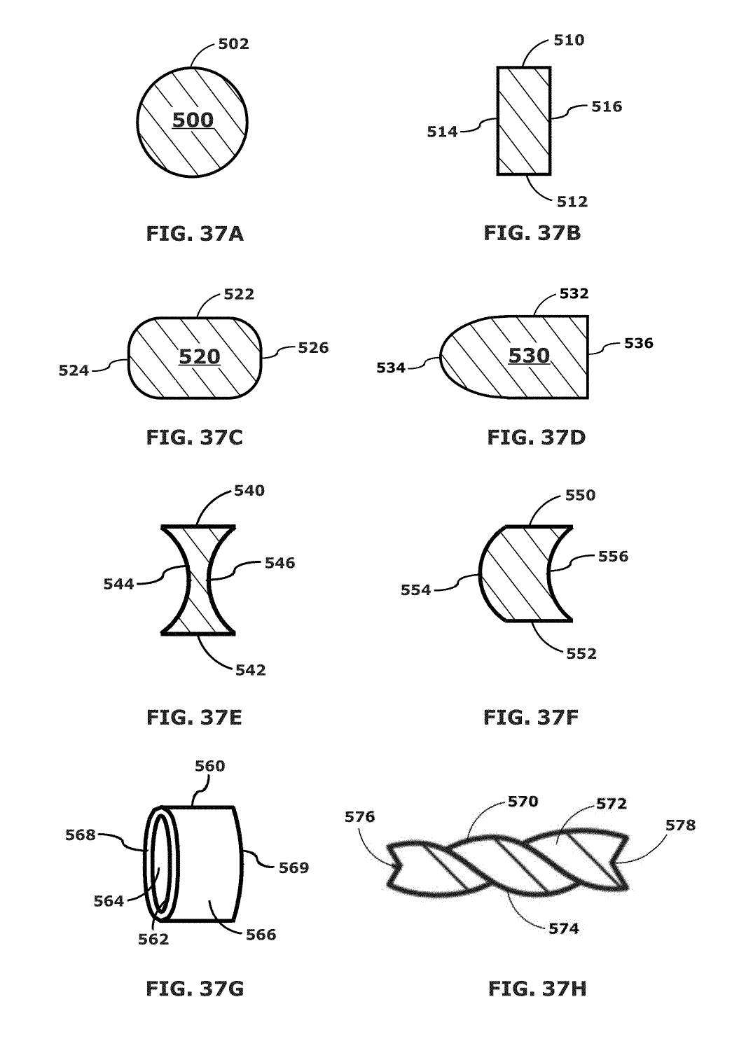

FIG. 37A-37H depict several possible forms of the nucleus 300 in accordance with the presently disclosed inventive concept. For purposes of clarity, the examples set forth in FIG. 37A-37H will be provided with different reference numerals directed to the specific examples. Referring now to FIG. 37A, schematically depicted is a nucleus 500 having a substantially spherical shape with an outer surface 502.

FIG. 37B schematically depicts a nucleus 510 constructed of a length of material having a uniform thickness with an outer surface 512, a first end 514 and a second end 516. The first and second ends 514 and 516 form planar surfaces substantially orthogonal to the longitudinal axis of the nucleus 510.

FIG. 37C schematically depicts a nucleus 520 constructed of a length of material having a uniform thickness with an outer surface 522, a first end 524 and a second end 526. The first end 524 and the second end 526 of the nucleus 520 form planar surfaces that are substantially orthogonal to the longitudinal axis of the nucleus 520. The intersection of the outer surface 522 and the first and second ends 524 and 526 are rounded.

FIG. 37D schematically depicts a nucleus 530 constructed of a length of material having an outer surface 532 with a first end 534 and a second end 536. The first end 534 of the nucleus 530 is shaped to substantially form a hemisphere. The second end 536 of the nucleus 530 forms a planar surface substantially orthogonal to the longitudinal axis of the nucleus 530.

FIG. 37E schematically depicts a nucleus 540 constructed of a length of material having a uniform thickness with an outer surface 542, a first end 544 and a second end 546. The first end 544 of the nucleus 540 may form a concave shape and the second end 546 may form a concave shape.

FIG. 37F schematically depicts a nucleus 550 constructed of a length of material having a uniform thickness with an outer surface 552, a first end 554 and a second end 556. The first end 554 of the nucleus 550 may form a substantially convex shape and the second end 556 may form a substantially concave shape.

FIG. 37G is a perspective view depicting a nucleus 560 constructed of a length of material forming a hollow cylinder defining a fluid impervious boundary wall 562 having an inner surface 564 and an outer surface 566 and having first end 568 and a second end 569.

FIG. 37H schematically depicts a nucleus 570 comprising a length of material formed as an auger having a substantially helicoid flighting shaped outer surface 572 with an outer peripheral edge 574, said auger having a first end 576 and a second end 578.

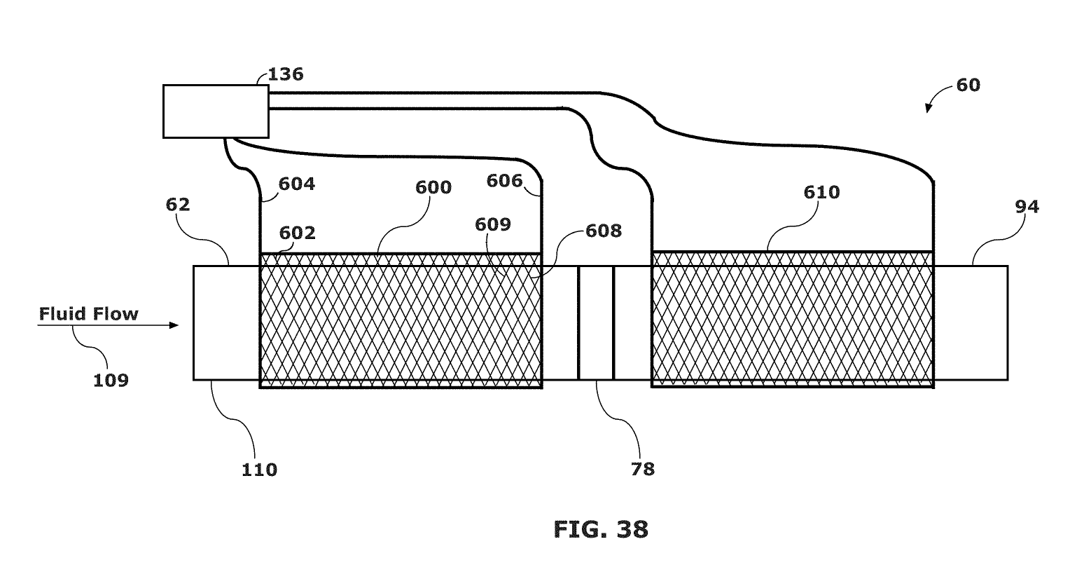

Shown in FIG. 38 is a top plan view depicting another embodiment of the apparatus 60 in which the structural elements are substantially the same as that shown in FIG. 30, with the exception that first and second coiled electrical conductors 116 and 117 are constructed as described below. In the interest of brevity, common features of the apparatus 60 will be labeled in FIG. 38.

Referring now to FIG. 38, first magnetically conductive conduit segment 62, non-magnetically conductive conduit segment 78 second magnetically conductive conduit segment 94 form a serial coupling of conduit segments, with first magnetically conductive conduit segment 62 encircled by a first coiled electrical conductor 600 and second magnetically conductive conduit segment 94 encircled by a second coiled electrical conductor 610. The first coiled electrical conductor 600 and the second coiled electrical conductor 610 may be substantially identical in construction and function. Therefore, in the interest of brevity, only the first coiled electrical conductor 600 will be described. The first coiled electrical conductor 600 may be provided with at least one electrical conductor 602 having a first conductor lead 604 and a second conductor lead 606. The at least one electrical conductor 602 is coiled with a plurality turns in a plurality of layers on the outer surface of the boundary wall of first magnetically conductive conduit 62 on tilted solenoid planes, wherein the turns of a first layer 608 produce a transverse field component and an axial field component having a first direction and the turns of a second layer 609 produce a transverse field component and an axial field component in a second, opposite direction. The first and second conductor leads 604 and 606 may be operably connected to the electrical power supply 136 so as to supply electrical current to first coiled electrical conductors 600 thereby energizing the first coiled electrical conductors 600 to provide a magnetic field having lines of flux directed along a longitudinal axis of fluid flow conduit 110 defining fluid flow path 109.

The combination of the first layer 608 of turns of the at least one electrical conductor 602 on a first tilted solenoid plane in substantially concentric surrounding relation of the second layer 609 of turns of the at least one electrical conductor 602 on a second tilted solenoid plane may result in the cancelling of the axial field components of the first and second layer 608 and 609 so that the transverse components of the first and second layer 608 and 609 of turns produce a pure dipole field.

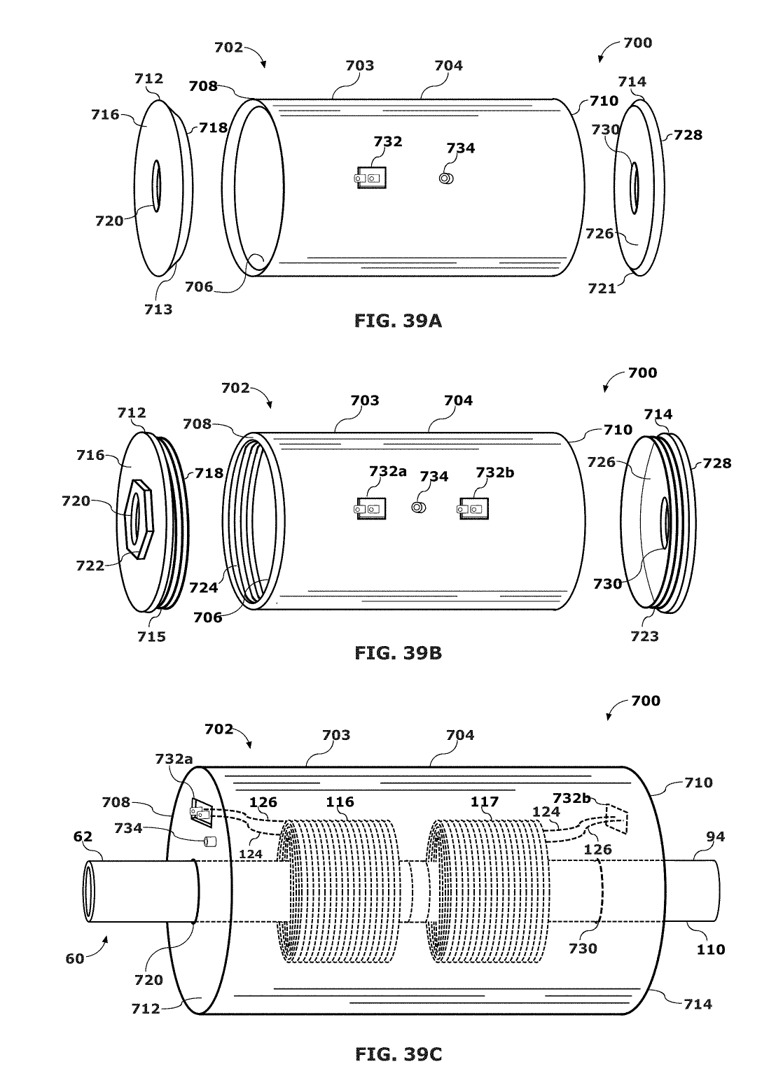

FIG. 39A-39C show plan views of an apparatus 700 having a pressure vessel 702. In the interest of brevity, the common structural elements of the pressure vessel 702 shown in FIG. 39A-39C will be described only once. The pressure vessel 702 may be formed as a cylindrical tube with a fluid impervious boundary wall 703 having an outer surface 704, an inner surface 706, a first end 708 and a second end 710. The apparatus 700 may also be provided with a first end cap 712 and a second end cap 714. The first and second end caps 712 and 714 may have an outer surface 716 and 728, an inner surface 718 and 726, and a port 720 and 730. The pressure vessel 702 may also be provided having at least one electrical connector 732 and a fitting 734.

Referring now to FIG. 39A in particular, in one embodiment the first and second end caps 712 and 714 may be provided having a planar surface 713 and 721 extending between the outer surface 716 and 728 and the inner surface 718 and 726. The planar surfaces 713 and 721 may form, for instance, an absolute angle of substantially 45° extending from the inner surface 718 and 726. The first and second ends 708 and 710 of the boundary wall 703 may be formed having a bevel extending from the outer surface 704 to the inner surface 706 at an absolute angle of substantially 45°. The planar surface 713 and 721 of the first and second end caps 712 and 714 may interface with the first and second ends 708 and 710 of the boundary wall 703 and sealed using methods known in the art such as, for instance, by welding, forming a fluid impervious connection. The electrical connector 732 and the fitting 734 may be deployed, for instance, in fluid connection with and extending through the boundary wall 703 of the pressure vessel 702.

Referring now to FIG. 39B, in another embodiment of the apparatus 700, the first and second end caps 712 and 714 may be provided having a conduit coupler 722 operably connected with the port 720 and 730 and a threaded surface 715 and 723, the threaded surfaces 715 and 723 being external threads. The pressure vessel 702 may be provided having at least a portion of the inner surface 706 of the boundary wall 703 at each of the first and second ends 708 and 710 that is a threaded portion 724, the threaded portion 724 being internal threads. The external threads of the threaded surfaces 715 and 723 may be configured to threadably engage the internal threads of the threaded portions 724 to form a fluid and/or airtight seal as known in the art. The pressure vessel 702 may further be provided having a first electrical connector 732a and a second electrical connector 732b. Although only one conduit coupler 722 associated with the first end cap 712, and one threaded portion 724 are shown, a person of skill in the art will recognize that the second end cap 714 may be provided having a conduit coupler, and the inner surface 706 at the second end 710 may be provided having a threaded portion as well.

Referring now to FIG. 39C, in one embodiment, the pressure vessel 702 of the apparatus 700 may be configured to concentrically surround and enclose at least a portion of the apparatus 60. The structural elements of the apparatus 60 shown in FIG. 39C are substantially identical to that shown in FIG. 30, therefore, in the interest of brevity, common features of the apparatus 60 will be labeled in FIG. 39C. For instance, as shown in FIG. 39C, the first magnetically conductive conduit segment 62 may be concentrically surrounded by and extending through the port 720 of the first end cap 712 and the second magnetically conductive conduit segment 94 may be concentrically surrounded by and extending through the port 730 of the second end cap 714. The first and second electrical connectors 732a and 732b may be deployed, for instance, in fluid communication with and extending through the first and second end caps 712 and 714 respectively. The first and second electrical connectors 732a and 732b may further be configured to operably connect to the first and second conductor leads 124 and 126 of the first and second coiled electrical conductors 116 and 117 of the apparatus 60 respectively. The fitting 734 may be deployed, for instance, in fluid communication with and extending through at least one of the first and second end caps 712 and 714 and may be configured to allow the pressure vessel 702 to be filled and/or emptied of at least one of a gas or a liquid.

In one embodiment of the apparatus 700, the apparatus 60 may be removably deployed within the pressure vessel 702. For instance, the pressure vessel 702 as shown in FIG. 39B, may be configured to enclose the apparatus 60 in a liquid and/or airtight casing. By way of example, the threaded surface 715 of the first end cap 712 may be threadably connected to the threaded portion 724 of the inner surface 706 of the boundary wall 703 at the first end 708 configured to form a liquid and/or airtight seal as known in the art. The apparatus 60 may be deployed within the pressure vessel 702 with the first magnetically conductive conduit segment 62 deployed being concentrically surrounded by and extending through the port 720 and the conduit coupler 722, the conduit coupler 722 being a compression fitting as known in the art. The conduit coupler 722 of the first end cap 712 may be engaged to form a liquid and/or airtight seal with the first magnetically conductive conduit segment 62. The conductor leads 124 and 126 of the first and second coiled electrical conductors 116 and 117 may be operably connected to the first and second electrical connectors 732a and 732b respectively. The second end 714 may be slid into place with the second magnetically conductive conduit segment 94 passing through and being concentrically surrounded by the port 730 and the conduit coupler 722. The threaded surface 723 of the second end cap 714 may be threadably connected to the threaded portion 724 of the inner surface 706 of the boundary wall 703 at the second end 710 configured to form a liquid and/or airtight seal as known in the art. The conduit coupler 722 of the second end cap 714 may then be engaged to form a liquid and/or airtight seal with the second magnetically conductive conduit segment 94. The pressure vessel 702 may then be filled with at least one of a gas and/or a liquid using the fitting 734. As will be recognized by one of ordinary skill in the art, this embodiment of the pressure vessel 702 would allow the apparatus 60 to be serviced and/or removed and replaced if necessary and then re-sealed.

In one embodiment as shown in FIG. 39C, the pressure vessel 702 may be constructed of a magnetically conductive material such as, for instance, carbon steel. The planar surface 713 of the first end cap 712 may be interfaced with the first end 708 of the boundary wall 703 of the pressure vessel 702 and circumferentially welded forming a fluid impervious seal. The apparatus 60 may be coaxially disposed within the inner surface 706 of the boundary wall 703 with the first magnetically conductive conduit segment 62 concentrically surrounded by and extending through the port 720 of the first end cap 712. The first magnetically conductive conduit segment 62 may be circumferentially welded to the port 720 of the first end cap 712 forming a fluid impervious seal. The first and second conductor leads 124 and 126 of the first coiled electrical conductor 116 may be operably connected to the electrical connector 732. Although not numbered, it is to be understood that the first and second conductor leads of the second coiled electrical conductor 117 may also be operably connected to the electrical connector 732a, or, in another embodiment, the first and second conductor leads may be operably connected to a second electrical connector disposed in the second end cap 714. The second end cap 714 may then be slid into place with the second magnetically conductive conduit segment 94 concentrically surrounded by and extending through the port 730. The planar surface 721 of the second end cap 714 may be interfaced with the second end 710 of the boundary wall 703 of the pressure vessel 702 and circumferentially welded forming a fluid impervious seal. The second magnetically conductive conduit segment 94 may be circumferentially welded to the port 730 of the second end cap 714 forming a fluid impervious seal. The pressure vessel 702 would then be fully sealed and may be, for instance, filled with a liquid and/or gas through the fitting 734.

In another embodiment, the apparatus 700 may be removably deployed, for instance, in an existing fluid flow system. Utilizing an embodiment essentially identical to the one described in the preceding paragraph, the apparatus 700 may be configured to concentrically surround an existing non-magnetically conductive fluid flow conduit configured to direct the flow of fluid. The fluid flow conduit 110 of the apparatus 60 which is enclosed and sealed within the apparatus 700 may slide over and concentrically surround the existing non-magnetically conductive fluid flow conduit forming a sleeve surrounding the existing conduit. When energized, the apparatus 60 may be configured to direct magnetic energy into the existing non-magnetically conductive fluid flow conduit.

In another embodiment, the apparatus 700 may be configured wherein the fluid flow conduit 110 of the apparatus 60 being one diameter concentrically surrounds at least one second fluid flow conduit being constructed substantially identical to the fluid flow conduit 110.

In still another embodiment of the apparatus 700 having the apparatus 60 deployed within the pressure vessel 702, the conductor leads 124 and 126 of the first and second coiled electrical conductors 116 and 117 may be connected to a single electrical connector 732.

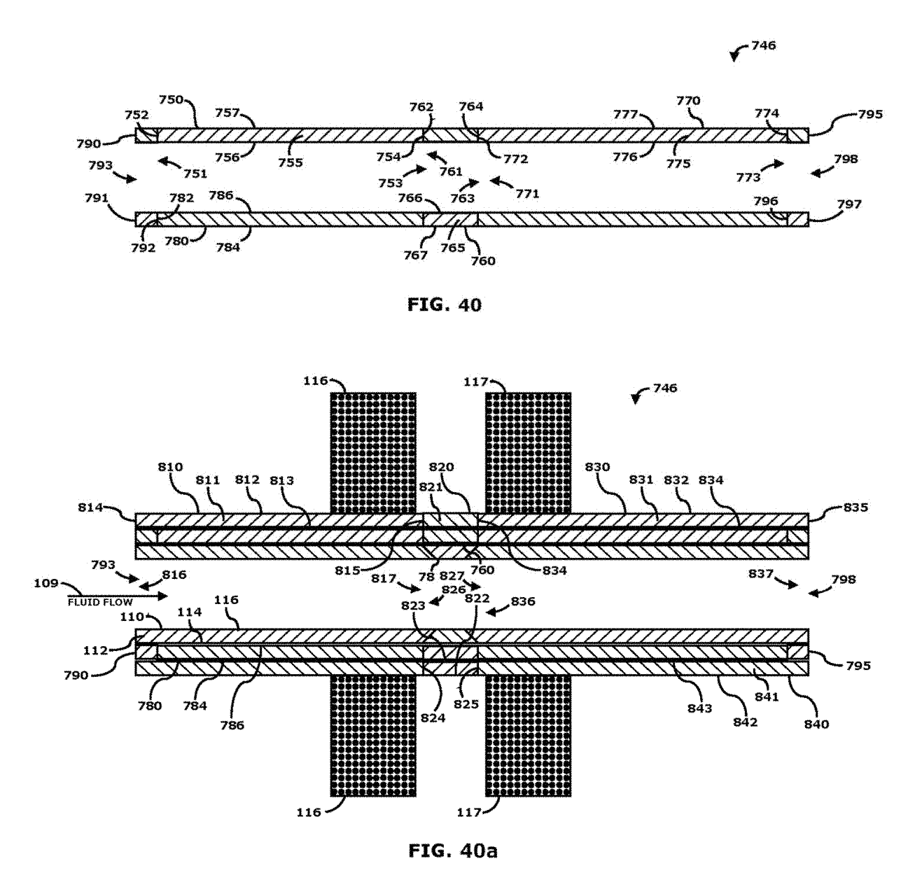

Referring now to FIG. 40, a cross sectional view of a pressure containment system 746 is shown comprising a serial coupling of axially aligned conduit segments having a first magnetically conductive conduit segment 750, a non-magnetically conductive conduit segment 760, a second magnetically conductive conduit segment 770, a first end cap 790, and a second end cap 795 in fluid communication with each other forming a pressure vessel 780. The first magnetically conductive conduit segment 750, the non-magnetically conductive conduit segment 760, and the second magnetically conductive conduit segment 770 each have a first port 751, 761 and 771 at a proximal end 752, 762 and 772, a second port 753, 763 and 773 at a distal end 754, 764 and 774, and a boundary wall 755, 765 and 775 having an inner surface 756, 766 and 776 and an outer surface 757, 767 and 777 extending between the first port 751, 761 and 771 and the second port 753, 763 and 773.

The first and second end caps 790 and 795 each have a first end 791 and 796, a second end 792 and 797, and a port 793 and 798. The second end 792 of the first end cap 790 may be provided in fluid communication with the proximal end 752 of the first magnetically conductive conduit segment 750, and the first end 796 of the second end cap 795 may be in fluid communication with the distal end 774 of the second magnetically conductive conduit segment 770.

In one embodiment of the pressure containment system 746, the first end cap 790, the first magnetically conductive conduit segment 750, the non-magnetically conductive conduit segment 760, the second magnetically conductive conduit segment 770, and the second end cap 795 may be mechanically connected at the boundary wall 755, 765, 775, the second end 792 of the first end cap 790, and the first end 796 of the second end cap 795 for instance, by welding the conduit segments 750, 760 and 770 and the end caps 790 and 795 together to form the pressure vessel 780 having a boundary wall 782 with an inner surface 786 and an outer surface 784 extending from the port 793 of the first end cap 790 to the port 798 of the second end cap 795.

In one embodiment of the pressure vessel 780, the first and second end caps 790 and 795 may be constructed of a magnetically conductive material. In another embodiment, the first and second end caps 790 and 795 may be constructed of a non-magnetically conductive material. In still another embodiment, one of the first and second end caps 790 and 795 may be constructed of a magnetically conductive material and the other end cap may be constructed of a non-magnetically conductive material.

Referring now to FIG. 40A, shown therein is the fluid flow conduit 110 positioned within the boundary wall 782 of the pressure vessel 780 with the non-magnetically conductive segment 760 of the pressure vessel 780 positioned adjacent to and substantially aligned with the non-magnetically conductive conduit segment 78 of the fluid flow conduit 110. The structural elements of the fluid flow conduit 110 are described above with reference to FIG. 30, and the structural elements of the pressure vessel 780 is described above with reference to FIG. 40. Therefore, in the interest of brevity, common features of the fluid flow conduit 110 and the pressure vessel 780 will be labeled in FIG. 40A.

As shown in FIG. 40A, in one embodiment of the pressure containment system 746 the pressure vessel 780 may sleeve the fluid flow conduit 110 and the pressure vessel 780 may be sleeved by a coil core 840. The coil core 840 may be comprised of a serial coupling of axially aligned coil core segments having a first magnetically conductive coil core segment 810, a non-magnetically conductive coil core segment 820, and a second magnetically conductive coil core segment 830 in fluid communication with one another to form the coil core 840. The first magnetically conductive coil core segment 810, the non-magnetically conductive coil core segment 820, and the second magnetically conductive coil core segment 830 each have a first port 816, 826 and 836 at a proximal end 814, 824 and 834, a second port 817, 827 and 837 at a distal end 815, 825 and 835, and a boundary wall 811, 821 and 831 having an inner surface 813, 823 and 843 and an outer surface 812, 822 and 832 extending between the first port 816, 826 and 836 and the second port 817, 827 and 837.

The first magnetically conductive coil core segment 810, the non-magnetically conductive coil core segment 820, and the second magnetically conductive coil core segment 830 may be mechanically connected at the boundary wall 811, 821, and 831 for instance, by welding the segments together to form the coil core 840 further having a boundary wall 841 with an inner surface 843 and an outer surface 842 extending from the first port 816 of the first magnetically conductive coil core segment 810 to the second port 837 of the second magnetically conductive coil core segment 830.

As shown in FIG. 40A, the inner surface 843 of the coil core 840 may concentrically surround at least a portion of the outer surface 784 of the pressure vessel 780. The inner surface 786 of the pressure vessel 780 may in turn concentrically surround the outer surface 114 of the fluid flow conduit 110. The inner surface 116 of fluid flow conduit 110 forms the fluid flow path 109. The non-magnetically conductive coil core segment 820 of the coil core 840 may overlap and be substantially aligned with the non-magnetically conductive conduit segment 760 of the pressure vessel 780, which may overlap and be substantially aligned with the non-magnetically conductive conduit segment 78 of the fluid flow conduit 110.

In one embodiment of the pressure containment system 746, the first coiled electrical conductor 116 may concentrically surround at least a portion of the first magnetically conductive coil core segment 810 of the coil core 840 and the second coiled electrical conductor 117 may concentrically surround at least a portion of the second magnetically conductive coil core segment 830.

Although the first end 791 of the first end cap 790 and the second end 797 of the second end cap 795 of the pressure vessel 780 are shown substantially aligned with the proximal end 814 of the first magnetically conductive coil core segment 810 and the distal end 835 of the second magnetically conductive coil core segment 830 of the coil core 840, it will be recognized by a person having skill in the art that this is not necessary and in some embodiments they may not be substantially aligned.

In one embodiment, the pressure vessel 780 may be mechanically connected to the fluid flow conduit 110, for instance, by welding the first and second end caps 790 and 795 to the outer surface 114 of the boundary wall 112. To facilitate the mechanical connection, the ports 793 and 798 of the first and second end caps 790 and 795 may be configured to have a slightly greater diameter (e.g., within 0.05 inches) than the outside diameter of the fluid flow conduit 110 so that the fluid flow conduit 110 can be pre-assembled and then positioned within the pressure vessel 780. However, it will be recognized by a person of skill in the art that when the outside diameter of the fluid flow conduit 110, i.e. the diameter of the outer surface 114, is within 0.05 inches of the inside diameter of the pressure vessel 780, i.e. the diameter of the inner surface 786 of the boundary wall , the first and second end caps 790 and 795 may be omitted and the proximal end 752 of the first magnetically conductive conduit segment 750 and the distal end 774 of the second magnetically conductive conduit segment 770 may be mechanically connected to the outer surface 114 of the boundary wall 112 of the fluid flow conduit 110, for instance, by welding.

In another embodiment, the pressure vessel 780 may be mechanically connected to the fluid flow conduit 110, for instance as described above, and the combination may be sleeved within the coil core 840 configured such that the combined pressure vessel 780 and the fluid flow conduit 110 can be removed from within the coil core 840, for instance, for servicing of the fluid flow conduit 110.

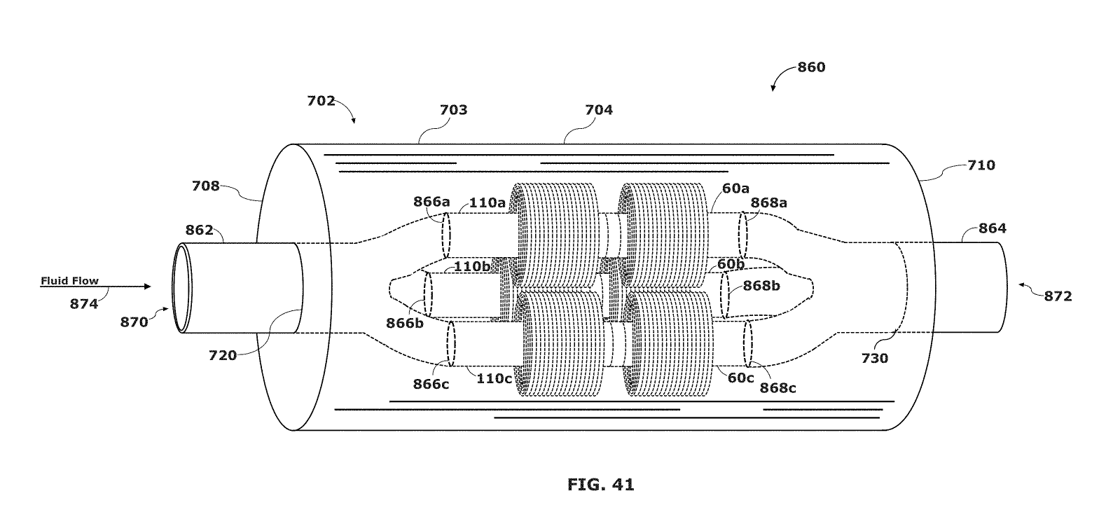

Referring to FIG. 41, shown there is one embodiment of a pressure containment system 860 constructed in accordance with the present disclosure. Some of the structural elements depicted in FIG. 41 are substantially the same as that shown in FIGS. 39A-39C. Therefore, in the interest of brevity, common features of the pressure vessel 702 will be labeled in FIG. 41. FIG. 41 is a plan view depicting one embodiment of the pressure containment system 860 comprising the pressure vessel 702, a plurality of the apparatus 60 for conditioning fluids (e.g., constructed as described above with reference to FIG. 30) positioned within the pressure vessel 702, an inlet manifold 862 and an outlet manifold 864. By way of example, three of the apparatus 60 are shown in FIG. 41 and designated as a first apparatus 60a, a second apparatus 60b and a third apparatus 60c. It should be understood that two or more of the apparatus 60 can be included in the pressure containment system 860 and disposed within the pressure vessel 702.

In one embodiment, the inlet manifold 862 and the outlet manifold 864 are connected to and support the first apparatus 60a and the second apparatus 60b and the third apparatus 60c in parallel. In the example shown, the inlet manifold 862 further comprises a port 870 in fluid communication with a first tubular connector 866a, a second tubular connector 866b, and a third tubular connector 866c. The outlet manifold 864 further comprises a port 872 in fluid communication with a first tubular connector 868a, a second tubular connector 868b, and a third tubular connector 868c.

The apparatus 60a has a fluid flow conduit 110a; the apparatus 60b has a fluid flow conduit 110b, and the apparatus 60c has a fluid flow conduit 110c. The fluid flow conduits 110a, 110b and 110c may be constructed in an identical fashion as the fluid flow conduit 110 that is described above. The first tubular connectors 866a and 868a are connected to and support the fluid flow conduit 110a of the apparatus 60a. The second tubular connectors 866b and 868b are connected to and support the fluid flow conduit 110b of the apparatus 60b. The third tubular connectors 866c and 868c are connected to and support the fluid flow conduit 110c of the apparatus 60c. The first, second, and third tubular connectors 866a, 866b, and 866c of the inlet manifold 862 may be provided in fluid communication with one end of the fluid flow conduits 110a, 110b and 110c of the first, second, and third apparatus 60a, 60b, and 60c and the first, second, and third tubular connectors 868a, 868b, and 868c of the outlet manifold 864 may be provided in fluid communication with the other end of the fluid flow conduits 110a, 110b and 110c of the first, second and third apparatus 60a, 60b, and 60c to provide a fluid flow path 874 extending from the port 870 of the inlet manifold 862 through the first, second, and third apparatus 60a, 60b, and 60c, and exiting the port 872 of the outlet manifold 864. In one embodiment of the pressure containment system 860, the inlet manifold 862 may be concentrically surrounded by and extend through port 720 of the first end 708 of the pressure vessel 702 and the outlet manifold 864 may be concentrically surrounded by and extend through port 730 of the second end 710 of the pressure vessel 702.

In one embodiment of the pressure containment system 860, the port 870 of the inlet manifold 862 may be 10″ in diameter, for instance, and the fluid flow conduits 110a, 110b, and 110c of the first, second, and third apparatus 60a, 60b, and 60c may be 4″ in diameter. In this embodiment, the ports 870 and 872 may have a larger internal diameter than an internal diameter of the fluid flow conduits 110a, 110b, and 110c thereby providing an enhanced flow capacity relative to a flow capacity of any of the fluid flow conduits 110a, 110b and 110c individually. Further, providing the first, second, and third apparatus 60a, 60b, and 60c in parallel may provide a turbulent mixing of the fluid as the fluid flows through the inlet manifold 862 well as a larger surface area for exposing the fluid to a magnetic energy. Although ports 870 and 872 have been described as having a diameter of 10″, it will be recognized by a person having ordinary skill in the art that the pressure containment system 860 may be provided with ports 870 and 872 having different diameters, for instance 6″, 8″, 10″, 12″, 14″, 16″, 18″, 20″, 22″, 24″ or other diameters, such as piping having metric measurements. Likewise, a number and internal diameter of the fluid flow conduits 110a, 110b, and 110c may be provided having diameters designed to maximize flow and/or surface area corresponding to the diameter of ports 870 and 872.

Although the pressure containment system 860 is shown with the pressure vessel 702 containing three apparatus 60a, 60b, and 60c, it should be noted that the pressure containment system 860 may be provided with the pressure vessel 702 containing more (for instance 4, 5, or 6) or less (for instance 2) apparatus 60. It will be recognized by a person having skill in the art that the number of apparatus 60, the diameter of the fluid flow conduits 110 of the apparatus 60, and the diameter of the ports 870 and 872 may be selected and/or designed to fit specific needs or for specific embodiments of the pressure containment system 860. Further, each of the apparatus 60 can be provided with a pressure vessel surrounding and encompassing the coiled electrical conductors 116 and 117 in an identical manner as the pressure vessel 702 surrounds and encompasses portions of the apparatus 60 shown in FIG. 39C.

From the above description, it is clear that the inventive concepts disclosed herein are well adapted to carry out the objects and to attain the advantages mentioned herein, as well as those inherent in the inventive concepts disclosed herein. For instance, when a fluid flow 109 is provided through the fluid flow conduit 110, the fluid flow 109 is conditioned and also serves to dissipate heat being generated by the coiled electrical conductors 116 and 117 and flowing through the coil core 840, the pressure vessel 780 and the fluid flow conduit 110 due to the coil core 840, the pressure vessel 780 and the fluid flow conduit 110 being constructed of thermally conductive material, such as metal. The cooling of the coiled electrical conductors 116 and 117 by the fluid flow 109 permits the magnetic energy to be maintained at substantially constant levels discussed above for periods of time including hours, days, weeks or months or years. Cooling of the coiled electrical conductors 116 and 117 may be provided by the distribution of at least one thermal dissipation material between coiled electrical conductors 116 and 117 and/or the outer layer of the coiled electrical conductors 116 and 117 and the inner surface of a protective coil enclosure, and without any need for fans to circulate air around the coils, cryogenic cooling systems or ancillary cooling systems circulating water, liquid nitrogen, liquid helium and other heat dissipating fluids around and/or through the coiled electrical conductors 116 and 117. While the embodiments of the inventive concepts disclosed herein have been described for purposes of this disclosure, it will be understood that numerous changes may be made and readily suggested to those skilled in the art which are accomplished within the scope and spirit of the inventive concepts disclosed herein.

What is claimed is:

1. An apparatus, comprising:
a magnetically conductive conduit having a fluid entry port, a fluid impervious boundary wall and a fluid discharge port defining a fluid impervious flow path through the magnetically conductive conduit, at least one end of the conduit having a taper forming a planar surface extending from an outer surface to an inner surface forming an angle having an absolute value within a range from about 15° to about 75°;
at least one electrical conductor comprising at least one length of an electrical conducting material having a first conductor lead and a second conductor lead, the electrical conductor coiled with at least one turn to form at least one uninterrupted coil of electrical conductor encircling at least a section of the outer surface of the magnetically conductive conduit, the at least one uninterrupted coil of electrical conductor having a length measurement in a range from 0.5 inches to 48 inches, at least one end of the uninterrupted coil of electrical conductor spaced a distance in a range from 0.00 inches to 14 inches from an end of the magnetically conductive conduit; and
at least one electrical power supply operably connected to at least one of the first and second conductor leads, wherein the at least one coiled electrical conductor is thereby energized to provide a magnetic field having lines of flux directed along a longitudinal axis of the magnetically conductive conduit.

2. The apparatus of claim 1, wherein the magnetic field is concentrated in a plurality of distinct areas along the longitudinal axis of the magnetically conductive conduit.

3. The apparatus of claim 1, wherein the magnetically conductive conduit has a first length of magnetically conductive conduit adapted to sleeve a second length of magnetically conductive conduit.

4. The apparatus of claim 1, wherein the magnetically conductive conduit has a first magnetically conductive conduit segment adapted to sleeve a non-contiguous array of a second magnetically conductive conduit segment and a third magnetically conductive conduit segment.

5. The apparatus of claim 1, wherein the magnetically conductive conduit is adapted to sleeve at least one length of non-magnetically conductive fluid flow conduit.

6. The apparatus of claim 1, wherein the at least one electrical conductor is coiled with at least one turn to form at least one first uninterrupted coil of electrical conductor encircling at least a section of the magnetically conductive conduit and at least one second uninterrupted coil of electrical conductor encircling at least a section of the magnetically conductive conduit, the first uninterrupted coil of electrical conductor spaced a distance from the second uninterrupted coil of electrical conductor, the distance being from about 0.25 inches to about 14 inches.

7. The apparatus of claim 1, wherein the magnetically conductive conduit is a first magnetically conductive conduit, and further comprising a non-magnetically conductive conduit, and a second magnetically conductive conduit, the first magnetically conductive conduit, the non-magnetically conductive conduit, and the second magnetically conductive conduit connected together to form a serial coupling of conduit segments forming a conduit having a fluid entry port, a fluid impervious boundary wall and a fluid discharge port defining a fluid impervious flow path through the conduit, the first and second magnetically conductive conduit segments establishing magnetically conductive regions and the non-magnetically conductive conduit establishing a non-magnetically conductive region wherein the non-magnetically conductive conduit is positioned between the first magnetically conductive conduit and the second magnetically conductive conduit, the first magnetically conductive conduit having a first end adjacent to the non-magnetically conductive conduit, and the second magnetically conductive conduit having a second end adjacent to the non-magnetically conductive conduit segment, the first end of the first magnetically conductive conduit being spaced from 0.125 inches to 3.5 inches from the second end of the second magnetically conductive conduit.

8. The apparatus of claim 7, wherein the at least one electrical conductor encircles at least a section of the first magnetically conductive conduit, the non-magnetically conductive conduit and at least a section of the second magnetically conductive conduit, wherein a length to height ratio of the coil is either (a) approximately 7:1 or (b) between about 1:1 to about 1:6.

9. The apparatus of claim 7, wherein the uninterrupted coil encircles the first magnetically conductive conduit, and has an end spaced a distance from about 0.25 inches to about 14 inches from the non-magnetically conductive conduit.

10. The apparatus of claim 7, wherein the first magnetically conductive conduit, the non-magnetically conductive conduit, and the second magnetically conductive conduit are adapted to sleeve at least one non-magnetically conductive fluid flow conduit.

11. The apparatus of claim 1, wherein the magnetically conductive conduit has at least one magnetically conductive conduit segment adapted to sleeve a serial coupling of conduit segments.

12. The apparatus of claim 1, wherein the magnetically conductive conduit is a first magnetically conductive conduit, and further comprising a second magnetically conductive conduit and a non-magnetically conductive conduit, the first magnetically conductive conduit, the non-magnetically conductive conduit, and the second magnetically conductive conduit being serially coupled to form a first serial coupling adapted to sleeve a second serial coupling of conduit segments.

13. The apparatus of claim 1, further comprising at least one magnetically conductive nucleus disposed within the magnetically conductive conduit.

14. The apparatus of claim 7, further comprising at least one magnetically conductive nucleus disposed within the non-magnetically conductive conduit.

15. The apparatus of claim 1, wherein the at least one supply of electrical power supply is at least one of continuous or pulsed.

16. The apparatus of claim 1, wherein the at least one supply of electrical power is pulsed with a repetition rate in a range of from about 1 Hz to 3 MHz.
